(19) United States
(12) Patent Application Publication
(10) Pub. No.: US 2004/0163116 A1
(43) Pub. Date: Aug. 19, 2004

(54) Information recording medium, information reproduction apparatus, and information reproduction method

(76) Inventors: Kazuhiko Taira, Yokohama-shi (JP); Hideki Mimura, Yokohama-shi (JP); Takao Sawabe, Tokorozawa-shi (JP); Takeshi Koda, Tokorozawa-shi (JP); Akira Imamura, Tokorozawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/748,304

(22) Filed: Dec. 31, 2003

(30) Foreign Application Priority Data
Jan. 6, 2003 (JP) 2003-000730

(51) Int. Cl. H04N 7/173; H04N 7/16

(52) U.S. Cl. 725/89; 725/134; 725/142

(57) ABSTRACT

A sub-picture category (SP_CAT) is added to a sub-picture unit header (SPUH) configuring a sub-picture unit, and a flag “Raw” indicating pixel data run length compression/non-compression is provided in the header. Original data with a 4-bit/1-pixel configuration is subjected to run length compression, and if the data after compression exceeds the size of the original data, flag “Raw”=1 (non-compression) is specified. If the data is slightly compressed, flag “Raw”=0 (compression) is specified, thereby enabling efficient recording of sub-picture information in a recording medium.

### CROSS-REFERENCE TO RELATED APPLICATIONS

This application is based upon and claims the benefit of priority from the prior Japanese Patent Application No. 2003-000730, filed Jan. 6, 2003, the entire contents of which are incorporated herein by reference.

### BACKGROUND OF THE INVENTION

1. Field of the Invention

The present invention relates to an information recording medium such as an optical disk for recording data of different purposes or types such as compressed motion picture data or voice data. The present invention also relates to an information playback apparatus and an information playback method for reproducing data from the medium.

2. Description of the Related Art

With recent spread of DVD video disks each having a high image quality and advanced functions and DVD video players for playing back the disks, there have been a variety of options including a peripheral device for reproducing multiple channel audio thereof, and there has been managed an environment in which home movie theater can be already achieved among popularity and in which a cinema, animation and the like can be freely enjoyed at home.

Further, in the past years, with the improvement of image compression technique, there has been a growing demand for recording high image quality contents of high definition TV scheme (hereinafter, simply referred to as an HD scheme) in a DVD video disk from a contents producer. Accordingly, there has been a demand for the similar improvement of image quality in expression capability of sub-picture information which has been utilized as a caption or menu information.

As a conventional compression technique for sub-picture information, there is provided a system for encoding or decoding sub-picture image data, the system compressing image data by replacing all of consecutive image data on sub-pictures, for example, in the form of one of the serial number of image data and the associated pixel data (for example, refer to Japanese Patent Application KOKAI Publication No. 8-242448).

However, with respect to a sub-picture which is a caption or menu information for high image quality contents of the HD scheme, there is a demand for capability of expressing 16 or more colors from the contents producer. The sub-pictures handled by the prior art is a 1-pixel, 2-bit expression (4 colors) which corresponds to contents of a conventional standard definition TV scheme (hereinafter, simply referred to as an SD scheme). Therefore, in the conventional method, sufficient compression of a sub-picture for high image quality cannot be carried out. That is, in image data on a sub-picture of 1-pixel, 4-bit expression (16 colors), a probability that the same image data is generated is lowered, and thus, a continuous run probability in which runs become continuous (for example, “01b”→“01b”) is lowered from ¼ to 1/16 as compared with the 1-pixel, 2-bit expression (4 colors). Therefore, if image data on a sub-picture of 1-pixel, 4-bit expression (16 colors) is compressed by a conventional encoding method on the presumption that continuous runs frequently take place, patterns of “image data with counter value 0” in the case of non-continuous runs appears continuously. Thus, there is a problem that compression of image data is sufficiently carried out because the capacity of the counter values becomes a burden.

### BRIEF SUMMARY OF THE INVENTION

It is an object of the present invention to provide an information recording medium, an information playback apparatus, and an information playback method capable of efficiently recording sub-picture information with high image quantity according to high image quality contents.

According to an embodiment of the present invention, there is provided an information recording medium recording a video manager and a plurality of video title sets, wherein each of the video title sets describes video title set information; the video title set information describes a video title set information management table; the video title set information management table describes an attribute of a sub-picture stream about a video title set menu; and the attribute of the sub-picture stream describes a flag indicating a method for storing pixel data and a flag indicating a run length compression/non-compression of the pixel data.

According to another embodiment of the present invention, there is provided an information recording medium recording a video object set comprising a plurality of video objects, each of the video objects comprising a plurality of cells, each of the cells comprising a plurality of video object units including a video pack and a sub-picture pack, wherein a sub-picture unit formed of a plurality of sub-picture data included in the sub-picture pack comprises a sub-picture unit header, pixel data, and a display control sequence table; the sub-picture unit header describes a sub-picture category; and the sub-picture category describes a flag indicating a method for storing the pixel data and a flag indicating a run length compression/non-compression of the pixel data, According to still another embodiment of the present invention, there is provided an information playback apparatus used for an information recording medium recording a video manager and a plurality of video title sets, wherein each of the video title sets describes video title set information; the video title set information describes a video title set information management table; the video title set information management table describes an attribute of a sub-picture stream about a video title set menu; and the attribute of the sub-picture stream describes a flag indicating a method for storing pixel data and a flag indicating a run length compression/non-compression of the pixel data, the information playback apparatus comprising means for reading the flag indicating the method for storing the pixel data and the flag indicating the run length compression/non-compression from the information recording medium; means for discriminating whether or not the pixel data is in a high definition scheme or in a standard definition scheme based on the flags read by the reading means; and means for making a decoder required for playback standby, according to a data scheme discriminated by the discriminating means.

According to still further embodiment of the present invention, there is provided an information playback apparatus used for an information recording medium recording a video object set comprising a plurality of video objects, each of the video objects comprising a plurality of cells, each of the cells comprising a plurality of video object units including a video pack and a sub-picture pack, wherein a sub-picture unit formed of a plurality of sub-picture data included in the sub-picture pack comprises a sub-picture unit header, pixel data, and a display control sequence table; the sub-picture unit header describes a sub-picture category; and the sub-picture category describes a flag indicating a method for storing the pixel data and a flag indicating a run length compression/non-compression of the pixel data, the information playback apparatus comprising means for reading the flag indicating the method for storing the pixel data and the flag indicating the run length compression/non-compression from the information recording medium; means for discriminating whether or not the pixel data is in a high definition scheme or in a standard definition scheme based on the flags read by the reading means; and making a decoder required for playback standby, according to a data scheme discriminated by the discriminating means.

According to still another embodiment of the L present invention, there is provided an information playback method for an information recording medium recording a video manager and a plurality of video title sets, wherein each of the video title sets describes video title set information; the video title set information describes a video title set information management table; the video title set information management table describes an attribute of a sub-picture stream about a video title set menu; and the attribute of the sub-picture stream describes a flag indicating a method for storing pixel data and a flag indicating a run length compression/non-compression of the pixel data, the information playback method comprising reading the flag indicating the method for storing the pixel data and the flag indicating the run length compression/non-compression from the information recording medium; discriminating whether or not the pixel data is in a high definition scheme or in a standard definition scheme based on the read flags; and making a decoder required for playback standby, according to the discriminated data scheme.

According to still further an embodiment of the present invention, there is provided an information playback method for an information recording medium recording a video object set comprising a plurality of video objects, each of the video objects comprising a plurality of cells, each of the cells comprising a plurality of video object units including a video pack and a sub-picture pack, wherein a sub-picture unit formed of a plurality of sub-picture data included in the sub-picture pack comprises a sub-picture unit header, pixel data, and a display control sequence table; the sub-picture unit header describes a sub-picture category; and the sub-picture category describes a flag indicating a method for storing the pixel data and a flag indicating a run length compression/non-compression of the pixel data, the information playback method comprising reading the flag indicating the method for storing the pixel data and the flag indicating the run length compression/non-compression from the information recording medium; discriminating whether or not the pixel data is in a high definition scheme or in a standard definition scheme based on the read flags; and making a decoder required for playback standby, according to the discriminated data scheme.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing an outline of an optical disk apparatus according to one embodiment of the present invention;

FIG. 2 is a block diagram showing a mechanical portion of the disk apparatus shown in FIG. 1 in detail;

FIG. 3 is a perspective view schematically showing a structure of an optical disk that is accessed by the disk apparatus shown in FIG. 1;

FIG. 4 is a view showing a schematic configuration of a key operation device and a display device shown in FIG. 1;

FIG. 5 is a view showing a schematic configuration of a remote control shown in FIG. 1;

FIG. 6 shows a structure (volume structure) of a logical format of the optical disk shown in FIG. 3;

FIG. 7 shows a structure of a video manager VMG and a video title set VTS shown in FIG. 6;

FIG. 8 shows a structure of the video manager information VMGI shown in FIG. 6;

FIG. 9 shows an example of a structure of a video object set VOBS shown in FIG. 6;

FIG. 10 is an illustrative view illustrating a structure of a video object unit VOBU shown in FIG. 8;

FIG. 11 shows parameters and contents of a video manager information table VMGI_MAT contained in video manager information VMGI shown in FIG. 8;

FIG. 12 shows a structure of a version number VERN contained in the video manager information VMGI shown in FIG. 8;

FIG. 13 shows a structure of a category VMG_CAT of a video manager contained in the video manager information VMGI shown in FIG. 8;

FIG. 14 shows a structure of an attribute VMGM_V_ATR contained in the video manager information VMGI shown in FIG. 8;

FIG. 15 shows a structure of the number of VMGM sub-picture streams VMGM_SPST_Ns contained in the video manager information VMGI shown in FIG. 8;

FIG. 16 shows a structure of a VMGM sub-picture attribute VMGM_SPST_ATR contained in the video manager information VMGI shown in FIG. 8;

FIG. 17 shows a structure of a title search pointer table TT_SRPT contained in the video manager information VMGM shown in FIG. 8;

FIG. 18 shows parameters and contents of title search pointer table information TT_SRPTI contained in a title search pointer table TT_SRPT shown in FIG. 17;

FIG. 19 shows parameters and contents of a title search pointer TT_SRP which corresponds to an input number of the title search pointer table TT_SRPT shown in FIG. 17;

FIG. 20 shows a structure of a video manager menu PGCI unit table VMGM_PGCI_UT shown in FIG. 8;

FIG. 21 shows parameters and contents of the video manager menu PGCI unit table information VMGM_PGCI_UTI shown in FIG. 20;

FIG. 22 shows parameters and contents of a video manager menu PGCI unit search pointer VMGM_LU_SRP shown in FIG. 20;

FIG. 23 shows a structure of a video manager menu language unit VMGM_LU shown in FIG. 20;

FIG. 24 shows parameters and contents of the video manager menu language unit VMGM_LU shown in FIG. 23;

FIG. 25 shows parameters and contents of a video manager menu PGC information search point VMGM_PGCI_SRP;

FIG. 26 shows parameters and contents of a video manager menu PGC category VMGM_PGC_CAT shown in FIG. 25;

FIG. 27 shows parameters and contents of a video manager menu cell address table VMGM_C_ADTI;

FIG. 28 shows parameters and contents of video manager menu cell piece information VMGM_CPI;

FIG. 29 shows parameters and contents of a video manager menu cell ID number VMGM_C_IDN contained in the video manager menu-cell piece information VMGM_CPI of FIG. 28;

FIG. 30 shows a structure of a video title set VTS shown in FIG. 6;

FIG. 31 shows parameters and contents of a video title set information management table VTSI_MAT of the video title set information VTSI shown in FIG. 30;

FIG. 32 shows a structure of a version number VERN contained in a video title set information management table VTSI_MAT of the video title set information VTSI shown in FIG. 31;

FIG. 33 shows a structure of a VTS category VTS_CAT contained in the video title set information management table VTSI_MAT of the video title set information VTSI shown in FIG. 31;

FIG. 34 shows a structure of a VTSM video attribute VTSM_V_ATR contained in the video title set information management table VTSI_MAT of the video title set information VTSI shown in FIG. 31;

FIG. 35 shows a structure of the number of VTSM audio streams VTSM_AST_Ns contained in the video title set information management table VTSI_MAT of the video title set information VTSI shown in FIG. 31;

FIG. 36 shows a structure of a VTSM sub-picture attribute VTSM_SPST_ATR contained in the video title set information management table VTSI_MAT of the video title set information VTSI shown in FIG. 31;

FIG. 37 shows a structure of a VTSTT picture attribute VTS_V_ATR contained in the video title set information management table VTSI_MAT of the video title set information VTSI shown in FIG. 31;

FIG. 38 shows contents of an audio stream attribute VTS_AST_ATR of the video title set VTS shown in FIG. 6;

FIG. 39 shows contents of a sub-picture stream attribute VTS_SPST_ATR of the video title set VTS shown in FIG. 6;

FIG. 40 shows a structure of a video title set program chain information table VTS_PGCIT of the video title set VTS shown in FIG. 30;

FIG. 41 shows parameters and contents of information VTS_PGCIT_I on the video title set program chain information table VTS_PGCIT shown in FIG. 40;

FIG. 42 shows parameters and contents of a search pointer VTS_PGCIT_SRP which corresponds to a program chain of the video title set program chain information table VTS_PGCIT shown in FIG. 40;

FIG. 43 shows a structure of program chain information VTS_PGCI for a video title set which corresponds to a program chain of the video title set program chain information table VTS_PGCIT shown in FIG. 40;

FIGS. 44A and 44B show a title structure in order to explain a concept of a playback structure;

FIG. 45 shows a structure of a program chain PGC;

FIG. 46 shows a structure of program chain information PGI;

FIG. 47 shows parameters and contents of program chain general information PGC_GI contained in the program chain information PGCI shown in FIG. 46;

FIG. 48 shows a structure of program chain contents PGC_CNT included in the program chain general information PGC_GI shown in FIG. 47;

FIG. 49 shows a structure of program chain sub-picture stream control PGC_SPST_CTL contained in the program chain general information PGC_GI shown in FIG. 47;

FIG. 50 shows a structure of a program chain sub-picture pallet PGC_SP_PLT contained in the program chain general information PGC_GI shown in FIG. 47;

FIG. 51 shows a structure of a program chain map PGC_PGMAP of the program chain information VTS_PGCI shown in FIG. 43;

FIG. 52 shows parameters and contents of an entry cell number ECELLN for a program that is described in the program chain map PGC_PGMAP shown in FIG. 43;

FIG. 53 shows a structure of a cell playback information table C_PBIT of the program chain information VTS_PGCI shown in FIG. 43;

FIG. 54 shows parameters and contents of cell playback information C_PBI shown in FIG. 53;

FIG. 55 shows a structure of cell position information C_POSI of the program chain information VTS_PGCI shown in FIG. 28;

FIG. 56 shows parameters and contents of the cell position information C_POSI shown in FIG. 55;

FIG. 57 shows a structure of a video title set menu. PGCI unit table VTSM_PGCI_UT shown in FIG. 30;

FIG. 58 show parameters and contents of the video title set menu PGCI unit table information VTSM_PGCI_UTI shown in FIG. 57;

FIG. 59 shows parameters and contents of a video title set menu PGCI unit search pointer VTSM_LU_SRP shown in FIG. 57;

FIG. 60 shows a structure of a video title set menu language unit VTSM_LU shown in FIG. 57;

FIG. 61 shows parameters and contents of the video title set menu language unit information VTSM_LUI shown in FIG. 57;

FIG. 62 shows parameters and contents of a video title set menu PGC information search point VTSM_PGCI_SRP;

FIG. 63 shows a structure of a navigation pack shown in FIG. 8;

FIG. 64 shows a structure of a video pack, an audio pack, or a sub-picture pack shown in FIG. 8;

FIG. 65 shows parameters and contents of playback control information PCI of the navigation pack shown in FIG. 63;

FIG. 66 shows a position in a VOBU of the playback control information PCI of the navigation pack shown in FIG. 63;

FIG. 67 shows parameters and contents of general information PGI_GI contained in the playback control information PCI shown in FIG. 65;

FIG. 68 shows a structure of a VOBU category VOBU_CAT contained in the general information PGI_GI contained in the playback control information PCI shown in FG. 67;

FIG. 69 shows parameters and contents of angle information NSML_AGLI contained in the playback control information PCI shown in FIG. 65;

FIG. 70 is an illustrative view when an angle change is carried out by utilizing the angle information NSML_AGLI contained in the playback control information PCI shown in FIG. 69;

FIG. 71 is a view showing validity of highlight information for each sub-picture stream at a playback period of one sub-picture unit;

FIG. 72 is a view illustrating video, sub-picture, and highlight information and a mixed picture obtained by combining them;

FIG. 73 shows parameters and contents of highlight information HLI contained in the playback control information PGI shown in FIG. 65;

FIG. 74 is a view illustrating contents of the highlight information HLI shown in FIG. 73;

FIG. 75 shows parameters and contents of highlight generation information HL_GI contained in the highlight information HLI shown in FIG. 73;

FIG. 76 shows a structure of a highlight information state HIL_SS contained in the highlight generation information contained in the highlight information HLI shown in FIG. 75;

FIG. 77 shows a structure of a start PTM of highlight information HIL_S_PTM contained in the highlight information HLI shown in FIG. 75;

FIG. 78 shows a structure of an end PTM of highlight information HIL_E_PTM contained in the highlight information HLI shown in FIG. 75;

FIG. 79 shows a structure of an end PTM of button select BTN_SL_E_PTM contained in the highlight information HLI shown in FIG. 75;

FIG. 80 shows a structure of a button mode BTN_MD contained in the highlight information HLI shown in FIG. 75;

FIG. 81 shows a relationship between a picture display region and a sub-picture display region;

FIG. 82 is a view showing a structure of a button color information table BTN_COLIT contained in highlight information HLI shown in FIG. 73;

FIG. 83 is a view showing in detail the contents of description of selection color information SL_COLI shown in FIG. 82;

FIG. 84 is a view showing in detail the contents of description of action color information AC_COLI shown in FIG. 82;

FIG. 85 is a view showing a structure of a button information table BTNI contained in the highlight information HLI shown in FIG. 73;

FIG. 86 is a view showing in detail the contents of description of button position information BTN_POSI contained in the button information BTNI shown in FIG. 85;

FIG. 87 shows a range of an X coordinate and a Y coordinate of a button position of each TV system;

FIG. 88 is a view showing in detail the contents of description of adjacent button position information AJBTN_POSI contained in the button information BTNI shown in FIG. 85;

FIG. 89 shows a structure of recording information RECI for video data, all audio data, and sub-picture data recorded in VOBU;

FIG. 90 shows parameters and contents of disk search information DSI on the navigation pack shown in FIG. 63;

FIG. 91 shows a position in VOBU of the disk search information DSI on the navigation pack shown in FIG. 90;

FIG. 92 shows parameters and contents of DSI general information DSI_GI contained in the disk search information DSI shown in FIG. 67;

FIG. 93 shows a structure of an application identification number VOBU_ADP_ID;

-FIG. 94 shows parameters and contents of angle information SML_AGLI contained in the disk search information DSI shown in FIG. 67;

FIG. 95 is an illustrative view when an angle change is carried out by utilizing the angle information SML_AGLI contained in the disk search information DSI shown in FIG. 94;

FIG. 96 shows parameters and contents of search information VOBU_SRI on the video object unit VOBU shown in FIG. 67;

FIG. 97 shows a bit map for describing a forward address FWDI of search information VOBU_SRI on the video object unit VOBU shown in FIG. 67;

FIG. 98 shows a bit map for describing a backward address BWDI of search information VOBU_SRI on the video object unit VOBU shown in FIG. 67;

FIG. 99 shows parameters and contents of synchronization playback information SYNCI on the video object unit VOBU shown in FIG. 67;

FIG. 100 shows a video player configuration P_CFG for video which is one of system parameters;

FIG. 101 is a view showing a player reference model;

FIG. 102 shows a configuration of a sub-picture unit;

FIG. 103 shows a relationship between a sub-picture unit SPU and a sub-picture pack SP_PCK;

FIG. 104 shows parameters and contents of a sub-picture unit header SPUH of the sub-picture unit shown in FIG. 102;

FIG. 105 shows a configuration of a sub-picture category SP_CAT shown in FIG. 104;

FIG. 106 shows allocation of pixel data PXD;

FIGS. 107A and 107B show an allocation example of pixel data PXD;

FIG. 108 shows an example of a run length compression rule;

FIG. 109 shows another example of a run length compression rule;

FIGS. 110A, 110B, 1° C., 110D, and 110E show a unit structure of run length compression data;

FIG. 111 is a block diagram showing an example of a configuration of a disk apparatus to which encode or decoding processing according to the present embodiment is applied;

FIG. 112 is a block diagram showing an example of a configuration of a subsidiary video picture encoder of a disk apparatus to which encoding processing according to the present embodiment is applied;

FIG. 113 is a block diagram showing an example of a configuration of a sub-picture decoder of the disk apparatus to which decoding processing according to the present embodiment is applied;

FIG. 114 is a view showing a 3-bit, 8-color expression run length compression rule (on a line by line basis) in 3-bit data, which is a run length compression rule according to the present embodiment;

FIG. 115 is a view showing a 4-bit, 16-color expression run length compression rule (on a line by line basis) in 3-bit data, which is a run length compression rule according to the present embodiment;

FIG. 116 is a view showing an example of a practical data structure according to the run length compression rule according to the present embodiment;

FIG. 117 is a view showing an example of unit of a practical data structure according to the run length compression rule according to the present embodiment;

FIGS. 118A, 118B, 118C, and 118D show an example of unit of a practical data structure according to the run length compression rule according to the present embodiment;

FIGS. 119A, 119B, 119C, 119D, 119E, and 119F show an example of unit of a practical data structure according to the run length compression rule according to the present embodiment;

FIG. 120 is a view showing another example of 4-bit, 16-color expression run length compression rule (on a line by line basis) in 4-bit data, which is a run length compression rule according to the present embodiment;

FIG. 121 is a flow chart showing a basic operation of encoding (compression) processing in the run length compression rule (on a line by line basis) according to the present embodiment;

FIG. 122 is a flow chart showing in detail encoding (compression) processing in the run length compression rule (on a line by line basis) according to the present embodiment;

FIGS. 123A and 123B are flow charts showing in detail encoding (compression) processing in the run length compression rule (on a line by line basis) according to the present embodiment;

FIGS. 124A and 124B are flow charts showing in detail encoding (compression) processing in the run length compression rule (on a line by line basis) according to the present embodiment;

FIG. 125 is a flow chart showing in detail encoding (compression) processing in the run length compression rule (on a line by line basis) according to the present embodiment;

FIG. 126 is a flow chart showing a basic operation of decoding (decompression) processing in the run length compression rule (on a line by line basis) according to the present embodiment;

FIG. 127 is a flow chart showing in detail decoding (decompression) processing in the run length compression rule (on a line by line basis) according to the present embodiment;

FIG. 128 is a flow chart showing in detail decoding (decompression) processing in the run length compression rule (on a line by line basis) according to the present embodiment;

FIG. 129 is a flow chart showing in detail decoding (decompression) processing in the run length compression rule (on a line by line basis) according to the present embodiment;

FIG. 130 shows another example of the run length compression rule;

FIG. 131 shows still another example of the run length compression rule;

FIG. 132 shows an example of run length compression per line;

FIG. 133 shows another example of a unit structure of run length compression data;

FIG. 134 shows in detail a display control sequence table SP_DCSQT shown in FIG. 102;

FIG. 135 shows in detail a display control sequence SP_DCSQ shown in FIG. 134;

FIG. 136 shows in detail a start time SP_DCSQ_STM of the display control sequence SP_DCSQ shown in FIG. 135;

FIG. 137 shows in detail a display control command SP_DCCMD shown in FIG. 135;

FIGS. 138A, 138B, and 138C respectively show in detail commands FSTA_DSP, STA_DSP, STP_DSP shown in FIG. 137;

FIG. 139 shows in detail a color code setting command SET_COLOR shown in FIG. 137;

FIG. 140 shows in detail a contrast setting command SET_CONTR shown in FIG. 137;

FIG. 141 shows in detail a pixel data display region setting command SET_DAREA shown in FIG. 137;

FIG. 142 shows a range of an X coordinate and a Y coordinate of a pixel data display region for each TV system;

FIG. 143 shows in detail a pixel data display start address setting command SET_DSPXA shown in FIG. 137;

FIG. 144 shows in detail a pixel data color and contrast change setting command CHG_COLCON shown in FIG. 137;

FIG. 145 shows in detail a display control command end command CMD_END shown in FIG. 137;

FIG. 146 shows in detail pixel control data PXCD shown in FIG. 144;

FIG. 147 shows in detail line control information LN_CTLI shown in FIG. 146;

FIG. 148 shows a range of line numbers for each TV system;

FIG. 149 shows in detail pixel control information PX_CTLI shown in FIG. 146;

FIG. 150 shows a configuration of a packet transfer processor;

FIG. 151 shows a configuration of a highlight processor;

FIG. 152 shows a flow chart for detecting the total number of titles in an optical disk, the number of chapters for each title (the number of programs), the number of audio streams for each title, a language of audio streams, the number of sub-picture streams for each title, and a language of sub-picture streams;

FIG. 153 shows a flow chart for detecting the total number of titles in an optical disk, the number of chapters for each title (the number of programs), the number of audio streams for each title, a language of audio streams, the number of sub-picture streams for each title, and a language of sub-picture streams;

FIG. 154 is a view showing a storage example of a memory table;

FIG. 155 is a view showing a playback example of a main menu image;

FIGS. 156A, 156B, 156C, 156D, and 156E show a playback example of images on a title menu, a chapter menu, an audio menu, a sub-picture menu, and an angle menu;

FIG. 157 shows a flow chart illustrating operating procedures when a menu is reproduced;

FIGS. 158A, 158B, 158C, and 158D illustrate video, sub-picture and highlight information and a mixed picture obtained by combining them;

FIGS. 159A, 159B, 159C, 159D, and 159E illustrate video, sub-picture and highlight information and a Mixed picture obtained by combining them;

FIGS. 160A and 160B show pixel 1 and pixel 16 in sub-picture data;

FIG. 161 shows a flow chart illustrating procedures for reproducing video data in a normal mode in an optical disk having the logical format shown in FIGS. 6 to 149;

FIG. 162 shows a flow chart illustrating procedures for reproducing video data in a normal mode in the optical disk having the logical format shown in FIGS. 6 to 149;

FIG. 163 shows a flow chart illustrating procedures for reproducing video data in a normal mode in the optical disk having the logical format shown in FIGS. 6 to 149;

FIG. 164 shows a flow chart illustrating procedures for changing an angle in video data playback in the optical disk having the logical format shown in FIGS. 6 to 149;

FIG. 165 is a block diagram showing an encoder system for encoding picture data, thereby generating a picture file;

FIG. 166 is a flow chart showing the encoding processing shown in FIG. 165;

FIG. 167 is a flow chart for creating a picture data file by combining main picture data, audio data, and sub-picture data encoded in the flow shown in FIG. 166;

FIG. 168 is a block diagram showing a disk formatter system for recording a formatted picture file in an optical disk;

FIG. 169 is a flow chart for generating logical data to be recorded in a disk in the disk formatter shown in FIG. 168;

FIG. 170 is a flow chart for generating physical data to be recorded from the logical data to a disk;

FIG. 171 is a schematic view showing a system for transferring the video title set shown in FIG. 6 via a communication system;

FIGS. 172A and 172B show a down conversion model for superimposing sub-picture data conforming to HD scheme or SD scheme in picture data conforming to HD scheme; and

FIG. 173 is a flow chart showing an example of processing for recording information into an information recording medium.

### DETAILED DESCRIPTION OF THE INVENTION

An embodiment of an information recording medium, an information playback apparatus, and an information playback method according to the present invention will now be described with reference to the accompanying drawings.

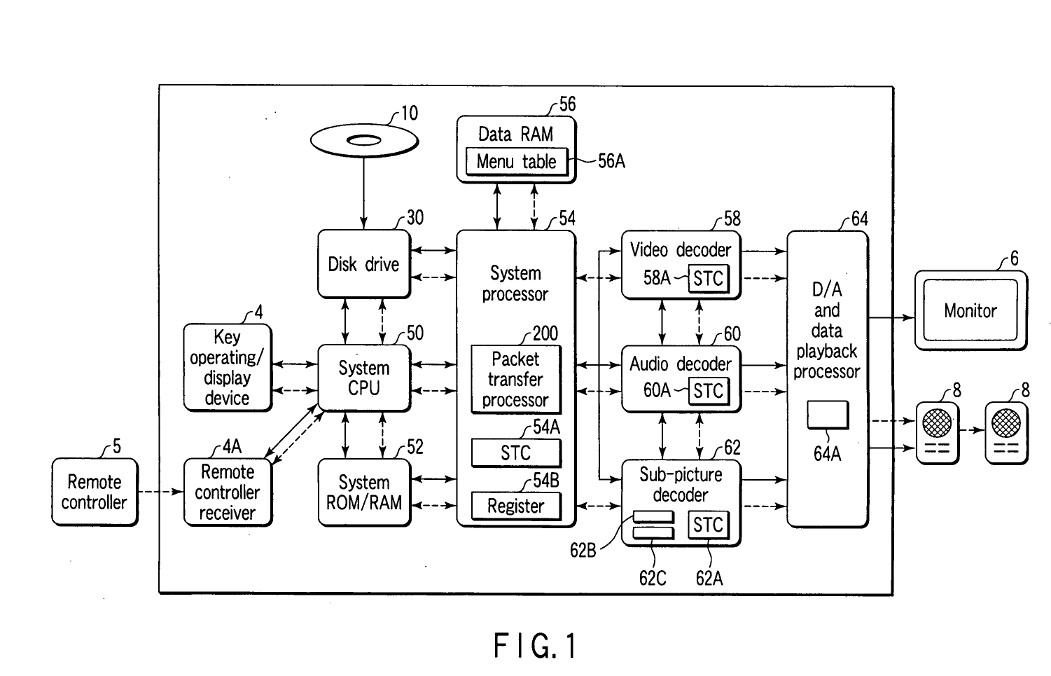

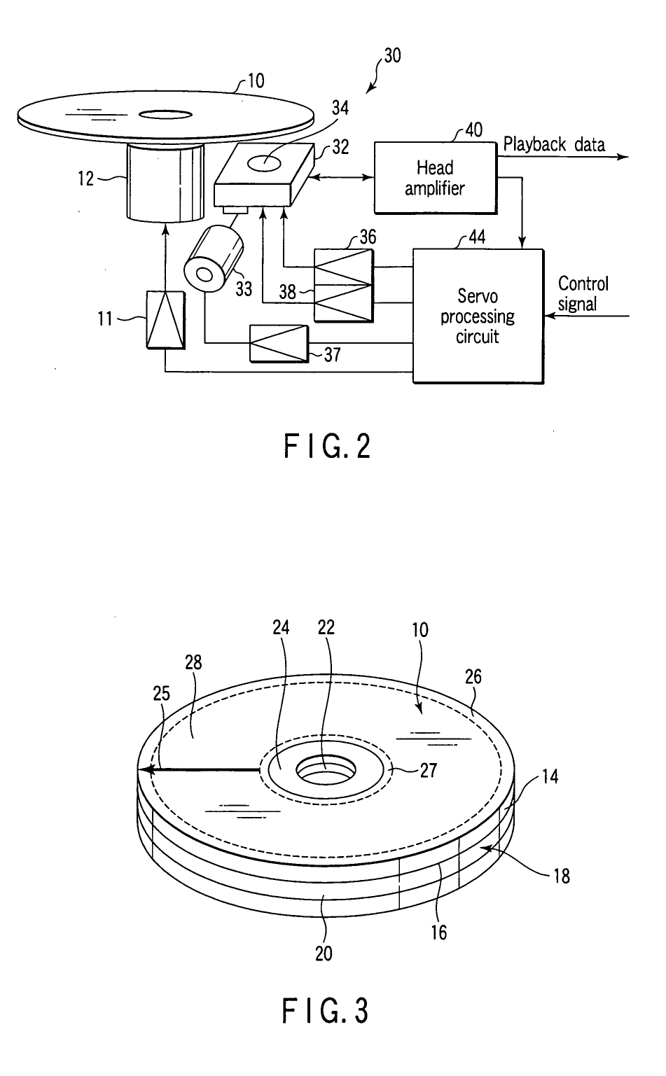

FIG. 1 is a block diagram showing an optical disk playback apparatus for reproducing data from an optical disk according to an embodiment of the present invention. FIG. 2 is a block diagram showing a disk apparatus for driving the optical disk shown in FIG. 1. FIG. 3 shows a structure of the optical disk shown in FIGS. 1 and 2.

As shown in FIG. 1, the optical disk playback apparatus, comprises a key operation/display device 4, a monitor 6, and a speaker 8. A user operates the key operation/display device 4, whereby recorded data is reproduced from an optical disk 10. The recorded data includes picture data, sub-picture data, and voice data. These items of data are converted into a video signal and an audio signal. The monitor 6 displays a picture by the video signal, and the speaker 8 generates a voice by the audio signal.

As already known, the optical disk 10 has a variety of structures. In this optical disk 10, for example, as shown in FIG. 3, there is a read-only disk in which data is recorded with high density. The optical disk 10 comprises a pair of composite layers 18 and an adhesive bonding layer 20 interposed between these composite disk layers 18. Each of the composite disk layers 18 comprises a transparent substrate 14 and a recording layer, i.e., a light reflection layer 16. The disk layers 18 are allocated such that the light reflection layer 16 comes into contact with the top face of the adhesive bonding layer 20. In the optical disk 10, a center hole 22 is provided, and clamping regions 24 for pressing the optical disk 10 during rotation thereof are provided around the center hole 22 on both sides of the disk. A spindle of a spindle motor 12 shown in FIG. 2 is inserted in the center hole 22 when the disk 10 is mounted on the optical disk apparatus. While the disk is rotated, the optical disk 10 is clamped in the clamping region 24 of the disk.

As shown in FIG. 3, the optical disk (for example, DVD disk) 10 has information region 25 capable of recording information in the optical disk 10 at the periphery of the clamping regions 24 on both sides of the disk. In each information region 25, the outer periphery region is defined in a lead-out region 26 in which no recording data is generally recorded. Similarly, the inner periphery region coming into contact with the clamping region 24 is defined in a lead-in area 27 in which no recording data is generally recorded. An interval between the read-out region 26 and the lead-in area 27 is defined in a volume space 28 which is a data recording region.

In the recording layer 16 of the information region 25, a track is continuously formed in a spiral shape as a region in which data is to be recorded. The continuous track is divided into a plurality of physical sectors; serial numbers are assigned to these sectors, and data is recorded with these sectors as a unit of recording. The volume space 28 of the information recording region 25 is an actual data recording region. As described later, playback information, video data (main picture data), sub-picture data, and audio data are recorded as pits (i.e., a change of physical state) similarly. In the read-only optical disk 10, pit trains are formed in advance in a transparent substrate 14 by stamper. On a face of the transparent substrate 14 on which these pit trains have been formed, a reflection layer is formed by vapor deposition, and the reflection layer is formed as the recording layer 16. In the read-only optical disk 10, in general, a track group is not provided in particular, and the pit trains formed on the face of the transparent substrate 14 are defined as tracks.

Such an optical disk apparatus 12, as shown in FIG. 1, further comprises a disk drive 30, a system CPU 50, a system ROM/RAM 52, a system processor 54, a data RAM 56, a video decoder 58, an audio decoder 60, a sub-picture decoder 62, and a D/A and data playback processor 64. The system processor 54 comprises a system time clock STC 54A and a register 54B. Similarly, the video decoder 58, audio decoder 60, and sub-picture decoder 62 comprise system time clocks STC 58A, 60A, and 62A, respectively.

As shown in FIG. 2, the disk drive 30 comprises a motor driving circuit 11, a spindle motor 12, an optical head 32 (i.e., an optical pickup), a feed motor 33, a focusing circuit 36, a feed motor driving circuit 37, a tracking circuit 38, a head amplifier 40, and a servo processing circuit 44. The optical disk 10 is placed on the spindle motor 12 driven by the motor driving circuit 11, and is rotated by the spindle motor 12. The optical head 32 for emitting a laser beam to the optical disk 10 is placed under the optical disk 10. The optical head 32 is placed on a guide mechanism (not shown). The feed motor driving circuit 37 is provided in order to supply a drive signal to the feed motor 33. The motor 33 is driven by the drive signal, and moves the optical head 32 in a radial direction of the optical disk 10. The optical head 32 comprises an objective lens 34 which is moved along its optical axis in accordance with a drive signal supplied from the focusing circuit 36.

In order to reproduce data from the above-described optical disk 10, the optical head 32 emits a laser beam to the optical disk 10 via the objective lens 34. The objective lens 34 is finely moved in the radial direction of the optical disk 10 in accordance with a drive signal supplied from the tracking circuit 38. The objective lens 34 is finely moved along its optical axis direction in accordance with the drive signal supplied from the focusing-circuit 36 such that its focal point is positioned in the recording layer 16 of the optical disk 10. As a result, with respect to the laser beam, a minimum beam spot is formed on a spiral track (i.e., pit trains), and a track is traced on an optical beam spot. The laser beam is reflected from the recording layer 16, and the reflected beam is returned to the optical head 32. At the optical head 32, the light beam reflected from the optical disk 10 is converted into an electrical signal, and the converted electrical signal is supplied from the optical head 32 to the servo processing circuit 44 via the head amplifier 40. The servo processing circuit 44 generates a focus signal, a tracking signal, and a motor control signal from the electrical signal, and supplies these signals to the focusing circuit 36, tracking circuit 38, and motor driving circuit 11, respectively.

Therefore, the objective lens 34 is moved along its optical axis and the radial direction of the optical disk 10, and its focal point is positioned in the recording layer 16 of the optical disk 10. With respect to the laser beam, a minimum beam spot is formed on a spiral track. By means of the motor driving circuit 11, the spindle motor 12 is rotated in a predetermined rotation frequency. As a result, the pit trains of the optical disk 10 are traced, for example, at a constant line speed with the light beam.

A control signal which is an access signal is supplied to the servo processing circuit 44 from the system CPU 50 shown in FIG. 1. In response to the control signal, a head moving signal is supplied from the servo processing circuit 44 to the feed motor driving circuit 37, and the feed motor driving circuit 37 supplies a drive signal to the feed motor 33. Therefore, the feed motor 33 is driven, and the optical head 32 is moved along the radial direction of the optical head 10. A predetermined sector formed in the recording layer 16 of the optical disk 10 is accessed by the optical head 32. Playback data is reproduced from the predetermined sector, and the playback data is supplied from the optical head 32 to the head amplifier 40. The supplied data is amplified by the head amplifier 40, and the amplified data is output from the disk drive 30.

The output playback data is stored in the data RAM 56 by the system processor 54 under the control of the system CPU 50 that is controlled by a program recorded in the system ROM/RAM 52. The stored playback data is processed by the system processor 54, and the processed data is classified into video data, audio data, and sub-picture data. The video data, audio data, and sub-picture data are output to the video decoder 58, audio decoder 60, and sub-picture decoder 62, respectively, and these output data are decoded. The decoded video data, audio data, and sub-picture data are converted into a video signal or an audio signal which is an analog signal by the D/A and playback processing circuit 64. In addition, these data are subjected to mixing processing, and the mixed video signal and sub-picture signal are supplied to the monitor 6, and the audio signal is supplied to the speaker 8, respectively. As a result, a picture is displayed at the monitor 6 by the video signal and the sub-picture signal, and a voice is reproduced from the speaker 8 by the audio signal.

In the optical disk playback apparatus shown in FIG. 1, the user operates the remote controller 5 which is a remote operating unit connected to the key operation/display device 4 on a front panel of a main body or a remote control receiver 4A in the main body by an optical communication, whereby recorded data, i.e., picture data, sub-picture data, and voice data are reproduced from the optical disk 10. Then, these data are converted into an audio (voice) signal and a video signal, and the converted signal is reproduced as a picture and a voice by the monitor 6 and the speaker 8 outside of the apparatus.

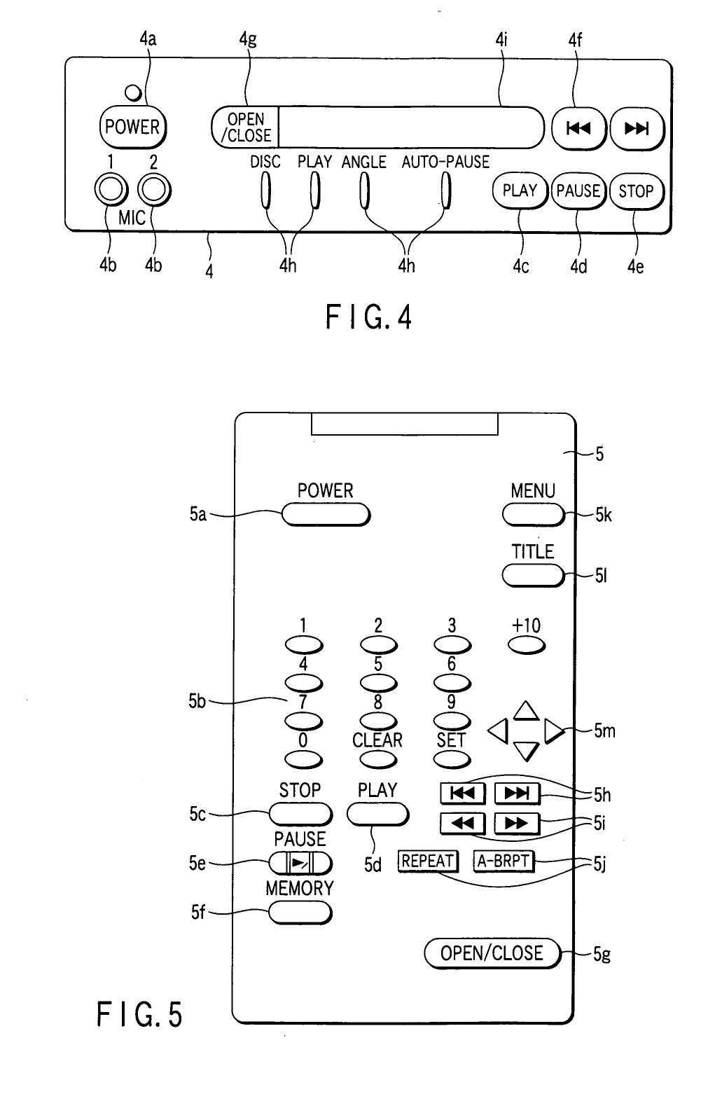

The key operation/display device 4, as shown in FIG. 4, comprises a power key 4a, a microphone input terminal 4b, a playback key 4c, a pause key 4d, a stop key 4e, a forward/backward key 4f, an open/close key 4g for instructing mount/removal of the optical disk 10, a display 4h, an opening 4i for inserting and removing the optical disk 10 and the like.

The remote controller 5, as shown in FIG. 5, comprises a power key 5a, a numeric key 5b, a stop key 5c, a playback key 5d, a pause key 5e, a memory key 5f, an open/close key 5g for instructing mount/removal of the optical disk 10, a forward/backward key 5h, a key 5i, a repeat key 5j for instructing repetition and indicating a range, a menu key 5k for instructing display of a menu screen, a title key 5l for instructing display of a title menu screen, an upward, downward, left, and right select key 5n used for selecting an item during menu screen display and the like.

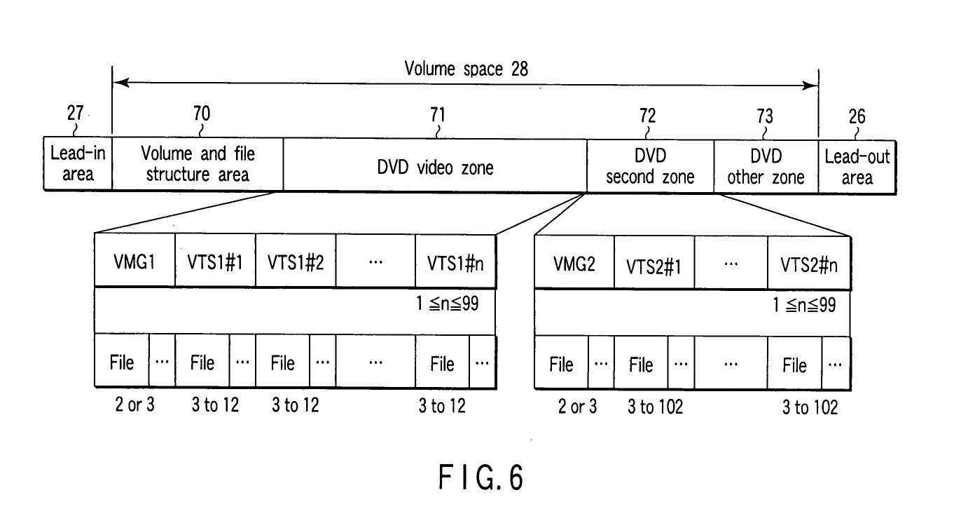

A detailed operation of the optical disk apparatus shown in FIG. 1 will be described in more detail with reference to a logical format of the optical disk 10 described later. The volume space 28 from the lead-in area 27 to the lead-out area 26 of the optical disk 10 shown in FIG. 3 has a volume and file structure as shown in FIG. 6. This structure is defined in conformance with a specific logical formal standard such as a micro UDF and ISO 9660, for example. As has already been described, the volume space 28 is physically divided into a plurality of sectors, and serial numbers are assigned to the physical sectors. In the following description, the logical address denotes a logical sector number LSN, as defined in the micro UDF and ISO 9660. The logical sector is of 2048 bytes similar to the size of the physical sector. With respect to the logical sector number LSN, serial numbers are assigned in ascending order of physical sector numbers.

As shown in FIG. 6, the volume space 28 has a hierarchical structure, and comprises a volume and file structure area 70, a DVD video zone 71, a DVD second zone 72, and DVD other zone 73. These regions are divided on the boundary of the logical sectors. As in a conventional CD, one logical sector is defined as 2,048 bytes. Similarly, one logical block is defined as 2,048 bytes, and therefore, one logical sector is defined as one logical block.

The volume and file structure area 70 is allocated to a UDF bridge structure. A single DVD video zone 71 is allocated to a DVD video disk. The DVD second zone 72 is allocated to a data structure of a DVD video disk. The DVD other zone 73 is used for non-DVD video disk application. The DVD video zone 71 comprises a single video manager VMG1 and at least one (up to 99) video title sets VTS1#n (1≦n≦99). The video manager VMG1 is allocated to the head of the DVD video zone 71, and comprises 2 or 3 files. Each video title set VTS1#n comprises 3 to 12 files. The DVD second zone 72 comprises a single video manager VMG2 and at least one (up to 99) video title sets VTS2#n (1≦n≦99). The video manager VMG2 is allocated to the head of the DVD second zone 72, and comprises 2 or 3 files. Each video title set VTS2#n comprises 3 to 12 files.

In order to maintain compatibility, the DVD disk according to the present embodiment records a mixture of image data conforming to the SD scheme and image data conforming to the HD scheme. This disk records the image data conforming to the SD scheme in the DVD video zone 71 and the image data conforming to the HD scheme in the DVD second zone 72. The video manager VMG1 manages an image file conforming to the SD scheme, and the video manager VMG2 manages an image file conforming to the HD scheme. A video manager menu VMSM of the video manager VMG2 can conform to the SD scheme as well as the HD scheme. Although a video object VOB and video title set manager VTSM included in the video title set VTS1#1 can conform to the SD scheme only, a video object VOB and video title set manager VTSM included in the video title set VTS2#n can conform to the SD scheme as well as the HD scheme. However, instead of the image file conforming to the SD scheme and the image file conforming to the HD scheme being thus recorded in separate directories, these files are recorded in the same directory, whereby the files conforming to the SD and HD schemes may be discriminated from each other.

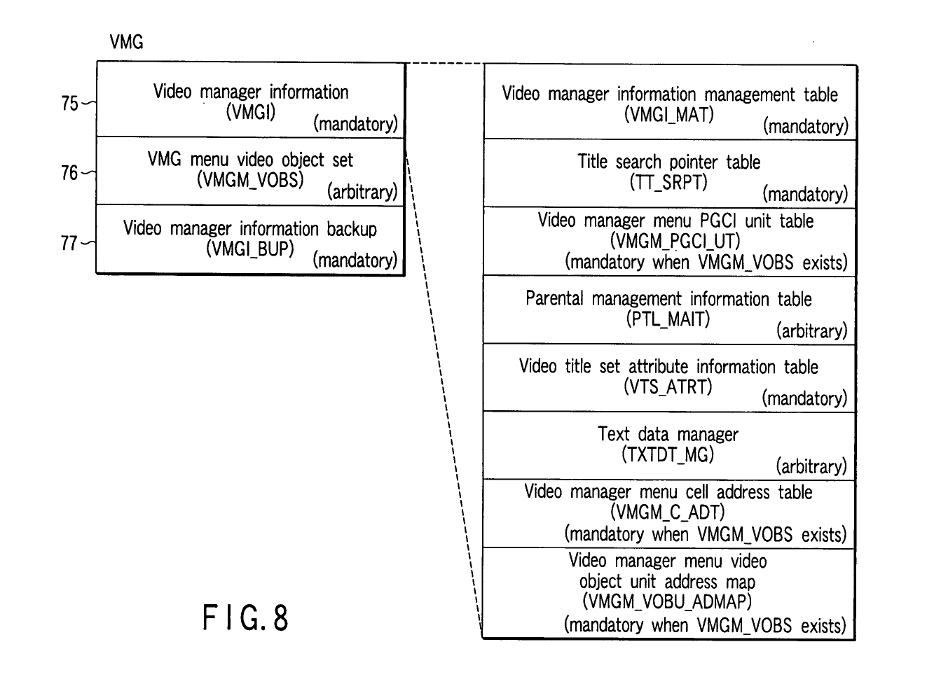

The volume and file structure area 70 corresponds to a management region defined in the micro UDF and ISO 9660, and the video manager VMG is stored in the system ROM/RAM 52 via a description of this region. In the video manager VMG, information for managing a video title set VTS is described as explained with reference to FIG. 8. This information comprises a plurality of files. Each video title set VTS stores video data, audio data, and sub-picture data compressed as explained later, and these items of playback information. Like a VMG, the information comprises a plurality of files. The DVD other zone 73 records information which can utilize the above-described video title set VTS. The DVD other zone 73 may not be always provided.

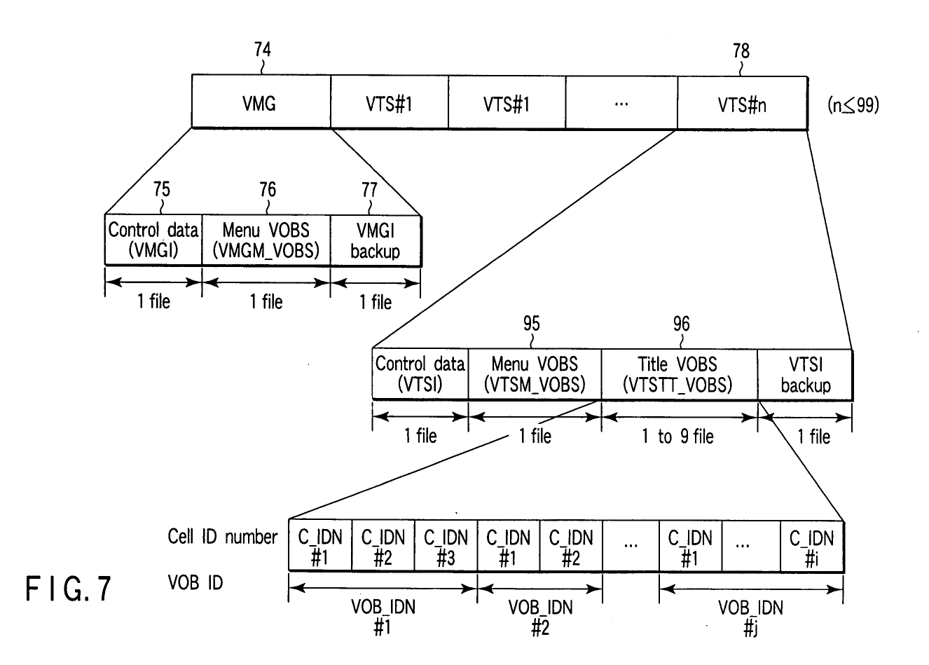

FIG. 7 shows a structure of a video manager VMG and a video title set VTS. This structure is provided as an example when all video object sets VOB are recorded in consecutive blocks.

The video manager includes control data VMGI, a menu VOBS VMGM_VOBS, and a backup VMGI. The video title set VTS includes control data VTSI, a menu VOBS VTSM_VOBS, a title VOBS (VTSTT_VOBS), and a backup VTSI. The title VOBS (VTSTT_VOBS) each includes a plurality of cells.

As shown in FIG. 8, a video manager VMG 74 contains three items corresponding to each file. That is, the video manager VMG 74 comprises video manager information VMGI 75, a video object set VMGI_VOBS 76 for video manager information menu, and a video manager information backup VMGI_BUP 77. The video manager information VMGI 75 and the video manager information backup VMGI_BUP 77 are provided as mandatory items, and the video object set VMGM_VOBS 76 for video manager information menu is provided as an option. The video object set VMSM_VOBS 76 for video manager information menu stores video data, audio data, and sub-picture data on a menu concerning a video of the optical disk managed by the video manager VMG 74.

By means of the video object set VMGM_VOBS 76 for video manager information menu, a volume name of the optical disk and an explanation of voice and sub-picture due to volume name display are displayed as in video playback explained later. In addition, selectable items are displayed in a sub-picture. For example, by the video object set VMGM_VOBS 76 for video manager information menu, video data storing games which one boxer has experienced to become the World Champion, i.e., a fighting pose of boxer X together with the history of the glory of boxer X is reproduced by video data, his theme song is reproduced by an audio, and his biography is displayed in a sub-picture. Options includes inquiring which language such as English or Japanese is selected to provide narration of a match, whether or not another language is displayed to be superimposed by a sub-picture, or which language is selected to be superimposed. By the video object set VMGM_VOBS 76 for video manager information menu, the user is ready for enjoying a video of the match of boxer X by reproducing an audio in English or by displaying a sub-picture in Japanese caption.

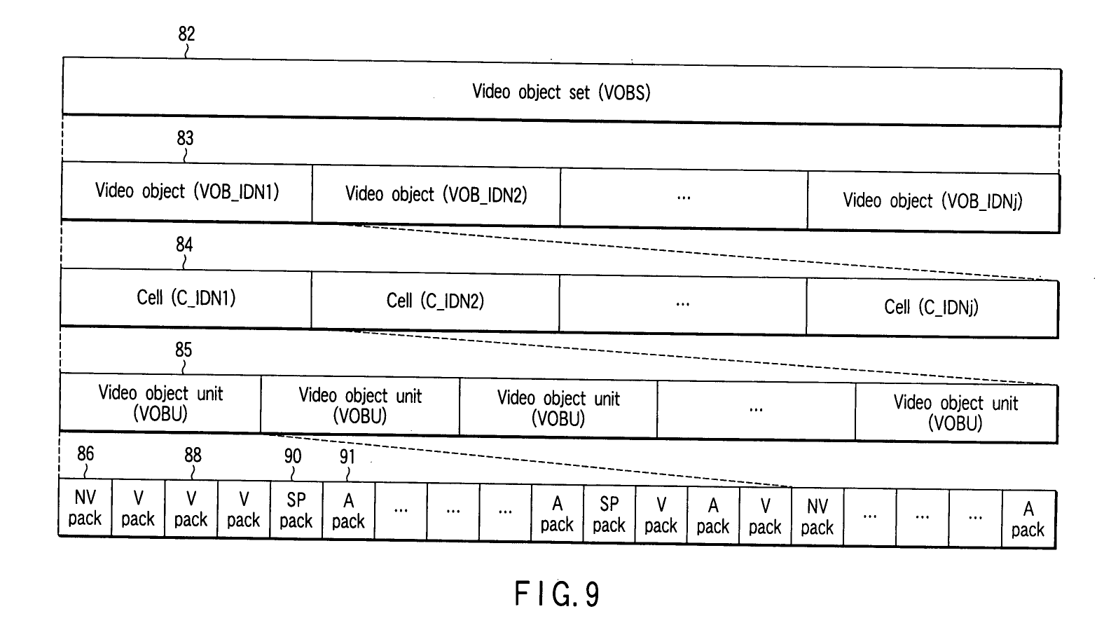

A structure of a video object set VOBS 82 will be described with reference to FIG. 9. FIG. 9 shows an example of the video object set VOBS 82. The video object set VOBS 82 includes a video object set VOBS 82 for menu display and a video object set VOBS 82 for title display. That is, the video object set VOBS 82, as shown in FIG. 7, includes a video object set VTSM_VOBS 95 for video title set menu and a video object set VTSTT_VOBS 96 for at least one or more video title sets in the video title set VTS 78. The video object sets VOBS 95 and 96 have the similar structure except that their applications are different from each other.

As shown in FIG. 9, the video object set VOBS 82 is defined as a set of one or more video objects VOB 83, and the video objects VOB 83 in the video object set VOBS 82 are provided for the same use. In general, the menu video object set VTSM_VOBS 95 comprises one video object VOB 83, and data for displaying a screen for a plurality of menus is stored therein. In contrast, the title set video object set VTSTT_VOBS 96, in general, comprises a plurality of video objects VOB 83.

The video object VOB 83 corresponds to picture data on each match of boxer X if the above-described boxing video is taken as an example. By specifying a video object VOB, for example, an eleventh match for challenging a world champion can be reproduced in video. Menu data on the match of the boxer X is stored in the menu video object set VTSM_VOBS 95 of the video title set 72. In accordance with a display of the menu, a specific match, for example, the eleventh match for challenging the world champion can be specified. In a general one-story cinema, one video object VOB 83 corresponds to one video object set VOBS 82, and one video stream is completed in one video object set VOBS 82. In an animation collection or in a cinema of omnibus style, a plurality of video streams corresponding to each story are provided in one video object set VOBS 82, and each video stream is stored in the corresponding video object. Therefore, the audio stream and sub-picture stream associated with the video streams are also complete in each video object VOB 83.

An identification number IDN#j is assigned to the video object VOB 83, and the video object VOB 83 can be specified by the identification number. The video object VOB 83 comprises one or a plurality of cells 84. Although a general video stream comprises a plurality of cells, the menu video stream, i.e., the video object VOB 83 may comprise one cell 84. Similarly, an identification number C_IDN#j is assigned to the cell, and the cell 84 is specified by the cell identification number C_IDN#j. During angle change described later, an angle is changed by specifying the cell number.

The angle used here means that an angle when it is viewed in the field of picture is changed. In an example of boxing, it means that a variety of angles such as a scene viewed from the champion's side, a scene viewed from the challenger's side or a scene viewed from the judge side can be viewed. An angle selection can be made according to the user's preference or can be repeated by automatically changing the angle in the same scene in the flow of story. In the case of selecting an angle, there is a case in which an angle is changed after the routine returns to the start of the same scene. For example, there is a case in which an angle is changed in a scene at a moment at which the boxer takes a counter punch, and the counter punch is reproduced. In addition, there is a case in which an angle is changed in a scene following that scene. For example, there is a case in which an angle is changed at a moment at which the boxer is punched after he has taken a counter punch. A navigation pack 86 described later in detail is provided in the video object unit VOBU 85 so as to achieve any angle change.

As shown in FIG. 9, each cell 84 comprises one or a plurality of video object units VOBU 85, and, in general, comprises a plurality of video object units VOBU 85. The video object unit VOBU 85 is defined as a pack train having one navigation pack (NV pack) 86 at the beginning of the train. That is, the video object unit VOBU 85 is defined as a set of all packs recorded from one navigation pack 86 to immediately before the next navigation pack. A playback time of the video object unit VOBU, as shown in FIG. 9, corresponds to a playback time of video data comprising singular or a plurality of GOPs included in the video object unit VOBU 85. The playback time is defined sodas to be equal to or longer than 0.4 second and so as not to be longer than 1 second. In MPEG, one GOP is generally 0.5 second, and is defined as screen data compressed for about 15 images to be reproduced during this period of time.

As shown in FIG. 9, when the video object unit VOBU 85 includes video data, the GOPs, each of which comprises a video pack (V pack) 88, a sub-picture pack (SP pack) 89, and an audio pack (A pack) 91 defined in the MPEG standard, are arranged, and a video data stream is configured. Irrespective of the number of GOPs, the video object unit VOBU 85 is defined with the GOP playback time being a reference, and the navigation pack (NV pack) 86 is always arranged at the beginning of the object. Even in playback data comprising only audio and/or sub-picture data, playback data is configured with the video object unit VOBU being one unit. That is, even if the video object unit VOBU comprises only the audio pack, the audio pack to be reproduced within the playback time of the video object unit VOBU to which the audio data belongs is stored in the video object unit VOBU, in the same manner as in the video object of video data. With respect to procedures for reproducing these packs, a description will be given later in more detail together with the navigation pack (NV pack) 86.

The video manager VMG 74 will be described again with reference to FIG. 8. The video manager information VMGI 75 allocated at the beginning of the video manager VMG 74 describes information for managing a video title set VTS such as information for making a search for a title or information for reproducing a video manager menu, and at least four tables 78, 79, 80, and 81 are recorded in the order shown in FIG. 8. These tables 78, 79, 80, and 81 each are made to be coincident with the boundary of logical sectors. The video manager information management table VMGI_MAT 78 which is a first table is provided as a mandatory table. This table describes the size of the video manager VMG 74, the start address of each item of information contained in the video manager VMG 74, attribute information concerning the video object set VMGM_VOBS for manager menu, and the like.

The title search pointer table TT_SRPT 79 which is a second table of the video manager information VMGI 75 describes an entry program chain (EPGC) of a video title included in a volume in the optical disk 10 which can be selected according to title number input from the key or the display device 4 of the apparatus or title number selection using the remote controller 5.

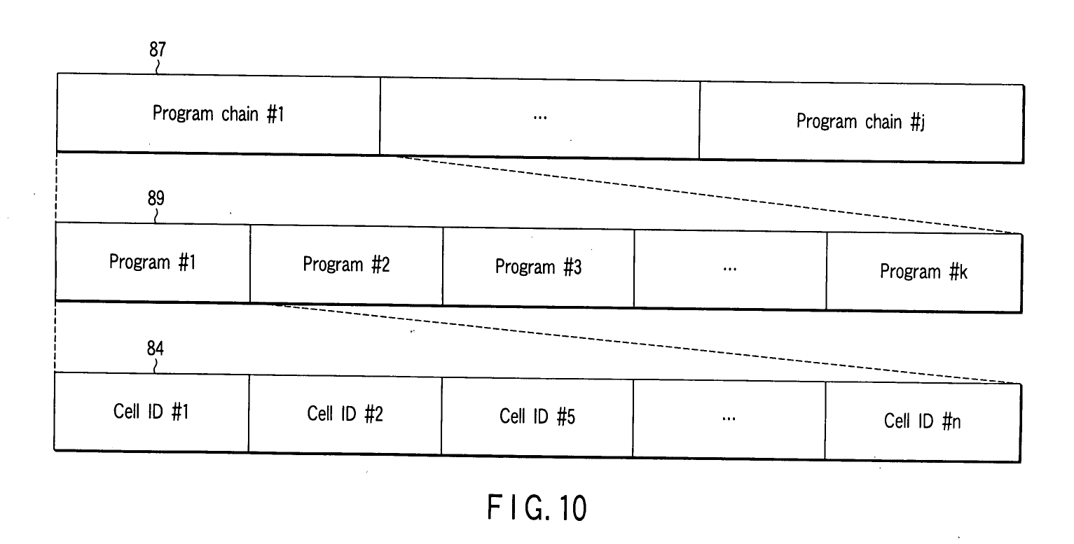

The program chain 87 is a set of programs 89 for reproducing a story of a predetermined title, as shown in FIG. 10, and a cinema of one title is completed by continuously reproducing the program chain. Therefore, the user can enjoy the cinema from a specific scene of the movie by specifying the program 89 in the program chain 87.

The video title set attribute table (VTS_ATRT) 80 which is a third table of the video manager information VMGI 75 describes attribute information defined in the video title set VTS 72 in a volume of the optical disk. That is, this table describes the number of the video title sets VTS 72 as attribute information, the video title set VTS 72 number, video attribute, for example, audio stream attribute such as video data compression scheme, for example, attribute of sub-picture such as audio coding mode, and, for example, sub-picture display type and the like.

A video manager menu PGCI unit table VMGM_PGCI_UT 81 which is a fourth table of the video manager information VMGI 75 describes information concerning a video object set VMGM_VOBS for a video manager menu.

The video manager menu PGCI unit table

VMGM_PGCI_UT 81 is a mandatory table when a video manager menu VMGM exists in the video object set VMGM_VOBS 76 for video manager menu.

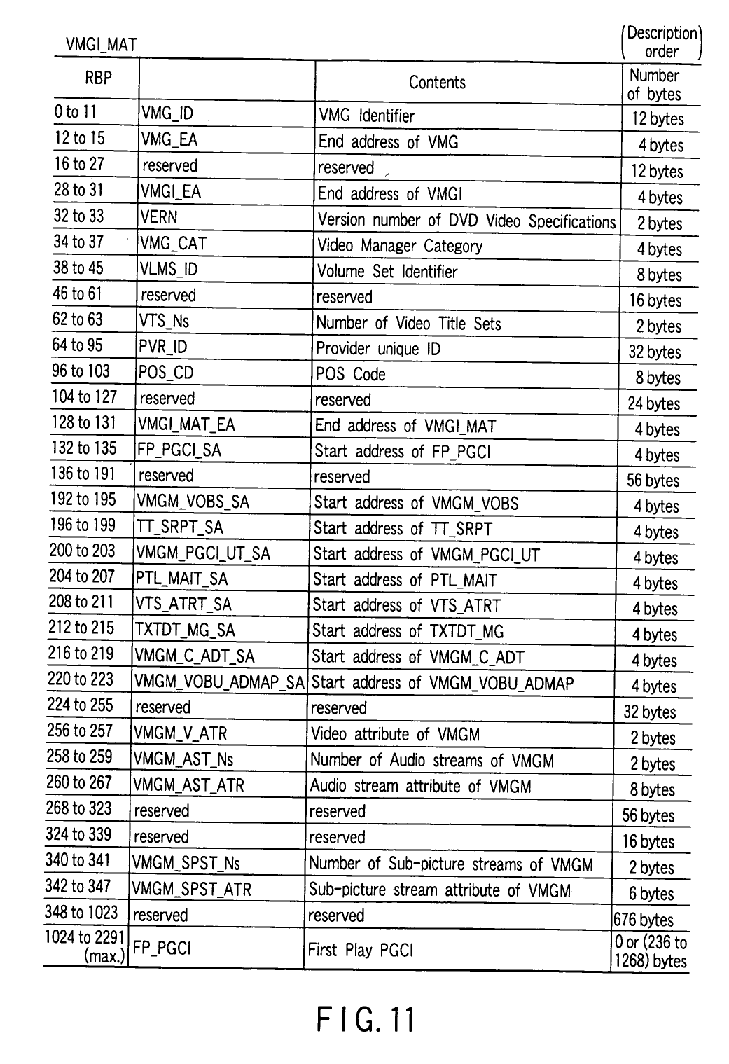

The contents of description contained in the video manager information management table VMGI_MAT 78 and title search pointer table TT_SRPT 79 will be described in more detail with reference to FIGS. 11, 12, 13, and 14.

As shown in FIG. 11, the video manager information management table VMGI_MAT 78 describes an identifier (VMG_ID) of the video manager VMG 74; an end address (VMG_EA) of the video manager which is represented by the number of logical blocks (where one logical block is of 2048 bytes as has been already described); an end address (VMGI_EA) of the video management information VMGI; a version number VERN of an optical disk (a so called digital versatile disk (digital multi-purpose disk: hereinafter, simply referred to as a DVD) video specifications; a category VMG_CAT of the video manager VMG 74; a video attribute VMGM_V_ATR of the video manager menu VMGM; the number of sub-picture streams VMGM_SPST_Ns of the video manager menu VMGM; a sub-picture stream attribute VMGM_SPST_ATR of the video manager menu VMGM and the like.

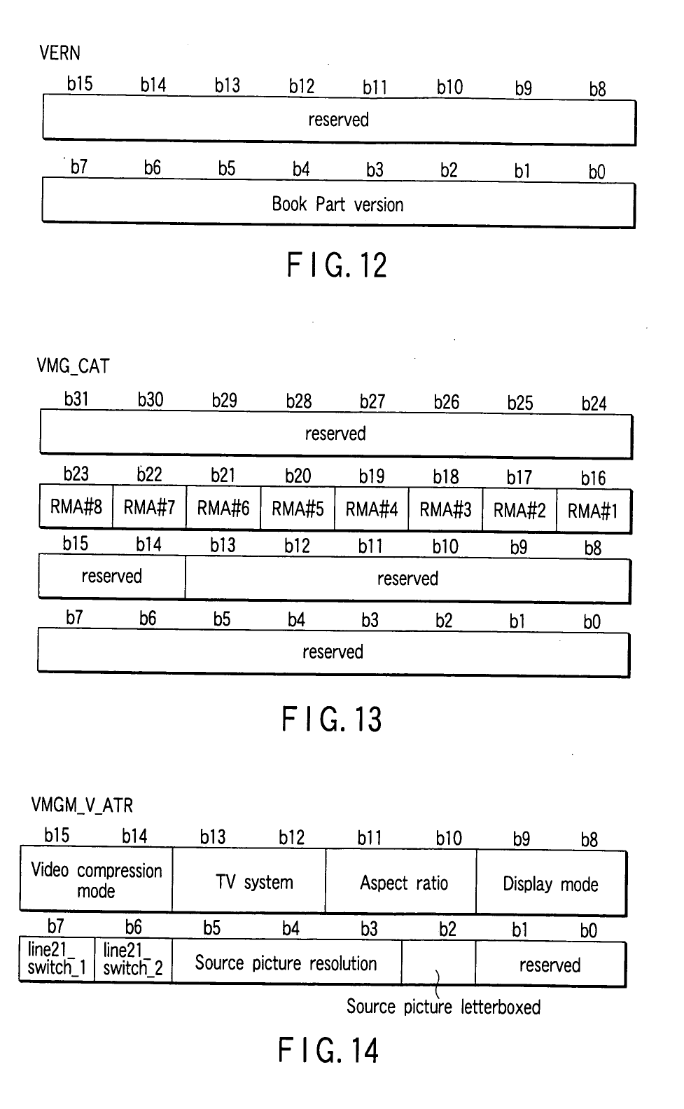

As the version number VERN, a Book Part version is described as shown in FIG. 12. In the case of version 2.0, “00100000b” is described. A playback apparatus reads the version number VERN contained in the video manager information management table VMGI_MAT 78 in the video manager information VMGI 75, thereby knowing the DVD video specifications (SD compatible specifications or HD compatible specifications) of a file to be reproduced. Then, a variety of decoders are powered ON as required, and operation can be ready to start. In the case of reproducing a file which conforms to the HD compatible specifications, playback control becomes complicated, and thus, playback can be carried out speedily if the decoders are in a standby state. In addition, these decoders are not required for reproducing a file which conforms to the SD compatible specifications, and thus, power can be saved by turning ON the power only if necessary.

The category VMG_CAT of the video manager VMG describes regional management of all VOBSs in VMG and VTS under the VIDEO_TS directory, as shown in FIG. 13. In RMA#n, if this volume can be reproduced in region #n, “0b” is described while if this volume cannot be reproduced in region #n, “1b” is described.

The table VMGI_MAT 78 further describes a volume set identifier (VLMS_ID); the number of video title sets (VTS_Ns); a provider's unique identifier of data recorded in this disk (PVR_ID); a start address (VNGM_VOBS_SA) of the video object set VMGM_VOBS 76 for video manager menu; an end address (VMGI_MAT_EA) of the video manager information management table VMGI_MAT 78; and a start address (TT_SRPT_SA) of the title search pointer table TT_SRPT 79.

The table 78 further describes a start address VMGM_PGCI_UT_SA of the video manager menu PGCI unit table VMGM_PGCI_UT 81. When the video manager menu PGCI unit table VMGM_PGCI_UT 81 does not exist, “00000000h” is described at the start address. The end address VMGI_MAT_EA of the VMGI_MAT 78 and the start address TT_SRPT_SA of the TT_SRPT 79 are described in number of relative logical blocks from the start logical block.

In the table 78, the start address VTS_ATRT_SA of the attribute table VTS_ATRT 80 of the video title set VTS 72 is described in relative number of types from the start byte of the VMGI manager table VMGI_MAT 71, and the video attribute VMGM_V_ATR of the video manager menu VMGM is also described.

FIG. 14 shows a structure of the video attribute VMGM_V_ATR of the video manager menu VMGM. The value of each field must coincide with information contained in the VMGM_VOBS video stream. When the VMGM_VOBS does not exist, “0b” is described in each bit.

In a video compression mode, “00b” is described if it is complied with MPEG-1; “01b” is described if it is complied with MPEG-2; “10b” is described if an advanced video encoding is carried out; and “11b” is provided to be reserved.

In a TV system, “00b” is described if a 525/60 scheme is established; “01b” is described if a 625/50 scheme is established; “10b” is described if a high definition scheme is established; and “11b” is provided to be reserved. A display mode describes a display mode permitted on a monitor with an aspect ratio of 4:3. In the case of standard definition (SD) contents, “11b” is described if the aspect ratio is 4:3, and “00b”, “01b”, or “10b” is described if the aspect ratio is 16:9. “00b” is available in pan/scan and letterbox; “01b” is available only in pan/scan; “10b” is available in letterbox; and “11b” is provided to be reserved. Pan/scan means a window with an aspect ratio of 4:3 cut from a demodulated pixel. If high definition (HD) contents are provided, “00b” is available in both of pan/scan and letterbox; “01b” is available only in pan/scan; “10b” is available only in letterbox; and “11b” is provided to be reserved.

With respect to a source picture resolution, if 720×480 (525/60 scheme) or 720×576 (625/50 scheme) is established, “00b” is described; if 704×480 (525/60 scheme) or 704×576 (625/50 scheme) is established, “001b” is described; if 352×480 (525/60 scheme) or 352×576 (625/50 scheme) is established, “010b” is described; if 352×240 (525/60 scheme) or 352×288 (625/50 scheme) is established, “011b” is described; if 1280×720 (HDTV scheme) is established, “100b” is described; if 1440×1080 (HDTV scheme) is established, “110b” is described; if 1920×1080 (HDTV scheme) is established, “111b” is described; and “101b” is provided to be reserved.

Table 78 also describes the number of audio streams VMGM_AST_Ns of the video manager menu VMGM; an audio stream attribute VMGM_AST_ART of the video manager menu VMGM; the number of sub-picture streams VMGM_SPST_Ns of the video manager menu VMGM; and a sub-picture stream attribute VMGM_SPST_ATR of the video manager menu VMGM.

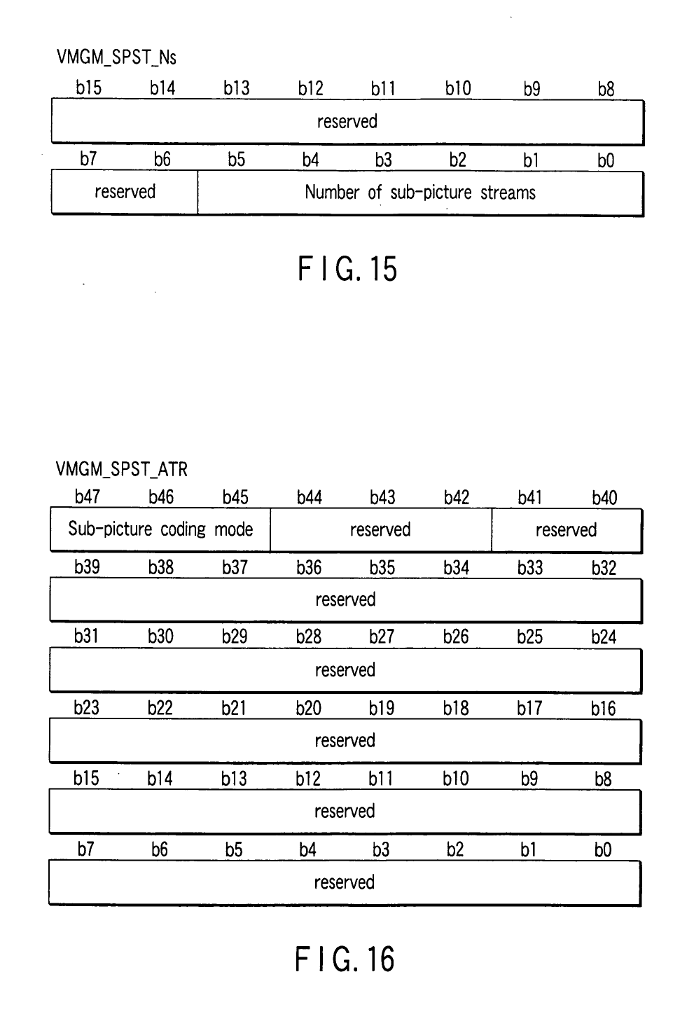

FIG. 15 shows the number of sub-picture streams VMGM_SPST_Ns of the video manager menu VMGM. When VMGM_VOBS does not exist, “0b” is described while when it exists, “1b” is described.

FIG. 16 shows a sub-picture stream attribute VMGM_SPST_ATR of the video manager menu VMGM. When VMGM_VOBS does not exist, “0b” is described in each bit. If run length compression for 2 bit/1 pixel is carried out, “000b” is described. If run length compression for 4 bit/i pixel is carried out, “010b” is described, and “001b” is reserved for an extended sub-picture.

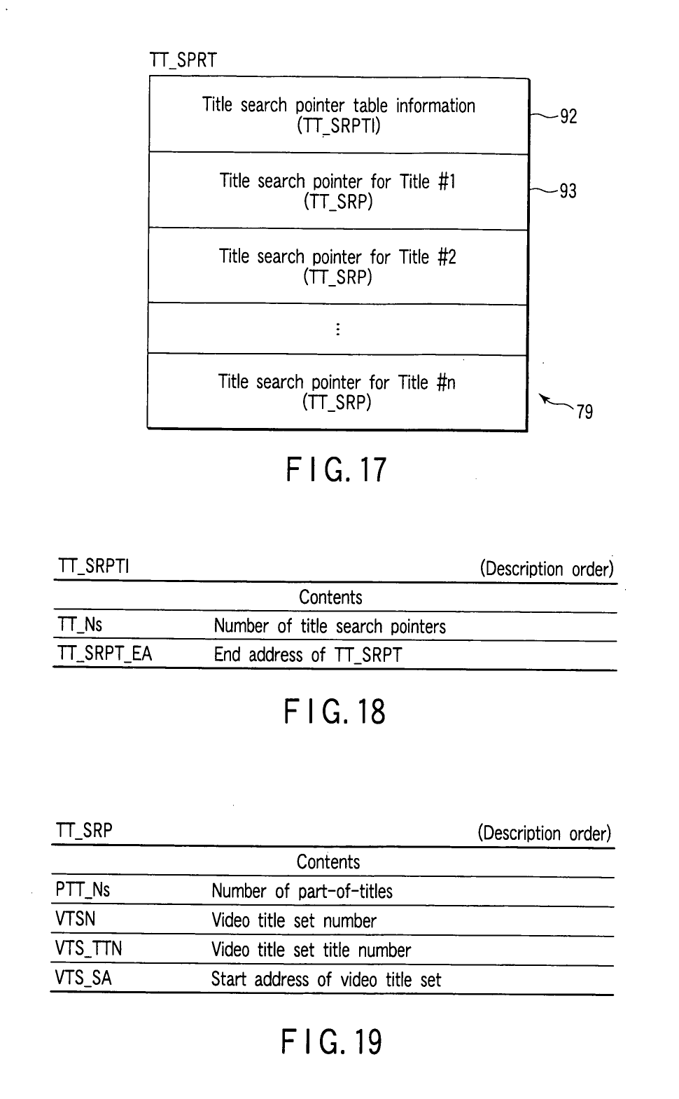

The title search pointer table TT_SRPT 79, as shown in FIG. 17, describes title search pointer table information TT_SRPTI 92 at the beginning of the table. The title search pointers TT_SRP corresponding to input number 1 to n (n≦99) are continuously described in required number. When only 1 title playback data, for example, only 1 title video data is stored in a volume of the optical disk, only one title search pointer TT_SRP 93 is described in the table TT_SRPT 79.

The title search pointer table information TT_SRPTI 92, as shown in FIG. 18, describes the number of title search pointers TT_Ns and the end address TT_SRPT_EA of the title search pointer table TT_SRPT 79. The address TT_SRPT_EA is described in relative number of bytes from the start byte of the title search pointer table TT_SRPT 79.

As shown in FIG. 19, each title search pointer TT_SRP describes the part-of-title number PTT_Ns as the number of chapters (the number of programs); the video title set number VTSN; the title number VTS_TTN of the video title set 72; and the start address VTS_SA of the video title set 72.

The video title set VTS 72 reproduced according to 10 the contents of the title search pointer TT_SRP 93 is specified, and the storage position of the video title set 72 is specified. At the start address VTS_SA of the video title set 72, a title set specified by the video title set number VTSN is described in number of logical blocks.

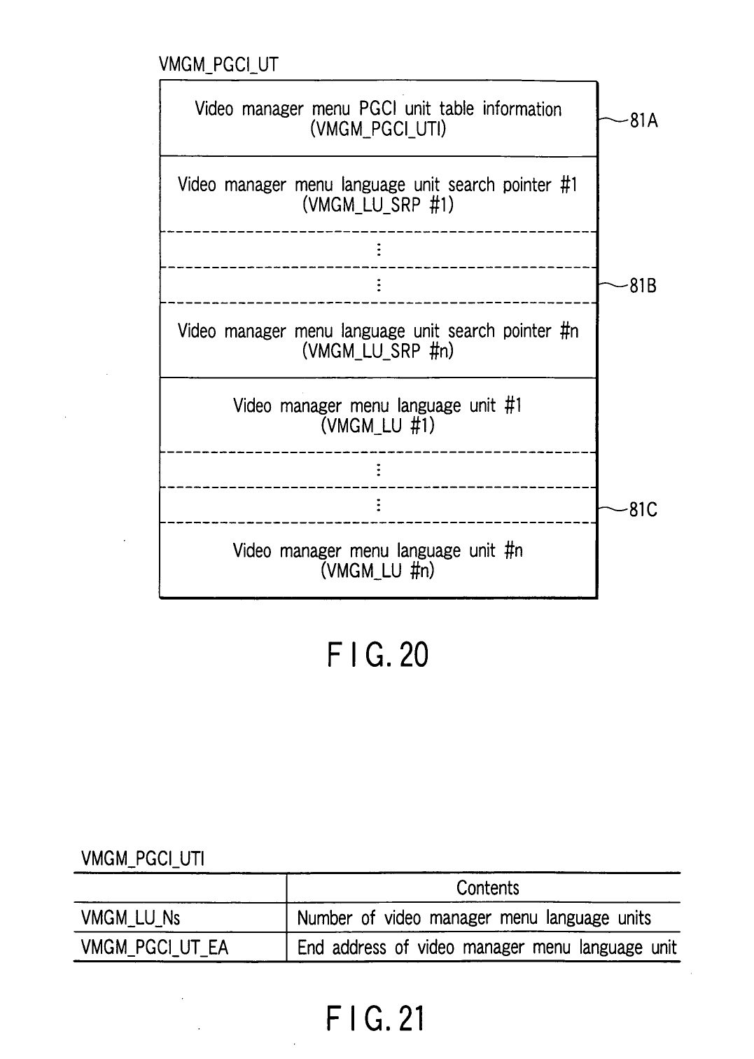

The contents of description contained in the video manager menu PGCI unit table VMGM_PGCI_UT 81 will now be described in more detail with reference to FIGS. 20, 21, 22, 23, 24, and 25. The video manager menu PGCI unit table VMGM_PGCI_UT 81 shown in FIG. 20 is a mandatory item in the case where the video object set VMGM_VOBS 76 for video manager menu is provided. Information about a program chain for reproducing the video manager menu VMGM provided for each language is described in this menu. By referring to the video manager menu PGCI unit table VMGM_PGCI_UT 81, a program chain of the language specified in the video object set VMGM_VOBS 76 can be acquired and reproduced as a menu.

The video manager menu PGCI unit table

VMGM_PGCI_UT 81, as shown in FIG. 20, comprises video manager menu PGCI unit table information VMGM_PGCI_UTI 81A; “n” video manager menu language search pointers VMGM_LU_SRP 81B; and “n” video manager menu language units VMGM_LU 81C. These components are described in the above order.

The video manager menu PGCI unit table information VMGM_PGCI_UTI 81A describes information on the table 81. The video manager menu PGCI unit search pointer VMGM_LU_SRP 81B describes language codes in order corresponding to #1 to #n video manager menus. In addition, this pointer gives a description concerning pointers for making a search for the video manager menu language unit VMGM_LU 81C described in order corresponding to #1 to #n video manager menus. In each of the video manager menu language units VMG_LU 81C, there are described the category and start address of the program chain in the corresponding video manager menu.

In more detail, in the video manager menu PGCI unit table information VMGM_PGCI_UTI 81A, as shown in FIG. 21, the number of the video manager menu language units VMGM_LU 81C is described as a parameter VMGM_LU_Ns. An end address of the video manager menu language unit VMGM_LU 81 is described as a parameter VMGM_PGCI_UT_EA.

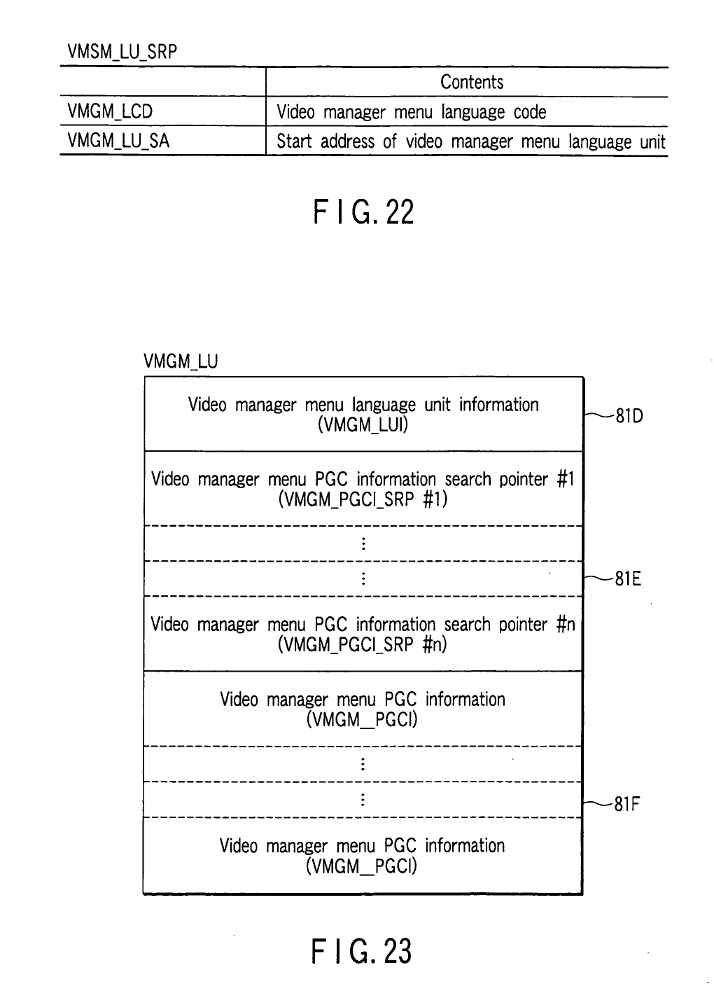

As shown in FIG. 22, in the video manager menu PGCI unit search pointer VMGM_LU_SRP 81B, a video manager menu language code is described as a parameter VMGM_LCD; and a start address of the video manager menu language unit VMGM_LU 81C is described as a parameter VMGM_LU_SA.

The video manager menu language unit VMGM_LU 81C, as shown in FIG. 23, comprises video manager menu language unit information VMGM_LUI 81D; a video manager menu PGC information search point VMGM_PGCI_SRP 81E; and video manager menu PGC information VMGM_PGCI 81F. These components are described in the above order. Information on this table 81C is described in the video manager menu language unit information VMGM_LUI 81D. In the VMGM_PGCI_SRP 81E, the category of the-program chain in the video manager menu is described in order corresponding to #1 to #n video manager menus; and there is given a description concerning pointers for making a search for the video manager menu PGC information search information VMGM_PGCI 81F described in order corresponding to #1 to #n video manager menus.

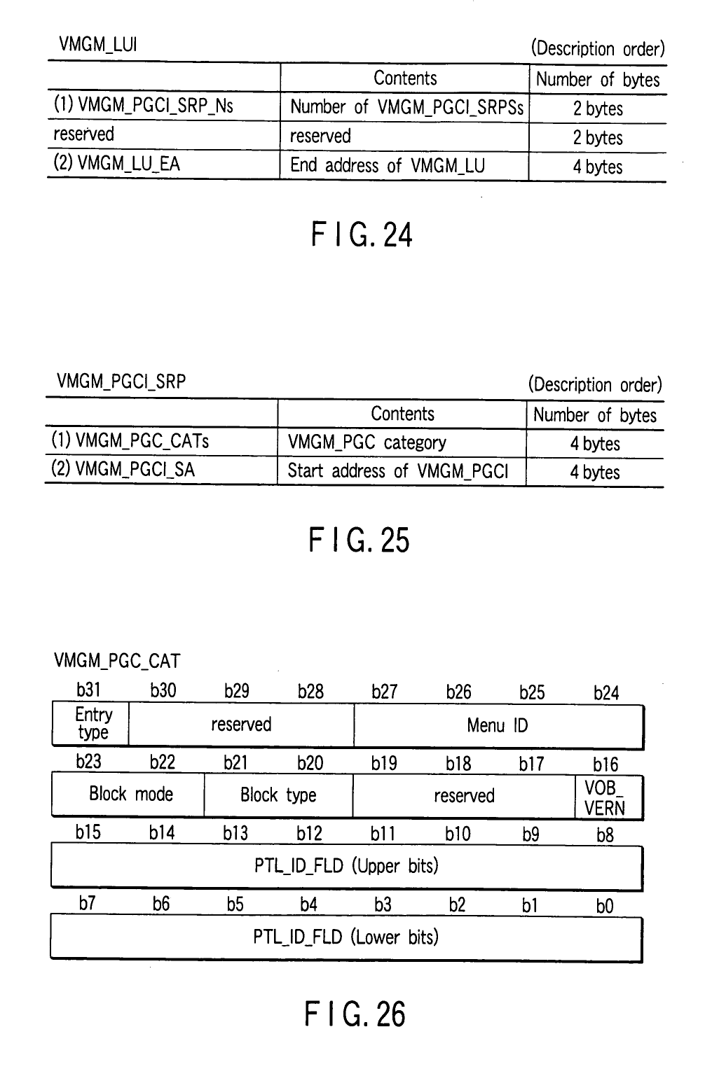

The video manager menu PGCI information search information VGMG_PGCI 81F describes information concerning a program chain in a video manager menu, i.e., VMGM program chain information VMGM_PCCI. In more detail, in the video manager menu language unit information VMGM_LUI 81D, as shown in FIG. 24, the number of VMGM program chain information VMGM_PGCI 81F is described as a parameter VMGM_PGCI_Ns; and an end address of the video manager menu language unit information VMGM_LUI 81D is described as a parameter VMGM_LUI_EA. As shown in FIG. 25, in the video manager menu PGC information search pointer VMGM_PGCI_SRP 81E, a category of the program chain in the video manager menu is described as a parameter VMGM_PGC_CAT; and a start address of the VMGM program chain information VMGM_PGCI 81F is described as a parameter VMGM_PGCI_SA.

The category VMGM_PGC_CAT of the program chain in the video manager menu, as shown in FIG. 26, describes a flag (entry type) indicating whether or not this PGC is entered; and a menu ID indicating a menu; version number VOB_VERN and the like. When entry type is not entry PGC, “0b” is described. When it is entry PGC, “1b” is described. As the menu ID, if entry PGC is “0b”, “0000b” is described; if entry PGC is “1b”, “0010b” is described. These descriptions each denote a title menu. In VOB_VERN, the version number of VMGM_VOB included in PGC is described; if VOB version 1.1 is issued, “0b” is described; and if VOB version 2.0 is issued, “1b” is described. The playback apparatus reads the version number VOB_VERN in the category VMGM_PGC_CAT of the program chain in the video manager menu, thereby knowing the DVD video specifications (SD compatible specifications or HD compatible specifications) of a file in the video object VOB, the file being to be reproduced. Then, a variety of decoders are powered ON as required, and operation can be ready to start. In the case of the HD compatible data playback, playback control becomes complicated, and thus, playback can be carried out speedily if the decoders are in a standby state. In addition, these decoders are not required for SD compatible data playback, and thus, power can be saved by turning ON the power only if necessary.

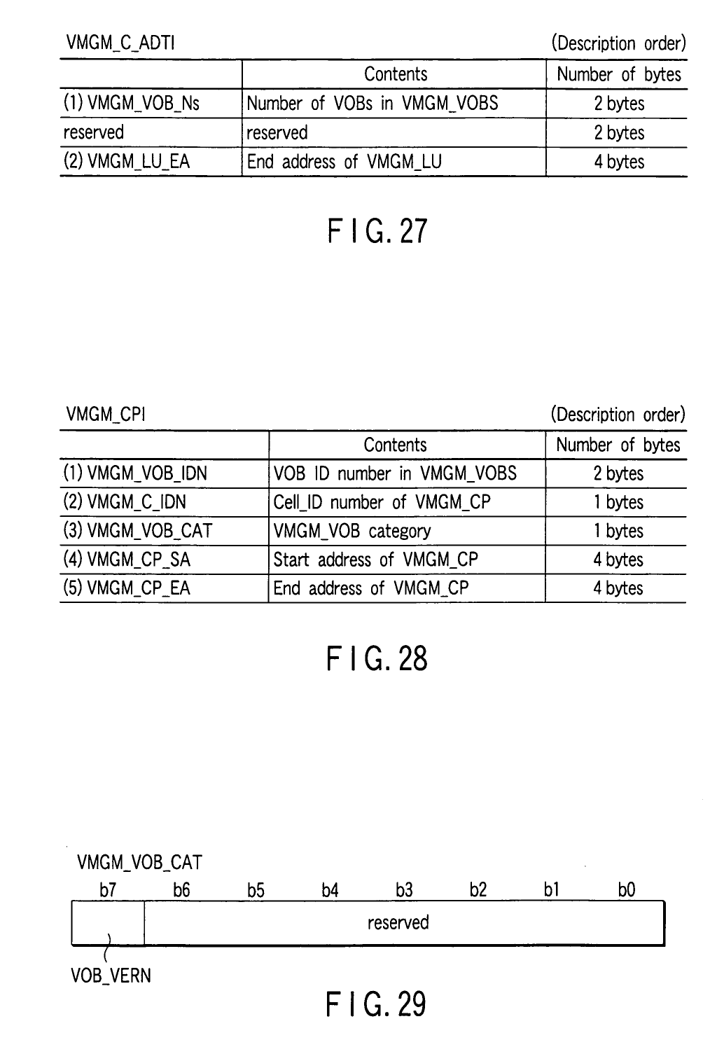

FIG. 27 shows a structure of video manager menu cell address table information VMGM_C_ADTI in a video manager menu cell address table VMGM_C_ADT of video: manager information VMGI.

FIG. 28 shows a structure of video manager menu cell piece information VMGM_CPI in the video manager menu cell address table VMGM_C_ADT of the video manager information VMGI.

FIG. 29 shows a structure of VMGM_VOB_CAT which indicates the category of VOB included in VMGM_CPI of FIG. 28. VOB_VERN describes the version number of VMGM_VOB to which this cell piece belongs. If VOB version 1.1 is issued, “0b” is described; and if VOB version 2.0 is issued, “1b” is described. The playback apparatus reads the version number VOB_VERN in the video manager menu cell piece information VMGM_CPI of the video manager information VMGI, thereby knowing the video specifications (SD compatible specifications or HD compatible specifications) of a file to be reproduced. Then, a variety of decoders are powered ON as required, and operation can be ready to start.

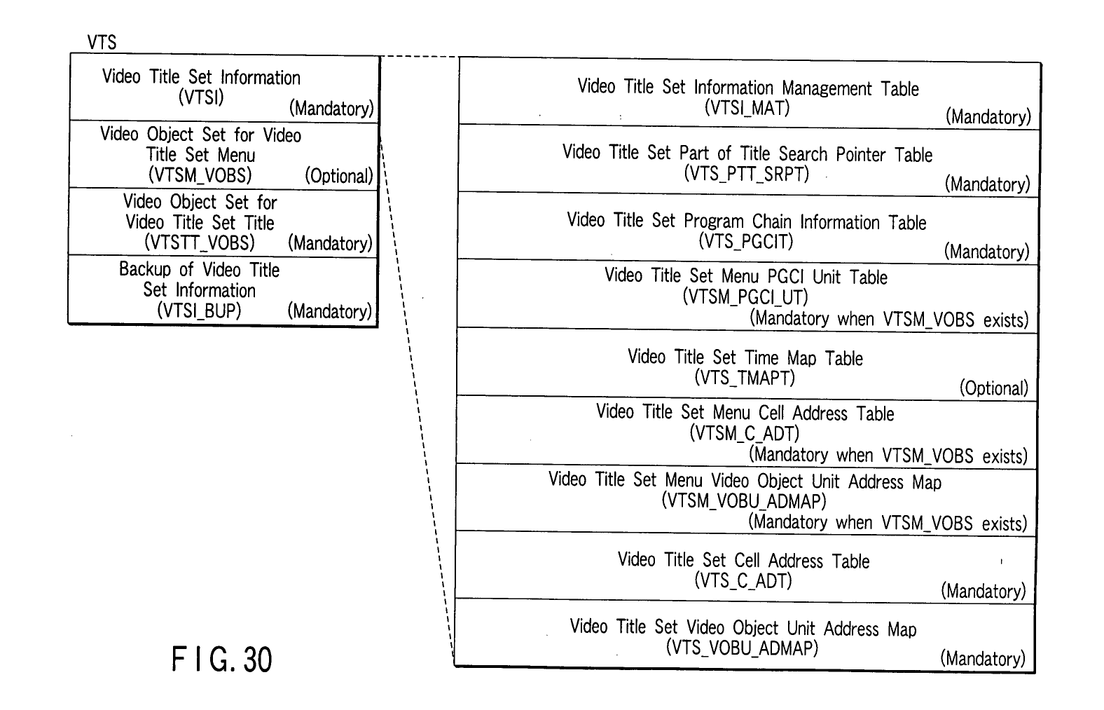

Now, a structure of a logical format of the video title set VTS shown in FIG. 6 will be described with reference to FIG. 30. The video title set VTS describes four items in order, as shown in FIG. 30. The video title set VTS comprises one or more video titles having common attributes. Management information on video title sets VTS, for example, information for entry search pointers; information for reproducing video object sets; information for reproducing a title set menu VTSM; and attribute information on video object sets VOBS are described in the video title set information VTSI.

Backup VTS_BUP of the video title set information VTSI is provided in the video title set VTS. Between the video title set information VTSI and the backup VTS_BUP, there are allocated a video object set VTSM_VOBS for video title set menu and a video object set VTSTT_VOBS for video title set title. These video objects sets VTSM_VOBS and VTSTT_VOBS both have a structure shown in FIG. 9, as has already been described.

The video title set information VTSI, backup VTSI_BUP of this information, and video object set VSTT_VOBS for video title set are mandatory items for the video title set VTS. The video object set VTSM_VOBS for video title set menu is an option provided as required.

The video title set information VTSI, as shown in FIG. 30, comprises at least 5 tables. These 5 tables are made coincident with the boundary between logical sectors. The video title set information management table VTSI_MAT which is a first table is provided as a mandatory table. This table describes the size of the video title set VTS, a start address of each item of information contained in the video title set VTS, and an attribute of the video object set VOBS contained in the video title set VTS.

The video title set part-of-title set search pointer table VTS_PTT_SRPT which is a second table is provided as a mandatory table. This table describes the number of TTUs in VTS and an end address of VTS_PTT_SRPT. The number of TTUs in VTS must be identical to the number of titles in VTS. The maximum number of TTUs is 99. The end address of VTS_PTT_SRPT is described with a relative type number RBN from the start byte of this VTS_PTT_SRPT.

The video title set program chain information table VTS_PGCIT which is a third table is provided as a mandatory table. This table describes VTS program chain information VTS_PGCI.

The video title set time map table VTS_TMART which is a fourth table is an optional table provided as required. This table describes information concerning a position of recording video data in each program chain PGC of the title set to which the map table VTS_TMAPT belongs, in response to a predetermined display time.

The video title set menu video object unit address map VTSM_VOBU_ADMAP which is a fifth table is provided as a mandatory item in the case where there is provided the video object set VTSM_VOBS for video title set menu. This table describes information on a program chain for reproducing the video set menu VTSM provided for each language. By referring to the video title set menu video object unit address map VTSM_VOBU_ADMAP, a program chain of the language specified in the video object set VTSM_VOBS can be acquired and reproduced as a menu.

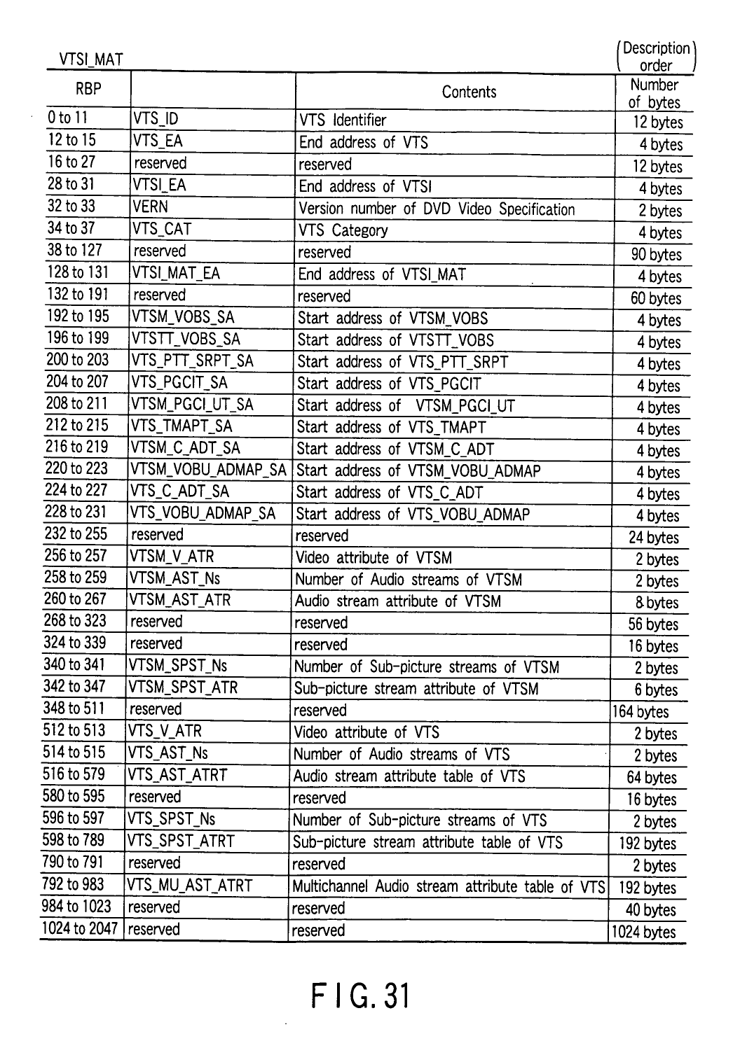

Now, the video title set information manager table VTSI_MAT and video title set program chain information table VTS_PGCIT shown in FIG. 30 will be described with reference to FIGS. 31 to 50.

FIG. 31 shows the contents of description of the video title information manager table VTSI_MAT. The table VTSI_MAT describes a video title set identifier VTS_ID; an end address VTSI_EA of video title information; a version number VERN of the DVD video specifications; a video title set category VTS_CAT; an end address VTSI_MAT_EA of the video title set information management table VTSI_MAT (relative block number from the start byte of the table VTSI_MAT); a start address VTSM_VOBS_SA of the video object set VTSM_VOBS of the VTS menu VTSM (described in a relative logical block RLBN from the start logical block of the video title set VTS); a start address VTS_PTT_SRPT_SA of the video title set part-of-title set search pointer table VTS_PTT_SRPT (described in the relative number of blocks from the start byte of the video title set information VTSI 94); a start address of the video title set program chain information table PGCIT 100 (described in the relative number of blocks from the start byte of the video title set information VTSI 94); a start address VTSM_CI_UT_SA of the video title set menu PGCI unit table VTSM_PGCI_UT (described in the relative number of blocks from the start byte of the video title set information VTSI 94); a start address VTS_TMAPT_SA of the time search map VTS_TMAPT of the video title set VTS (described in the relative logical sector from the start logical sector of the video title set VTS) and the like. When the video manager menu PGCI unit table VMGM_PGCI_UT does not exist, “10000000h” is described at the start address.

Further, this table VTSI_MAT describes a video attribute VTS_V_ATR of the video object set VTST_VOBS for video title set menu VTSM in the video title set VTS and of the video object set VTST_VOBS for title VTSTT of the video title set VTS; and the number of audio streams VTS_AST_Ns of the video object set VTSTT_VOBS 96 for title VTSTT of the video title set in the video title sets VTS. The video attribute VTS_V_ATR describes a video compression mode, a TV system frame rate, an aspect ratio when a display is made on a display unit and the like.

The video title set information management table VTSI_MAT 98 also describes an audio stream attribute table VTS_AST_ATRT of the video object set VTST_VOBS 96 for the title VTSTT of the video title set VTS 72 in the video title sets VTS. The attribute table VTS_AST_ATRT describes an audio coding mode which describes how audio has been encoded; in what bit audio quantization has been executed; the number of audio channels; an audio language code and the like.

The table VTST_MAT also describes the number of sub-picture streams VTS_SPST_Ns of the video object set VTST_VOBS for the title VTSTT in the video title set VTS; and an attribute table VTS_SPRT_ATRT of each sub-picture stream. This sub-picture stream attribute table VTS_SPST_ATRT describes the sub-picture coding mode and sub-picture display type or sub-picture language code and the like.

Further, the table VTST_MAT describes the video attribute VTSM_V_ATR of the video title set menu VTSM; the number of audio streams VTSM_AST_Ns; an audio stream attribute VTSM_AST_ART; the number of sub-picture streams VTSM_SPST_Ns; and an sub-picture stream attribute VTSM_SPST_ATR.

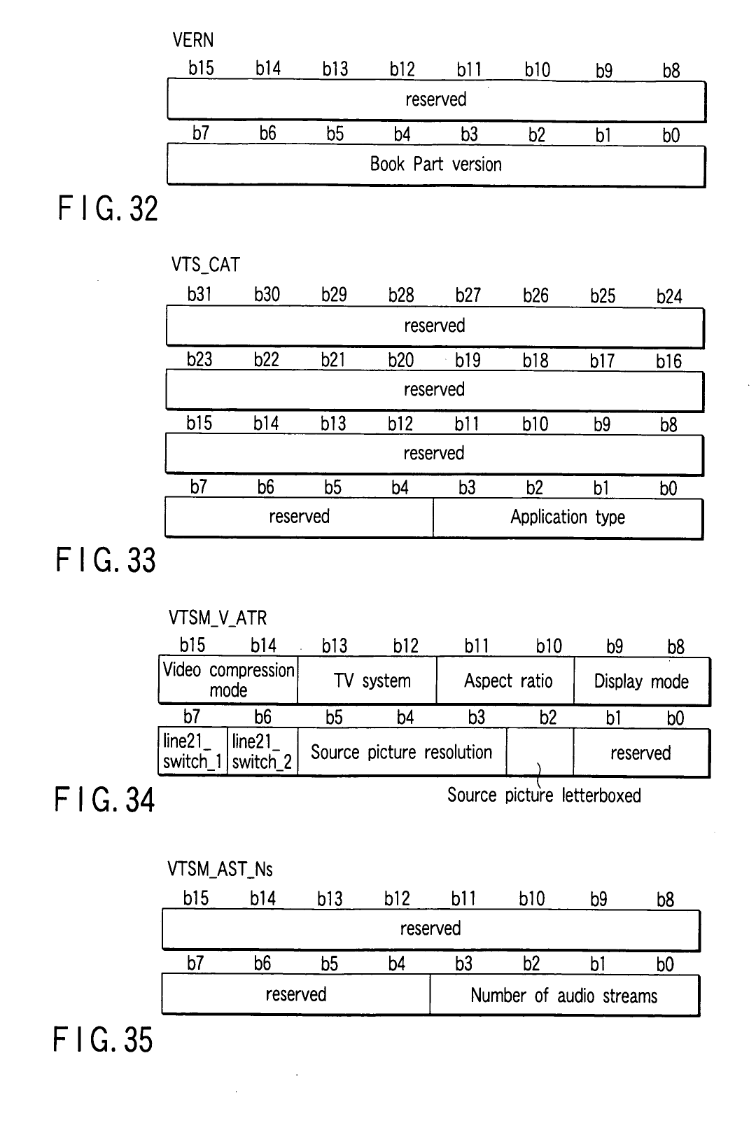

FIG. 32 shows a structure of the version number VERN of the DVD video specifications in the table VTSI_MAT. If version 1.0 is issued, “00010000b” is described; if version 1.1 is issued, “00010001b” is described; if version 2.0 is issued, “00100000b” is described; and the other is provided to be reserved. This version number is also used for standby of required decoders as in the above-described version number.

FIG. 33 shows a structure of the VTS category VTS_CAT in the table VSTI_MAT. The application type of this VTS is described. If nothing is specified, “0000b” is described, and if “karaoke” is specified, “0001b” is described.

FIG. 34 shows a structure of the VTSM video attribute VTSM_V_ATR in the table VTSI_MAT. A video compression mode describes “10b” if advanced video compression is specified. In the TV system, if 525/60 scheme is specified, “00b” is described; if 625/50 scheme is specified, “01b” is described; and if HD system is specified, “10b” is described. If the aspect ratio is 4:3, “00b” is described; and if the aspect ratio is 16:9, “10b” is described. A display mode describes a display mode allowed on a monitor with an aspect ratio of 4:3. In the case of SD contents, if the aspect ratio is 4:3, “11b” is described; and if the aspect ratio is 16:9, “00b,” “01b,” or “10b” is described. “00b” is available in both pan/scan and letterbox; “01b” is available only in pan/scan; “10b” is available only in letterbox; and “11b” is provided to be reserved. Pan/scan means a window with an aspect ratio of 4:3 cut from a demodulated pixel. In the case of HD contents, “00b” is available in both pan/scan and letterbox; “01b” is available only in pan/scan; “10b” is available only in letterbox; and “11b” is provided to be reserved.

With respect to source picture resolution, if 720×480 (525/60 scheme) or 720×576 (625/50 scheme) is established, “000b” is described; if 704×480 (525/60 scheme) or 704×576 (625/50 scheme) is established, “001b” is described; if 352×480 (525/60 scheme) or 352×576 (625/50 scheme) is established, “010b” is described; if 352×240 (525/60 scheme) or 352×288 (625/50 scheme) is established, “011b” is described; if 1280×720 (HDTV scheme) is established, “10b” is described; if 1440×1080 (HDTV scheme) is established, “110b” is described; if 1920×1080 (HDTV scheme) is established, “111b” is described; and “101b” is provided to be reserved.

Source picture letterboxed describes whether or not video output is letterboxed (after video and sub-picture has been mixed). When the aspect ratio is “11b” (16:9), “0b” is described; and when the aspect ratio is “00b” (4:3), “0b” or “1b” is described. “0b” is not letterboxed. “1b” is letterboxed.

FIG. 35 shows a structure of the number of VTSM audio streams VTSM_AST_Ns in the table VTSI_MAT.

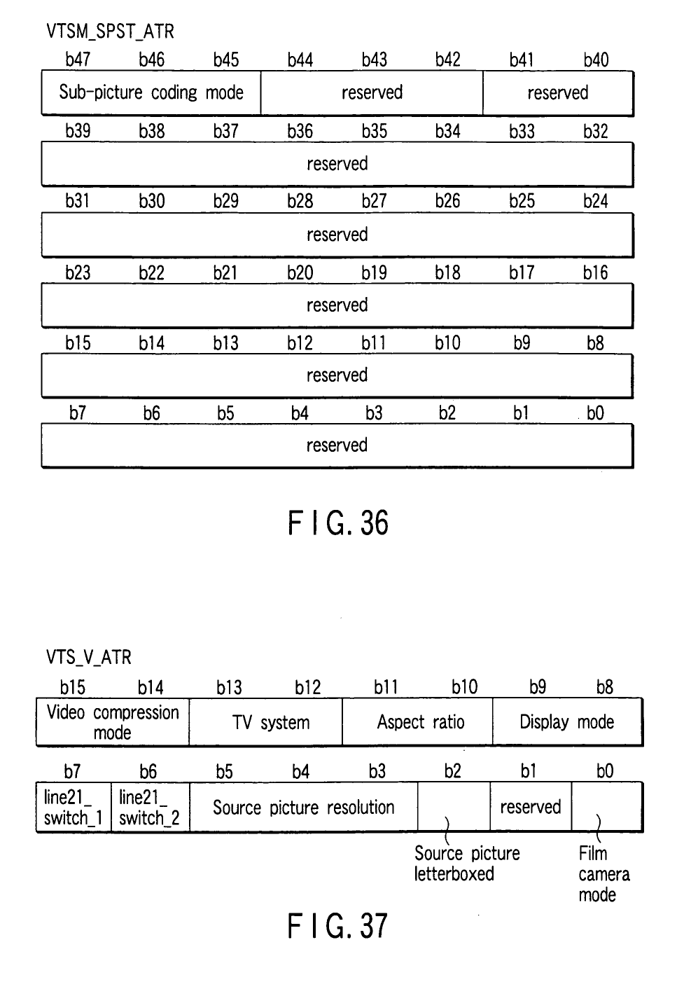

FIG. 36 shows a structure of the VTSM sub-picture stream attribute VTSM_SPST_ATR in the table VTSI_MAT. In a sub-picture coding mode, if 2-bit/1-pixel run length compression is carried out, “000b” is described; if 4-bit/1-pixel run length compression is carried out, “010b” is described; and “001b” is provided to be reserved.

FIG. 37 shows a structure of the VTS video attribute VTS_V_ATR in the table VTST_MAT. In a video compression mode, if advanced video compression is carried out, “10b” is described. In the TV system, if 525/60 scheme is established, “00b” is described; 625/50 scheme is established, “01b” is described; and if HD system is established, “10b” is described. If the aspect ratio is 4:3, “00b” is described; and if the aspect ratio is 16:9, “10b” is described. The display mode describes a display mode allowed on a monitor with an aspect ratio of 4:3. In the case of standard definition (SD) contents, if the aspect ratio is 4:3, “11b” is described, and if the aspect ratio is 16:9, “00b,” “01b,” or “10b” is described. “00b” is available in both pan/scan and letterbox, “01b” is available only in pan/scan, “10b” is available only in letterbox, and “11b” is provided to be reserved. Pan/scan means a window with an aspect ratio of 4:3 cut from a demodulated pixel. In the case of high definition (HD) contents, “00b” is available in both pan/scan and letterbox, “01b” is available only in pan/scan, “10b” is available only in letterbox, and “11b” is provided to be reserved.

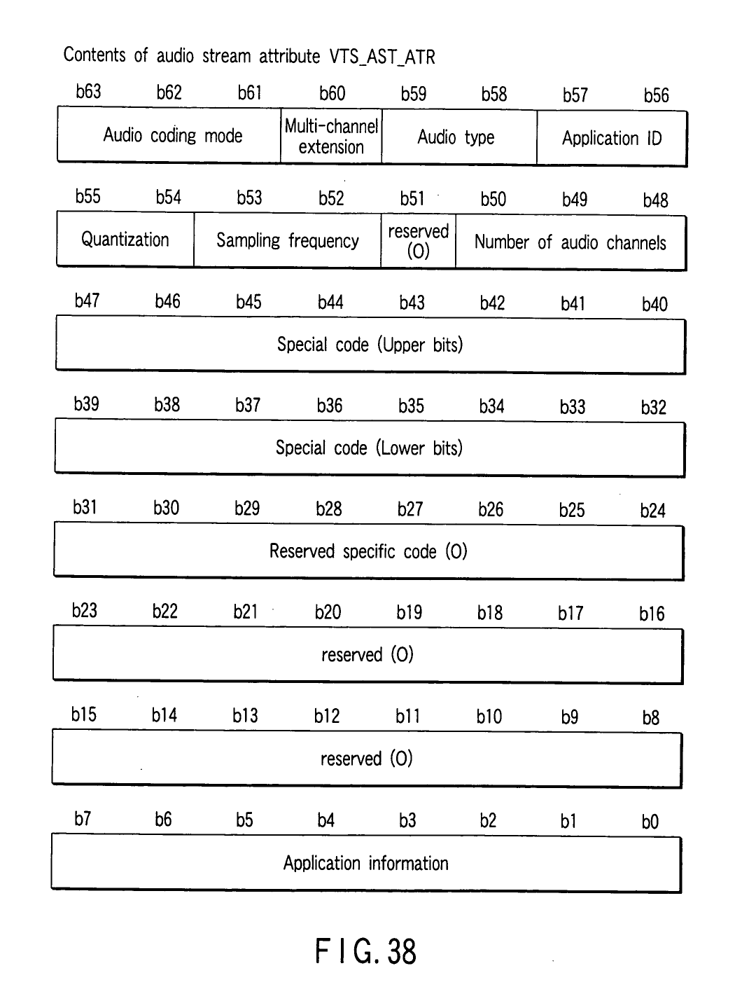

FIG. 38 shows the audio stream attribute table VTS_AST_ATRT of the video title set VTS in the table VTST_MAT. Bit number b63 to bit number b48 describe audio coding mode, multi-channel extension, audio type, audio application ID, quantization, sampling frequency, reservation, and the number of audio channels. Bit number b47 to bit number b40 and bit number b39 to bit number b32 describe an audio stream language code as a special code, and reservation for such a special code is provided in bit number b31 to bit number b24. Bit number b23 to bit number b8 are reserved for future use, and application information is described in bit number b7 to bit number b0. When VST menu video object set VTSM_VOBS 95 does not exist, or when an audio stream does not exist in that video object set, “0b” is described in each of the bits of bit number b63 to bit number b0.

Special codes are described in b47 to b40 and b39 to b32. When an audio stream type is a language, i.e., a voice, the code of the language defined in ISO-639 is described in a language symbol. When the audio stream type is not a language, that is, is not a voice, this region is provided to be reserved.

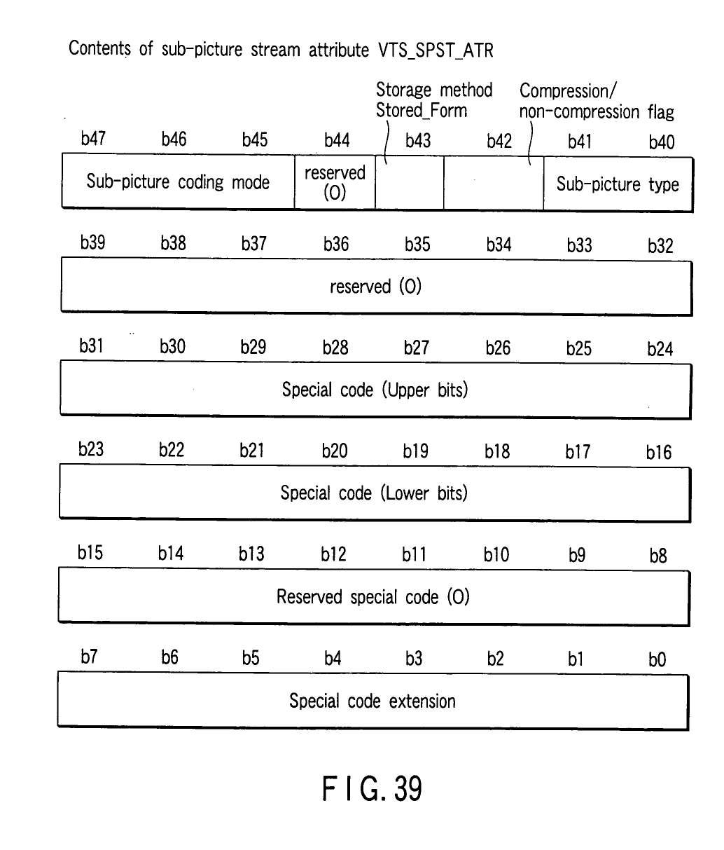

FIG. 39 shows the sub-picture stream attribute table VTS_SPST_ATRT of the video title set VTS in the table VTST_MAT. Bit number b47 to bit number b45 describe a sub-picture coding mode, bit number b44 describes reservation, bit number b43 describes a flag “Stored_Form” indicating a method for storing 4-bit/1-pixel pixel data, bit number b42 describes a flag “Raw” indicating run length compression/non-compression of pixel data PXD, bit numbers b41 and b40 describe a sub-picture type, bit number b39 to bit number b32 are provided to be reserved, bit number b31 to bit number b24 and bit number b23 to bit number b16 describe language codes of this sub-picture stream as a special code, bit number b15 to bit number b8 are assumed to be reservation of special code, and bit number b7 to bit number b0 describe special code extension.

The flag “Stored-Form” indicating a method for storing pixel data specifies “0b” (top/bottom) in the case where interlace display is carried out. By separately storing display data to be divided into top and bottom, there can be achieved a data structure in which data can be easily acquired and an interlace display can be easily made. When a non-interlace display is carried out, “1b” (plain) is specified, and display data is stored in batch, whereby there can be achieved a data structure in which data can be easily acquired and a non-interlace display can be easily made. The HD scheme carries out a non-interlace display with its superior image quality, and the SD scheme carries out an interlace display. The playback apparatus reads this flag “Stored_Form,” whereby a variety of decoders are powered ON as required, and operation can be ready to start.

The flag “Raw” indicating run length compression/non-compression specifies “0b” (compression) for a stream of superimposition with its good compression rate of superimposition or the like or specifies “1b” (not-compression) for a slightly complicated image stream which causes an increased amount of data after compression. In this manner, compression/non-compression can be specified in units of sub-picture streams, information can be allocated to a main picture stream or another stream (such as audio), and sub-picture information can be efficiently recorded in an information recording medium. Thus, high image quality contents in the HD scheme can be recorded. Since, if compression is carried out, an image quality is slightly degraded, it is preferable that the image in the HD scheme be set to be non-compressed. The playback apparatus reads the flag “Raw” indicating run length compression/non-compression, thereby knowing whether or not a sub-picture stream to be reproduced required decompression. Then, a required decoder is powered ON, and operation can be ready to start.

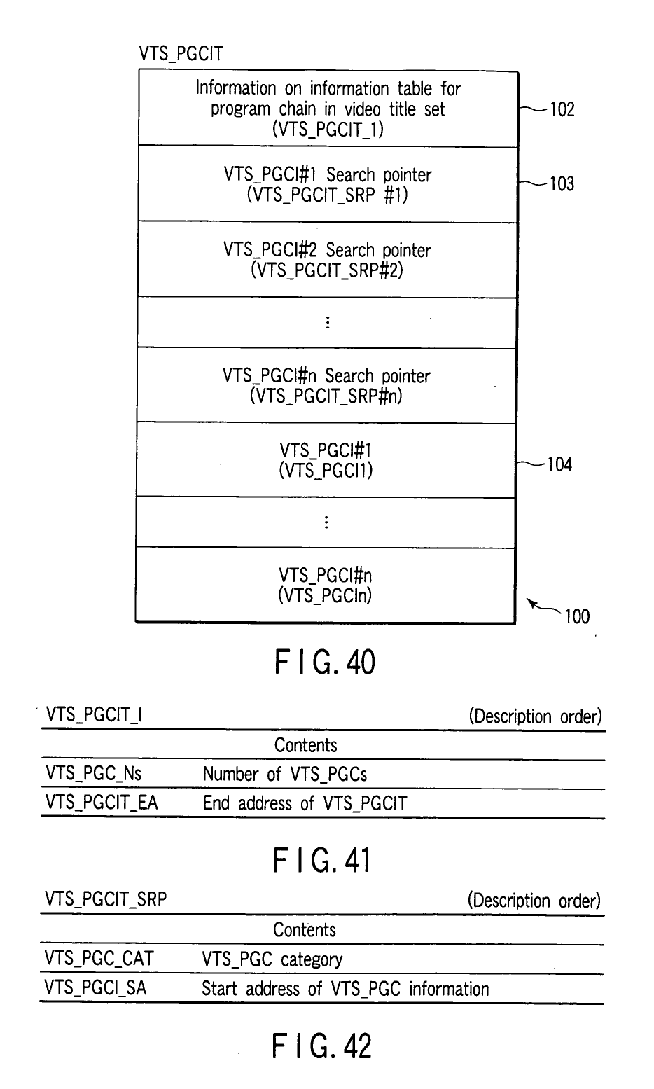

The VTS program chain information table VTS_PGCIT 100 is configured as shown in FIG. 40. The information table VTS_PGCIT 100 describes information VTS_PGCI concerning the VTS program chain VTS_PGC. As a start item, there is provided information VTS_PGCIT_I 102 of the information table VTS_PGCIT 100 concerning the VTS program chain VTS_PGC. Following the information VTS_PGCIT_I 102, in the information table VTS_PGCIT 100, there is provided a VCTS_PGCI search pointer VTS_PGCIT_SRP 103 for making a search for the VTS program chains VTS_PGC in number #1 to #n of VTS program chains VTS_PGC in the information table VTS_PGCIT 100, and lastly, there is provided information VTS_PGCI 104 concerning each VTS program chain VTS_PGC in number corresponding to the VTS program chains VTS_PGC.

In the information VTS_PGCIT_I 102 of the VTS program chain information table VTS_PGCIT 100, as shown in FIG. 41, the number VTS_PGC_Ns of VTS program chains VTS_PGC is described as contents, and an end address VTS_PGCIT_EA of the table information VTS_PGCIT_I 102 is described in the relative number of bytes from the start byte of the information table VTS_PGCIT 100.

In the VTS_PGCIT search pointer VTS_PGCIT_SRP 103, as shown in FIG. 42, there are described an attribute VTS_PGC_CAT of the program chain VTS_PGC of the video title set VTS 72, and an start address VTS_PGCI_SA of the VTS_PGC information VTS_PGCI in the relative number of bytes from the start byte of the VTS_PGC information table VTS_PGCIT 100. In the VTS_PGC attribute VTS_PGC_CAT, as an attribute, for example, it is described as to whether or not the entry program chain PGC is firstly reproduced. In general, the entry program chain PGC is described prior to the program chain PGC which is not an entry program chain PGC.

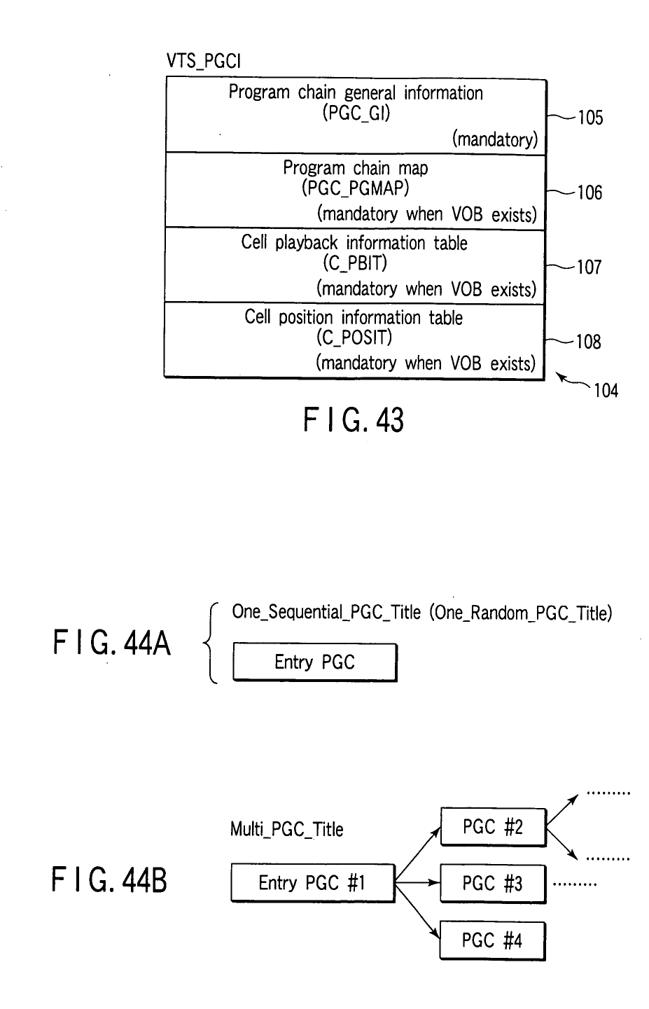

The PGC information VTS_PGCI 104 in the video title set, as shown in FIG. 43 describes 4 items. The PGC information VTS_PGCI 104 initially describes program chain general information PGC_GI 105 which is a mandatory item, and subsequently describes at least 3 items 106, 107, and 108 which are mandatory items only in the case where a video object VOB exists. That is, as the three items, the program chain program map PGC_PGMAP 106, the cell playback information table C_PBIT 107, and cell position information table C_POSIT 108 are described in the PGC information VTS_PGCI 104.

A program chain structure will be described here. A DVD playback structure consists of a title structure and a program chain PGC structure. A title comprises at least one program chain, and a program chain comprises at least one cell. PGC at the beginning of each title is referred to as an entry PGC. An example of the title structure is shown in FIGS. 44A and 44B, wherein FIG. 44A indicates a title comprising only one PGC, and FIG. 44B indicates a title comprising two or more PGCs.

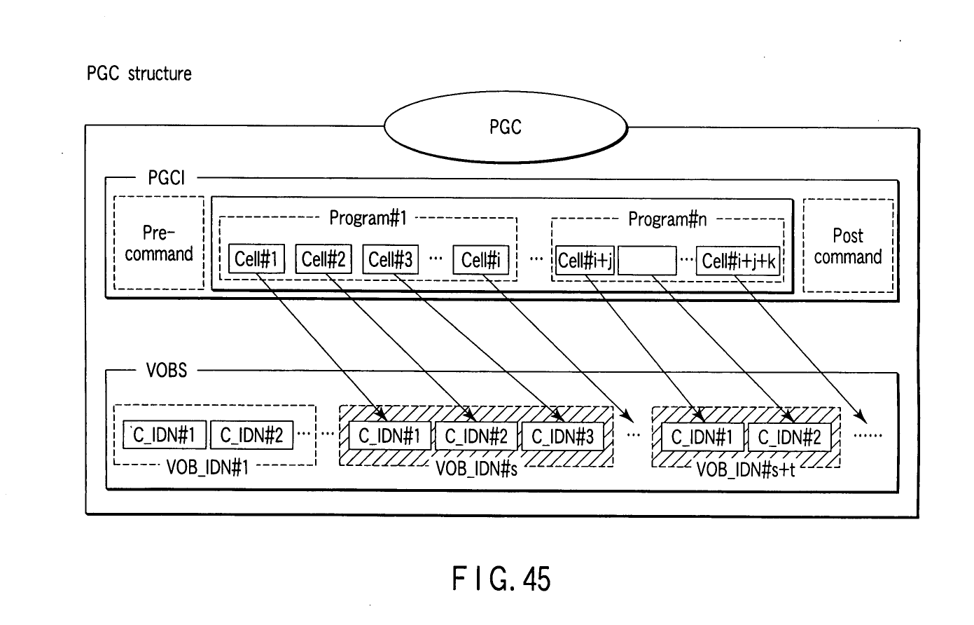

FIG. 45 shows a PGC structure. PGC comprises playback information referred to as program chain information PGCI and a cell in VOB required for reproducing PGC. PGCI includes a navigation command and a cell playback sequence.

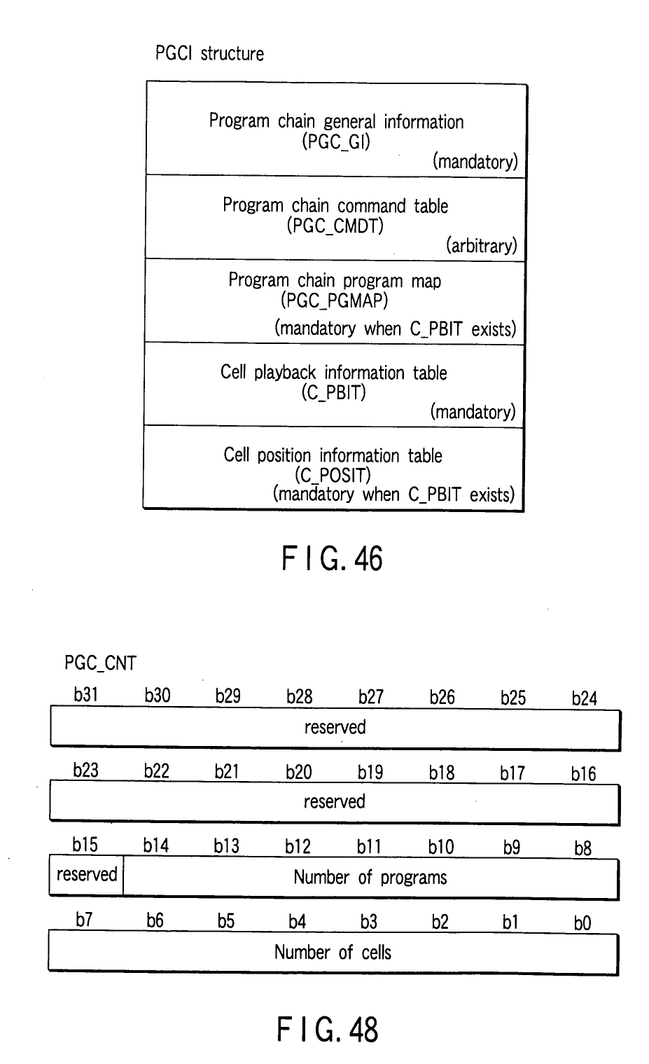

FIG. 46 shows a structure of the program chain information PGCI. PGCI comprises program chain general information PGC_GI, a program chain command table PGC_CMDT, a program chain program map PGC_PGMAP, a cell playback information table C_PBIT, and a cell position information table C_POSIT.

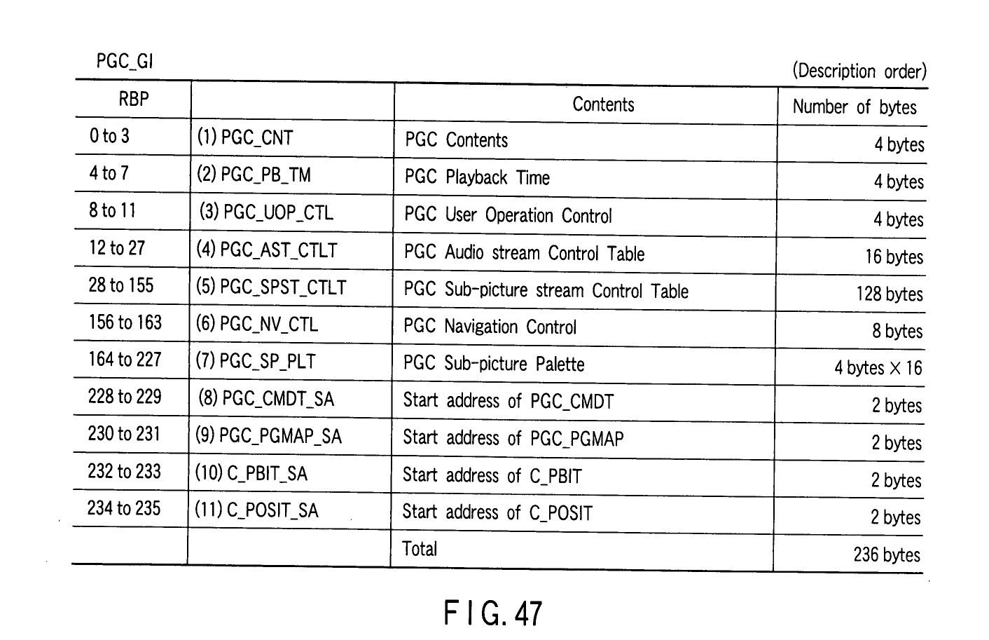

The program chain general information PGC_GI, as shown in FIG. 47, describes contents PGC_CNT of the program chain PGC, a playback time PGC_PB_TM of the program chain PGC and the like. The PGC contents PGC_CNT, as shown in FIG. 48, describes the contents of the program chain contents, i.e., the number of programs and the number of cells. Bit number b31 to bit number b15 are blanked to be reserved, bit number b14 to bit number b8 describe the number of programs from 1 to 99 in the program chain PGC, and bit number b7 to bit number b0 describe the number of cells from 1 to 255 in the program chain PGC.

The PGC playback time PGC_PB_TM describes a total playback time or the like of a program in the PGC. The playback time is described as a program playback time when a program in the PGC is continuously reproduced irrespective of the playback procedures. When an angle mode is set, the playback time of angle cell number 1 represents the playback time of the angle.

The program chain general information PGC_GI also describes a PGC audio stream control table PGC_AST_CTLT, a PGC sub-picture stream control table PGC_SPST_CTLT, and a PGC sub-picture pallet PGC_SP_PLT. The PGC sub-picture stream control table PGC_SPST_CTLT described the number of sub-pictures which can be used in the PGC, and the PGC audio stream control table PGC_AST_CTLT describes the number of audio streams which can be used in the PGC, similarly. The PGC sub-picture pallet PGC_SP_PLT describes a set of a predetermined number of color pallets used in all the sub-picture streams of the PGC.

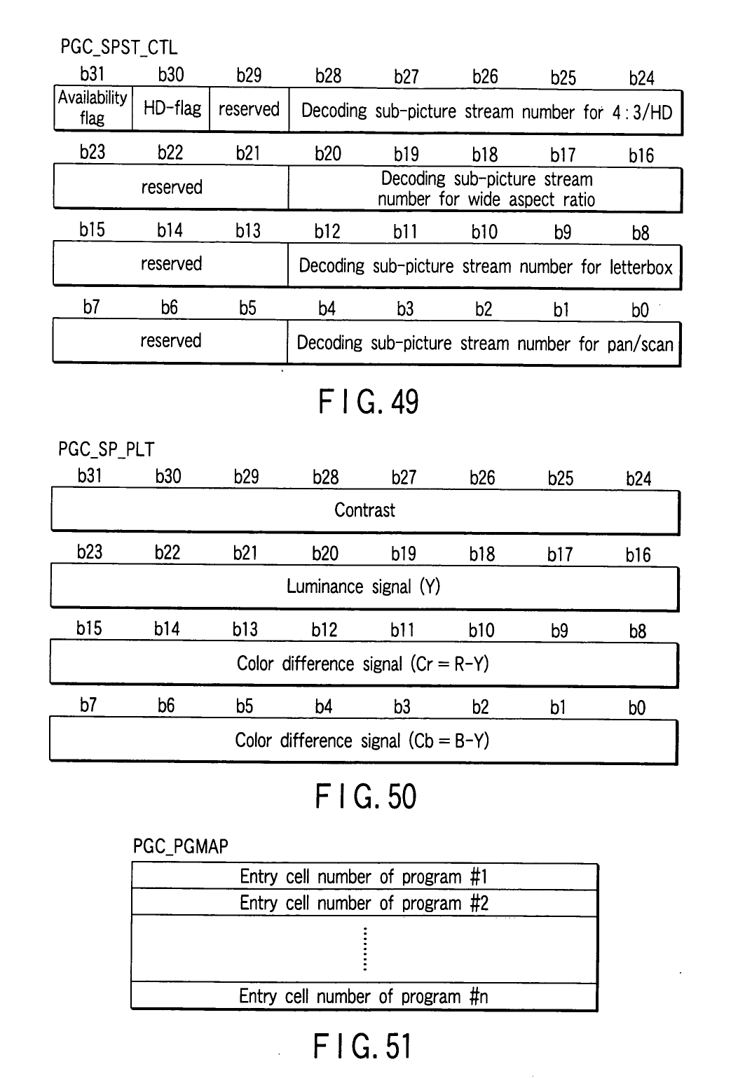

FIG. 49 shows a structure of the sub-picture stream control information PGC_SPST_CTL. With respect to an Availability flag, if a stream is valid in this PGC, “1b” is described, and if the stream is invalid, “0b” is described. With respect to each sub-picture stream, this value must be equal to each other in all TT_PGCs in the same TT_DOM. In FP_DOM, this value is invalid, and any value can be input.

With respect to an HD flag, if a sub-picture stream number for 4:3 (SD) is decoded, “0b” is described, and if a sub-picture stream number for HD is decoded, “1b” is described. When the HD flag is set to “0b,” a decoding field of the sub-picture stream number for 4:3 or HD is used for decoding the sub-picture stream number for 4:3 (SD). When the HD flag is set to “1b,” a decoding field of the sub-picture stream number for 4:3 or HD is used for decoding the sub-picture stream number for HD.

FIG. 50 shows a structure of the PGC subsidiary pallet PGC_SP_PLT. A contrast indicates a transparency level between non-transparency and transparency. If this value is set to “00h,” the pixel allocated to this pallet is completely non-transparent; if this value is set to “7F,” the pixel allocated to this pallet is transparent by 50%; and if this value is set to “FFh,” the pixel allocated to this pallet is completely transparent. With respect to R, G, and B between “0” and “1b,” Y, Cr, and Cb are calculated by the formula below.

When the resolution of Sub-picture is SD,

Y=16+219×(0.299R+0.587G+0.114B) (16≦Y≦235)

Cr=128+224×(0.500R−0.419G−0.081B) (16≦Cr≦240)

Cb=128+224×(−0.169R−0.331G+0.500B) (16≦Cb≦240)

When the resolution of Sub-picture is HD,

Y=16+219×(0.2126R+0.7152G+0.0722B) (16≦Y≦235)

Cr=128+224×(0.5000R−0.4542G−0.0458B) (16≦Cr≦240)

Cb=128+224×(−0.1146R−0.3854G+0.5000B) (16≦Cb≦240)

The PGC general information PGC_GI 105 also describes a start address C_PBIT_SA of the cell playback information table C_PBIT 107 and a start address C_POSIT_SA of the cell position information table C_POSIT 108. Both of the start addresses C_PBIT_SA and C_POSIT_SA are described in the relative number of logical blocks from the start byte of the VTS_PGC information VTS_PGCI.

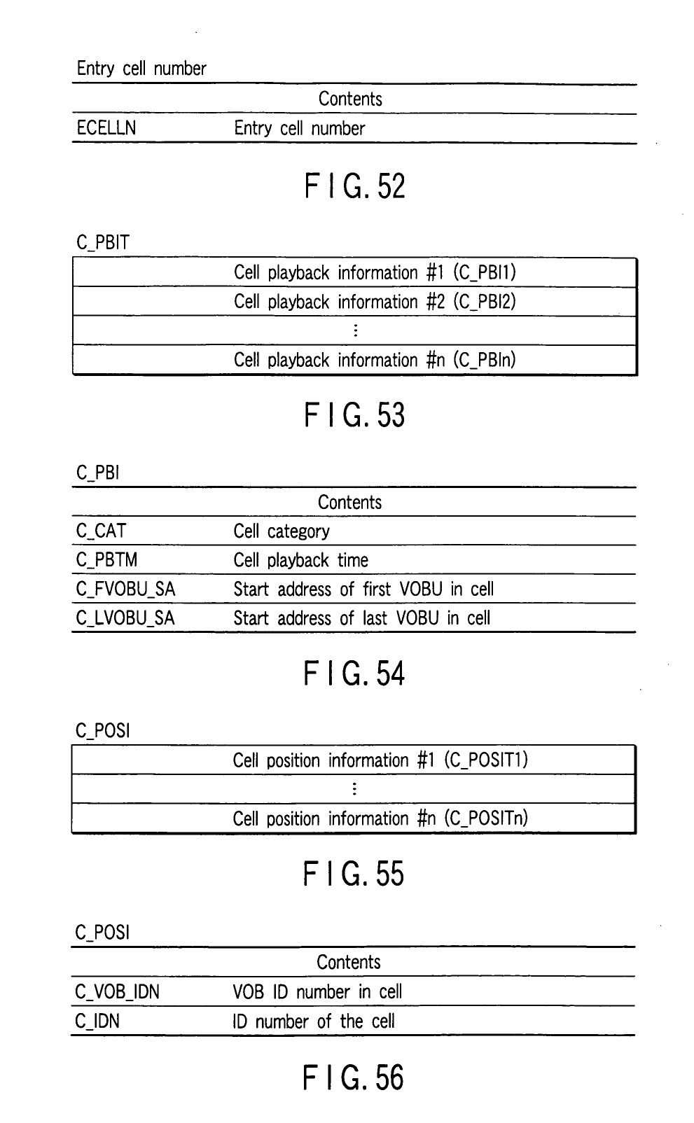

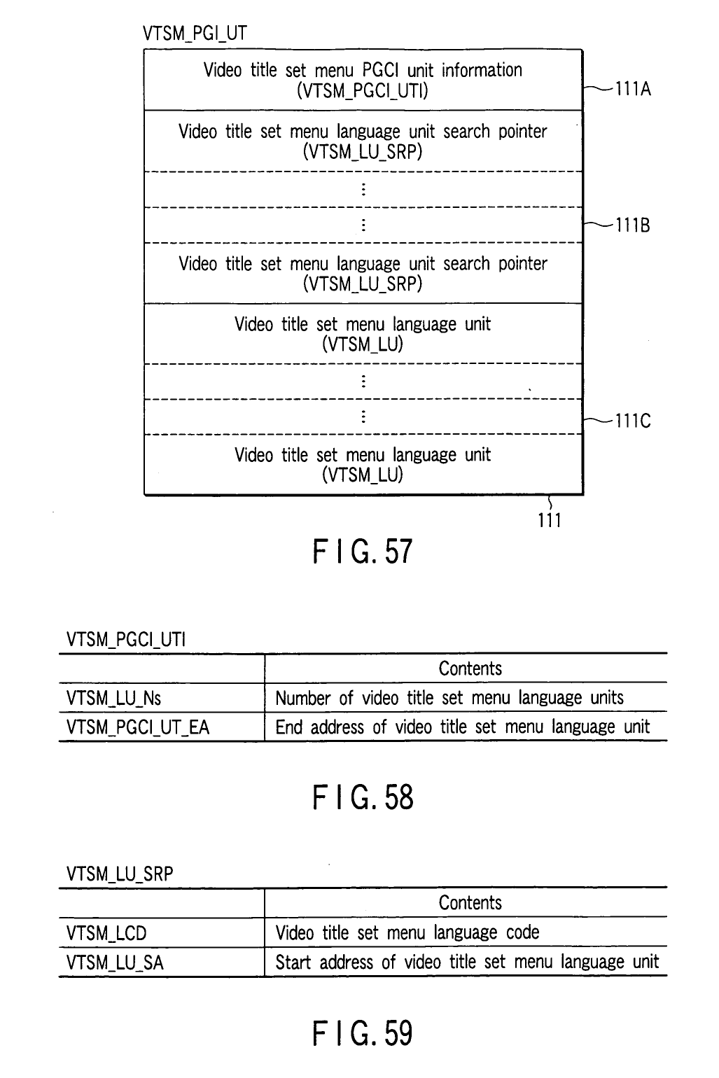

The program chain program map PGC_PGMAP 106 is a map indicating a configuration of programs in the PGC, as shown in FIG. 51. In the map PGC_PMAP 106, as shown in FIGS. 51 and 52, entry cell numbers ECELIN which are start cell numbers of programs are described in ascending order. Program numbers are allocated from 1 in description orders of entry cell numbers. Therefore, the first entry cell number of the map PGC_PGMAP 106 must be “1.” The cell playback information table C_PBIT 107 defines PGC cell playback sequences. The cell playback information table C_PBIT 107, as shown in FIG. 53, continuously describes items of cell playback information C_PBIT. Basically, cells are reproduced in order of cell numbers. The cell playback information C_PBIT described a cell category C_CAT as shown in FIG. 54. The cell category C_CAT describes a cell block mode indicating whether a cell is included in a cell block or, if so, it is the first cell, a cell block type indicating whether a cell is not a part of the block or an angle block, and an STC discontinuity flag indicating whether it is required or not to reset a system time clock STC. The cell block used here is defined as a set of cells at a specific angle. An angle change is achieved by changing a cell block. That is, if a baseball is taken as an example, a change of an angle block when a scene from infield has been photographed from an angle block in which a scene from outfield has been photographed corresponds to the angle change.

The cell category C_CAT describes a cell playback mode indicating whether playback is continuously carried out in a cell or playback is made static in units of video object units VOBU in a cell, and cell navigation control indicating whether or not playback is made static after cell playback or the still time.

As shown in FIG. 54, the cell playback information table C_PBIT 107 includes a cell playback time C_PBTM describing all the PGC playback times. When an angle cell block is included in the PGC, the playback time of the angle cell number 1 represents the playback time of the angle block. The cell playback information table C_PBIT 107 describes a start address C_FVOBU_SA of the start video object unit VOBU 85 in a cell in the relative number of logical sectors from the start logical sector of the video object unit VOBU 85 in which the cell has been recorded. That is, there is described a start address C_LVOBU_SA of the start video object unit VOBU 85 in a cell in the relative number of logical sectors from the start logical sector of the video object unit VOBU 85 in which the cell has been recorded.

The cell position information table C_POSI 108 specifies an identification number VOB_ID of the video object VOB of a cell used in the PGC and a cell identification number C_ID. In the cell position information table C_POSI, as shown in 55, the cell position information C_POSI corresponding to the cell number described in the cell playback information table C_PBIT 107 is described in the same order as that in the cell playback information table C_PBIT. The cell position information C_POSI, as shown in FIG. 56, describes an identification number C_VOB_IDN of the cell video object unit VOBU 85, and a cell identification number C_IDN.

The video title set menu PGCI unit table VTSM_PGCI_UT 111 describing information on each language of the video title set menu VTSM shown in FIG. 30 comprises video title set menu PGCI unit table information VTSM_PGCI_UTI 111A, “n” video title set menu language unit search pointers VTSM_LU_SRP 111B, and “n” video title set menu language units VTSM_LU 111C. These components are described in the above order.

The video title set menu PGCI unit table information VTSM_PGCI_UTI 111A describes information contained in the table 111. The video title set menu PGCI unit search pointer VTSM_LU_SRP 111B describes language codes in order corresponding to #1 to #n video title set menus. In addition, this pointer gives a description concerning a pointer for making a search for the video title set menu language unit VTSM_LU 111C described in order corresponding to #1 to #n video title set menus. In each of the video title set menu language units VTSM_LU 111C, there are described a category and a start address of a program chain of the corresponding video title set menu.

In more detail, in the video title set menu PGCI unit table information VTSM_PGCI_UTI 11A, as shown in FIG. 58, the number of the video title set menu language units VTSM_LU 111C is described as a parameter VTSM_LU_Ns, and an end address of the video title set menu language unit VTSM_LU 111C is described as a parameter VTSM_PGCI_UT_EA.

As shown in FIG. 59, in the video title set menu PGCI unit search pointer VTSM_LU_SRP 111B, a video title set menu language code is described as a parameter VTSM_LCD, and a start address of the video title set menu language unit VTSM_LU 111C is described as a parameter VTSM_LU_SA.

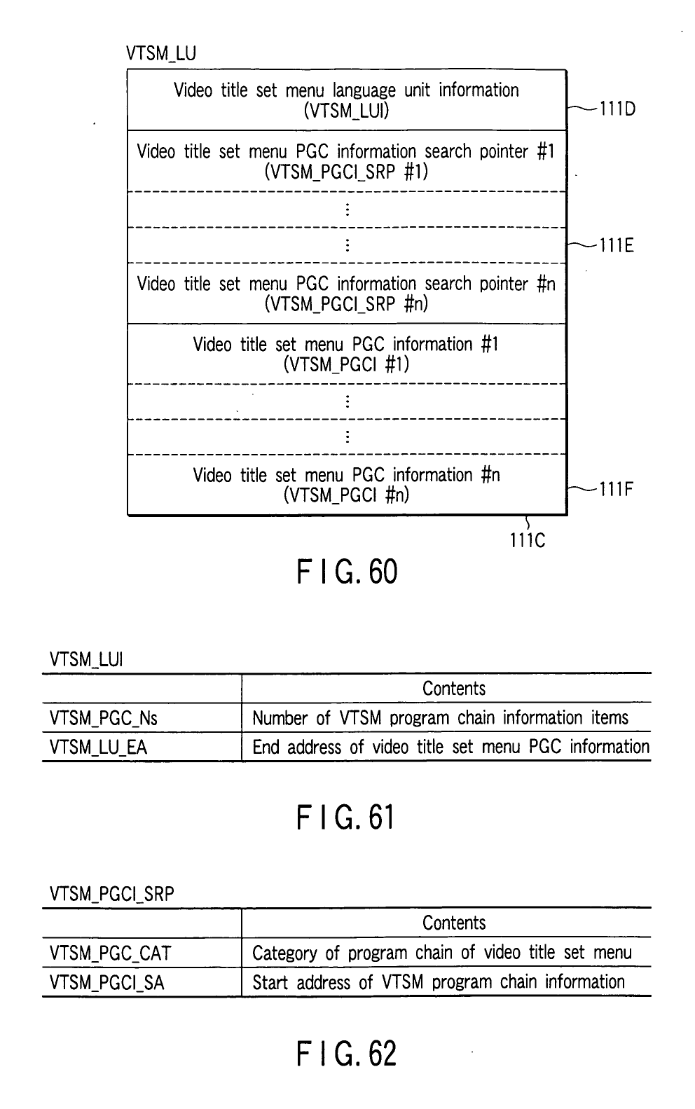

The video title set menu language unit VTSM_LU 11C, as shown in FIG. 60, comprises video title set menu language unit information VTSM_LUI 111D, a video title set menu PGC information search pointer VTSM_PGCI_SRP 111E, and video title set menu PGC information VTSM_PGCI 11F. These components are described in the above order. The video title set menu language unit information VTSM_LUI 111D describes information contained in the table 111C. The pointer VTSM_PGCI_SRP 111E describes a category of program chains in the video title set menu in order corresponding to #1 to #n video title set menus. In addition, this pointer gives a description concerning pointers for making a search for the video title set menu PGC information VTSM_PGCI 111F described in order corresponding to #1 to #n video title set menus.

The video title set menu PGC information VTSM_PGCI 111F describes information concerning program chains in the video title set menu, i.e., VTSM program chain information VTSM_PGCI.

In more detail, in the video title set menu language unit information VTSM_LUI 111D, as shown in FIG. 61, the number of items of the VTSM program chain information VTSM_PGCI 111F is described as a parameter VTSM_PGCI_Ns, and an end address of the video title set menu language unit information VTSM_LUI is described as a parameter VTSM_LUI_EA.

As shown in FIG. 62, in the video title set menu PGC information search pointer VTSM_PGCI_SRP 111E, a category of program chains in the video title set menu is described as a parameter VTSM_PGC_CAT, and a start address of the VTSM program chain information VTSM_PGCI 111F is described as a parameter VTSM_PGCI_SA.

The video title set menu program chain category VTSM_PGC_CAT describes a flag indicating whether PGC is entered or not and a menu ID indicating a menu. As the menu ID, when “0100b” is described, it denotes a sub-picture menu; when “0101b” is described, it denotes an angle menu; and when “0111b” is described, it denotes a program menu.

As has been described with reference to FIG. 9, the cell 84 is formed of a set of video object units VOBU 85, and the video object units VOBU 85 are defined as a pack train starting from the navigation (NV) pack 86. Therefore, the start address C_FVOBU_SA of the first video object unit VOBU 85 in cell 84 represents a start address of the NV pack 86.

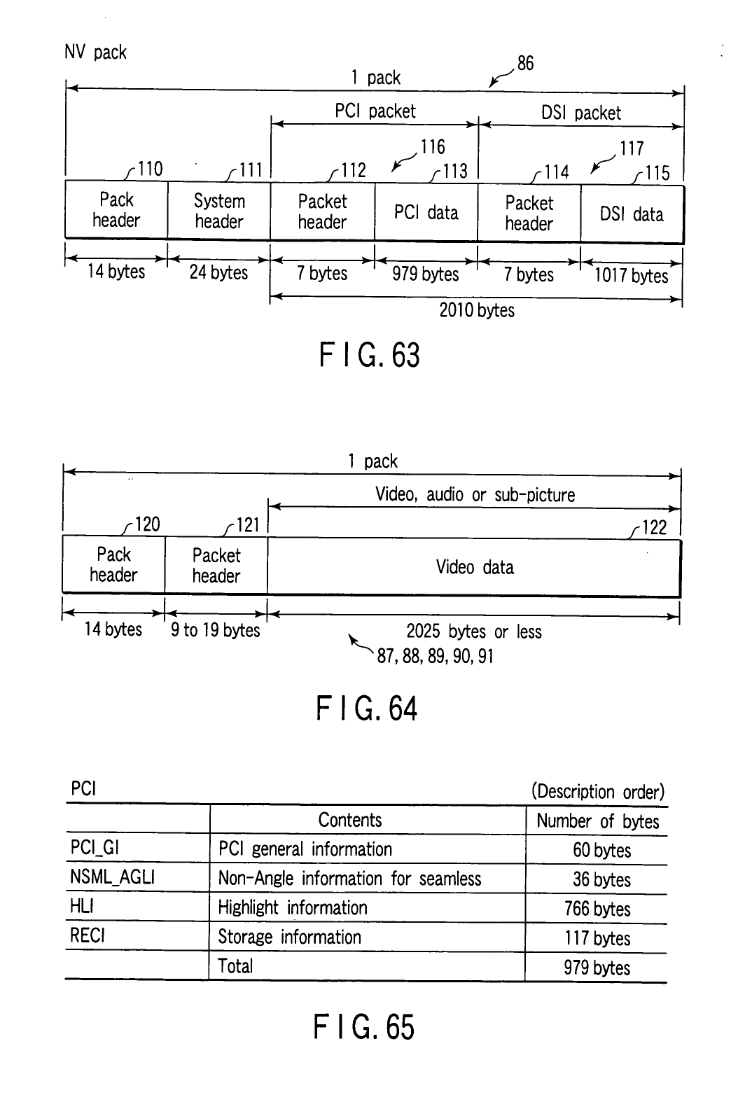

The NV pack 86 includes a pack header 110, a system header 111, and two packets being navigation data, i.e., a playback control information PCI packet 116 and a data search information (DSI) packet 117. The number of bytes as shown in FIG. 63 is allocated to each portion, and one pack is defined in 2,049 bytes corresponding to one logical sector. The NV pack is allocated immediately before a video pack including the first data contained in the group-of-picture GOP. Even when the object unit 85 does not include a video pack, the NV pack is allocated at the beginning of the object unit including an audio pack and/or a sub-picture pack. Thus, even when the object unit does not-include a video pack, as in the case where the object unit includes such a video pack, the playback time of the object unit is defined with a video playback unit being a reference.

The GOP used here is specified by the MPEG specifications, and is defined as a data train configuring a plurality of screens, as has already been described. That is, the GOP corresponds to compressed data. If this compressed data is decompressed, image data on a plurality of frames capable of reproducing a motion picture is reproduced. The pack header 110 and system header 111 are defined by an MPEG-2 system layer. The pack header 110 stores a pack start code, a system clock reference (SCR), and multiplexing rate information. The system header 111 describes a bit rate and a stream ID. The packet headers 112 and 114 of the PCI packet 116 and DSI packet 117 each store a packet start code, a packet length, and a stream ID, as defined in the MPEG-2 system layer, similarly.

The other video, audio, and sub-picture packs 88, 90, and 91, as shown in FIG. 64, comprises a pack header 120, a packet header 121, and a packet 122 storing the corresponding data, similarly, as defined in the MPEG-2 system layer, and the pack length is defined in 2,048 bytes. These packs each are made coincident with the boundary of logical blocks.

PCI data 113 of the playback control information PCI packet 116 is provided as navigation data for changing presentation, i.e., the contents of display, in synchronism with the playback state of video data contained in the VOB unit VOBU 85. That is, the PCI data 113, as shown in FIG. 65, describes PCI general information PCI_GI which is information on the entire PCI, non-angle information for seamless NSML_AGLI which is jump destination angle information at the time of angle change, highlight information HLI, and recording information RECI.

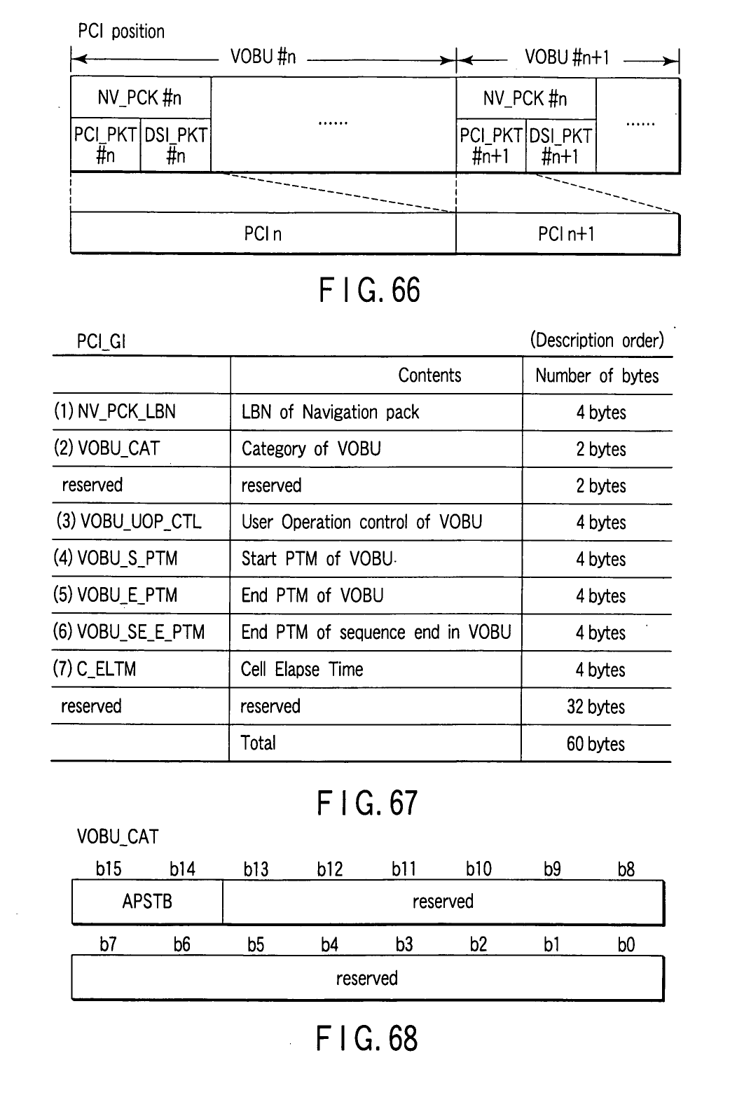

PCI is allocated at the beginning of the NV pack in VOBU as shown in FIG. 66.

The playback control information PCI general information PCI_GI, as shown in FIG. 67, describes an address NV_PCK_LBN of the NV pack NV_PCK 86 in which PCI 113 is recorded in the relative number of logical blocks from the logical sector of the VOBU 85 in which the PCI 113 is recorded. The PCI general information PCI_GI describes a category VOBU_CAT of the VOBU 85, a start time VOBU_S_PTM of the VOBU 85, and an end time VOBU_E_PTM of the VOBU 85. The VOBU 85 start time VOBU_S_PTM indicates a playback start time (start presentation time stamp SPTM) of video data contained in the VOBU 85 in which the PCI 113 is included. The playback start time is a first playback start time contained in the VOBU 85. In general, a first picture corresponds to a playback start time of I-picture (Intra-picture) in the MPEG specifications. The VOBU 85 end time VOBU_E_PTM indicates a playback end time (end presentation time stamp EPTM) of the VOBU 85 in which the PCI 113 is included.

FIG. 68 shows a structure of the VOBU 85 category VOBU_CAT. In APSTB, when CGMS in descriptor of a file including this VOBU is “00b,” “01b,” or “10b,” “00b” is described. When CGMS in descriptor of a file including this VOBU is “11b,” it is defined as follows.

“00b”: Analog protection system (APS) is OFF.

“01b”: APS type 1 is ON.

“10b”: APS type 2 is ON.

“11b”: APS type 3 is ON.

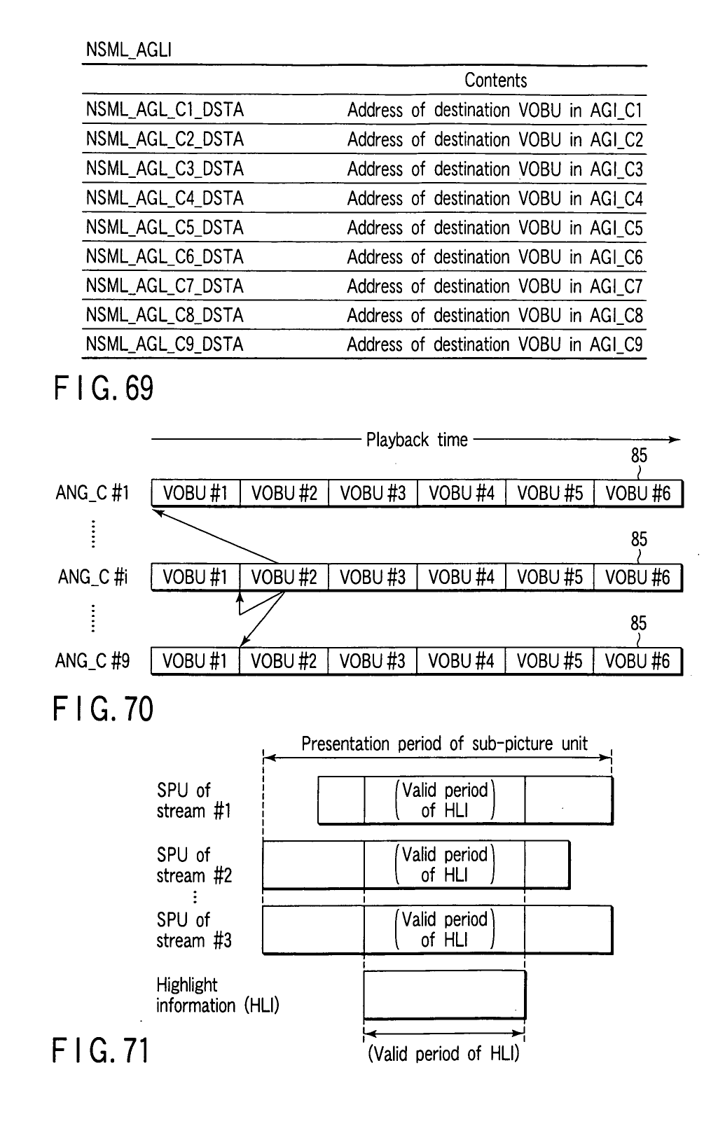

The angle information NSML_AGLI, as shown in FIG. 69, describes an angle cell start address NSML_AGL_C_DSTA of a jump destination in number of angles, wherein the start address is described in a relative logical sector from the logical sector of the NV pack 86 in which PCI 113 has been-recorded.

In the case of an angle change based on the angle information NSML_AGLI, as shown in FIG. 70, the angle information NSML_AGLI describes a start address of VOBU 85 in another angle block equal to the playback time of the VOBU 85 in which the PCI 113 has been recorded, or a start address NSML_AGL_C_DSTA of VOBU 85 in another angle block having the closest playback time which is before a predetermined playback time.

According to a description of such an angle cell start address NSML_AGL_C_DSTA, specifically, the following angle change is achieved. An angle change will be described assuming a scene in which a series of times have continued until a pitcher pitches a ball, a batter hits the pitched ball, and the hit ball results in home run. An angle cell ANG_C#j controlled by PCI 113 can be changed in units of the video object units VOBU 85 as shown in FIG. 70. In FIG. 70, numbers are assigned to the video object units VOBU 85 in accordance with the playback order. The video object unit VOBU#n 85 corresponding to playback number “n” of the angle cell ANG_C#j stores another angle cell ANG_C#1, or video data concerning a scene at a time which is identical to or earlier than and close to that of the video object unit VOBU#n 85 of playback number “n” corresponding to the angle cell ANG_C#9. Assume that, in the angle cell ANG_C#j, the whole scene including the pitcher and batter is displayed on a screen, VOBUs 85 are continuously arranged as video data when a series of motions are displayed; in the angle cell ANG_C#1, in order to watch the batter's batting form, VOBUs 85 are continuously arranged as video data when only the batter is displayed on a screen; in the angle cell ANG_C#1, VOBUs 85 are continuously arranged as video data when only the pitcher's face is displayed on a screen. If the current angle is first changed to angle cell #1 at a moment at which the batter hits a ball when a user watches angle cell #j (AGL_C#j), i.e., if the current angle is changed to an angle at which only the batter is displayed at a moment at which the batter hits the ball, the current screen is changed to a screen on which the batter before starting hitting starts swinging a bat without being changed to the screen on which the batter is displayed after hitting the ball. If the current cell is changed to angle cell #9 at a moment at which the batter hits the ball when the user watches angle cell #j (AGL_C#i), i.e., if the current angle is changed to an angle at which only the pitcher is displayed at a moment at which the batter hits the ball, the face of the pitcher immediately after the hitting is displayed on a screen, and the user can watch the pitcher's mental change.

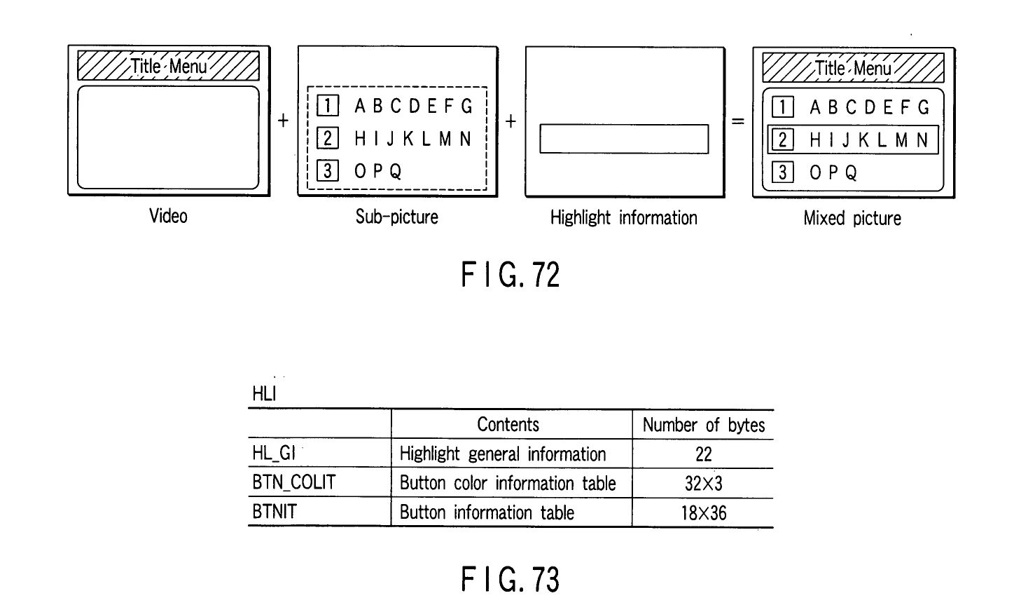

Highlight information HLI is provided as information for applying highlight to one rectangular region in a display region of sub-picture data in order to display a menu. This highlight information describes a mixture ratio (contrast) between color and video of sub-picture data contained in a specific rectangular region (button) in the display region of the sub-picture data. The highlight information, as shown in FIG. 71, is commonly valid with respect to all the sub-picture streams reproduced in the validity period. For example, when video, sub-picture, and highlight information are combined with each other, a composite screen as shown in FIG. 72 is displayed at the monitor 6. The highlight in the menu indicates a selected item. That is, a highlight region changes according to an operator's action.

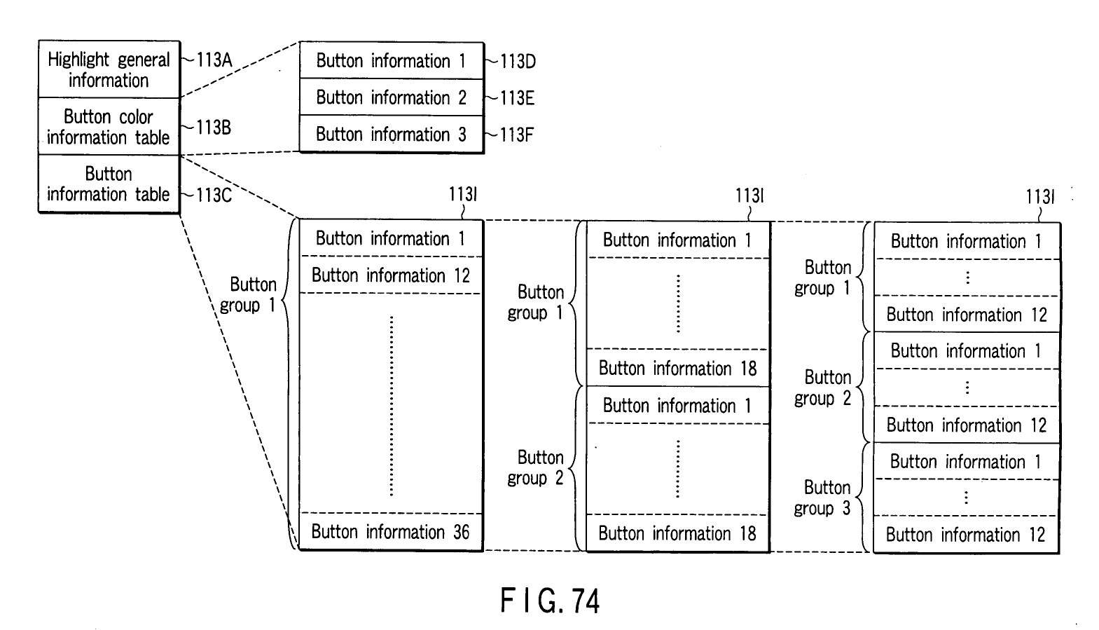

The highlight information HIL, as shown in FIGS. 73 and 74, describes highlight general information HL_GI 113A, a button color information table BTN_COLIT 113B, and a button information table BTNIT 113C. The highlight general information HL_GI 113A is allocated in 22 bytes, the button color information table BTN_COLIT 113B is allocated in 32 bytes×3, and the button information table BTNIT 113C is allocated in 18 bytes×36, and a total of 766 bytes are allocated. The button color information table BTN_COLIT 113B describes button color information BTN_COLI 113D, 113E, and 113F, and the button information table BTNIT 113C describes a maximum of 36 items of button information BTNI 113I, For example, as shown in FIG. 74, by specifying a button group, 36 items of button information BTNI 113I, . . . are described in a i-group mode comprising 36 items of button information; in a 2-group mode in which each group comprises 18 items of button information; and in a 3-group mode in which each group comprises 12 items of button information.

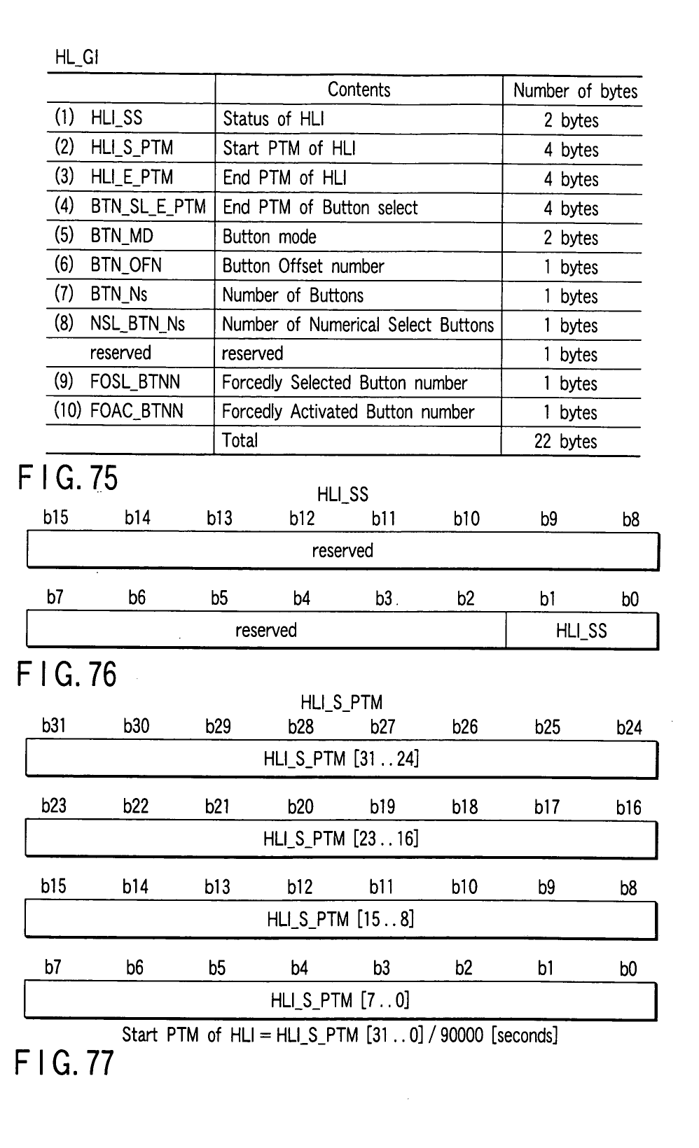

The highlight general information HL_GI 113A is provided as information on the whole highlight information. The highlight general information HL_GI 113A, as shown in FIG. 75, describes a 2-byte highlight information state HLI_SS, a 4-byte highlight start time HLI_S_PTM, a 4-byte highlight end time HLI_E_PTM, a 4-byte button select end time BTN_SL_E_PTM, a 2-byte button mode BTN_MD, a 1-byte button start number BTN_SN, the number of 1-byte valid buttons BTN_Ns, the number of buttons which can be selected by 1-byte number NSBTN_Ns, a 1-byte forced selection button number FSLBTN_N, and a 1-byte forced action button number FACBTN_N.

In the highlight information state HLI_SS, as shown in FIG. 76, bit numbers b1 and b0 describe the highlight information state HLI_SS in the corresponding playback control information PCI. For example, if no valid highlight information HIL exists, “00b” is described; if highlight information different from the preceding VOBU highlight information exists, “01b” is described; if highlight information identical to the preceding VOBU highlight information exists, “10b” is described; and if the remaining portion of highlight information HLI is invalid, “11b” is described. In the start VOBU of the cell, the highlight state HLI_SS must be “00b” or “01b.”

A start PTM of highlight information HLI_S_PTM, as shown in FIG. 77, describes a highlight start time (start presentation time SPTM) when this highlight information is validated. The highlight start time must be equal to a display start time of the sub-picture unit SPU for highlight information. When the highlight state HLI_SS is described as “01b,” there is described a highlight start time of highlight information updated during the playback period of VOBU in which this playback control information PCI is included. When the highlight state HLI_SS is “10b” or “11b,” there is described the highlight start time of highlight information which is continuously used during the playback period of VOBU in which this PCI is included.

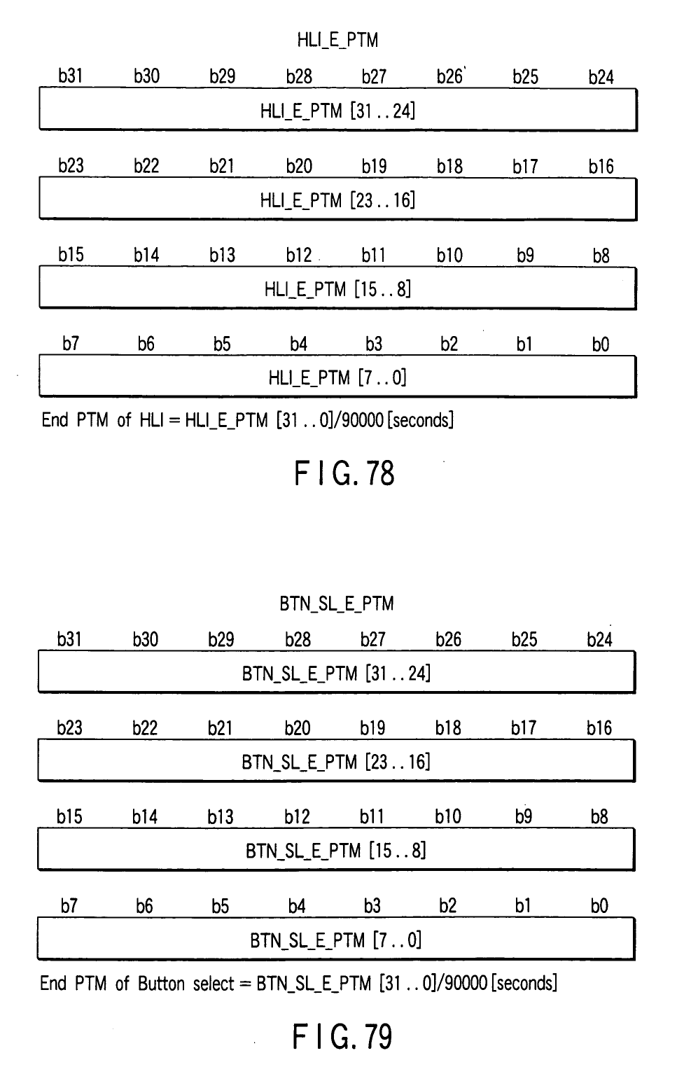

An end PTM of highlight information HLI_E_PTM, as shown in FIG. 78, describes a highlight end time when this highlight information is validated. The highlight end time must be equal to a display end time of the sub-picture stream SPU for highlight information HIL. When the highlight information HLI_SS is described as “01b,” there is described a highlight end time of highlight information updated during the playback period of VOBU in which this playback control information PCI is included. When the highlight information HLI_SS is described as “10b” or “11b,” there is described a highlight end time of highlight information which is continuously used during the playback period of VOBU in which this PCI is included. While the highlight information HLI is in a still state, “FFFFFFFFh” is described as the highlight end time HLI_E_PTM.

The button select end time BTN_SL_E_PTM, as shown in FIG. 79, describes an end time of a validity period of button selection (hereinafter, referred to as a button select end time). The button select end time is identical to or earlier than the display end time of the sub-picture stream for highlight information. When the highlight information state HLI_SS is described as “01b,” there is described a button select end time of highlight information updated during the playback period of VOBU in which the playback control information PCI is included. When the highlight information state HLI_SS is described as “10b” or “11b,” there is described a button select end time of highlight information which is continuously used during the playback period of VOBU in which that PCI is included. While HLI is in a still state, “FFFFFFFFh” is described as the button select end time BTN_SL_E_PTM.

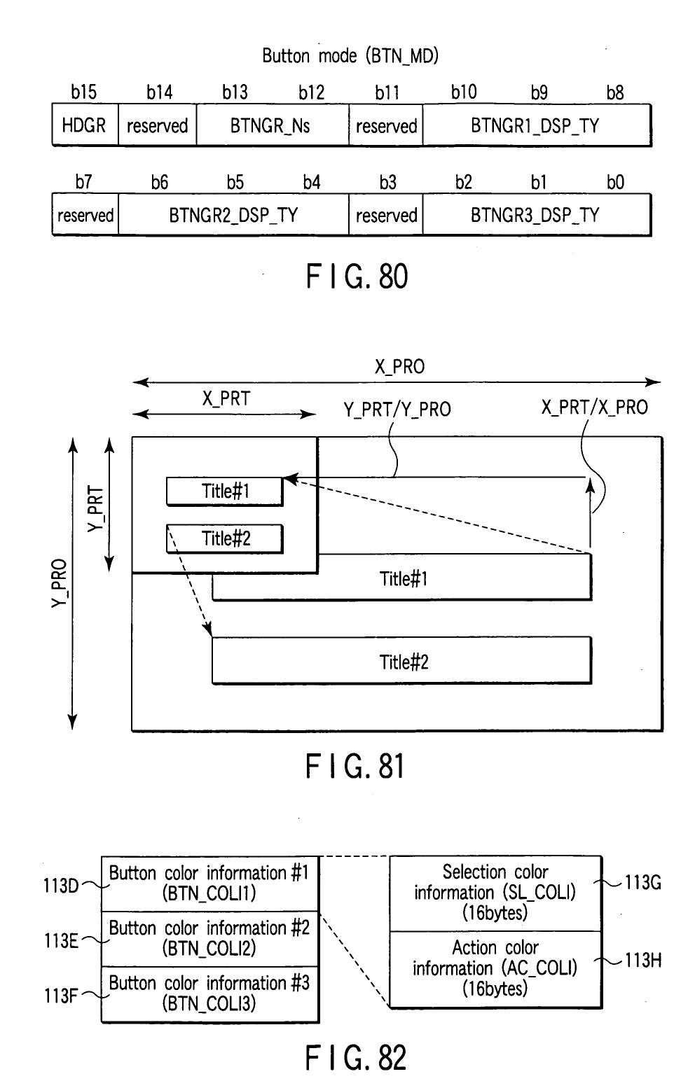

In a button mode BTN_MD, as shown in FIG. 80, there are grouped buttons and display type of sub-picture data corresponding to each group. For example, bit number b15 describes a flag HDGR indicating whether or not an HD button group is recorded, bit number b14 is provided to be reserved, bit numbers b13 and b12 describe the number of button groups BTNGR_Ns, bit number b11 is provided to be reserved, bit numbers b10 to b8 describe sub-picture data display type BTNGR1_DSPTY corresponding to button group 1, bit number b7 is provided to be reserved, bit numbers b6 to b4 describe sub-picture data display type BTNGR2_DSPTY corresponding to button group 2, bit number b3 is provided to be reserved, and bit numbers b2 to b0 describe sub-picture data display type BTNGR3_DSPTY corresponding to button group 3. The contents of the subsequent button group display types are switched by the flag HDGR.

The flag HDGR is set to “0b” in the case where no HD button group is recorded or is set to “1b” in the case where the HD button group is recorded. If the aspect ratio of video attribute is “00b” (4:3), “0b” is described.

The number of button groups BTNGR_Ns describes the number of button groups. If the aspect ratio of video attribute is “00b” (4:3), “01b” is described. “00b” is provided to be reserved, “01b” indicates 1 group, “10b” indicates 2 groups, and “11b” indicates 3 groups.

The BTNGR1_DSPTY describes a display type of a decoding sub-picture stream for button group 1. If the aspect ratio of video attribute is “00b” (4:3), “000b” is described. If the flag HDGR is set to “0b,” the following values are validated. “000b” is available only in normal aspect (4:3), “00b” is available only in wide aspect ratio (16:9), “010b” is available only in letterbox, “011b” is available in both letterbox and wide aspect ratio, “100b” is available in pan/scan, “101b” is available in both pan/scan and wide aspect ratio, “110b” is available in both pan/scan and letterbox, and “111b” indicates all of pan/scan, letterbox, and wide aspect ratio. If the flag HDGR is set to “1b,” the following values are validated. “000b” indicates that only HD is available. That is, when HDGR=1 (if HD button group exists), there is no coexistence with a conventional SD normal aspect. Thus, by allocating HD group herein, a data structure can be easily used.

The BTNGR2_DSPTY describes a display type of a decoding sub-picture stream for button group 2. If the aspect ratio of video attribute is “00b” (4:3), “000b” is described. If the number of button groups BTNGR_Ns is “01b,” “00b” is described. “001b” is available only in wide aspect ratio (16:9), “010b” is available only in letterbox, “011b” is available in both letterbox and wide aspect ratio, “100b” is available only in pan/scan, “101b” is available in both pan/scan and wide aspect ratio, “110b” is available in both pan/scan and letterbox, and “111b” is provided to be reserved.

The BTNGR3_DSPTY describes a display type of a decoding sub-picture stream for button group 3. If the aspect ratio of video attribute is “00b” (4:3), “000b” is described. If the number of button groups BTNGR_Ns is “01b,” “000b” is described. “001b” is available only in wide aspect ratio (16:9), “010b” is available only in letterbox, “011b” is provided to be reserved, “100b” is available only in pan/scan, and “101b,” “110b,” and “111b” are provided to be reserved.

When the button group is 2 or 3, the same display type of decoding sub-picture stream must not be described for each button group. For example, when 3 button groups exist, “001b” (only wide aspect ratio), “010b” (only letterbox), or “100b” (only pan/scan) must be described for each of the button group display types (BTNGR1_DSPTY, BTNGR2_DSPTY, and BTNGR3_DSPTY). When the video attribute display type allows pan/scan (“00b” or “01b”), a pan/scan button group must exist. When the video attribute display type allows a letterbox (“00b” or “10b”), a letterbox button group must exist.

When a button group for wide aspect ratio does not exist when the flag HDGR is set to “1b,” the button position of the wide aspect ratio is calculated from the HD button position by using the following formula (refer to FIG. 81):

X_{—}WIDE=(X_{—}PRT/X_{—}PRO)×X_HD

W_{—}WIDE=(Y_{—}PRT/Y_{—}PRI)×Y_{—}HD

where X_WIDE denotes an x position of the button for the wide aspect ratio calculated from the X_HD position;

X_PRT denotes a target resolution in the x direction;

X_PRO denotes an original resolution in the x direction;

X_HD denotes an x position of the button for the HD to be displayed;

Y_WIDE denotes a y position of the button for the wide aspect ratio calculated from the Y_HD position;

Y_PRT denotes a target resolution in the y direction;

Y_PRO denotes an original resolution in the y direction; and

Y_HD denotes a y position of the button for the HD to be displayed.

The fractional portion of the number is truncated.

In this manner, the highlight information for displaying an HD compatible menu can be efficiently recorded together with information for displaying an SD compatible menu. Moreover, the playback apparatus reads the flag HDGR, thereby making it possible to know whether or not the HD button group is recorded. The HD decoder is powered ON as required, and operation can be made standby.

The button start number BTN_SN describes an offset number of a first button in a button group. The offset number can be described within the range of 1 to 255. The button start number BTN_SN is commonly applied to each button group.

The number of valid buttons BTN_Ns describes the number of valid buttons in a button group. The number of buttons can be described in the range of 1 to 36 when the button group is 1, can be described in the range of 1 to 18 when the button group is 2, and can be described in the range of 1 to 12 when the button group is 3. The number of valid buttons BTN_Ns is commonly applied to each button group.

The number of buttons which can be selected by number NSBTN_Ns describes the number of buttons which can be selected by the button number in a button group. The number of buttons can be described in the range of 1 to 36 when the button group is 1, can be described in the range of 1 to 18 when the button group is 2, and can be described in the range of 1 to 12 when the button group is 3. The number of buttons which can be selected by the number NSBTN_Ns is commonly applied to each button group.

The forced selection button number FSLBTN_N describes a button number which is forcibly set to be in a selected state by the highlight start time HLI_S_PTM. In this manner, even if presentation starts within the highlight validity period, the button number set in the highlight information is selected. The button number can be described in the range of 1 to 36 and to be 63 when the button group is 1, can be described in the range of 1 to 18 and to be 63 when the button group is 2, and can be described in the range of 1 to 12 and to be 63 when the button group is 3. The forced selection button number FSLBTN_N is commonly applied to each button group.

The forced action button number FACBTN_N describes a button number which is forcibly set to a determined state by the button select end time BTN_SL_E_PTM. The button number can be described in the range of 1 to 36 and to be 63 when the button group is 1; can be described in the range of 1 to 18 and to be 63 when the button group is 2; and can be described in the range of 1 to 12 and to be 63 when the button group is 3. The forced action button number FACBTN_N is commonly applied to each button group.

The button color information table BTN_COLIT 113B, as shown in FIG. 82, describes three items of button color information BTN_COLI 113D, 113E, and 113F. The button color numbers BTN_COLN are allocated from 1 in description orders of the button color information BTN_COLI 113D, 113E, and 113F. The button color information BTN_COLI 113D, 113E, and 113F each, as shown in FIG. 82, describe 16-byte selection color information SL_COLI 113G and action color information AC_COLI 113H. The selection color information SL_COLI 113G describes a color and a contrast changed when a button is set to be in a selected state. The action color information AC_COLI 113H describes a color and a contrast changed when a button is set to be in a determined state. The selected state of the button denotes a state in which is selected color is displayed. When this state is established, a user can make a change from a highlighted button to another button. The determined state of the button denotes a state in which a determined color is displayed, and a button command can be executed. When this state is established, the user cannot make a change from the highlighted button to another button.

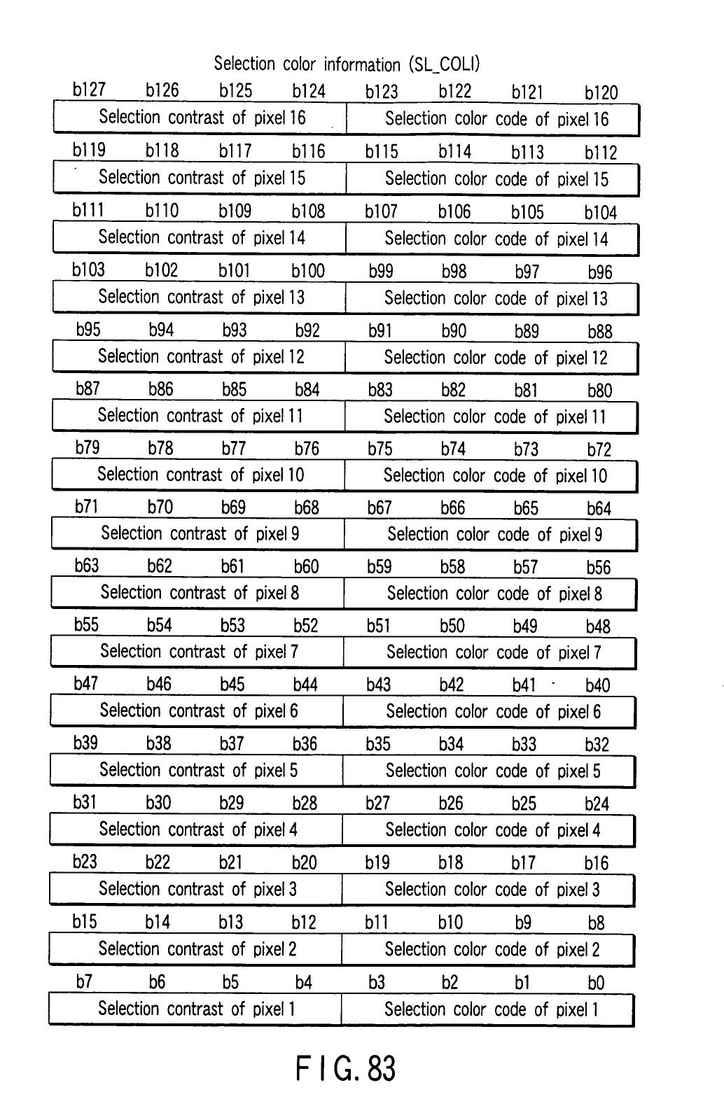

The selection color information SL_COLI 113G, as shown in FIG. 83, describes selection contrasts of pixel 16 from bit numbers b127 to b124, selection color codes of pixel 16 from bit numbers b123 to b120, and selection contrasts and selection color codes of pixels 15, 14, . . . 1 from bit numbers b119 to b0. The selection contrasts are contrast values of pixels when a button is selected. When no change is required, the default value of the contrast is described. The selection color codes are color codes of pixels when a button is selected. When no change is required, the default color code is described. The default value denotes the color code and contrast value defined in a sub-picture unit.

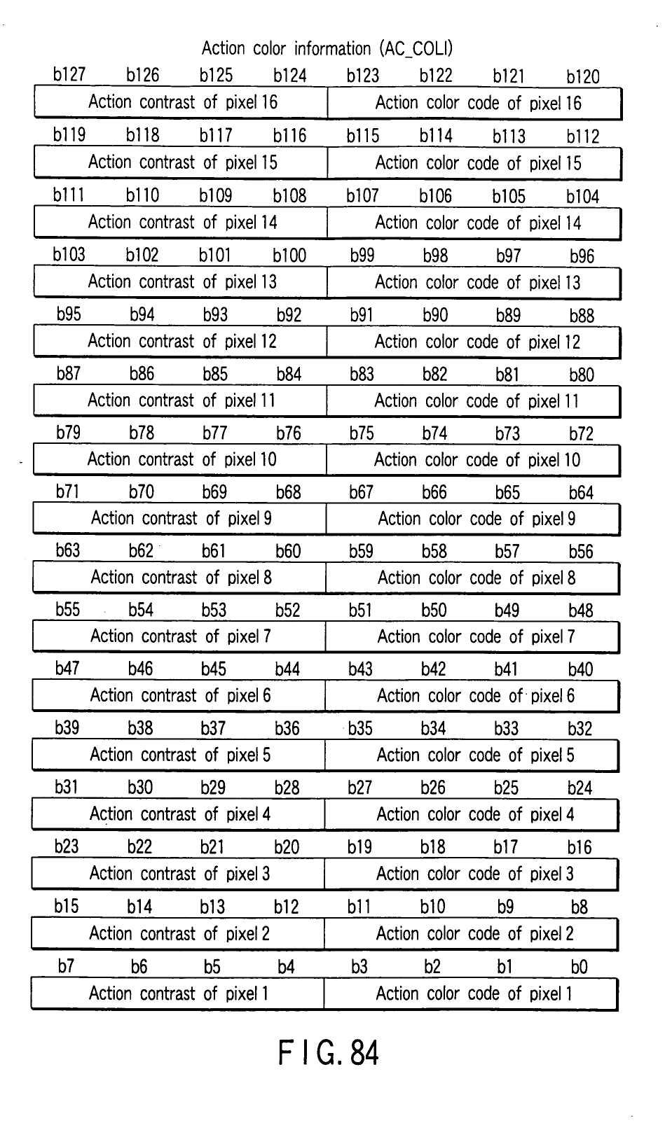

The action color information AC_COLI 113H, as shown in FIG. 84, describes action contrasts of pixel 16 from bit numbers b127 to b124, action color codes of pixel 16 from bit numbers b123 to b120, and action contrasts and action color codes of pixels from bit numbers b119 to b0. The action contrasts are contrast values of pixels when a button is determined. When no change is required, the default contrast value is described. The action color code is color codes of pixels when a button is determined. When no change is required, the default color code is described. The default value denotes the color code and contrast value defined in a sub-picture unit.

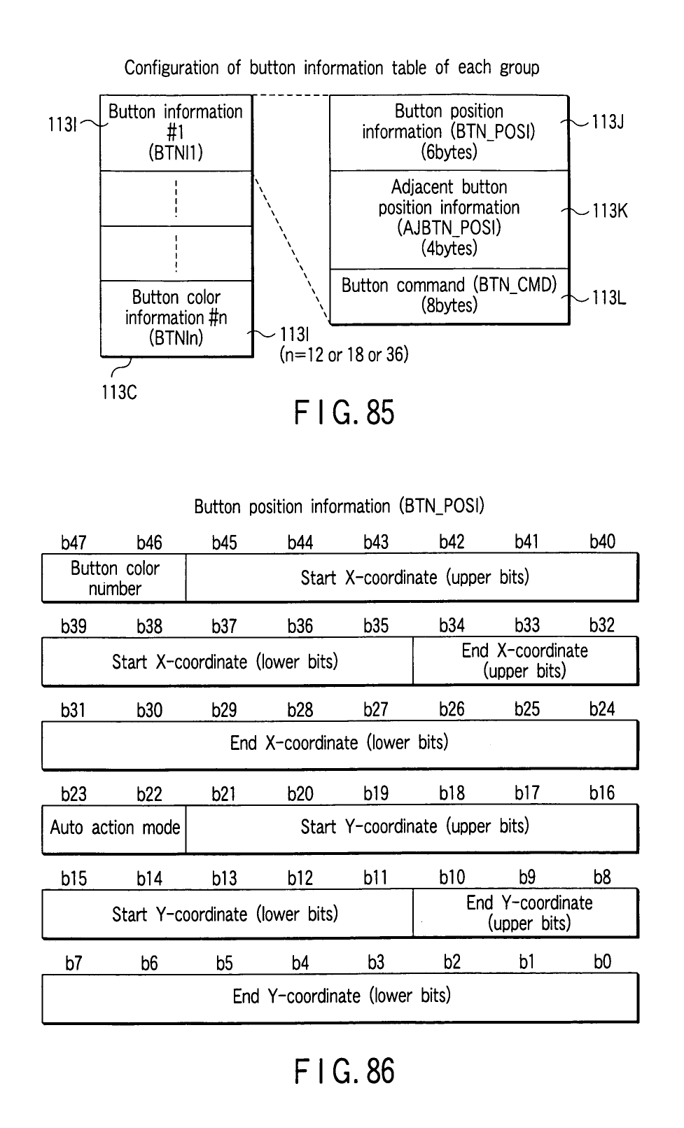

The button information table BTNIT 113C, as shown in FIG. 85, described 36 items of button information BTNI 113I, . . . In accordance with the contents of description of the number of button information BTNGR_Ns, three modes can be used as a 1-group mode in which all of the 36 items of button information BTNI 113I, are valid in description orders of the button information table BTNIT, a 2-group mode in which 18 items of button information BTNI 113I, . . . are grouped, and 12 items of button information BTNI 113I, . . . are grouped. A description region of the button information BTNI 113I in each group mode is fixed, and thus, all the region in which the valid button information BTNI 113I does not exist are described as 0. In description orders of the button information BTNI 113I in each button group, button numbers (BTNN) are allocated from 1.

Among from the button groups, the user can specify button number valued described from BTN_{—}#1 to NSBTN_Ns.

The button information BTNI 113I, as shown in FIG. 85, describes button position information BTN_POSI 113J, adjacent button position information AJBTN_PI 113K, and a button command BTN_CMD 113L.

The button position information BTN_POSI 113J, as shown in FIG. 86, describes color numbers (1 to 3) which buttons use and a rectangular display region on a video display screen. The button position information BTN_POSI 113J describes a button color number of a button BTN_COLN, a start X coordinate of a rectangular region in which a button is displayed (Start X-coordinate), an end X-coordinate of a rectangular region in which a button is displayed (End X-coordinate), a start Y-coordinate of a rectangular region in which a button is displayed (Start Y-coordinate), an end Y-coordinate of a rectangular region in which a button is displayed, and an automatic determination mode (auto action mode). The auto action mode describes whether or not a selected state is maintained or whether a selected state or a determined state is maintained.

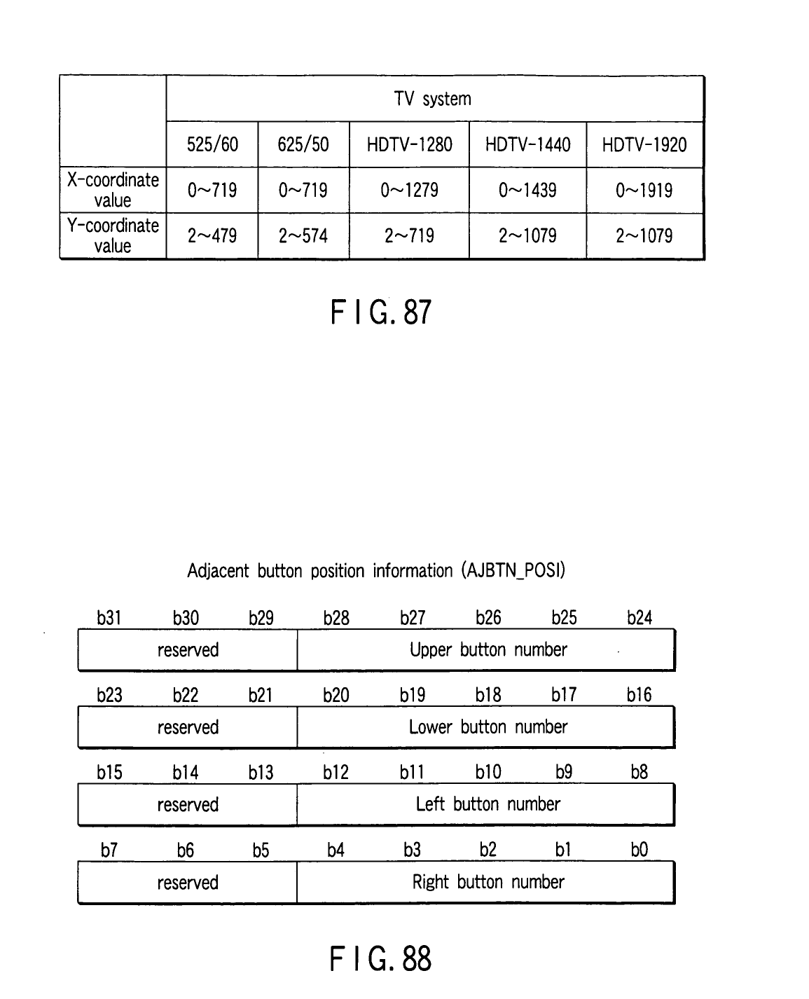

The origin of the X-coordinate is a start point of sub-picture line. The value of the start X-coordinate is within the range shown in the chart of FIG. 87. The value of the end X-coordinate is within the range shown in the chart of FIG. 87. The origin of the Y-coordinate is a start point of sub-picture line number 0. The value of the start Y-coordinate is within the range shown in the chart of FIG. 87. The value of the end Y-coordinate is within the range shown in the chart of FIG. 87.

Auto action mode=“00b” indicate that, when this button is selected, the state of this button enters a selected state. Auto action mode=“01b” indicates that, when this button is selected, the state of this button enters a determined state (SPRM (8) is changed) without displaying the selected color. The other is assumed to be reserved. The auto section mode is valid only when a button is selected by a cursor moving operation.

The adjacent button position information

AJBTN_POSI-113K describes whether, when a button selecting function is used, the button numbers positioned in four directions, i.e., upward, downward, left and right directions, of a destination to which a highlight moves and target buttons have a selected state. A button which does not have a selected state denotes a button which enters a determined state immediately without being a selected state when the button moves to the target button. For example, as shown in FIG. 88, bit numbers b28 to b24 describe upward moving button numbers, bit numbers b20 to b16 describe downward moving button numbers, bit numbers b12 to b8 describe left moving button numbers, and bit numbers b4 to b0 describe right moving button numbers. The other bit numbers are described as being reserved. These bit numbers are in response to an instruction of a select key Sm.

The button command BTN_CMD 113L describes a command executed when a button is determined. In accordance with this command, for example, a program chain for reproducing a program or title to be moved to another selection screen is specified.

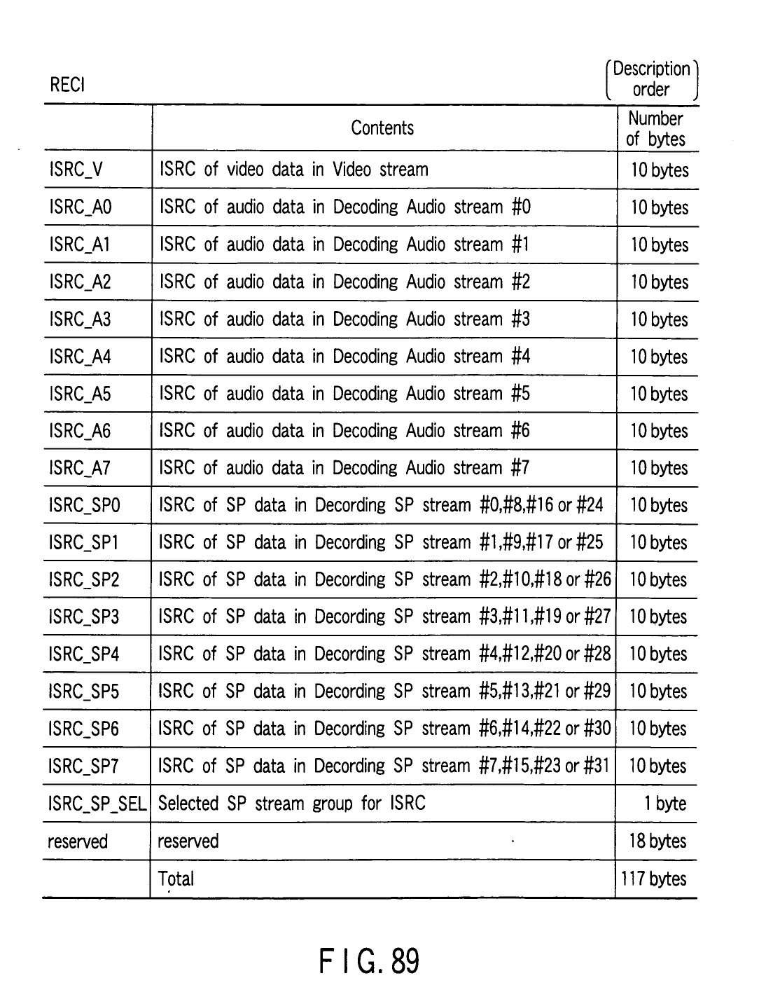

FIG. 89 shows a structure of recording information RECI. The recording information REIC is provided as information for video data, all audio data, and sub-picture data recorded in this VOBU. Each item of information is described as an ISRC conforming to ISO 3901.

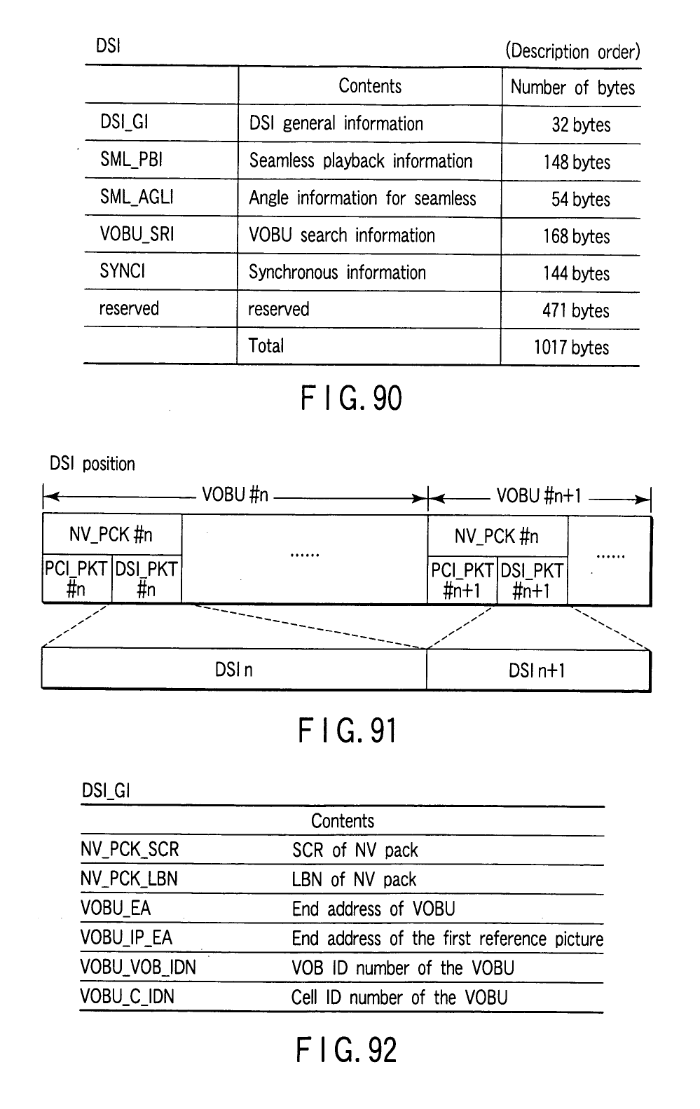

DSI data DSI 115 of the data search information DSI packet 117 shown in FIG. 63 is provided as navigation data for executing a search for the VOB unit VOBU 85. The DSI data DSI 115, as shown in FIG. 90, describes DSI general information DSI_GI, angle information SML_AGLI, VOB unit search information VOBU_SRI, and synchronization playback information SYNCI. FIG. 90 shows the contents of data search information DSI. The data search information DSI is provided as navigation data for making a search and executing VOBU seamless playback. The data search information DSI is described in a DSI packet DSI_PKT contained in the navigation pack NV_PCK, and the contents of the information are updated for each VOBU. The data search information DSI, as shown in FIG. 91, is allocated next to the PCI packet of the NV pack contained in the video object unit VOBU.

The DSI general information DSI_GI describes information of the entire DSI 115. That is, as shown in FIG. 92, the DSI general information DSI_GI describes a system time clock reference value NV_PCK_SCR of the NV pack 86. The system time clock reference value NV_PCK_SCR is stored in a system time clock STC incorporated in each portion shown in FIG. 1. With the STC being a reference, the video, audio, and sub-picture packs are decoded at the video, audio, and sub-picture decoder 58, 60, and 62, and the picture and voice are reproduced at the monitor 6 and speaker 8. The DSI general information DSI_GI describes a start address NV_PCK_LBN of the NV pack NV_PCK 86 in which DSI 115 is recorded in the relative number of logical sectors RLSN from the start logical sector of the VOB set VOBS 82 in which DSI 115 is recorded. In addition, this information describes an address VOBU_EA of the last pack contained in the VOB unit VOBU 85 in which DSI 115 is recorded in relative number of logical sectors RLSN from the start logical sector of the VOB unit VOBU.

The DSI general information DSI_GI describes an end address VOBU_IP_EA of the V pack V_PCK 88 in which the end address of the first I-picture in the VOBU is recorded in the relative number of logical sections RLSN from the start logical sector of the VOB unit VOBU in which DSI 115 is recorded. In addition, this information describes an identification number VOBU_IP_IDN of VOBU 83 in which DSI 115 is recorded, and an application identification number VOBU_ADP_ID of the VOBU.

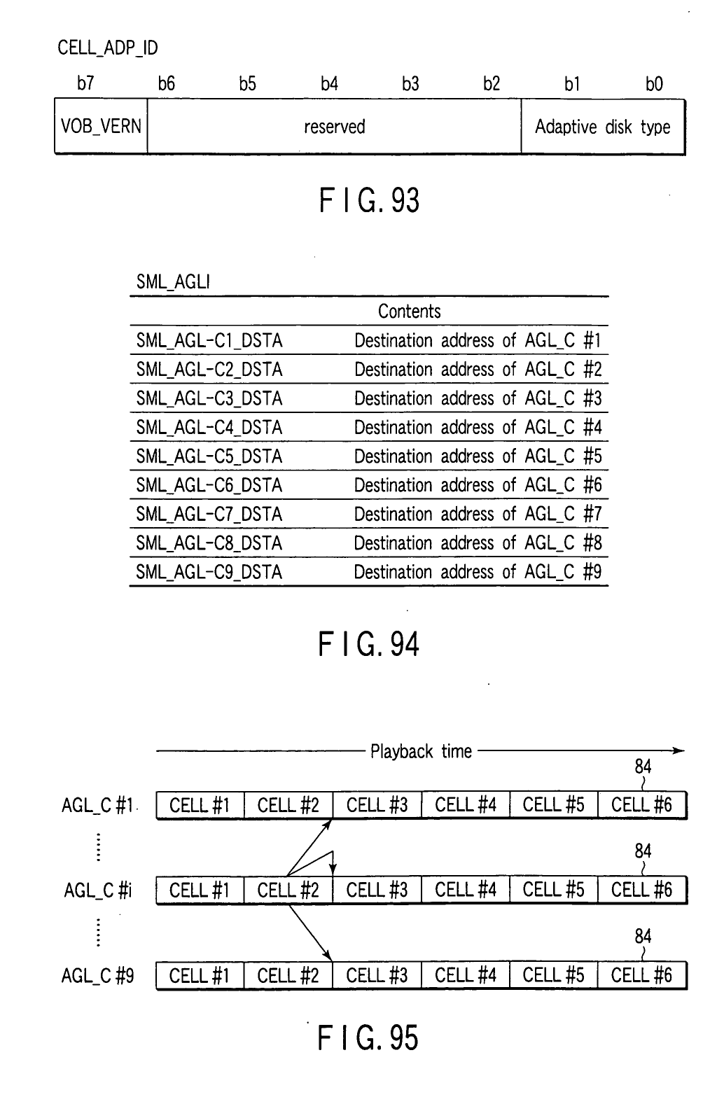

FIG. 93 shows a structure of the application identification number VOBU_ADP_ID. The VOB_VERN represents a VOB version number. If the VOB version 1.1 is issued, “0b” is described; and if the VOB version 2.0 is issued, “1b” is described. This version number VOB_VERN is also used for standby of a required decoder according to file specification as in the above-described version number. The adaptable disk type represents a disk type. If a DVD-ROM disk is specified, “00b” is described; and if a DVD-R disk or DVD-RW disk is specified, “01b” is described.

The angle information SML_AGLI describes a start address SML_AGL_C_DSTA of an angle cell which is a jump destination by the number of angles as shown in FIG. 94 as is the angle information SML_AGLI of the playback control information PCI 113. The start address of the information is described in the relative number of logical sectors from the logical sector of the NV pack 86 in which the data search information DSI 115 has been recorded.

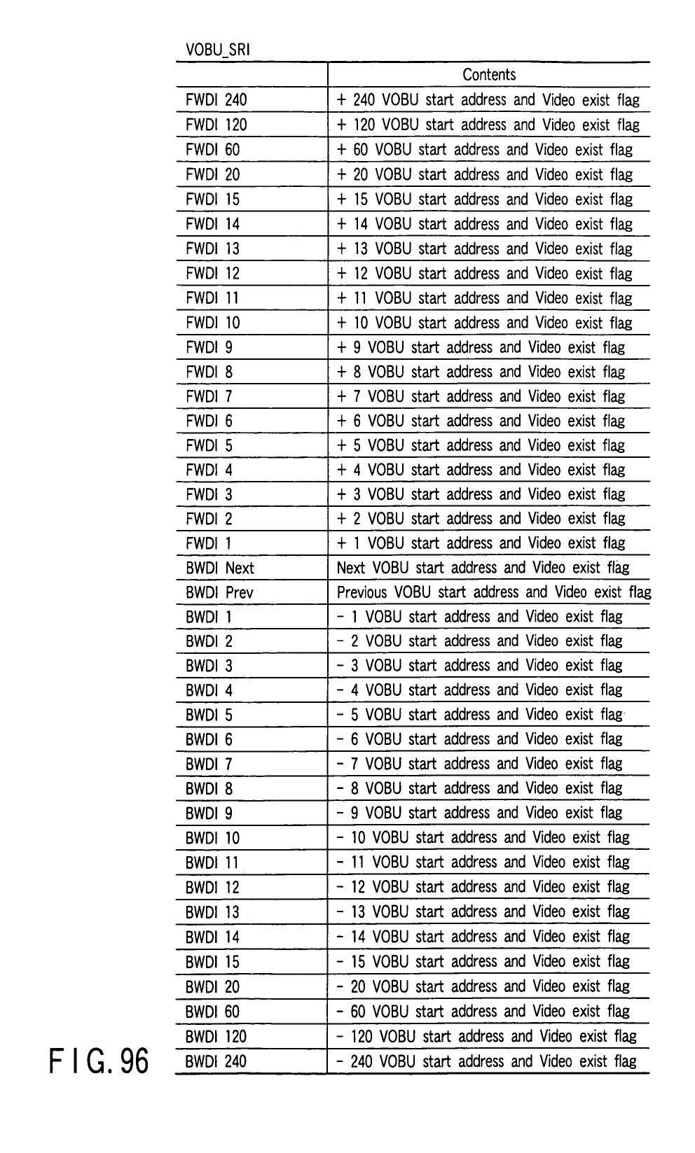

When an angle is changed based on this angle information SML_AGLI, as shown in FIG. 95, a start address of the cell 84 in another angle block at or after the playback time of VOBU 85 in which the DSI 115 is recorded is described in this angle information SML_AGLI.

When the DSI angle information SML_AGLI is used, the playback control information PCI can be changed by the video object unit VOBU. In response to this change, an angle is changed in units of cells, and a scene is continuously changed with an elapse of time. That is, PCI angle information NSML_ALGI describes a discontinuous angle change with an elapse of time. In contrast, the DSI angle information SML_AGLI describes a continuous angle change with an elapse of time. Referring to a specific example of angle using the above-described example of baseball, the following angle change is achieved. Angle cell #j (AGL_C#j) 84 is assumed to be a stream of image data comprising a series of scenes in which a pitcher pitches a ball, and then, a batter hits the pitched ball, resulting in homerun are seen from the infield side. In addition, angle cell #1 is assumed to be an image data stream in which similar scene has been seen from the outfield side. Angle cell #9 is assumed to be an image data stream in which the outlook of a team to which the batter belongs with respect to the similar scene has been seen. If the current angle cell is changed to angle cell #1 at a moment at which the batter hits the ball when the user watches angle cell #j (AGL_C#j), that is, if the current scene is changed to a scene from the outfield side at a moment of the batter hits the ball, the current scene can be changed to a screen on which the hit ball flies in the outfield, the screen being continuous with en elapse of time after the batter has hit the ball. When the user watches angle cell #j (AGL_C#j), if the current angle is changed to angle cell #9 at a moment of homerun, that is, if the current angle is changed to an angle at which the outlook of the team to which the batter belongs, the outlook of the team with great joy because of homerun and the manager's face are displayed on a screen. In this manner, when PCI 113 angle information NSML_AGLI and DSI 115 angle information SML_AGLI are used, clearly difference scenes are reproduced.

The VOBU 85 search information VOBU_SRI, as shown in FIG. 96, describes information specifying a start address in a cell. That is, in the VOBU 85 search information VOBU_SRI, as shown in FIG. 96, with the VOB unit VOBU 85 including DSI 115 being a reference, in accordance with the playback sequence, the presence or absence or, if any, a start address FWDn of VOB unit VOBU 85 from +1 to +20, +60, +120, and +240 is described as forward address data FWDIn in the relative number of logical sectors from the start logical sector of the VOB unit.

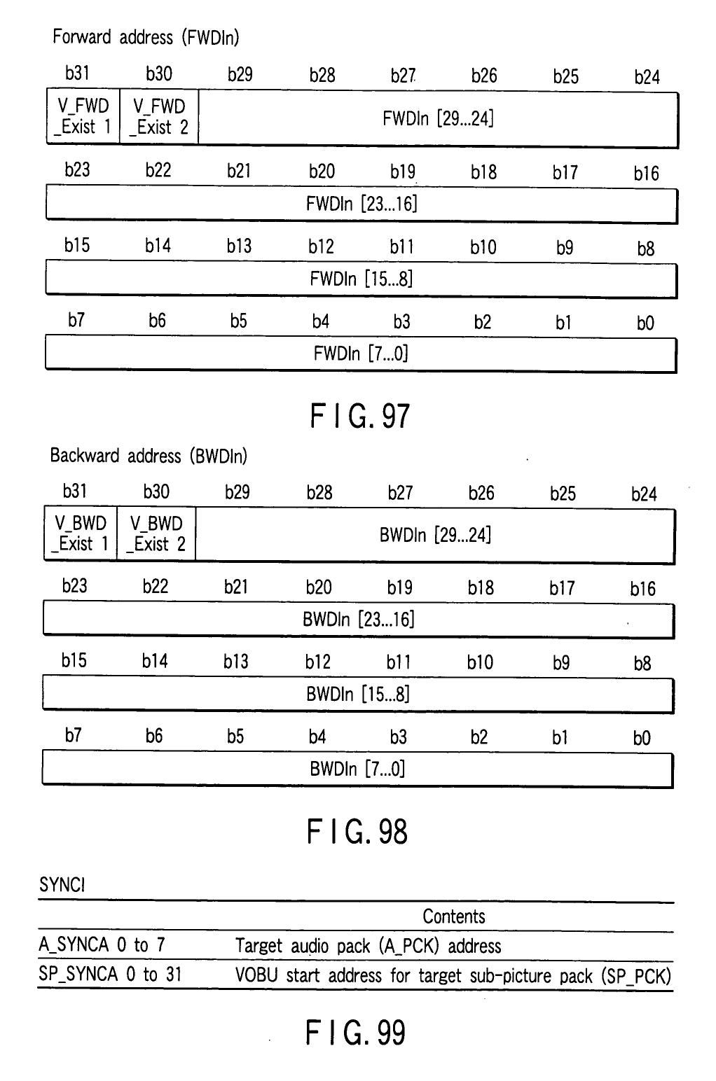

The forward address FWDIn is expressed in 32 bits as shown in FIG. 97. Bit number 29 (b29) to bit number 0 (b0) describes the associated address, for example, an address of forward address 10 (FWDI10). At the beginning of the forward address FWDIn, there are described a flag V_FWD_Exist1 indicating whether or not video data exists in video object unit VOBU 85 corresponding to the forward address FWDIn, and a flag V_FWD_Exist2 indicating whether or not video data exists between the video object and a video object unit being a forward destination. That is, V_FWD_Exist1 corresponds to bit number 31 (b31). When this flag is set to “0,” it denotes that no video data exists in the video object unit VOBU 85 specified by the forward address FWDIn described in bit number 29 to bit number 0. When this flag is set to “1,” it denotes that video data exists in the video object unit VOBU 85 specified by the forward address FWDIn described in bit number 29 to bit number 0. For example, when video data exists in the forward address 10 (FWDI10), a flag “1” is set in V_FWD_Exist1 of bit number 31. When no video data exists in that address, “0” is described in V_FWD_Exist1 of bit number 31. V_FWD_Exist2 corresponds to bit number 30 (b30). When this flag is set to “0,” it denotes that no video data exists in any of video object units VOBU 85 between the video object unit VOBU 85 specified by the forward address FWDIn described in bit number 29 to bit number 0 and the video object unit VOBU 85 including DSI 115 which describes this forward address. When this flag is set to “1,” it denotes that video data exists in any of the video object units VOBU 85 therebetween. For example, when video data exists in a plurality of video object units which correspond to forward address 1 to forward address 9 between the video object unit 85 of forward address 10 (BWDI10) and the video object unit 85 including DSI 115 which describes forward address 10 corresponding to forward address 0, a flag “1” is set in V_FWD_Exist2 of bit number 30. When no video data exists in that address, “0” is described in V_FWD_Exist2 of bit number 30.

Similarly, in the VOBU 85 search information VOBU_SRI, as shown in FIG. 96, with VOB unit VOBU 85 including the DSI 115 being a reference, in a direction opposite to the playback direction, the start address BWDIn of VOB unit VOBU 85 from −1 to −20, −60, −120, and −240 is described as backward data BWDIn in the relative number of logical sectors from the start logical sector of the VOB unit VOBU 85.

The backward address BWDIn is expressed in 32 bits as shown in FIG. 98. Bit number 29 (b29) to bit number 0 (b0) describe the address, for example, the address of backward address 10 (BWDI10). At the beginning of that backward address BWDIn, there are described a flag V_BWD_Exist1 indicating whether or not video data exists in video object unit VOBU 85 which corresponds to that backward address BWDIn and a flag V_BWD_Exist2 indicating whether or not video data exists between the video object and a video object unit being a backward destination. That is, V_BWD_Exist1 corresponds to bit number 31 (b31). When this flag is set to “0,” it denotes that no video data exists in the video object unit VOBU 85 specified by the backward address BWDIn described in bit number 29 to bit number 0. If this flag is set to “1,” it denotes that video data exists in the video object unit VOBU 85 specified by the backward address BWDIn described in bit number 29 to bit number 0. For example, when video data exists in backward address 10 (BWDI10), a flag “1” is set in V_BWD_Exist1 of bit number 31. When video data exists in that address, “0” is described in V_BWD_Exist1 of bit number 31. V_BWD_Exist2 corresponds to bit number 30 (b30). When this flag is set to “0,” it denotes that no video data exists in any of the video object units between the video object unit VOBU 85 specified by the backward address BWDIn described in bit number 29 to bit number 0 and the video object unit including DSI 115 which describes this backward address. When this flag is set to “1,” it denotes that video data exists in the video object unit VOBU 85. For example, when video data exists in any of the video object units 85 between the video object unit of backward address 10 (BWD10) and backward address 10 corresponding to backward address 0, a flag “1” is set in V_BWD_Exist2 of bit number 30. When no video data exists in that address, “0” is described in V_BWD_Exist2 of bit number 30.

The synchronous information SYNCI describes address information on sub-picture and audio data to be reproduced in synchronism with the playback start time of video data of the VOB unit VOBU in which the data search information DSI 115 is included. That is, as shown in FIG. 99, a start address A_SYNCA of the target audio pack A_PCK 91 is described in the relative number of logical sectors RLSN from the NV pack NV_PCK 86 in which DSI 115 is recorded. When a plurality of audio streams (a maximum of 8 audio streams) exist, synchronous information SYNCI is described by the number. In the synchronous information SYNCI, an address SP_SYNCA of the NV pack NV_PCK 86 of VOB unit VOBU 85 including the target audio pack NV_PCK 86 is described in the relative number of logical sectors RLSN from the NV pack NV_PCK 86 in which DSI 115 is recorded. When a plurality of sub-pictures (a maximum of 32 sub-pictures) exist, synchronous information SYNCI is described by the number.

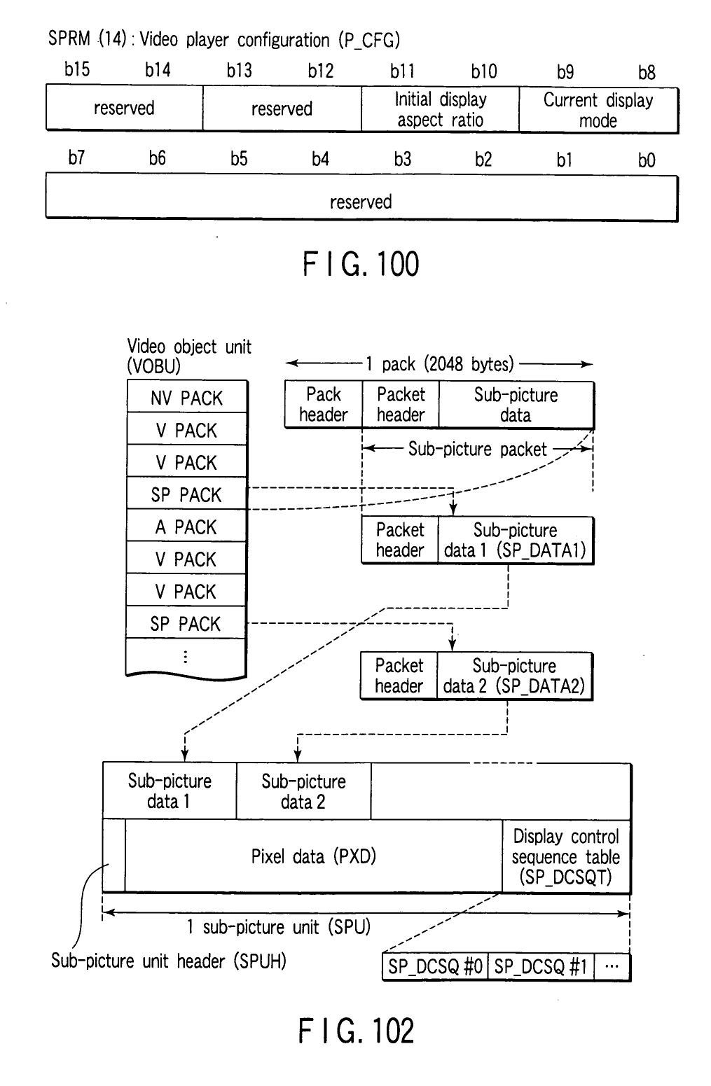

FIG. 100 shows a configuration of video player configuration SRRM (14): P_CFG in system parameter SPRM. This player parameter specifies a default display aspect ratio and a current display mode. SPRM (14) is exclusively used for navigation command readout. The default display aspect ratio describes the user selected display aspect ratio. If the aspect ratio is 4:3, “00b” is described; and if the aspect ratio is 16:9, “11b” is described. The current display mode describes a current video output mode of the player in the current domain. In general, if the aspect ratio is (4:3) or wide (16:9), “00b” is described; if pan/scan is carried out, “01b” is described; and if a letterbox is specified, “10b” is described.

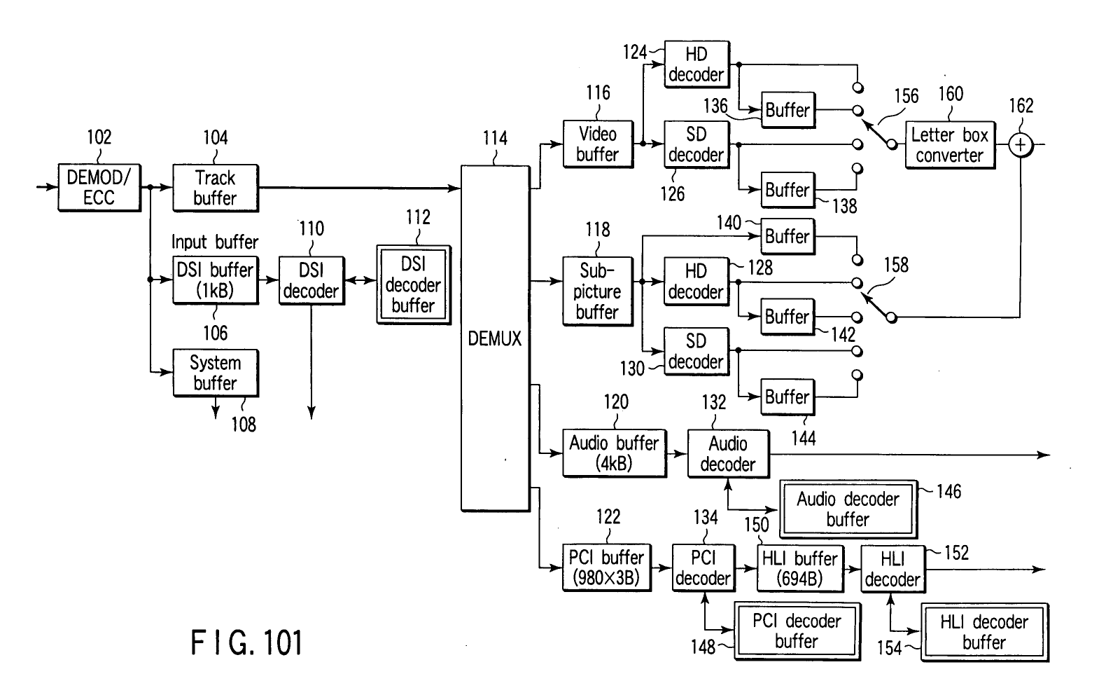

FIG. 101 shows a player reference model. During the playback period, each pack in the program stream read from a disk is sent to a track buffer 104 from a demodulator/error correction circuit 102, and the sent pack is stored in the buffer. An output of the track buffer 104 is separated by a multiplexer 114, and the separated outputs are transferred to input buffers 116, 118, 120, and 122 for target decoders 124, 126, 128, 130, 132, and 134, each of which is specified in ISO/IEC 13818-1. The track buffer 104 is provided to ensure continuous data supply to the decoders 124, 126, 128, 130, 132, and 134. DSI_PKT in the navigation pack is stored in the track buffer 104, and at the same time, is stored in a data search information DSI buffer 106. Then, the DSI_PKT is decoded by a DSI decoder 110. A DSI decoder buffer 112 is also connected to the DSI decoder 110, and a system buffer 108 is also connected to the demodulator/error correction circuit 102.

An output (main picture) of the video buffer 116 is supplied to the HD decoder 124 and the SD decoder 126 each. The outputs of the HD decoder 124 and SD decoder 126 are supplied intact to a selector 156, and are supplied to the selector 156 via buffers 136 and 138. An output of the selector 156 is supplied to a mixer 162 via a letterbox converter 160.

An output of the sub-picture buffer 118 is supplied to the HD decoder 128 and the SD decoder 130 each. The outputs of the HD decoder 128 and SD decoder 130 are supplied intact to a selector 158, and are supplied to the selector 158 via buffers 142 and 144. An output of the selector 158 is supplied to the mixer 162.

An output of the audio buffer 120 is supplied to the audio decoder 132. An output of the playback control information PCI buffer 122 is supplied to the PCI decoder 134. An audio decoder buffer 146 is also connected to the audio decoder 132. An output of the audio decoder 132 is output intact. A PCI decoder buffer 148 is also connected to the PCI decoder 134, and an output of the PCI decoder 134 is supplied to an HIL decoder 152 via a highlight HIL buffer 150. An HIL decoder buffer 154 is also connected to the HIL decoder 152, and an output of the HIL decoder 152 is forwarded intact.

Power supply timings of the decoders 124, 126, 128, 130, 132, and 134 each are controlled according to the above-described version number or compression/non-compression flags, and a required decoder is made standby according to the SD/HD scheme. Thus, playback can be started speedily while power is saved.

A sub-picture unit comprising sub-picture data of a plurality of subsidiary packets will be described with reference to FIG. 102. In 1 GOP, a sub-picture unit being still picture data (for example, superimposition) for some tens of screens can be recorded. A sub-picture unit SPU comprises a sub-picture unit header SPUH, pixel data comprising bit map data PXD, and a display control sequence table SP_DCSQT.

The size of the display control sequence table SP_DCSQT is half or less of that of the sub-picture unit. The display control sequence SP_DCSQ describes the contents of display control of each pixel. Each display control sequence SP_DCSQ is continuously recorded to be adjacent to each other as shown in FIG. 102.

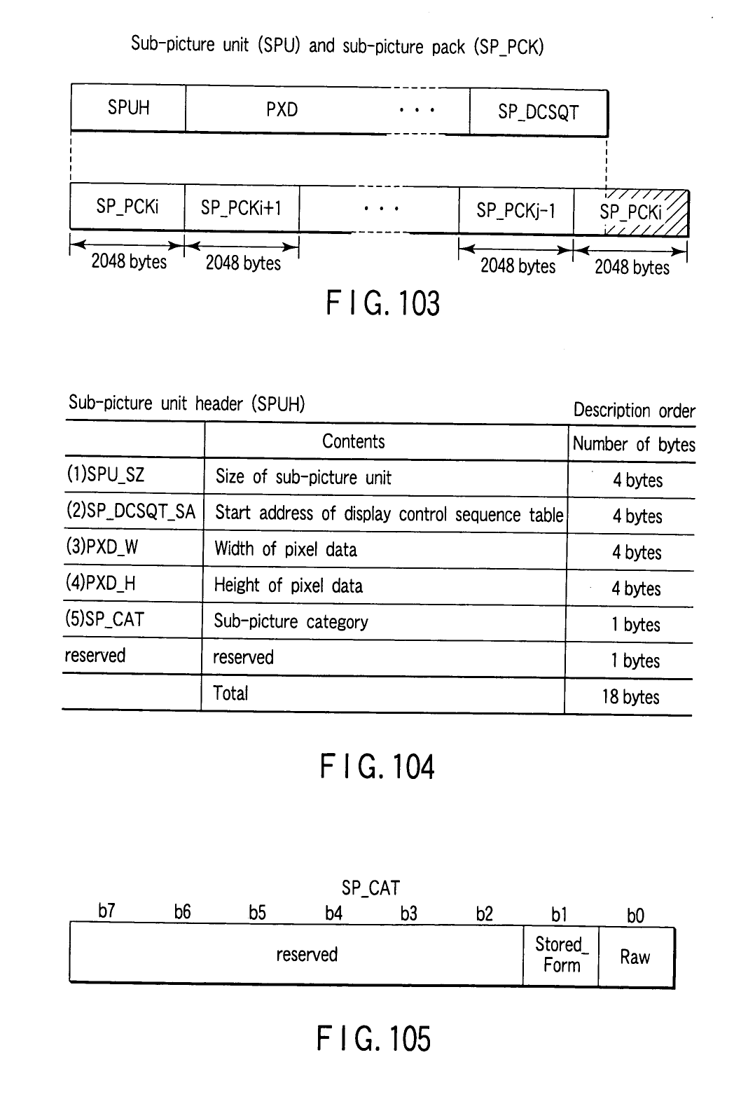

The sub-picture unit SPU, as shown in FIG. 103, is divided into an integer number of sub-picture packs SP_PCK, and is recorded on a disk. The sub-picture pack SP_PCK can have a padding packet or a stuffing byte only in the case of the last pack of one sub-picture unit SPU. When a length of SP_PCK including the last data of the unit is less than 2,048 bytes, the length is adjusted. SP_PCK other than the last pack cannot have a padding packet.

PTS of the sub-picture unit SPU must be made coincident with a top field. The validity period of the sub-picture unit SPU is from PST of the sub-picture unit SPU to PTS of the sub-picture unit SPU to be reproduced next. However, when a still picture is generated with navigation data during the validity period of the sub-picture unit SPU, the validity period of the sub-picture unit SPU continues until that still picture ends.

The display of the sub-picture unit SPU is defined below.

1) When the display is turned ON during the validity period of the sub-picture unit SPU by a display control command, the sub-picture data is displayed.

2) When the display is turned OFF during the validity period of the sub-picture unit SPU by a display control command, the sub-picture data is cleared.

3) The sub-picture unit SPU is forcibly cleared when the validity period of the sub-picture unit SPU has elapsed, and the sub-picture SPU is discarded from a decoder buffer.

The sub-picture unit header SPHU comprises address information on each item of data contained in the sub-picture unit SPU. As shown in FIG. 104, this header describes the size SPU_SZ of a 4-byte sub-picture unit, a start address SP_DCSQT_SA of a 4-byte display control sequence table, a 4-byte pixel data width PXD_W, a 4-byte pixel data height PXD_H, a 1-byte sub-picture category SP_CAT, and 1-byte reservation.

The size of the sub-picture unit SPU_SZ describes the size of the sub-picture in bytes. The maximum size must be 524,287 bytes (“7FFFFh”). The size must be in even number bytes. If the size is in odd number bytes, 1 byte of “FFh” is added to the last of the sub-picture data in order to set an even number byte. The size of the first address SP_DCSQT_SA in the sub-picture unit SPU is equal to or less than the size of SPU.

The start address SP_DCSQT_SA describes the start address of the display control sequence table SP_DCSQT in the relative byte number RBN from the start byte of the sub-picture unit.

The maximum value of the pixel data width is 1,920, and the maximum value of the pixel data height is 1,080.

The sub-picture category SP_CAT, as shown in FIG. 105, describes a flag “Stored-Form” indicating reservation in bit numbers b7 to b2 and a method for storing data in a 4-bit/1-pixel pixel data PXD region in bit number b1, and a flag indicating pixel data PXD run length compression/non-compression in bit number b0.

When an interlace display is made, the flag “Stored_Form” indicating the method for storing data in the PXD region specifies “0b” (top/bottom). The display data is stored in separate places by dividing the data into top and button, whereby there can be achieved a data structure in which data can be easily acquired, and an interlace display can be easily made. When a non-interlace display is made, “1b” (plan) is specified. Then, the display data is stored in batch, whereby there can be achieved a data structure in which data can be easily acquired, and a non-interlace display can be easily made. In the SD scheme, an interlace display is made, and in the HD scheme, a non-interlace display is made. As is the flag “Stored_Form” of the sub-picture stream attribute shown in FIG. 39, this flag “Stored-Form” is also utilized for standby of the HD decoder.

The flag “Raw” indicating run length compression/non-compression specifies “0b” (compression) for a superimposition stream with its good compression rate such as superimposition, and specifies “1b” (non-compression) for such a slightly complicated image stream with its poor compression rate such as a pattern, the image causing an increased amount of data after compression. In this manner, compression/non-compression can be specified in units of sub-picture units SPU, and information can be allocated to main picture data or other data (such as audio data). In addition, sub-picture information can be efficiently recorded in an information recording medium, and thus, high definition contents can be maintained. As is the sub-picture stream flag “Raw” shown in FIG. 39, this flag “Raw” is also utilized for standby of the HD decoder.

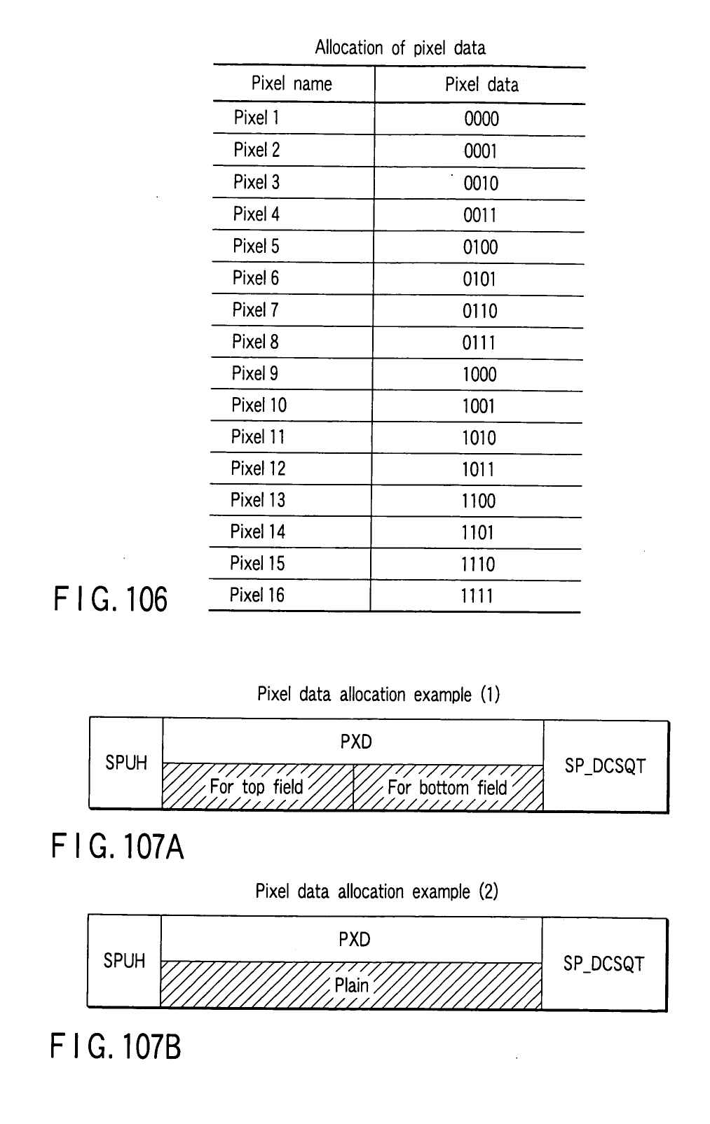

Pixel data is provided as data obtained by compressing raw data or bit map data on a line by line basis by specific run length compression technique described in a run length compression rule. The pixel data shown in FIG. 106 is allocated to pixels of the bit map data.

The pixel data is allocated to data discriminated in a filed or plain data, as shown in FIGS. 107A and 107B. The pixel data is organized such that all of the portions of pixel data displayed in 1 field are continuous in each sub-picture unit SPU. In an example shown in FIG. 107A, top field pixel data is first recorded (after SPUH); bottom field pixel data is then recorded; and pixel data suitable to an interlace display is allocated. In an example shown in FIG. 107B, plain data is recorded, and pixel data suitable to a non-interlace display is allocated. Even number of “00b” may be added at the end of pixel data so as to match size limitation of SP_DCSQT.

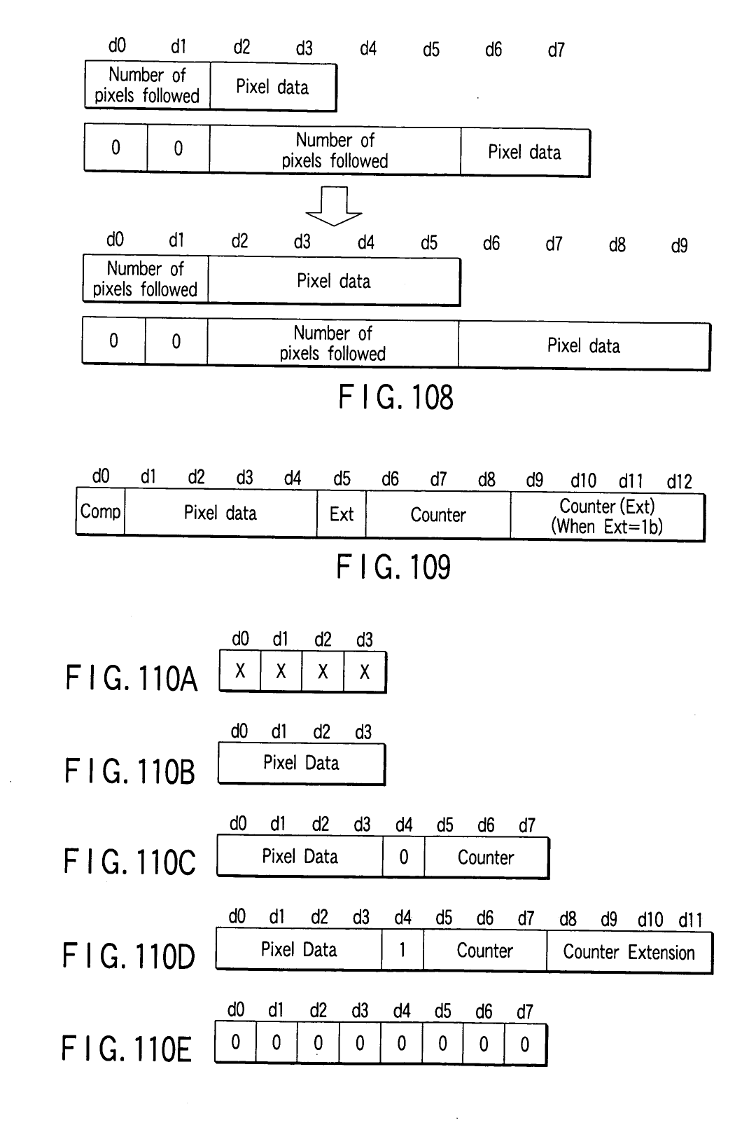

When high image contents of high definition TV scheme are recorded in a DVD video disk, sub-picture information which has been utilized as superimposition or menu information is also required to be recorded in the high definition TV scheme, similarly. A sub-picture run length compression rule according to the present embodiment will be described below. FIG. 108 shows compression of pixel data in the case where the run length compression rule is fixed, and where only pixel data is extended from the conventional 2-bit/1-pixel to 4-bit/1-pixel. In this scheme, in the 4-bit/1-pixel image data, the probability that the same image data is generated is lowered, and thus, the probability of continuous run is lowered. Therefore, there is a problem that compression of image data cannot be sufficiently carried out because the capacity of the counter value becomes a burden.

FIG. 109 shows the run length compression rule according to the present embodiment to solve this problem. The pixel of bit map data is compressed in accordance with the following rule on a line by line basis.

The compressed pixel pattern basically consists of five portions: a run length compression flag (Comp); a pixel data field (Pixel data); a counter extension flag (Ext); a counter field (Counter); and an extended counter field (Counter(Ext)). The run length compression flag (Comp) describes “0b” if pixel data is not compressed or “1b” if the data is compressed in run length encoding. When the pixel data is not compressed, one data unit represents only one pixel, and the counter extension flag (Ext) and subsequent do not exist. The pixel data describes any of 16 items of pixel data shown in FIG. 106, and this value represents an index of a color lookup table. The counter extension flag (Ext) describes “0b” if the counter field is in 3 bits or “1b” if it is in 7 bits. The counter field specifies serial number of pixels. When the flag (Ext) is set to “0b,” this field is in 3 bits. When the flag is set to “1b,” this field is in 7 bits (the extended counter field is used).

The data compressed in accordance with this compression rule comprises a plurality of units. Each unit has 4 pixel change points. The unit consists of a unit header which forms a bundle of 4 run length flags shown in FIGS. 110A and 4 types of compression patterns shown in FIG. 110B to FIG. 110E.

The unit header shown in FIG. 110A is provided as a set of run length compression flags (Comp) indicating whether or not a run length exists. If the run length does not continue, “0b” is described; and if the run length continues, “1b” is described.

In compression pattern (A) shown in FIG. 110B, if the pixel of the same value does not continue, the run length compression flag (Comp) is set to “0b,” and 4-bit pixel data is described.

In compression pattern (B) shown in FIG. 110C, 1 to 7 pixels of the same value follow, the run length compression flag (Comp) is set to “1b.” Pixel data is described in the first 4 bits; “0b” is specified for the next 1 bit (flag Ext); and a counter is described for the next 3 bits.

In compression pattern (C) shown in FIG. 110D, 8 to 127 pixels of the same value follow, the run length compression flag (Comp) is set to “1b.” Pixel data is described for the first 4 bits; “1b” is specified for the next 1 bit (flag Ext); a counter is described for the next 3 bits; and counter extension is described for the next 4 bits.

In compression pattern (D) shown in FIG. 110E, an end-of-line code describes: “0b” for all of 8 bits in the case where pixels of the same value are continuous at the end of line; and the run length compression flag (Comp) is set to “1b.”

If adjustment of byte is incomplete when pixel description of one line has terminated, 4-bit dummy data “0000b” is inserted for the purpose of adjustment.

The size of run length coded data in one line is 7,680 bits or less.

The encoding/decoding method according to the present embodiment carries out run length compression or decompression according to the following combinations of (1) to (4).

(1) There is provided a run length compression flag (Comp) indicating whether or not run is continuous, thereby determining compression/non-compression.

(2) There is provided a counter extension flag (Ext) extending a run continuity counter (Counter) according to the number of run continuities so as to add an extended counter (Counter(Ext)).

(3) There is provided a data structure in which 4 run change points are handled as one unit, thereby providing a nibble (4-bit) configuration in which bytes are easily matched.

(4) An end code E is provided for run length compression or decompression on a line by line basis (however, if information on the capacity for one line can be assigned in advance to an encoding/decoding device, this end code can be omitted).

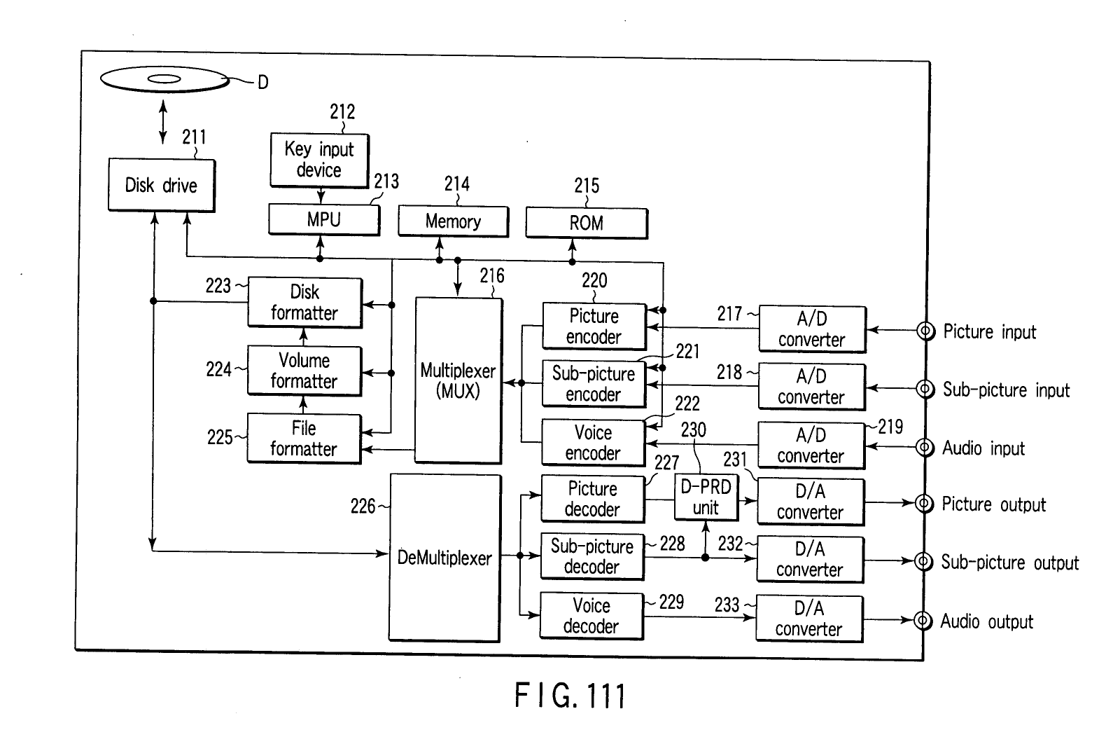

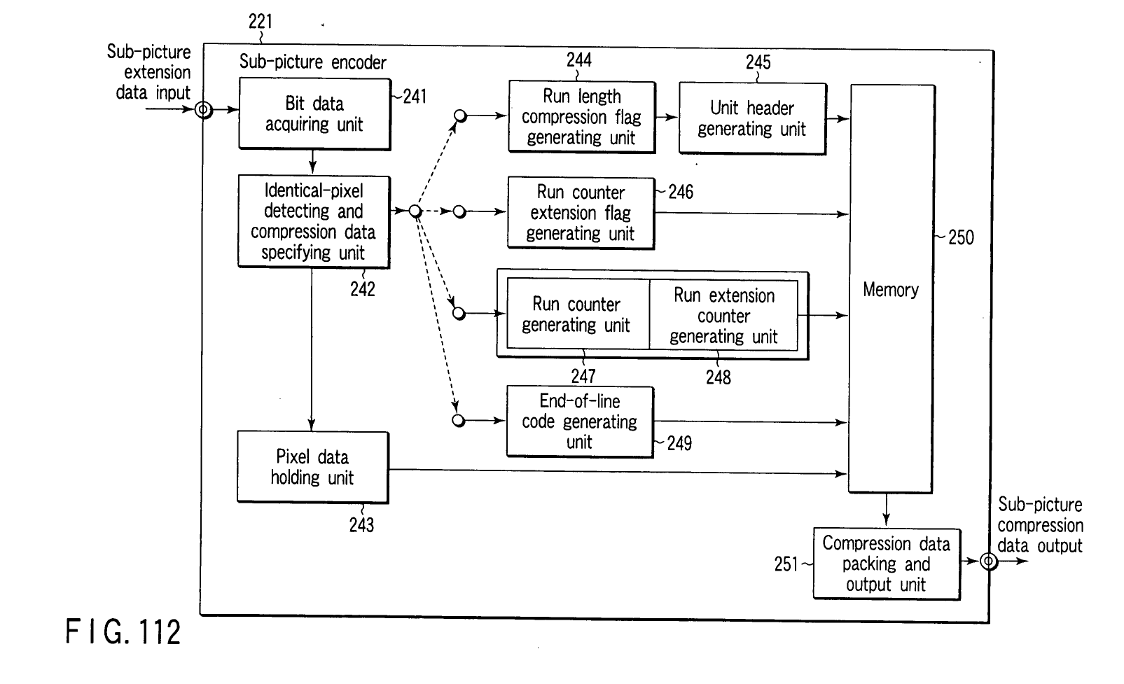

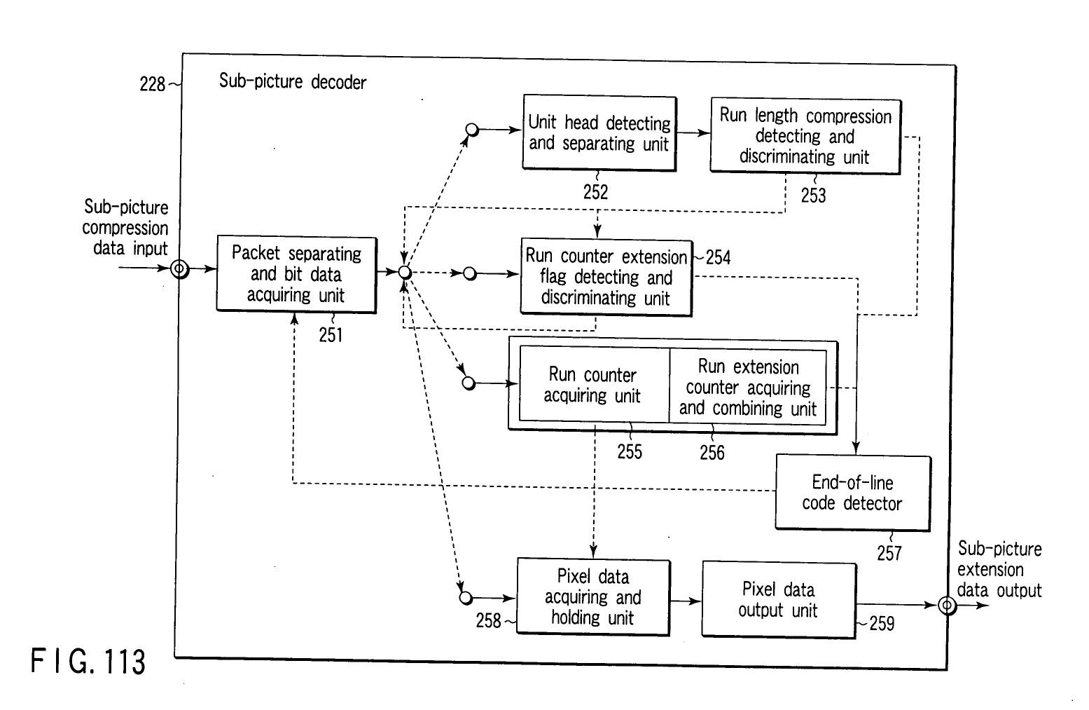

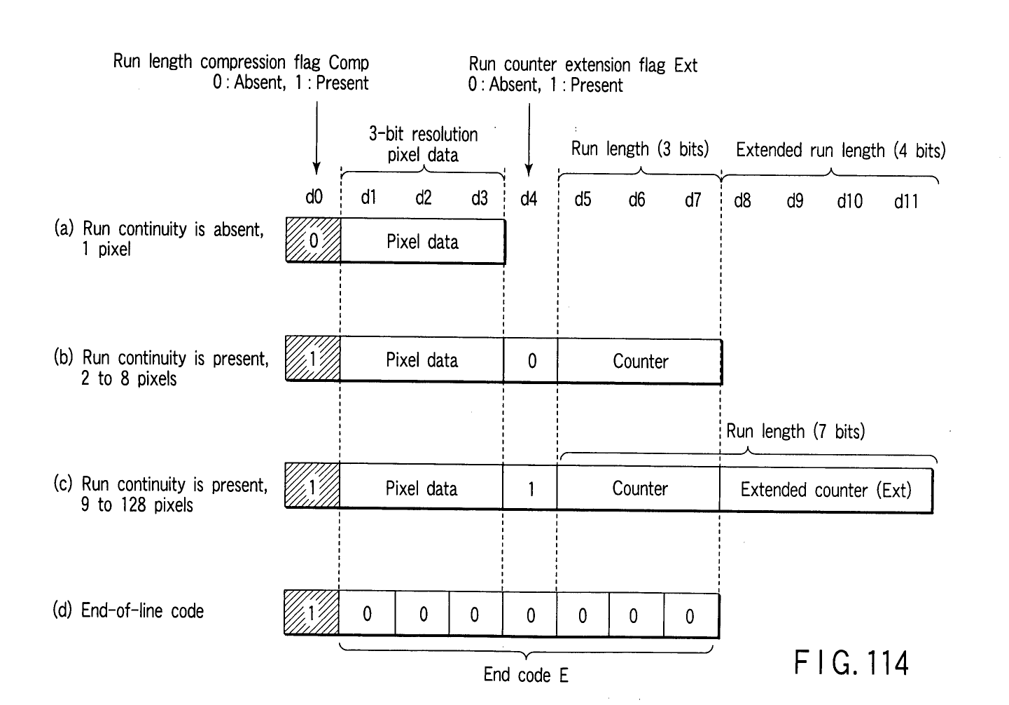

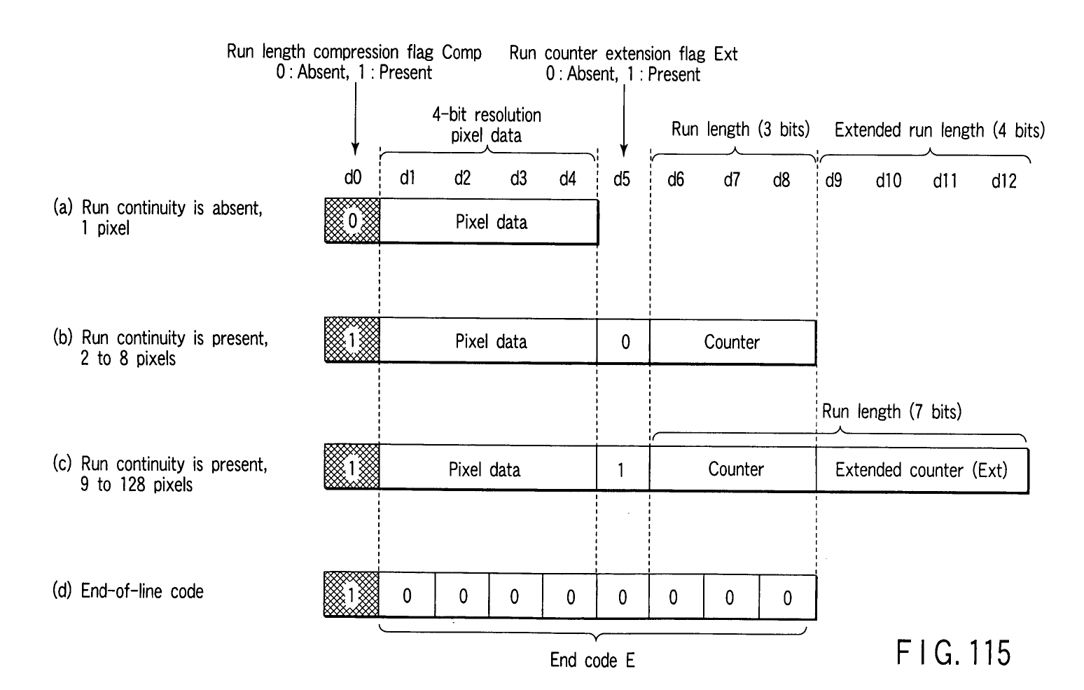

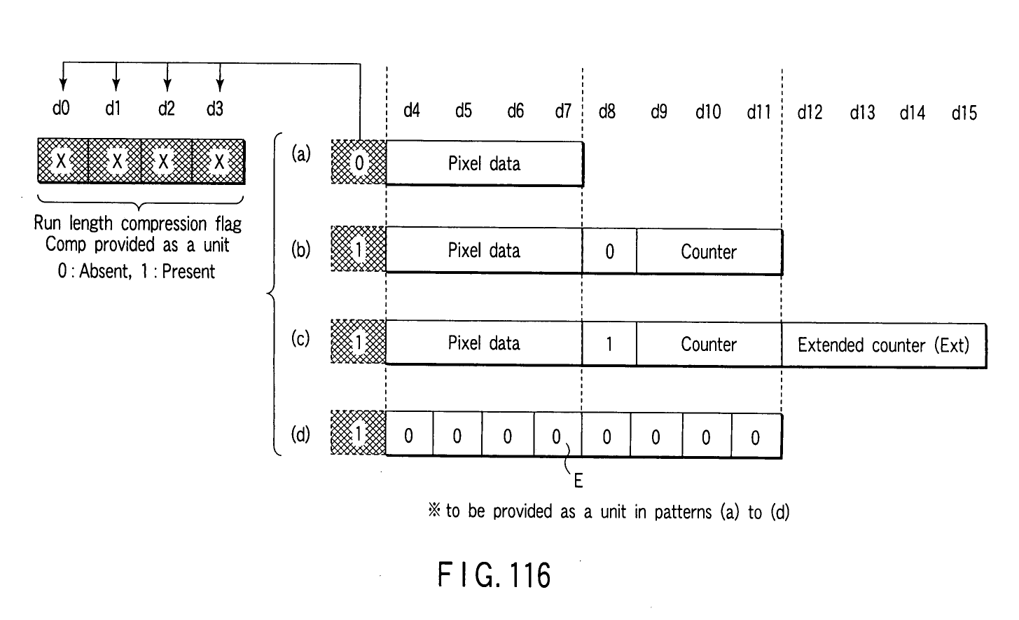

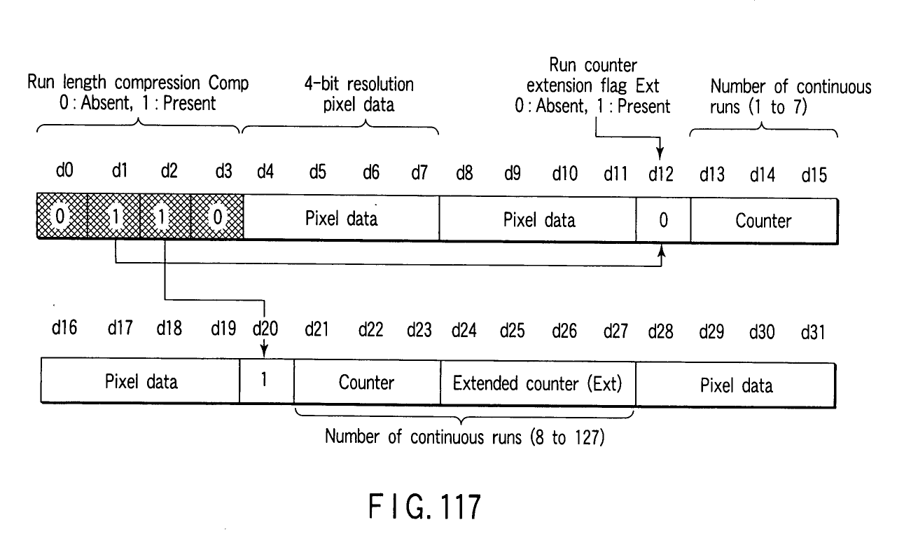

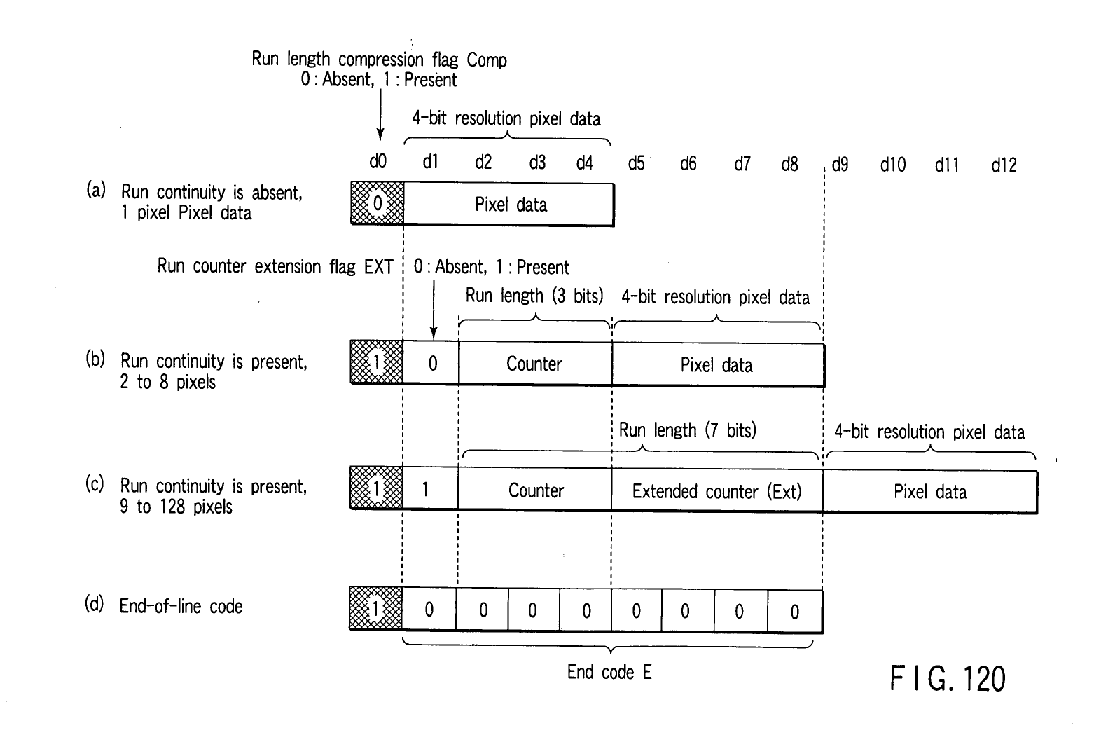

FIG. 111 is a block diagram showing an example of a configuration of a disk apparatus to which encode or decoding processing is applied according to the present embodiment. FIG. 112 is a block diagram showing an example of a configuration of a sub-picture encoder of the disk apparatus to which encoding processing is applied according to the present embodiment. FIG. 113 is a block diagram showing an example of a configuration of a sub-picture decoder. FIG. 114 is a view showing a “run length rule (on a line by line basis) for 3-bit, 8-color expression in 3-bit data” which is a run length compression rule according to the present embodiment (in this case, an example of no unit is required in particular because it can be handled in units of 4 bits). FIG. 115 is a view showing “a run length compression rule (on a line by line basis) for 4-bit, 16-color expression in 4-bit data.” FIG. 116 is a view showing an example of a practical data structure in accordance with the run length compression rule according to the present embodiment. FIGS. 117 to 119A-119F are views each showing an example in which this data structure is provided as a unit. FIG. 120 is a view showing another example of the run length compression rule (on a line by line basis) for 4-bit, 16-color expression in 4-bit data.

FIG. 111 shows a disk apparatus for carrying out playback processing for reading out information stored from a disk-formed information recording medium D and carrying out decoding and playback processing; or record processing for, upon the receipt of a picture signal, a sub-picture signal, and a voice signal, carrying out encoding processing and recording the encoded signal in a disk-shaped information recording medium D.

The information recording medium D is mounted on a disk drive 211. This disk drive 211 rotationally drives the mounted information recording medium D. Then, the information stored in the information recording medium D is read, decoded, and reproduced by using an optical pickup (when the information recording medium D is an optical disk), or the information according to the encoded signal is recorded in the information recording medium.

Now, with respect to the playback processing, the disk apparatus according to the present embodiment will be described here. The information read by the disk drive 211 is supplied to an MPU (Micro Processing Unit) portion 213. After error correction processing has been applied, the information is stored in a buffer (not shown). Among from items of the information, control data region management information is recorded in a memory 214, and the recorded information is utilized for playback control, data management and the like.

Among from the above information stored in the buffer, video object region information is transferred to a demultiplexer 226, and the transferred-information is separated for each of a main picture pack 203, a voice pack 204, and a sub-picture pack 205.

The information contained in the main picture pack 203 is supplied to a picture decoder 227; the information contained in the voice pack 204 is supplied to a voice decoder 229; and the information contained in the sub-picture pack 205 is supplied to a sub-picture decoder 228, respectively. Then, decoding processing is carried out.

The main picture information processed to be decoded at the picture decoder 227 and the sub-picture information processed to be decoded at the sub-picture decoder 228 are supplied to a D-processor 230, and superimposition processing is applied. Then, the superimposed information is converted into an analog form by a D/A (Digital/Analogue) converter 231. The sub-picture information is converted intact to an analog form at a D/A converter 232, and the converted information is output as a picture-signal to a picture display unit (not shown) (for example, CRT: Cathode Ray Tube or the like).

The voice information processed to be decoded at the voice decoder 229 is converted to an analog form at the D/A converter 233, and the converted voice information is output as a voice signal to a voice playback unit (not shown) (for example, a speaker or the like).

A series of playback operations for the information recording medium D as described above is controlled by the MPU 213. The MPU 213 receives operation information from a key input device 212, and controls each portion based on a program stored in a ROM (Read Only Memory) 215.

With respect to record processing, the disk apparatus according to the present embodiment will be described here. In FIG. 111, the data input through the input terminals of picture, voice, and sub-picture are supplied to A/D converters 217, 218, and 219, respectively, and analog signals are converted into digital signals. The video data digitally converted at the A/D converter 218 is supplied to a picture encoder 220, and the supplied video data is encoded. The sub-picture data digital-converted by the A/D converter 218 is supplied to a sub-picture encoder 221 to be encoded. The audio data digital-converted by the A/D converter 219 is supplied to a voice encoder 222 to be encoded.

The video, audio, and sub-picture data encoded by the encoders each are supplied to a multiplexer (MUX) 216, a packet and pack of data are provided, respectively, and MPEG-2 program streams are configured as a video pack, an audio pack and a sub-picture pack. The multiplexed data group is supplied to a file formatter 225, and the supplied data group is converted to a file which conforms to a file structure which can be recorded or reproduced by this disk apparatus. This file is supplied to a volume formatter 224, and data format conforming to a volume structure which can be recorded or reproduced by this disk apparatus is formed. Here, the data filed by the file-formatter 225, playback control information for reproducing the filed data and the like are added. Then, these data and information are supplied to a disk formatter 223, and the filed data is recorded in the disk D by the disk drive 211.

Such playback operation or record operation is carried out by executing it at the MPU 213 under an instruction from the key input device 212 based on a series of processing programs stored in the ROM 215 of this disk apparatus.

Although this disk apparatus carries out both of encoding processing and decoding processing of sub-picture data, only encoding processing may be carried out solely by an authoring system or the like or only decoding processing may be carried out by the disk apparatus.

Now, the above sub-picture encoder 221 will be described with reference to FIG. 112. FIG. 112 is a block diagram showing internal processing of the sub-picture encoder 221. In the figure, if sub-picture decompression data (sub-picture data before compressed) is input from an input terminal, data is acquired on a 4-bit by 4-bit basis at a bit data acquiring unit 241. With respect to the acquired data, first, an identical pixel detecting and compression data specifying unit 242 detects the same pixel, and specifies one data block in which runs are continuous. The pixel data detected by the identical pixel detection and compression data specifying unit 242 is temporarily held at a pixel data holding unit 243. Under the instruction from the identical pixel detecting and compression data specifying unit 242, a run length compression flag generating unit 244 generates a run length compression flag (Comp) according to whether or not runs are continuous. With respect to the flag generated at the run length compression flag (Comp) generating unit 244, a unit header generating unit 245 generates a unit header collected in units of 4 change points (data blocks).

When the data block runs specified by the identical pixel detecting and compression data specifying unit 242 are continuous, a run counter extension flag generating unit 246 generates a counter extension flag (Ext), and a run counter generating unit 247 generates a counter (Counter). If the number of run continuities exceeds a predetermined value, a run extension counter generating unit 248 further generates an extended counter (Counter(Ext)).

When the end of line is detected, an end-of-line code generating unit 249 generates an end-of-line code E. A memory 250 organizes the data generated at the generating units each and data contained in the pixel data holding unit 243. A compression data packing and outputting portion 251 packs compression data, and outputs sub-picture compression data from an output terminal.

In an encoding method of the sub-picture encoder according to the present embodiment, even for sub-picture image data for 1-pixel, 4-bit expression (16 colors) for which run discontinuity last comparatively long, in the case where pixel data is not continuous, a counter is not used. Thus, an increase of data length does not occur. In addition, even when run continuity lasts longer than a predetermined number, such continuity can be reliably reproduced by using an extension counter (Counter(Ext)). Therefore, sufficient compression effect can be achieved by function of these run length compression flag (Comp), a basic counter (Counter), an extension counter (Counter(Ext)), or a counter extension flag (Ext) and the like. This run length compression flag (Comp) is collected as 4-bit expression (or its multiple), and then, is allocated at the beginning of data train. In this manner, a mode in which decoding processing can be easily carried out using 4-bit information is employed, thereby making it possible to improve a decoding processing speed.

The end-of-line code E generated at the end-of-line code generating unit 249 is not always required for encode/decoding processing if the number of pixels for one line is predetermined. That is, even if the end-of-line position is not identified, the number of pixels is counted from a start position, thereby making it possible to process sub-picture image data on a line by line basis to be encoded or decoded.

Now, the above described sub-picture decoder 228 will be described with reference to FIG. 113. FIG. 113 is a block diagram showing an inside of the sub-picture decoder 228. In the figure, when sub-picture compression is input from an input terminal, the bit data acquiring unit 251 acquires data on a 4-bit by 4-bit basis. With respect to the acquired data, first, a unit head detecting and separating unit 252 detects and separates the unit head 4 bits (run length compression flag (Comp)) of the compression data provided as a unit. A run length compression flag detecting and discriminating unit 253 extracts the run length flag (Comp), and discriminates whether or not the runs are continuous at change points each. Subsequently, a pixel data acquiring and holding unit 258 temporarily holds the pixel data acquired at the bit data acquiring unit 251, and a pixel data output unit 259 feeds pixel data for 1 pixel, and outputs 1-pixel data. Then, at the run length compression flag detecting and discriminating unit 253, if the run length compression flag (Comp) is true (=1: Continuous), the first 1 bit of the data then acquired at the bit data acquiring unit 251 is acquired at a run counter extension flag detecting and discriminating unit 254, and the subsequent 3-bits are acquired at a run counter acquiring unit 255.

At this time, at the run counter flag detecting and discriminating unit 254, if the counter extension flag (Ext) is true (=1: Extended), the data then acquired at the bit data acquiring unit 251 is combined with a 3-bit run counter of the run counter acquiring unit, at a run extension counter acquiring and combining unit 256, and the number of run continuities is represented as a 7-bit run counter. The pixel data held at the pixel data acquiring and holding unit 258 fed to the pixel data output unit-259 based on the acquired 3-bit or 7-bit counter, and the remaining pixel data is output as sub-picture extension data to an output terminal. If the run length compression flag (Comp) is true (=1: Continuous) and if the counter including the run counter extension flag is 0 at the run counter extension flag detecting and discriminating unit 254 and the run counter acquiring unit 255, an end-of-line code detector 257 detects the end of line, and completes decoding of this line.

In the decoding method of the sub-picture decoder according to the present embodiment, even in the case of sub-picture image data for 1-pixel, 4-bit expression (16 colors) for which run discontinuity lasts comparatively significantly, sufficient compression effect can be achieved by the function of the run length compression flag (Comp), basic counter (Counter), extension counter (Counter(Ext), counter extension flag (Ext) and the like. This run length compression flag (Comp) is collected as 4-bit expression (or its multiple), and is allocated at the beginning of data train. In this manner, a mode in which decoding processing can be easily carried out using 4-bit information is taken, thereby making it possible to improve a decoding processing speed.

As is the case of encoding processing, the end-of-line code E detected at the end-of-line code detector 257 is not always required for encoding/decoding processing. If the number of pixels per line is predetermined, decoding processing can be carried out on a line by line basis according to the number of pixels.

Now, a description will be given with respect to an example of data structure compressed or decompressed by the encoding/decoding method according to the present embodiment.

FIG. 114 shows a run length compression rule (on a line by line basis) for 3-bit, 8-color expression in 4-bit data.

A basic data structure comprises a 1-bit run length compression flag (Comp) (d0) indicating the presence or absence of run continuity, 3-bit pixel data (d1 to d3) indicating run pixel data, a 1-bit counter extension flag (Ext) (d4) indicating the presence or absence of counter extension when run length compression flag (Comp)=1 (present), 3-bit counter (Counter) (d5 to d7) for continuous runs, and 4-bit extension counter (Counter(Ext)) (d8 to d11) which is utilized as a 7-bit run counter by combining it with the 3-bit counter when the counter extension flag (Ext)=1 (present) The pattern shown in (a) of FIG. 114 can express 1-pixel data without run continuity, and the pattern shown in (b) of FIG. 114 can express 2 to 8 pixel data for which runs are continuous by using the counter (Counter). The pattern shown in (c) of FIG. 114 can express 9 to 128 pixel data for which runs are continuous by using the counter (Counter) and extension counter (Counter(Ext)). The pattern shown in (d) of FIG. 114 is provided as an end-of-line code E indicating the end of run length compression on a line by line basis.

The data structure of each of the patterns shown in (a) to (d) of FIG. 114 comprises 4-bit (nibble). Unlike FIG. 115, even if the data structure is provided as a unit, byte matching can be easily achieved, and a system can be constructed comparatively easily.

FIG. 115 is a view showing a run length compression rule (on a line by line basis) which is a base of the present embodiment. In this figure, a basic data structure comprises a 1-bit run length compression flag (Comp) (d0) indicating the presence or absence of run continuity, 4-bit pixel data (d1 to d4) indicating run pixel data, a 1-bit counter extension flag (Ext) (d5) indicating the presence or absence of counter extension when the run length compression flag (Comp)=1 (present), 3-bit counter (Counter (d6 to d8) for continuous runs, and 4-bit extension counter (Counter(Ext)) (d9 to d12) which is utilized as a 7-bit counter by combining it with the 3-bit counter when the counter extension flag (Ext)=1 (Present).

The pattern shown in (a) of FIG. 115 can express 1-pixel data without run continuity, and the pattern shown in (b) of FIG. 115 can express 2 to 8 pixel data for which runs are continuous by using the counter (Counter). The pattern shown in (c) of FIG. 115 can express 9 to 128 pixel data for which runs are continuous by using the counter (Counter) and extension counter (Counter(Ext)). The pattern shown in (d) of FIG. 115 is provided as the end-of-line code E indicating the end of run length compression on a line by line basis.

The data structure of each of the patterns shown in (a) to (d) of FIG. 115 comprises odd number bits. In this case, byte matching is not achieved, and a processing system is prone to be complicated.

FIG. 116 shows a practical data structure in the present embodiment. In the figure, in order to ensure that the data structure of each of the patterns shown in (a) to (d) of FIG. 115 comprises nibble (4-bits) so as to easily achieve byte matching, 4 run change points are provided as a unit, and 4 run length compression flags (Comp) are provided as 4-bit unit flags (f0 to d3) (refer to FIG. 109). By doing this, a system in which 4 run change points are provided as a unit, and byte processing can be easily carried out can be constructed comparatively easily.

FIG. 117 shows an example of unit of run length compression using the data structure provided as a unit shown in FIG. 116.

(1) First, subsequent data patterns are determined by 4-bit run length compression flags (Comp) (d0 to d3).

(2) When d0=0, the first run is found to be comprising one discontinuous pixel; the pattern shown in (a) of FIG. 116 is applied, and the subsequent pixel data (d4 to d7) are expanded.

(3) When d1=1, the second run is found to be continuous, and any of the patterns shown in (b) to (d) of FIG. 116 is applied. First, pixel data (d8 to d11) is held. Then, based on the fact that d12=0 and the number of counters (d13 to d15) is not 0 by the extension counter (Counter(Ext)) (d12), the pattern shown in (b) of FIG. 116 without the extension counter is produced. Then, the pixel data (d8 to d11) are expanded, and then, the pixel data (d8 to d11) whose number is equal to or smaller than 7, indicated by the 3-bit counters (d13 to d15) are expanded.

(4) When d2=1, the third run is found to be continuous, and any of the patterns shown in (b) to (d) of FIG. 1-16 is applied as in (3). First, pixel data (d16 to d19) is held. Then, by the run length compression flag (Comp) (d20), when d20=1, the pattern shown in (c) of FIG. 116 is produced. Then, by combining the counter (Counter) (d21 to d23) and extension counter (Counter(Ext)) (d24 to d27), the pixel data (d16 to d19) are expanded. Subsequently, the pixel data (d16 to d19) whose number is equal to or smaller than 127 indicated by the 7-bit counter (d21 to d27) are expanded.

(5) When d3=0, the last run comprises one discontinuous pixel, the pattern shown in (a) of FIG. 116 is applied, and the subsequent pixel data (d28 to d31) are expanded.

In this manner, 4 change points are provided as one unit, and run length expansion is carried out.

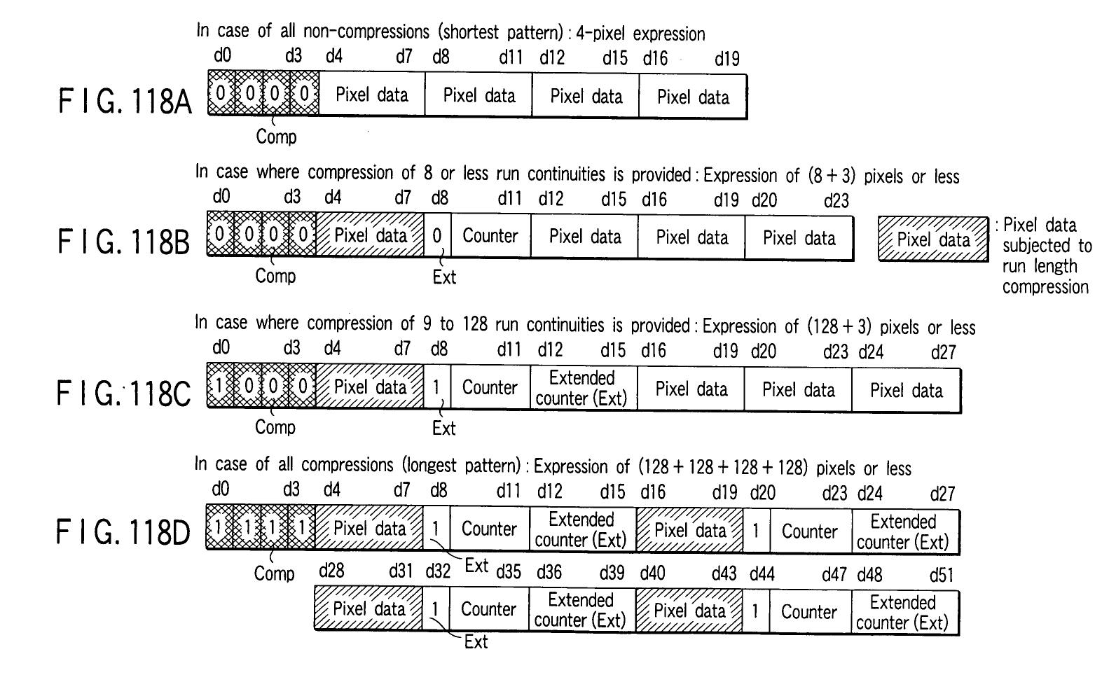

FIG. 118 shows an example of unit of the run length compression rule according to the present embodiment.

In FIG. 118A, there is shown a case of all non-compressions, wherein 4-pixel pixel data is expressed intact. In FIG. 118B, run continuity of 8 pixels or less and 3-pixel, non-compression pixel data are expressed intact. In FIG. 118C, run continuity of 128 pixels or less and 3-pixel, non-compression pixel data are expressed. In FIG. 118D, there is shown a case of all compressions, wherein pixel data on run continuity of four 128 pixels or less (a maximum of 512 pixels) are expressed.

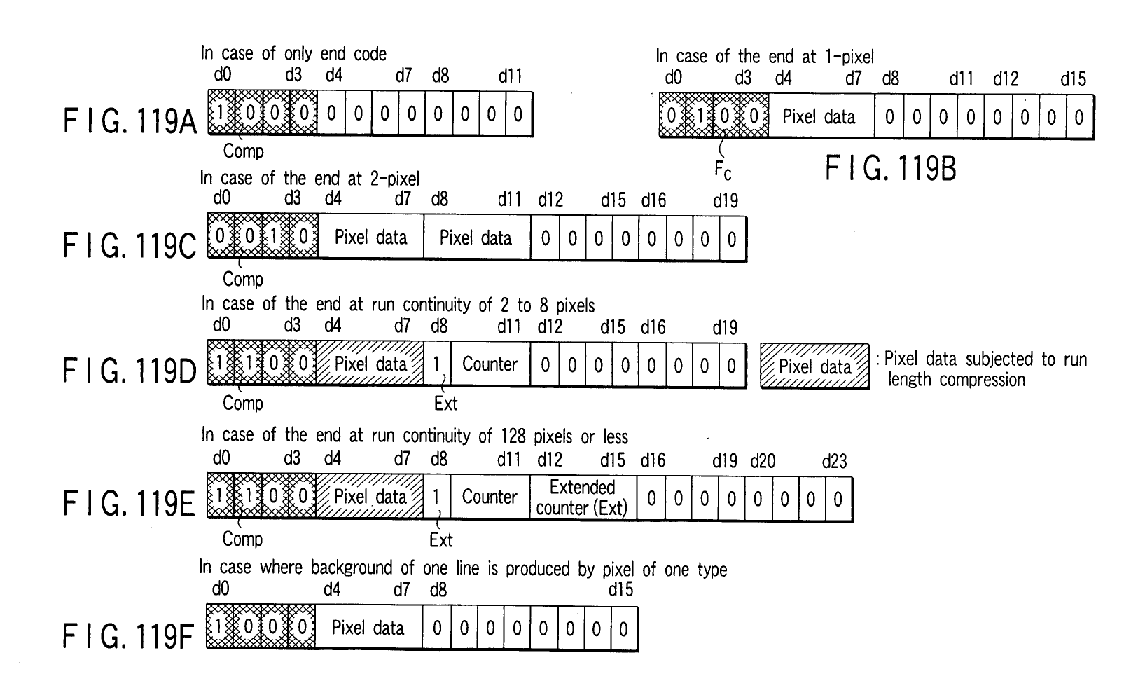

FIGS. 119A to 119F show an example of unit having an end code E indicating the end of line in the run length compression rule according to the present embodiment. The figure also shows an example of unit having a background code. The unit is ended by inserting the end code E, and the run length compression flag (Comp) in the subsequent unit is ignored. In FIG. 119A, there is shown an example of unit comprising only the end code E. In FIG. 119B, there is shown an example of unit comprising one pixel and the end code E. In FIG. 119C, there is shown an example of unit comprising 2 pixels and the end code E. In FIG. 119D, there is shown an example of unit comprising run continuity of 2 to 8 pixels and the end code E. In FIG. 119E, there is shown an example of unit comprising run continuity of 128 pixels or less and the end code E. In FIG. 119F, there is a view showing an example when the background code is used.

In FIG. 119F, there is shown a case in which the data train equal to that shown in FIG. 119B is provided, the number of pixels per line is determined, and no end code is used. In this case, the background code “00000000” is used. That is, with respect to one line, when a background image is produced using all the identical image data, one item of pixel data is placed after the unit of run length compression flag (Comp); and thereafter, a background code is placed, the background code denoting that one line is the identical background image, thereby making it possible to display the image. The background image is thus displayed and encoded, and accordingly, a background image according to one item of pixel data is decoded, thereby making it possible to compress or decompress the background image at a high compression rate.

FIG. 120 shows another pattern of the run length compression rule (on a line by line basis) which is a basic pattern shown in FIG. 115. The data structure comprises 1-bit run length compression flag (Comp) (d0) indicating the presence of absence of run continuity, a 1-bit counter extension flag (Ext) (d1) indicating the presence of absence of counter extension when the run length compression flag (Comp)=1 (present), a continuous run 3-bit counter (Counter) (d2 to d4), a 4-bit extension counter (Counter(Ext)) (d5 to d8) which is utilized as a 7-bit counter by combining it with the 3-bit counter when the counter extension flag (Ext)=1 (present), and 4-bit pixel data ((a) d1 to d4, (b) d5 to d8, and (c) d9 to d12) indicating run pixel data according to each of the patterns shown in (a) to (c) of FIG. 120.

As in FIG. 115, the pattern shown in (a) of FIG. 120 can express 1-pixel data without run continuity, and the pattern shown in (b) of FIG. 120 can express 2 to 8 pixel data for which runs are continuous by using the counter. In addition, the pattern shown in (c) of FIG. 120 can express 9 to 128 pixel data for which runs are continuous by using the counter (Counter) and extension counter (Counter(Ext)). The pattern shown in (d) of FIG. 120 is provided as the end-of-line code E indicating the end of run length compression on a line by line basis.

The encoding/decoding method according to the present embodiment can be widely applied to general digital data processing as well as the encoder and decoder of the above described disk apparatus. Therefore, the similar operation and advantageous effect are achieved by using the similar procedures by way of a microcomputer and a computer program for supplying an instruction to the microcomputer. Now, the encoding/decoding method according to the present embodiment will be described in detail in accordance with a flow chart.

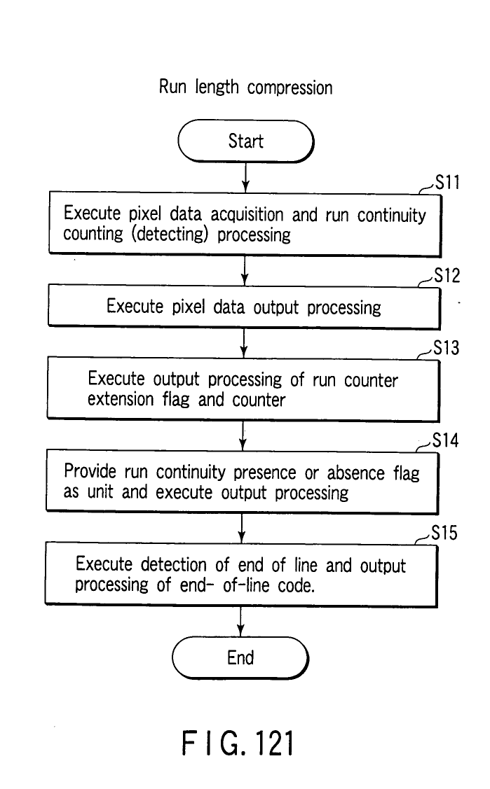

FIG. 121 shows a basic flow chart of encoding (compression) of the run length compression rule (on a line by line basis) according to the present embodiment. In FIG. 121, referring to the basic flow of encoding processing (compression) according to the present embodiment, first, pixel data is acquired, and processing for counting (detecting) continuous runs is carried out (S11). Then, processing for outputting pixel data is carried out (S12). Then, processing for outputting the counter extension flag (Ext) and counter (Counter) is carried out (S13). Then, processing for providing the run length compression flag (Comp) as a unit and outputting the provided flag is carried out (S14). Then, processing for detecting the end of line and outputting the end-of-line code E is carried out, whereby the encoding processing is executed (S15).

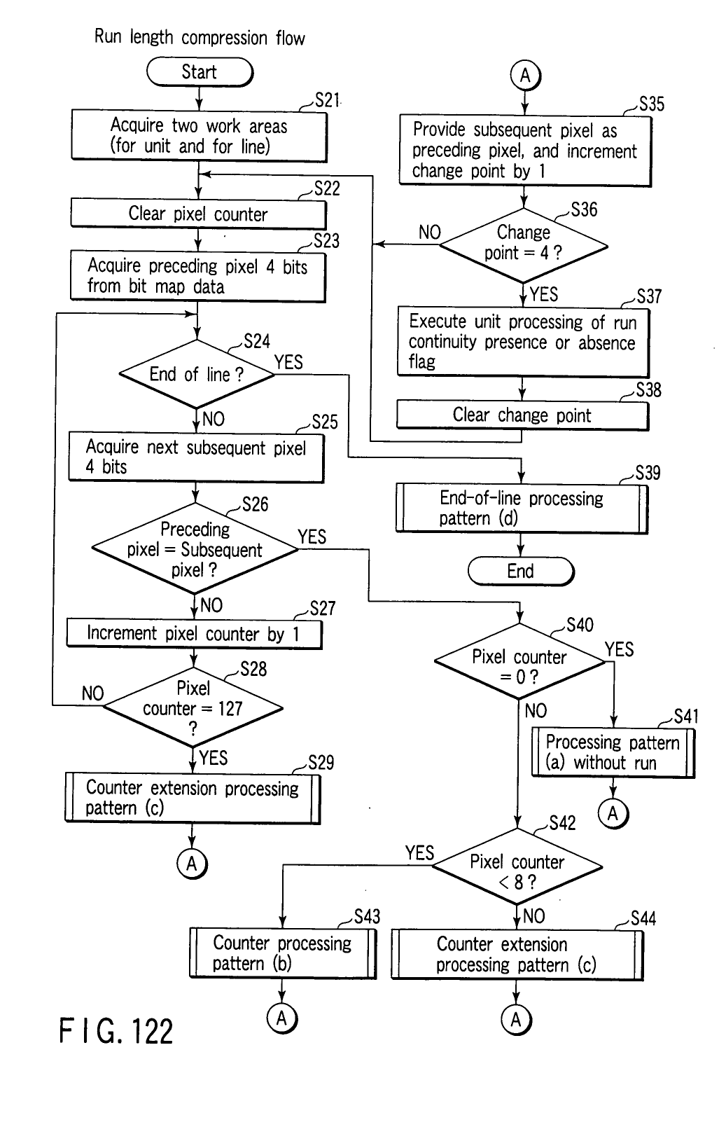

Now, a detailed description of these processes will be given with reference to the accompanying drawings. FIGS. 122 to 125 each show a detailed flow chart of the flow chart shown in FIG. 121. FIG. 122 is a main flow chart. In FIG. 122, two work areas for unit and line are allocated (S21). A pixel counter is 0-cleared (S22). The preceding 4 bits are acquired from bit map data (S23). It is determined whether or not the end of line is reached (S24). If the check result is NO, the next subsequent 4-bit pixels are acquired (S25). It is determined whether or not the preceding pixels are equal to the subsequent pixels (S26). If the check result is NO, the pixel counter carries out counting by adding +1 (S27). It is determined whether or not pixel counter=127 (S28). If the check result is YES, processing of the counter extension processing pattern (c) is executed (S29).

If the check result is YES in step S26, it is determined whether pixel counter=0 (S40). If the check result is YES in step S40, processing of run free processing pattern (a) without run is executed (S41). If it is NO, it is determined whether pixel counter<8 (S42). If it is YES, processing of counter processing pattern (b) is executed (S43). If the check result is NO in step S42, processing of counter extension processing pattern (c) is executed (S44).

After processing of step S29, step S41, step S43, and step S44, the subsequent pixels are defined as the preceding pixels, and the change point is counted by adding+1 (S35). It is determined whether or not the change point=4 (S36). If the check result is YES, the unit processing of the run length compression flag (Comp) is executed (S37). The change point is 0-cleared, processing returns to step S22 in which processing is continued (S38).

In step S24, if the check result is YES, processing of the end-of-line processing pattern (d) is executed, and compression processing is ended (S39). In step S36, if the check result is NO, processing returns to step S22 in which processing is continued.

In this manner, basic processing of the run length compression is carried out.

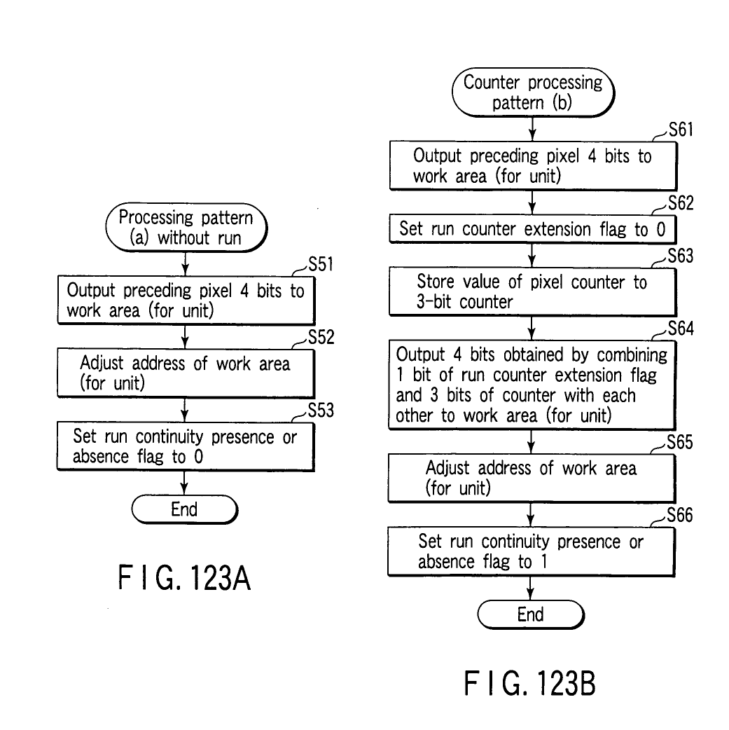

In FIG. 123A, there is shown processing of a run free processing pattern (a). As shown in the figure, the preceding pixel 4 bits are output to a work area (for unit) (S51). The address of the work area (for unit) is adjusted (S52). The run length compression flag (Comp) is set to “0,” whereby processing of the run free processing pattern (a) is carried out (S53).

In FIG. 123B, there is shown processing of a counter processing pattern (b). As shown in the figure, the preceding pixel 4 bits are output to the work area (for unit) (S61). The run counter extension flag is set to “0” (S62). The value of the pixel counter is stored in a 3-bit counter (S63). 4 bits obtaining by combining 1 bit of run counter extension flag and 3 bits of counter are output to the work area (for unit) (S64). The address of the work area (for unit) is adjusted (S65). The run length compression flag (Comp) is set to “1” (S66).

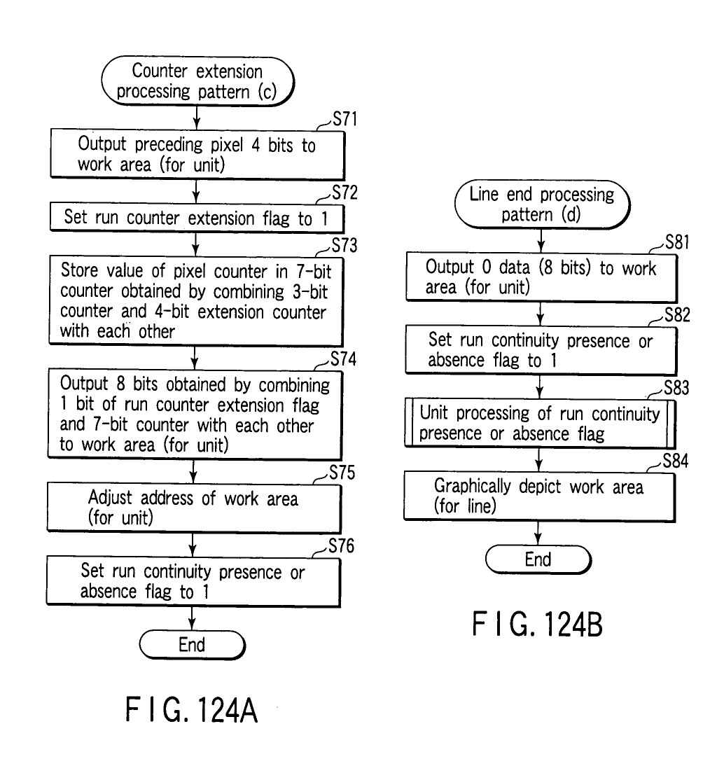

In FIG. 124A, there is shown processing of a counter extension processing pattern (c). As shown in the figure, the preceding pixel 4 bits are output to the work area (for unit) (S71). The run counter extension flag is set to “11” (S72). The value of the pixel counter is stored in a 7-bit counter obtained by combining a 3-bit counter and 4-bit extension counter (S73). 8 bits obtained by combining 1 bit of run counter extension flag and 7 bits of counter are output to the work area (for unit) (S74). The address of the work area (for unit) is adjusted (S75). The run length compression flag (Comp) is set to “1” (S76).

In FIG. 124B, there is shown processing of an end-of-line processing pattern (d). As shown in the figure, 0 data (8 bits) are output to the work area (for unit) (S81). The run length compression flag (Comp) is set to “1” (S82). Processing for providing the run length compression flag (Comp) as a unit is executed (S83). A work area (for line) is graphically depicted (S84).

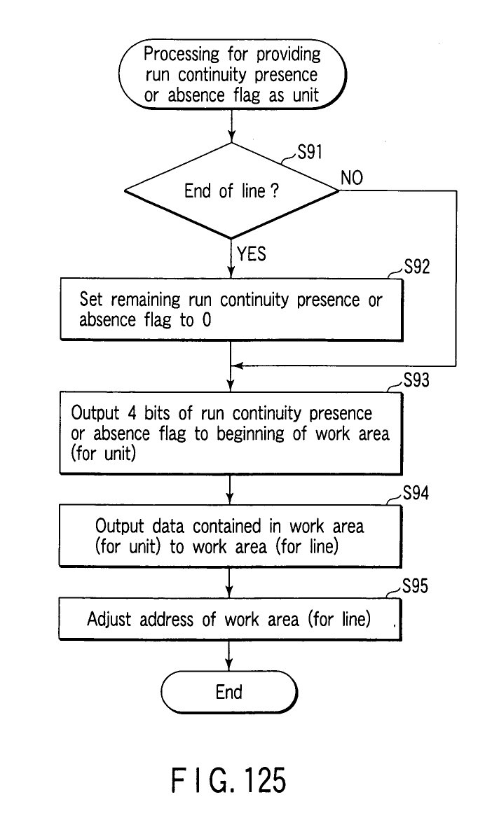

FIG. 125 shows processing for providing a run length compression flag (Comp) as a unit. As shown in the figure, it is determined whether or not the end of line is reached (S91). If the check result is YES, the remaining run length compression flag (Comp) is set to “0” (S92). 4 bits of the run length compression flag (Comp) are output at the beginning of the work area (for unit) (S93). The data in the work area (for unit) is output to the work area (for line) (S94). The address of the work area (for line) is adjusted (S95). In step S91, if the check result is NO, processing goes to step S93.

In accordance with such procedures, the encoding method according to the present embodiment is carried out. Based on the spirit equivalent to the above described encoder unit, sufficient compression effect is achieved by using a flag or the like, with respect to image data of high bit expression in which run discontinuity frequently occurs.

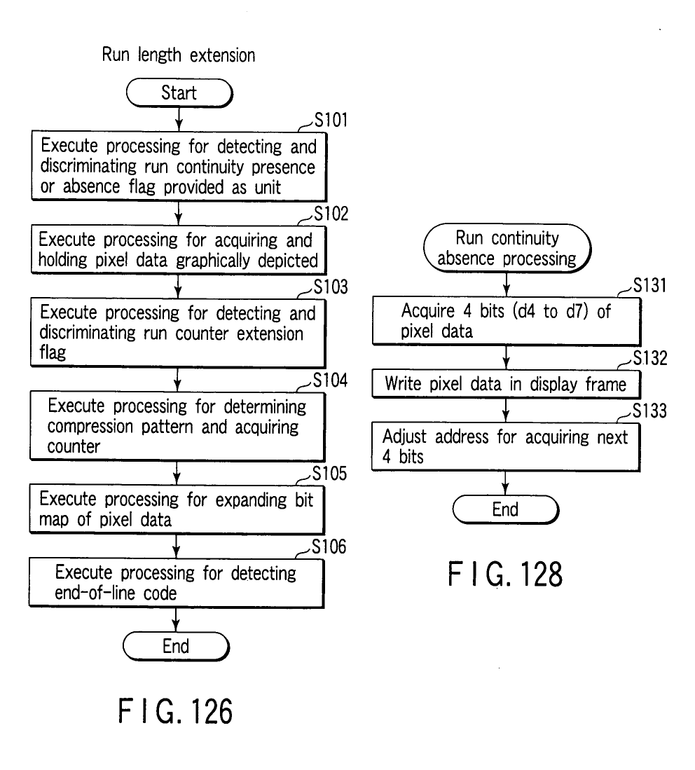

Now, the decoding method according to the present embodiment will be described in detail with reference to a flow chart. FIG. 126 shows a basic flow chart for decoding (decompressing) the run length compression rule (on a line by line basis) according to the present embodiment. As shown in the figure, in the basic flow of decompression, processing for detecting run continuity flag provided as a unit and discriminating the flag is carried out (S101). Then, processing for acquiring and holding pixel data to be graphically depicted is carried out (S102). Then, processing for detecting a run counter extension flag and discriminating the flag is carried out (S103). Then, processing for determining compression pattern shown in FIG. 116 and acquiring a counter is carried out (S104). Processing for expanding pixel data in a bit map is carried out (S105). Then, processing for detecting an end-of-line code is carried out, whereby decoding processing is executed (S106).

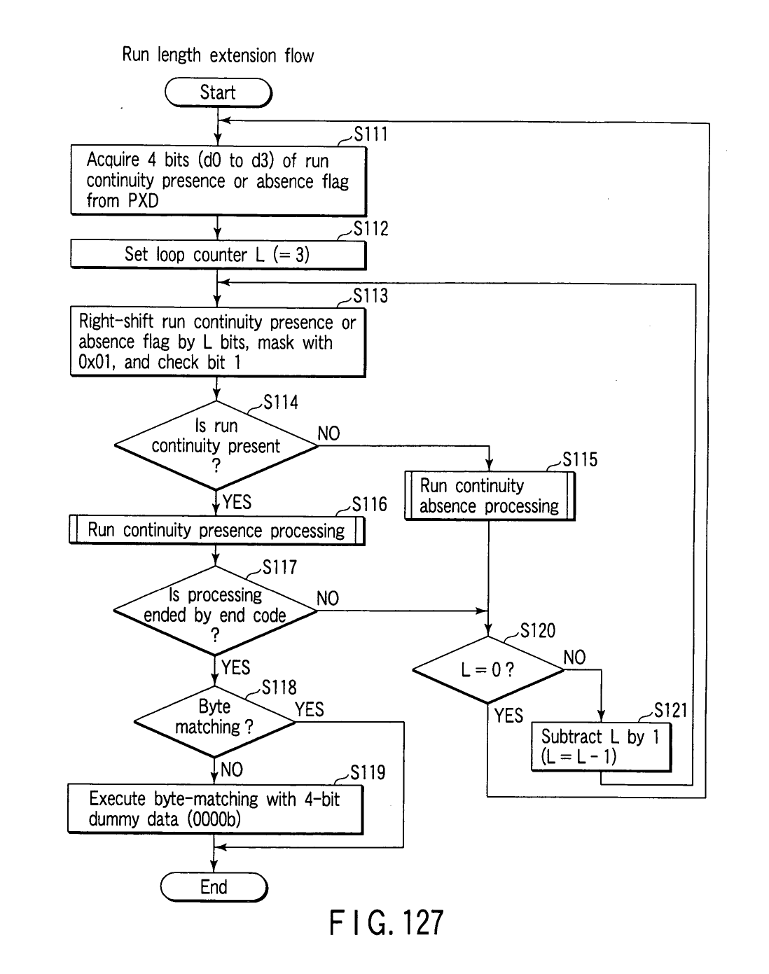

FIGS. 127 to 129 each show a detailed flow chart of the flow chart shown in FIG. 126. FIG. 127 is a main flow. As shown in the figure, in accordance with the run length compression rule according to the present embodiment, 4 bits (d0 to d3) of the run length compression flag (Comp) are acquired from coded pixel data PXD which is a first unit (S111). A loop counter L (=3) is set (S112). The run length compression flag (Comp) is L-bit right-shifted; the shifted flag is masked with “0×01b,” and bit “1” is checked (S113). It is determined whether or not run continuity exists (run length compression flag (Comp)=“1”) (S114). If the check result is NO, processing without run continuity is executed (S115). If the check result is YES, processing with run continuity is executed (S116).

After step S116 has been executed, it is determined whether or not the end of line is reached with an end code (S117). After step S115 has been executed or if the check result is NO in step S117, it is determined whether or not the loop counter L=“0” (S120). If the check result is NO, L carries out counting by subtracting “1” (L=L−1), and processing returns to step S113 (S121). In step S120, if the check result is YES, processing returns to step S111 in which a next unit is acquired.

In step S117, if the check result is YES, it is determined whether or not byte matching is achieved (S118). In step S118, if the check result is NO, byte matching is carried out with 4-bit dummy data “0000b,” and decoding on a line by line basis is ended (S119). In step S118, if the check result is YES, decoding on a line by line basis is ended.

FIG. 128 shows a processing routine without run continuity in step S115. As shown in the figure, 4-bits pixel data (d4 to d7) are acquired (S131). The acquired pixel data is written into a display frame (S132). An address is adjusted for the sake of the next 4-bit acquisition, and processing is ended (S133).

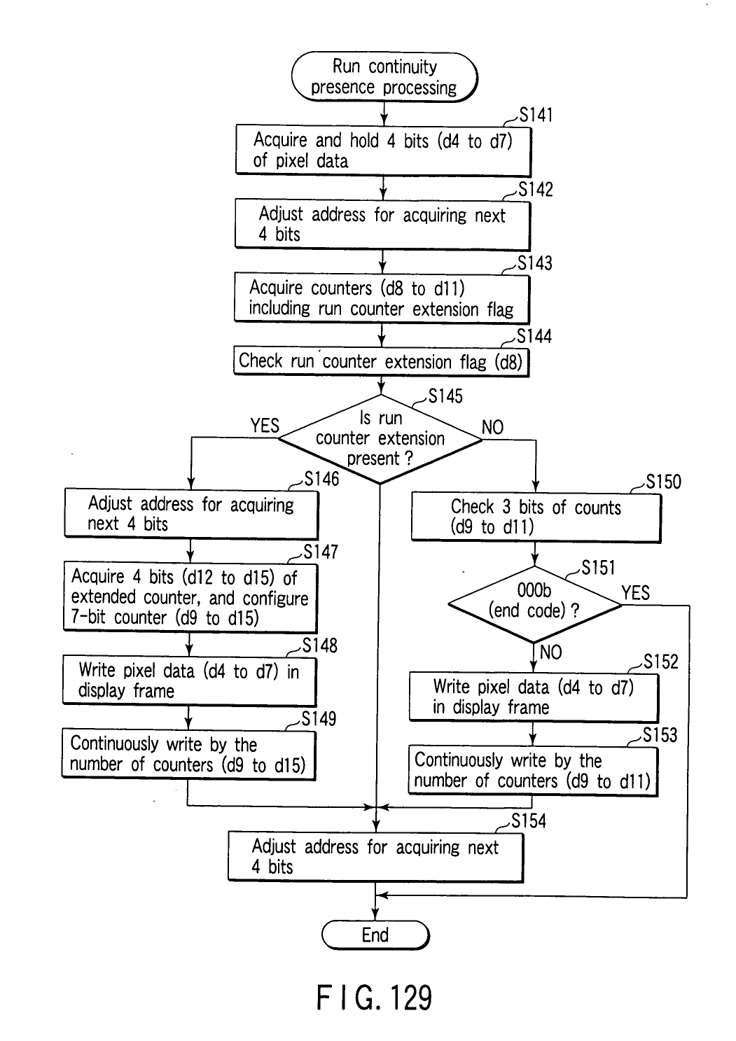

FIG. 129 shows a processing routine with run continuity in step S116. As shown in the figure, first, 4-bit pixel data (d4 to d7) are acquired (S141). An address is adjusted for the sake of the next 4-bit acquisition (S142). Counters (d8 to d11) including run counter extension flags are acquired (S143). The run counter extension flag (d8) is checked (S144). It is determined whether or not run counter extension exists (S145).

If the check result is YES, an address is adjusted for the sake of the next 4-bit acquisition (S146). 4-bit extension counters (d12 to d15) are acquired, and 7-bit counters (d9 to d15) are configured (S147). The pixel data (d4 to d7) acquired in step S141 are written into the display frame (S148). Further, pixel data is continuously written into counters (d9 to d15) according to the number of counters, and processing goes to step S154 (S149).

In step S145, if the check result is NO, the counter 3 bits (d9 to d11) are checked (S150). It is determined whether or not the end code is “000b” (S151). In step S151, if the check result is NO, the pixel data (d4 to d7) acquired in step S141 are written into the display frame (S152). Further, pixel data are continuously written into counters (d9 to d11) according to the number of counters, processing goes to step S154 (S153).

After steps S149 and S153 have been executed, an address is adjusted for the sake of the next 4-bit acquisition (S154). After step S154 has been executed or if the check result is YES in step S151, these processes are ended.

In accordance with such procedures, the decoding method according to the present embodiment is carried out. Based on the spirit equivalent to that of the above described decoder unit, sufficient compression effect can be also achieved by using a flag or the like, with respect to image data with high bit expression in which run discontinuity frequently occurs.

Although the encoding/decoding method according to the present embodiment has been described by way of example of the encoder unit and decoder unit for sub-picture of the disk apparatus, this method can be applied to general digital data which can be compressed, without being limited thereto.

As has been described above in detail, according to the present embodiment, the run length compression flag (Comp) has been provided, whereby, even in the case of sub-picture image data or the like for 1-pixel, 4-bit expression (16 colors) in which the frequency of run continuity of the same pixel is low, the overhead of data due to compression can be reduced to the minimum. In addition, the counter extension flag (Ext) has been provided, whereby there can be provided an encoding method and a decoding method in which sufficient compression effect is achieved with respect to the sub-picture data with high bit expression in which the frequency of run continuity is low; and these encoder and decoder units and a recording medium.

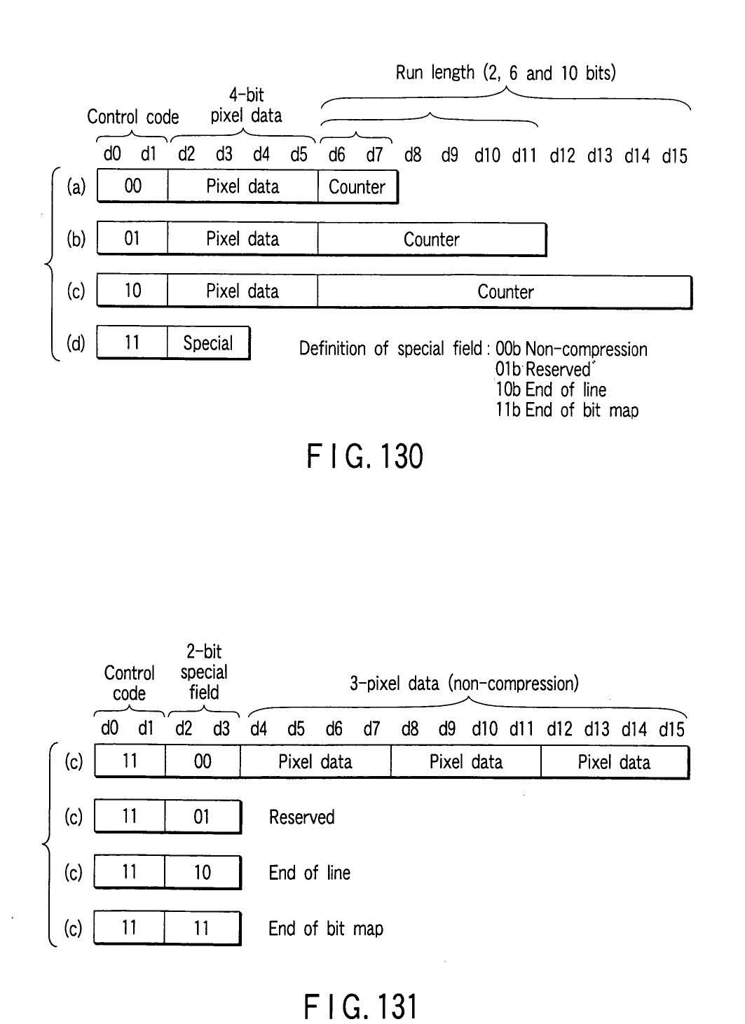

FIG. 130 shows another example of unit of the run length compression rule according to the present embodiment. Control codes d0 and d1 are provided, and the end of line and the end of bit map are specified. A run length of pixel data which follows is controlled with the 4-pattern control codes shown in (a) to (d). In a special field, if non-compression is carried out, “00b” is described; if reservation is specified, “01b” is described; if the end of line is reached, “10b” is described; and if the end of bit map is reached, “11b” is described. Pixel data is in 4 bits, and the run length is in any of 2, 6, and 10 bits.

In the case of control code=“11b,” it is interpreted as shown in FIG. 131 in accordance with the value of the special field. When the controls bits d0 and d1 are set to “11b,” if the value of the special field is “00b,” it denotes non-compression; if the value is “01b,” it denotes reservation; if the value is “10b,” it denotes the end of line; and if the value is “11b,” it denotes the end of bit map.

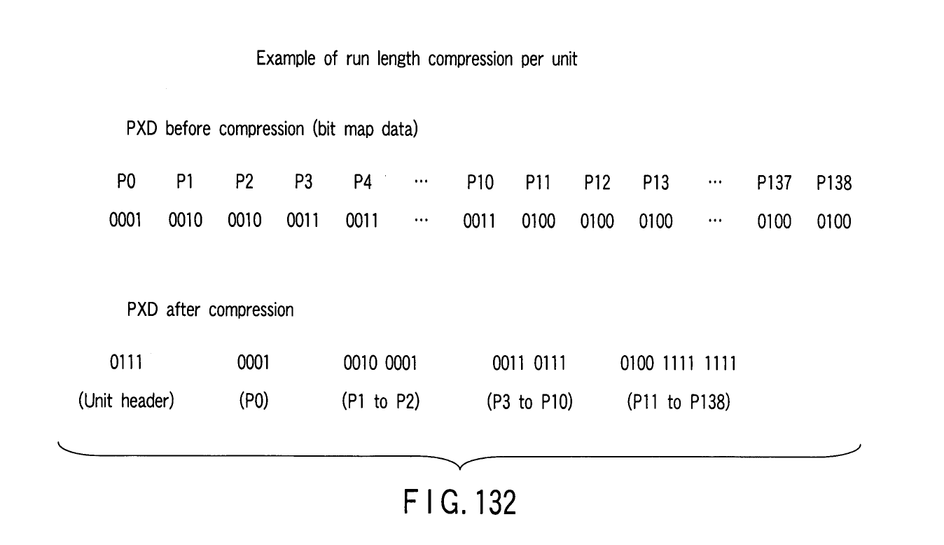

FIG. 132 shows an example of run length compression (pixel data before compression and pixel data after compression).

With respect to a sub-picture data display region, an arbitrary rectangular region can be set in a video display region. The sub-picture data display region is provided as an arbitrary rectangular region in the video display region, and is defined by a sub-picture line and pixel data. Pixel data is raw data or run length compression bit map data. The size of bit map data is equal to or greater than that of the sub-picture data display region. That is, the number of lines for pixel data from the line defined by a command SET_DSPXA to the end line of the field is equal to or greater than the number of sub-picture lines in a display region defined by the command SET_DSPXA with respect to top and bottom fields. This rule is applied even when the scroll of sub-picture data is executed by using the command SET_DSPXA.

The SP display region and bit map pixel data are associated with each other in three ways. In any case, the left limit of the bit map coincides with that of the display region.

Case 1: The bit map pixel data region and SP display region are identical in size.

Case 2: The bit map pixel data is greater than the SP display region in size (while they are identical to each other in width).

Case 3: The SP display region is aligned with the bit map pixel data region of different widths.

In any case, the widths of the display region and pixel data region must be equal to each other.

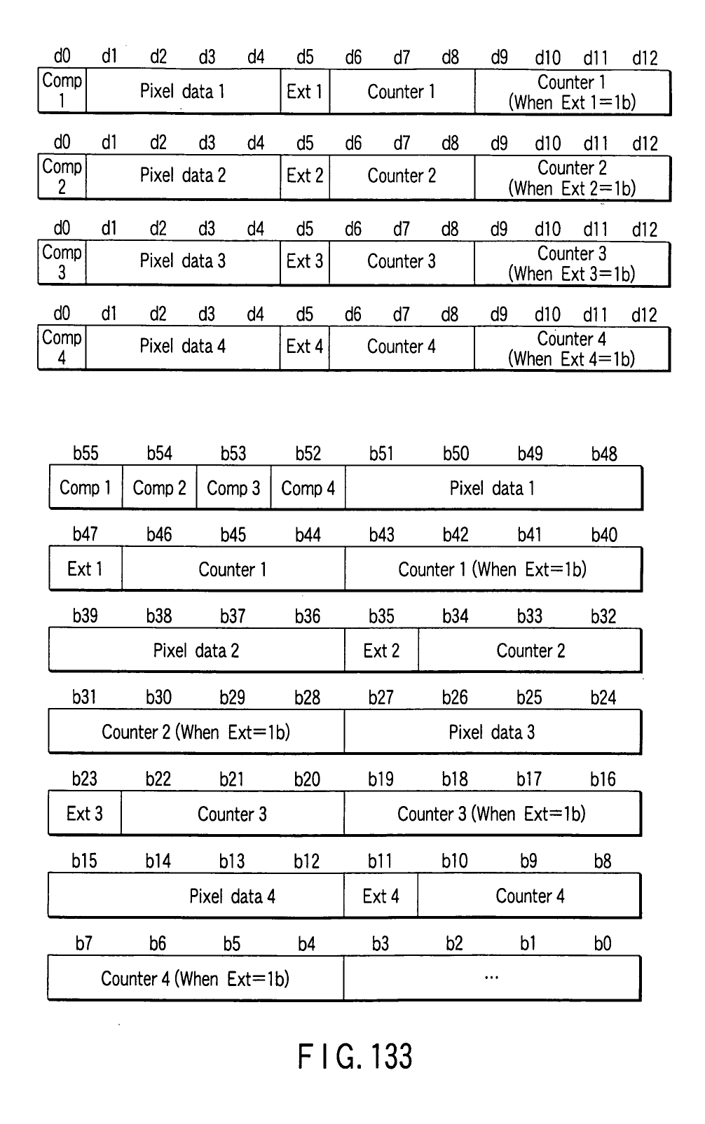

FIG. 133 shows another example of the run length compression. 4 compression data units configure one storage unit called a Quadra-unit. In order to configure the storage unit, run length compression flags (Comp) are collected, and the collected flags are allocated at the beginning of the unit. The remaining data such as pixel data, counter extension flag, counter, and extension counter are combined after the flag. When the last storage unit of pixel data in each line is not byte-matched, adjustment zero-data are inserted into bit number b3 to b0.

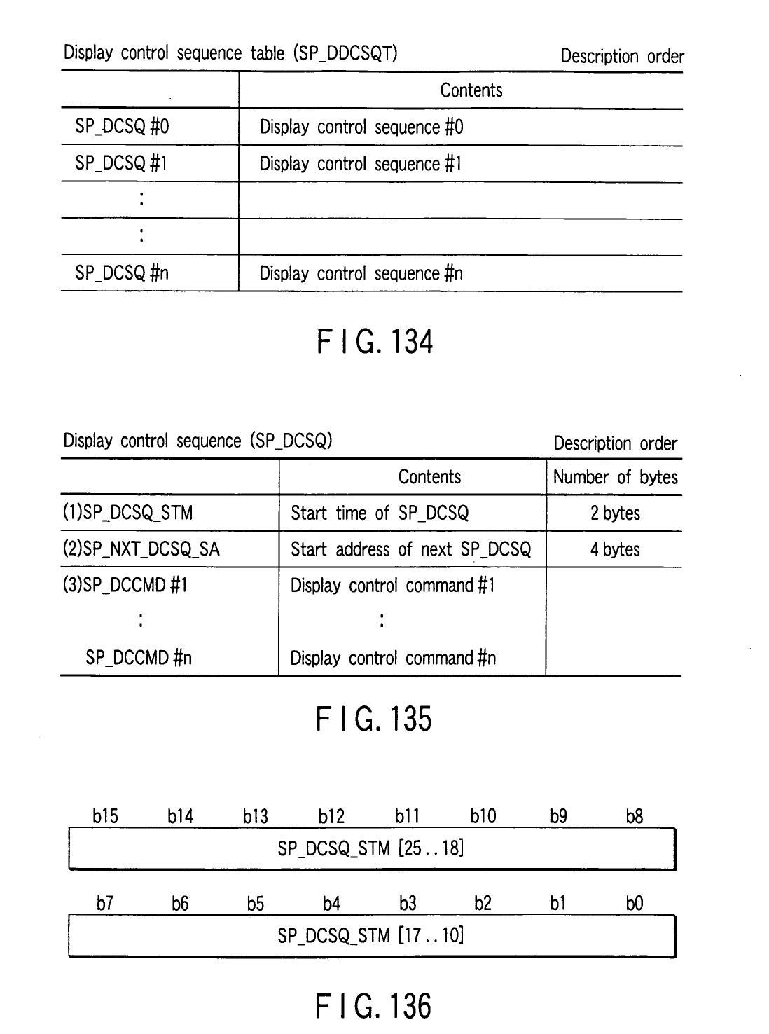

The display control sequence table SP_DCSQT is provided as a display control sequence for changing the display start/stop and attribute of sub-picture data in the validity period of the sub-picture unit SPU. As shown in FIG. 134, the display control sequences SP_DCSQ are described in order of executions. The display control sequences SP_DCSQ having the same execution time must not exist in the display control sequence table SP_DCSQT. One or more display control sequences SP_DCSQ must be described in the sub-picture unit.

Each display control sequence SP_DCSQ, as shown in FIG. 135, describes a start time SP_DCSQ_STM of a 2 byte display control sequence SP_DCSQ, a start address SP_NXT_DCSQ_SA of the next 4-byte display control sequence, and one or more display control commands SP_DCCMD.

The start time SP_DCSQ_STM of the display control sequence describes an execution start time of a SP display command SP_DCCMD described in the display control sequence SP_DCSQ in relative PTM from PTS described in SP_PKT. From the first top field after the described execution start time, the display control sequences are disclosed in accordance with the display control sequence SP_DCSQ.

The start time SP_DCSQ_STM in the first display control sequence SP_DCSQ (SP_DCSQ#0) must be “0000b.” The execution start time must be PTS or more recorded in the SP packet header. Therefore, the start time SP_DCSQ_STM of the display control sequence must be “0000b” or a positive integer value calculated below.

SP_{—}DCSQ_{—}STM [25 . . . 10]=(225×n)/64

where 0≦n≦18,641 (625/50 in the case of SDTV system)

SP_{—}DCSQ_{—}STM [25 . . . 10]=(3,003×n)/1,024;

where 0≦n≦22,347 (525/60 in the case of SDTV system)

SP_{—}DCSQ_{—}STM [25 . . . 10]=(225×n)/64

where 0≦n≦18,641 (in the case of HDTV system)

In the above formula, the sign “n” denotes a video frame number after SPU's PTS. n=0 denotes a video frame of time PTS. The sign “/” denotes integer division by dropping the fractional portion of the number.

The last PTM in SPU must be PTS or less described in the SP packet including the next SPU. The last PTM is defined as shown in FIG. 136.

Last PTM_SPU#i=PTM_SPU#i+SP_DCSQ_STM last SPDCSQ+1 video frame period

The start address SP_NXT_DCSQ_SA of the next display control sequence describes a start address of the next display control sequence SP_DCSQ in the relative byte number RBN from the start byte of SPU. When the next display control sequence SP_DCSQ does not exist, the start address of this display control sequence SP_DCSQ is described in RBN from the start byte of SPU.

SP_DCCMD#n describes one or more display control commands SP_DCCMD executed in this display control sequence SP_DCSQ. The same display control command SP_DCCMD must not be described two or more times.

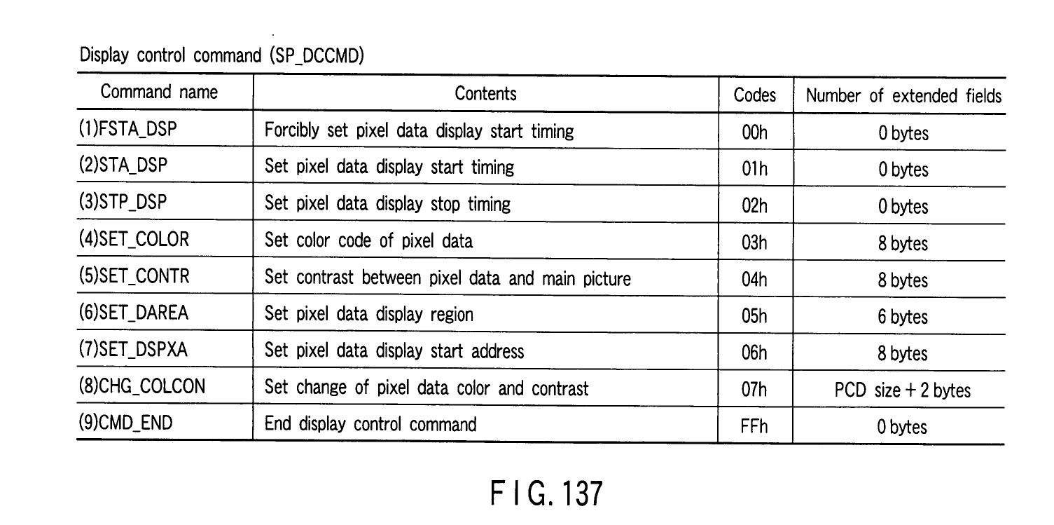

The display control command SP_DCCMD, as shown in FIG. 137, comprises a pixel data forced display start timing set command FSTA_DSP, a pixel data display start timing set command STA_DSP, a pixel data display end timing set command STP_DSP, a pixel data color code set command SET_COLOR, a pixel data to main picture contrast ratio set command SET_CONTR, a pixel data display region set command SET_DAREA, a pixel data display start address set command SET_DSPXA, a pixel data color change and contrast change set command CHG_COLCON, and a display control command end command CMD_END.

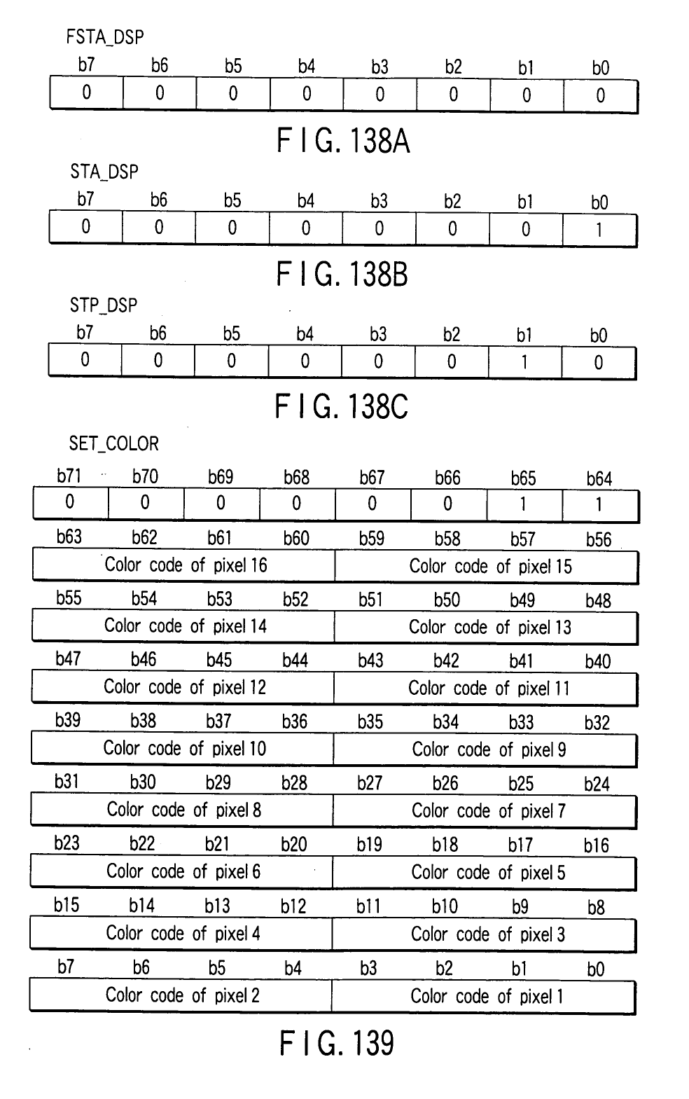

The command FSTA_DSP is provided as a command for forcibly starting display of a sub-picture unit irrespective of whether or not the display state of sub-picture data is turned ON/OFF. As shown in FIG. 138A, the code is set to “00h.” The command STA_DSP is provided as a command for starting display of a sub-picture unit. As shown in FIG. 138B, the code is set to “01h.” This command is ignored when the display state of sub-picture data is turned OFF.

The command STP_DSP is provided as a command for stopping display of a sub-picture unit. As shown in FIG. 138C, the code is set to “02h.” Sub-picture data is redisplayed by the command STA_DSP.

The command SET_COLOR for setting the color of each pixel for pixel data is shown in FIG. 139. The code of this command is set to “03h.” The pallet code of each pixel is described in an extension field. When this command does not exist in the display control sequence SP_DCSQ, each pixel color holds the last SET_COLOR value set by the preceding display control sequence SP_DCSQ in this SPU. This command sets the color at the beginning of each line.

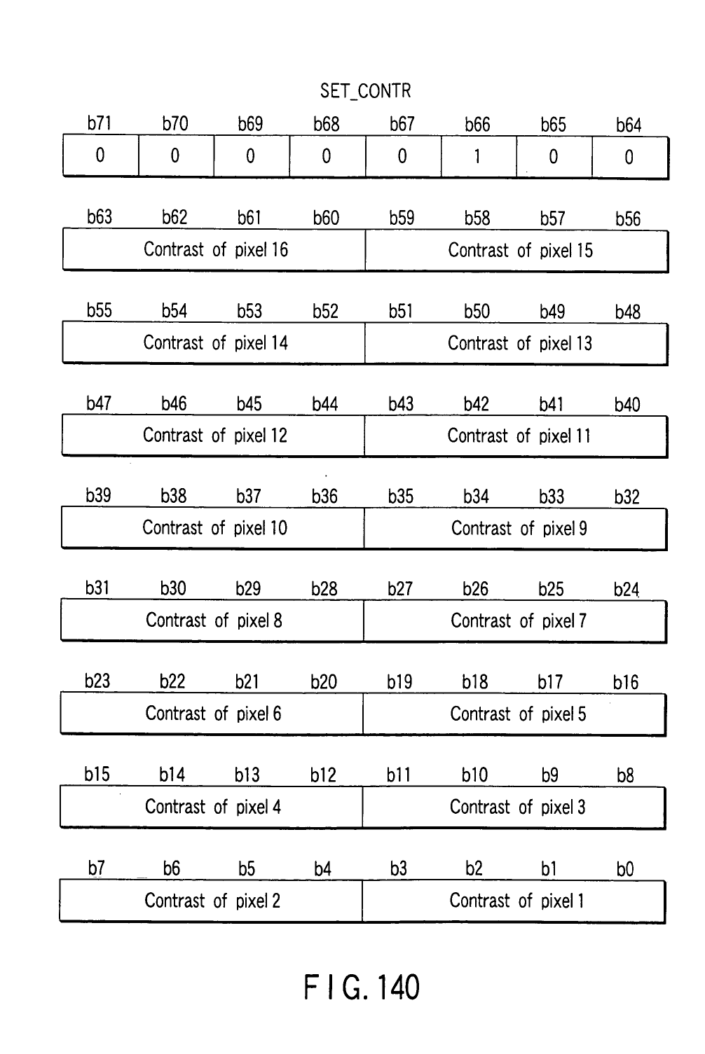

FIG. 140 shows a command SET_CONTR for setting a mixture rate between each pixel and main picture of pixel data. The code of this command is set to “04h.” The contrast of each pixel is described in an extension field. The contrast is defined as follows with respect to description.

Contrast: Main picture=(16−k)/16, sub-picture=k/16

When the described value is “0,” k=described value.

When the described value is not “0,” k=described value+1.

When this command does not exist in the display control sequence SP_DCSQ, the mixture rate holds the last SET_CONTR value defined by the preceding display control sequence SP_DCSQ in this SPU. This command determines the contrast of the beginning of each line.

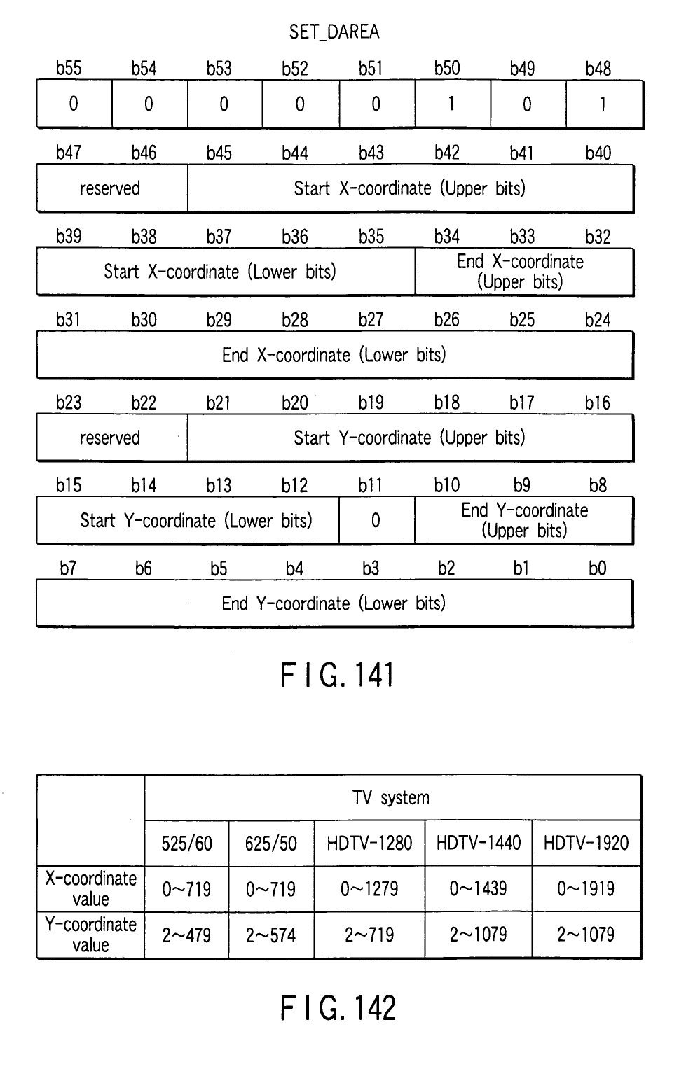

FIG. 141 shows a command SET_DAREA for setting a pixel data display region as one rectangle. The code of this command is set to “05h.” The X and Y coordinates of the start/end points in the rectangular display region are described in an extension field. The number of pixels displayed on one line (end point X coordinate−start point X coordinate+1) must be equal to the number of pixels on one line of bit map data encoded as PXD.

The origin of the Y coordinate is “0” in the number of sub-picture lines as shown in FIG. 142. The origin of the X coordinate is set as a start point of “0” in the number of sub-picture lines as shown in FIG. 142. The ranges of the X coordinate and Y coordinate differ from each other dependent on a variety of TV systems, as shown in FIG. 142. The detail of the scope of the valid SP line number is defined by extension of SP active interval. When this command exists in the display control sequence SP_DCSQ, the display region holds the last SET_DAREA value set by the preceding display control sequence SP_DCSQ in this SPU.

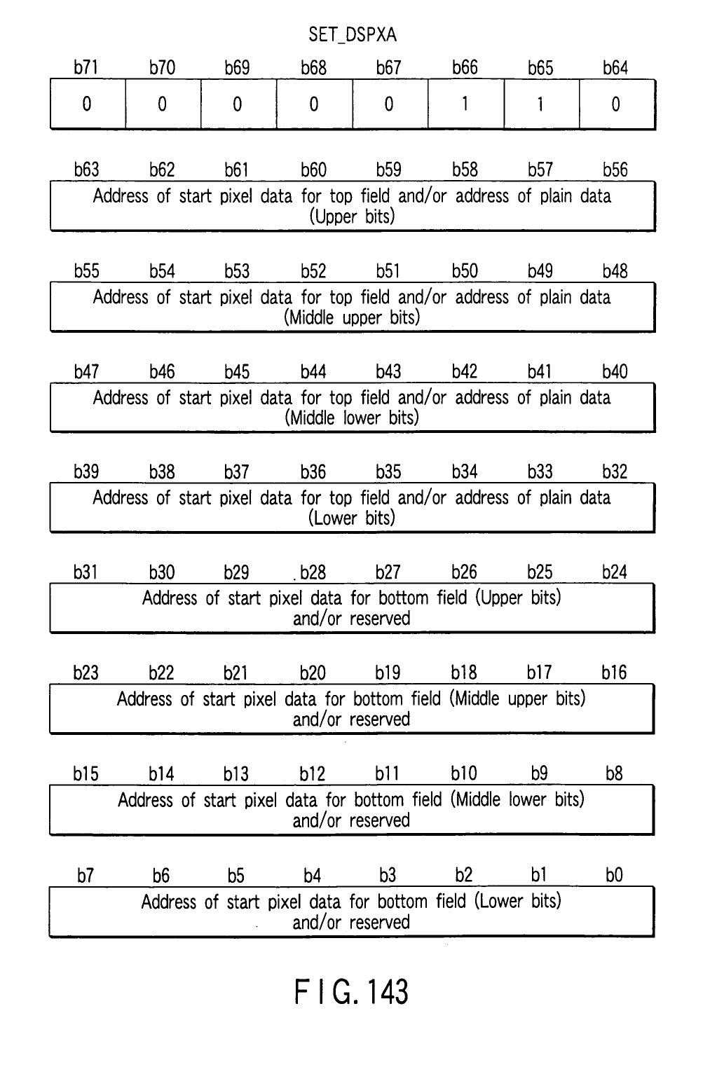

FIG. 143 shows the command SET_DSPXA for setting the start address of pixel data used for display. The code of this command is set to “06h.” If the storage flag “Stored_Form” is set to “0b” (top/bottom is specified), the addresses of start pixel data for top and bottom fields are described in an extension field in the relative byte number from the start byte of a sub-picture unit. When the same data is used in the top and bottom fields, the same address is described. If the storage flag “Stored_Form” is set to “1b” (“Plan” is specified), the plain data address is described in the extension field in relative byte number from the start byte of a sub-picture unit. When this command does not exist in the display control sequence SP_DCSQ, the pixel data contained in the display region holds the last SET_DSPXA value set by the preceding display control sequence SP_DCSQ in this sub-picture unit.

A portion of pixel data specified by SET_DSPXA [63 . . . 32] must be decoded as sub-picture line numbers (Ystart, Ystart+2, Ystart+4, . . . ). A portion of pixel data specified by SET_DSPXA [31 . . . 0] must be decoded as sub-picture line numbers (Ystart+1, Ystart+3, Ystart+5, . . . ). Ystart is provided asia start Y coordinate defined in advance by a portion of SET_DAREA command [21 . . . 11].

If the storage flag “Stored_Form” is set 1 (“Plain” is specified), SET_DSPXA [31 . . . 0] is provided to be reserved.

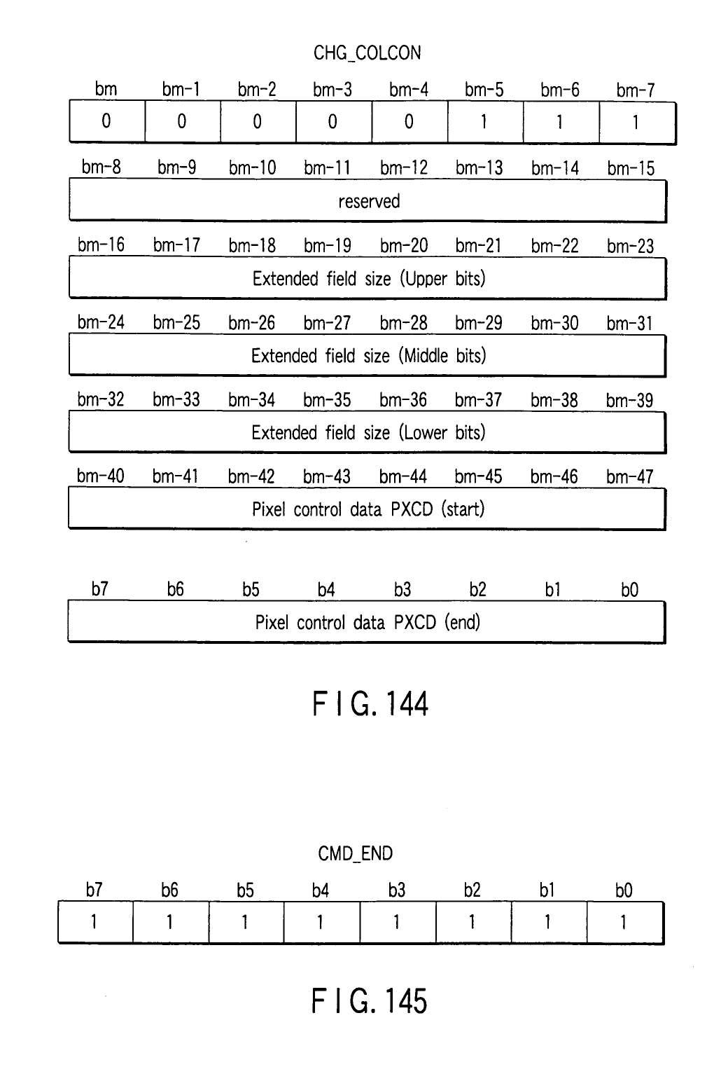

FIG. 144 shows a command CHG_COLCON for changing the color and contrast of pixel data at a video frame change point being displayed. The code of this command is set to “07h.” The command size and pixel control data in accordance with pixel control data are described in the extension field.

Extension field size=(m−7)/8 (bytes).

This command is disabled when highlight information is in use.

When this command does not exist in the display control sequence SP_DCSQ, the last CHG_COLCON is valid intact. At the beginning of each line, the color and contrast set by the commands SET_COLOR and SET_CONTR are used.

FIG. 145 shows the command CMD_END for ending the display control sequence. The code of this command is set to “FFh.” This command must be described at the last portion of each display control sequence SP_DCSQ.

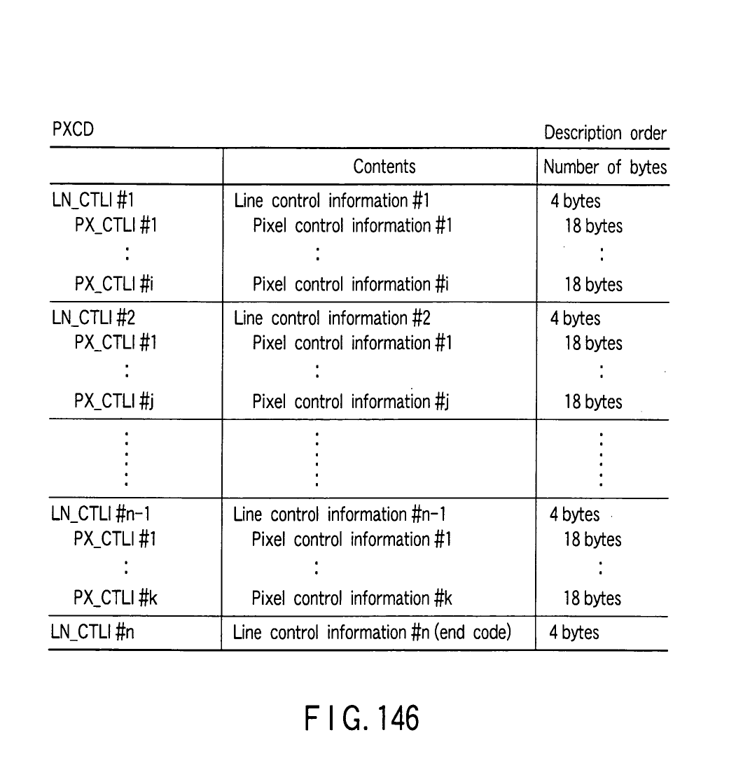

FIG. 146 shows a command PXCD for controlling the color and contrast of pixel data during a display period. The contents of control described in PXCD are executed on a frame by frame basis from the first video frame after the start time SP_DCSQ_STM of the specified display control sequence. This execution lasts until a new PXCD is set.

When the current PXCD is updated to a new PXCD, the past PXCD processing is invalidated. There is described line control information LN_CTLI for specifying the number of lines on which the same change is made. A plurality of items of pixel control information PX_CTLI can be described in order to specify a plurality of positions at which a change is made on one line. One item of line control information LN_CTLI and a group of one or more items of pixel control information PX_CTLI are repeatedly described. The PXCD command end code “0FFFFFFh” must be described in the line control information LN_CTLI. When only the end code exists in PXCD, the result of the preceding CHG_COLCON command is END.

The sub-picture line number and pixel number must be described in video display number in accordance with the following rule.

1) With respect to each item of line control information LN_CTLI, the end-of-change sub-picture line number must be equal to or greater than the start-of-change sub-picture line number.

2) The start-of-change sub-picture line number of each item of line control information LN_CTLI must be equal to or greater than the end-of-change sub-picture line number if the preceding line control information LN_CTLI exists.

3) The start-of-change sub-picture line numbers in continuous items of line control information LN_CTLI must be described in PXCD in ascending order.

4) In a group of pixel control information PX_CTLI immediately after each item of line control information LN_CTLI, the start-of-change pixel numbers in the pixel control information PX_CTLI must be described in ascending order.

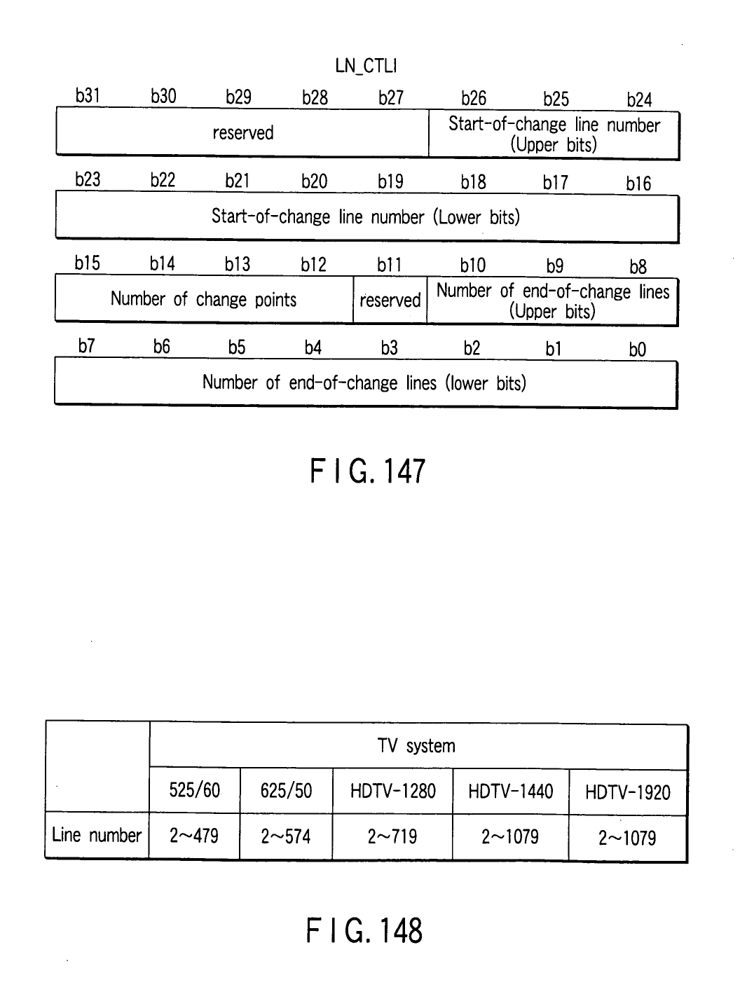

FIG. 147 shows line control information LN_CTLI for describing the start-of-change sub-picture line number, the end-of-change line number, and the number of change points in line.

The start-of-change line number is provided as a line number for which the contents of pixel control are started. This line number is described in sub-picture line number.

The number of change points describes the number of change points on change line (the number of PX_CTLI). This number must be described in numerals from 1 to 8.

The end-of-change line number is provided as a line number for which the contents of pixel control are ended. This number must be described in sub-picture line number.

FIG. 148 shows the range of line numbers.

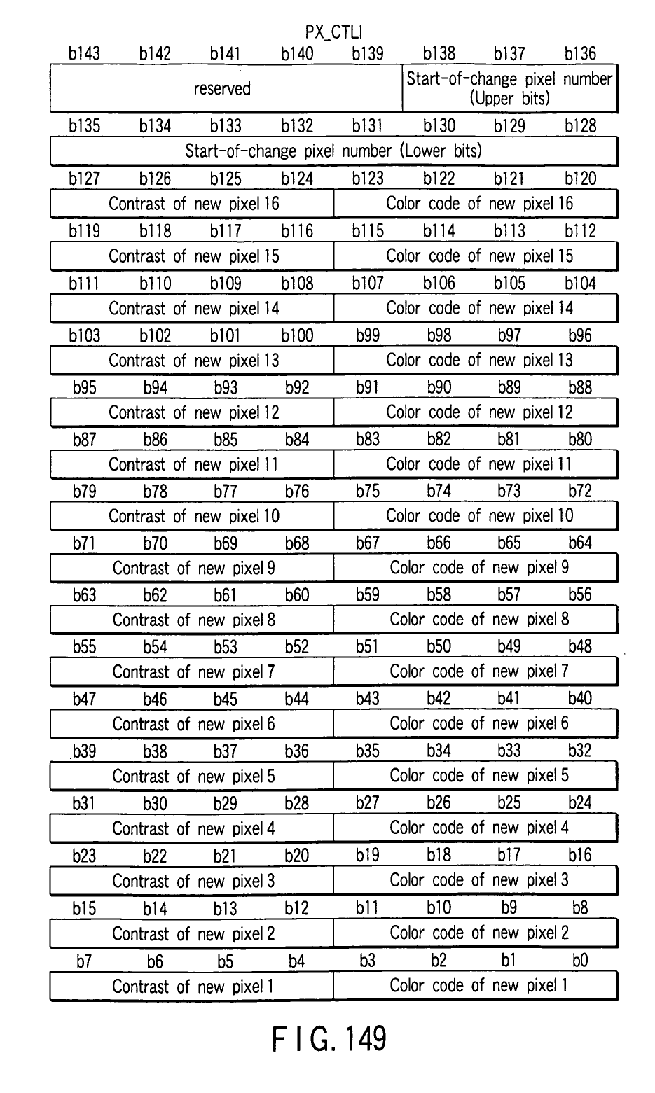

FIG. 149 shows PX_CTLI for describing the start-of-change pixel number, the start-of-change pixel, and the color and contrast of pixels which follow them. Up to 8 start-of-change pixels per line may exist. With respect to the start-of-change pixel and the pixels which follow it, at least 8 pixels having the same content must be continuous.

The start-of-change pixel number is provided as a pixel number for which the contents of pixel control are started. This number is described in pixel number in order of display. The last value is set to “0.” In this case, the commands SET_COLOR and SET_CONTR are invalidated.

The color codes from new pixel 1 to new pixel 16 describe the start-of-change pixel and the palette codes of new pixel 1 to new pixel 16 which follow it in descending order. When no change is required, the same code as the default value is described.

The contrasts from new pixel 1 to new pixel 16 describe the start-of-change pixel and the palette codes from new pixel 1 to new pixel 16 which follow it in descending order. When no change is required, the same code as the default value is described.

The default value denotes the color code and contrast value to be used in the sub-picture unit.

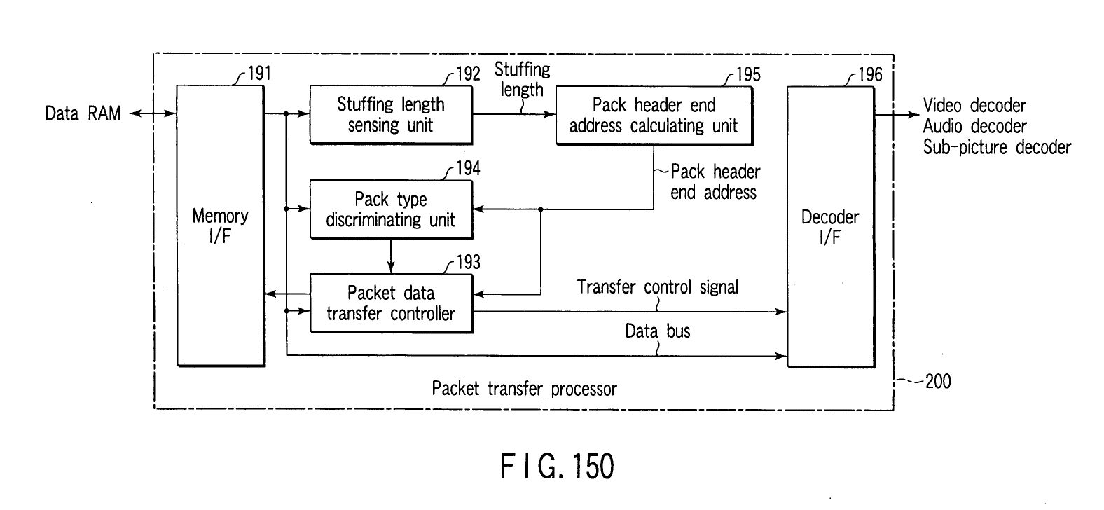

The above system processor 54 shown in FIG. 1 has a packet transfer processor 200 for determining packet type and transferring the data contained in the packet to each decoder. The packet transfer processor 200, as shown in FIG. 150, comprises a memory interface (memory I/F) 191, a stuffing length sensing unit 192, a pack header end address calculating unit 195, a pack type discriminating unit 194, a packet data transfer control potion 193, and a decoder interface (decoder I/F) 196.

The memory I/F 191 outputs pack data from the data RAM 56 to the stuffing length sensing unit 192, pack type discriminating unit 194, packet data transfer controller 193, and decoder I/F 196 by a data bus.

The stuffing length sensing unit 192 senses what byte is the stuffing length in the pack header 120 in the pack data supplied from the memory I/F 191. The sensing result is output to the pack header end address calculating unit 195.

The pack header end address calculating unit 195 calculates a pack header end address according to the stuffing length supplied from the stuffing length sensing unit 192. The calculation result is output to the pack type discriminating unit 194 and the packet data transfer controller 193.

The pack type discriminating unit 194 discriminates any of the video pack 88, audio pack 91, sub-picture pack 90, and NV pack 86 according to the contents of 4-byte data supplied to the next address of the address contained in the pack data supplied from the memory I/F 191 in accordance with the pack header end address supplied from the pack header end address calculating unit 195. The discrimination result is output to the packet data transfer controller 193.

The packet data transfer controller 193 determines the transfer destination and packet start address according to the discrimination result of the pack header end address supplied from the pack header end address calculating unit 195 and the pack type supplied from the pack type discriminating unit 194. In addition, this controller determines the packet length in the pack data packet header 121 to be further supplied. Further, the packet data transfer controller 193 supplies to the decoder I/F 196 a signal indicating a transfer destination, the signal being a transfer control signal. Then, the packet end address is supplied from the packet start address to the memory I/F 191.

The decoder I/F 196 outputs to the corresponding decoder 58, 60, and 62 the video data, audio data, and sub-picture data which are packet data including the packet header 121 supplied to be controlled by the packet data transfer controller 193 from the memory I/F 191 in response to the transfer control signal supplied from the packet data transfer controller 193. In addition, this decoder I/F outputs navigation data and computer data as packet data to the data RAM 56.

Now, processing of the packet transfer processor 200 will be described here.

That is, the pack data read out from the data RAM 56 is supplied via the memory I/F 191 to the stuffing length sensing unit 192, pack type discriminating unit 194, packet data transfer controller 193, and decoder I/F 196.

In this manner, the stuffing length sensing unit 192 senses a stuffing length, and outputs data indicating the stuffing length to the pack header end address calculating unit 195.

The pack header end address calculating unit 195 calculates the pack header end address by the stuffing length to be supplied, and supplies the pack header end address to the pack type discriminating unit 194 and the packet data transfer controller 193.

The pack type discriminating unit 194 discriminates any of the NV pack 86, video pack 88, dorby AC3 audio pack 91, linear PCM audio pack 91, and sub-picture pack 90 according to the contents of 4 to 6 type data supplied to the next address of the address in accordance with the pack header end address to be supplied, and supplies the discrimination result to the packet data transfer controller 193.

That is, when 1-byte stream ID indicating a private stream 2 has been supplied, the NV pack 86 is discriminated. Then, the video pack 88 is discriminated by the 1-byte stream ID indicating the video stream. Then, any of the dorby AC3 audio pack 91, linear PCM audio pack 91, and sub-picture pack 90 is discriminated by the 1-byte stream ID indicating the private stream 1.

When the stream ID is set to the private stream 1, the linear PCM audio pack, dorby AC3 audio pack, or sub-picture stream is discriminated by the sub-stream ID which follows the packet header 121, and the stream number is discriminated.

The packet data transfer controller 193 determines a transfer destination and a packet start address according to the discrimination result of pack type supplied and the pack header end address. Further, this controller determines the packet length in the packet header 121 of pack data to be supplied. In this manner, the packet data transfer controller 193 supplies to the decoder I/F 196 a signal indicating a transfer destination as a transfer control signal, and supplies the packet end address from the packet start address to the memory I/F 191.

Therefore, substantially valid packet data is supplied from the memory I/F 191 to a data bus, and then, the supplied packet data is transferred to the decoders 58, 60, and 62 or data RAM portion 56 which are transfer destinations according to the type.

That is, video data packet data is transferred to the video decoder 58, audio data packet data is transferred to the audio decoder 60, and sub-picture data packet data is transferred to the sub-picture decoder 62.

At this time, the above pack data is set to a fixed length, and the storage state in the data RAM 56, i.e., the start address is set to a fixed interval. Thus, the start of the pack data contained in the data RAM 56 is always stored in an address with the same interval, and management of only pack numbers will suffice without pack data management carrying out address management.

In the discrimination process for data type, when PCI data and DSI data are provided as NV data indicating the video data playback position or the like, this NV data is not transferred to the decoder, and this NV data is stored in the data RAM 56. This NV data is referred to by the system CPU 50 as required, and is utilized for special playback of video data. At this time, the PCI data and DSI data are provided so as to be identified by sub-stream ID assigned to these data.

When playback of one cell has ended, cell information to be reproduced next is acquired from cell playback sequence information contained in program chain data, and playback is continued similarly.

At the above sub-picture decoder 62 shown in FIG. 1, there is a highlight processor 62C which carries out highlight processing for sub-picture data after decoding by the decoder 62B for decoding the sub-picture data supplied from the above system processor 54. The highlight processor 62C carries out highlight processing according to the X and Y coordinate values, color code, and highlight color/contrast value indicating a rectangular region for displaying a selection item which is highlight information supplied from the above system CPU 50.

The above decoder 62B decomposes pixel data compressed by run length compression, the pixel data being sub-picture data, according to pixels 1 to 16.

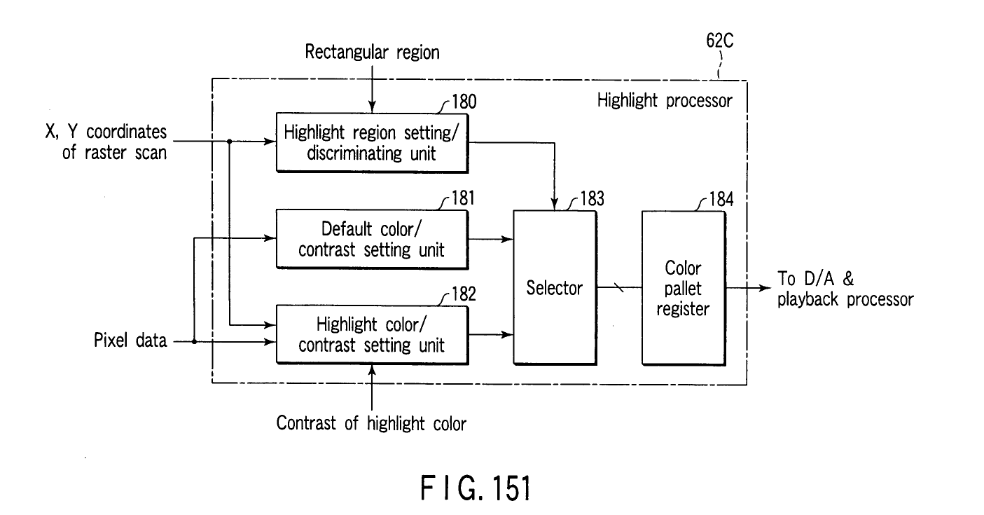

The above highlight processor 62C, as shown in FIG. 151, comprises a highlight region setting/discriminating unit 180, a default color/contrast setting unit 181, a highlight color/contrast setting unit 182, a selector 183, and a color pallet register 184.

The highlight region setting/discriminating unit 180 discriminates a specified highlight region by the X and Y coordinate values indicating a rectangular region (specified highlight region) in which a selection item is displayed by the above system CPU 50 and the X and Y coordinate values obtained by a raster scan, namely, the pixel data X and Y coordinate values, outputs a switch signal indicating a highlight interval, and supplies the output to the selector 183.

The default color/contrast setting unit 181 sets the default display color and contrast for each pixel included in sub-picture data.

The highlight color/contrast setting unit 182 sets the highlight color and contrast value by the above system CPU 50.

The selector 183 selectively outputs to the color pallet register 184 the default display color and contrast from the default color/contrast setting unit 181 according to the switch signal from the highlight region setting/discriminating unit 180 or outputs to the color pallet register 184 the highlight color and contrast from the color/contrast setting unit 182 during highlighting.

The color pallet register 184 outputs a signal according to the color and contrast supplied from the selector 183.

Therefore, when the above highlight region setting/discriminating unit 180 discriminates that a highlight region is out of the range, the selector 183 receives the default display color and contrast on a pixel data by pixel data basis from the default color/contrast setting unit 181. Then, the display color and contrast are output to the color pallet register 184 and the color signal from the color pallet register 184 is output to the D/A and playback processor 64.

When the above highlight region setting/discriminating unit 180 discriminates that the highlight region is within the range, the selector 183 receives the display color and contrast during highlighting for each pixel data from the highlight color/contrast setting unit 182. Then, the display color and contrast is output to the color pallet register 184, and the color signal from the color pallet register 184 is output to the D/A and playback processor 64.

Now, menu playback processing will be described using the optical disk 10 having the logical format shown from FIGS. 6 to 149 with reference to FIG. 1. In FIG. 1, the arrow indicated by solid line between blocks indicates a data bus, and the arrow indicated by broken line indicates a control bus.

In the optical disk apparatus shown in FIG. 1, after power has been supplied, when the optical disk 10 is mounted, the system CPU 50 reads out an initialization operation program from a system ROM/RAM 52, and activates the disk drive 30. Therefore, the disk drive 30 starts a readout operation from the lead-in area 27. Then, the volume and file structure area 70 ruling a volume and file structure is read out in conformance with ISO-9660 or the like following the lead-in area 27. That is, the system CPU 50 supplies a read instruction to the disk drive 30 in order to read out the volume and file structure area 70 recorded at a predetermined position of the optical disk 10 set at the disk drive 30. Then, this-CPU 50 reads out the contents of the volume and file structure area 70, and temporarily stores them in the data RAM 56 via the system processor 54. The system CPU 50 samples information such as a file recording position, recording capacity and size or other management information which is information required for management via a path table and a directory record stored in the data RAM 56, and transfers and stores these items of information in a predetermined place of the system ROM/RAM 52.

Then, the system CPU 50 acquires the video manager VMG 74 comprising a plurality of files beginning at file number 0 by referring to information such as file recording positions or recording capacity from the system ROM/RAM 52. That is, the system CPU 50 supplies a read instruction to the disk drive 30 by referring to information such as file recording positions or recording capacity acquired from the system ROM/RAM 52, stores the positions and sizes of a plurality of files configuring the video manager VMG 74 which exists on a root directory, reads out them from the video manager VMG 74, and stores them in the data RAM 56 via the system processor 54.

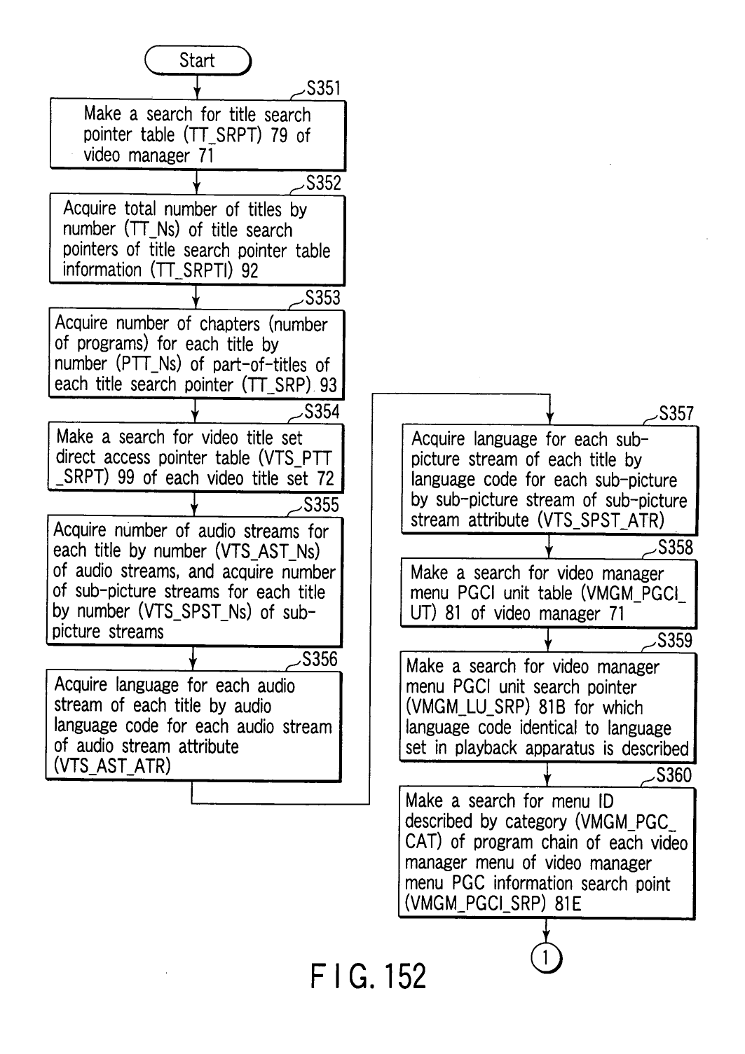

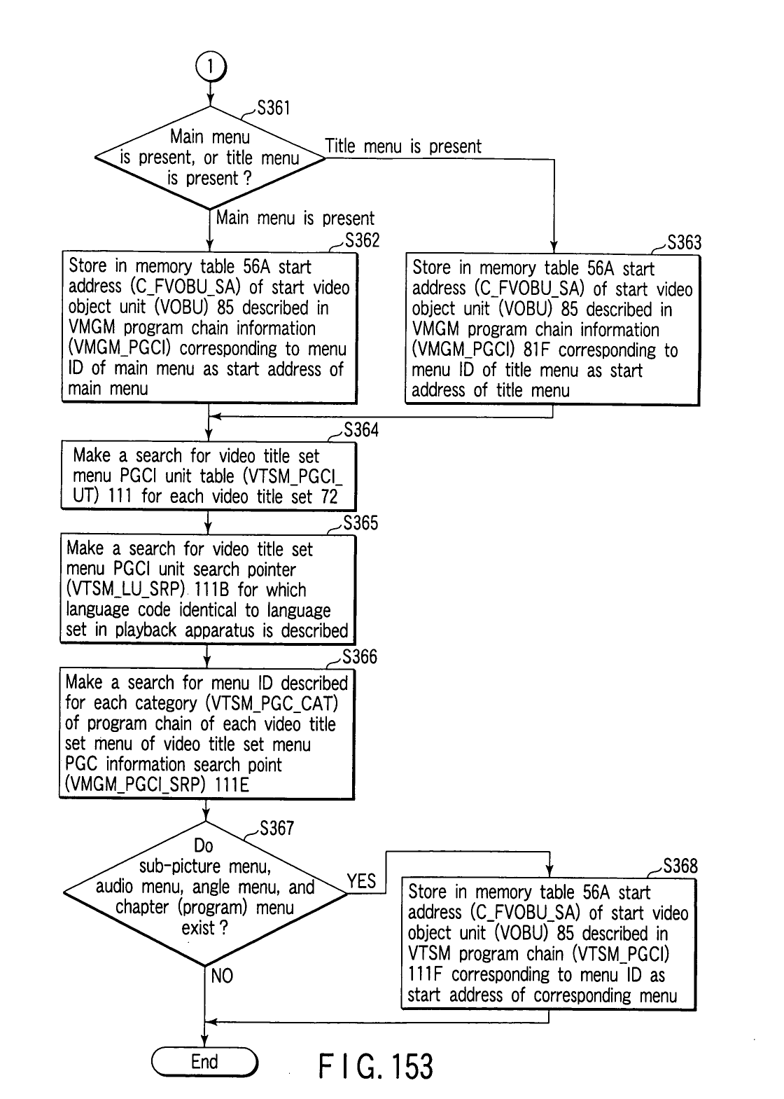

Then, the system CPU 50, as shown in the flow chart of FIGS. 152 and 153, detects a total number of titles contained in the optical disk 10, the number of chapters (the number of programs) for each title, the number of audio streams for each title and audio stream language, and the number of sub-picture streams for each title and the sub-picture stream language.

That is, the system CPU 50 makes a search for the title search pointer table TT_SRPT 79 which is a second table of the video manager VMG 74 (step S351). The system CPU 50 acquires the total number of titles contained in the optical disk 10 by the number TT_Ns of title search pointers described in the title search pointer table information TT_SRPTI 92 contained in the title search pointer table TT_SRPT 79 (step S352).

The system CPU 50 acquires the number of chapters (the number of programs) for each title by the number of part-of-titles PTT_Ns which is the number of chapters (the number of programs) described in each title search pointer TT_SRP 93 contained in the title search pointer table TT_SRPT 79 (step S353).

The system CPU 50 makes a search for the video title set part-of-title set search pointer table VTS_PTT_SRPT 99 contained in the video title set information VTSI 94 which is a first table of each video title set 72 by using the start address VTS_SA of the video title set 72 described in each title search pointer TT_SRP 93 (step S354). The system CPU 50 acquires the number of audio streams for each title by the number of audio streams (VTS_AST_Ns) described in the table (VTS/DAPT) 99 of each video title set 72, and acquires the number of sub-picture streams for each title by the number of sub-picture streams (VTS_SPST_Ns) (step S355).

The system CPU 50 acquires the language on an audio stream by audio stream basis of each title by an audio language code on an audio stream by audio stream basis described in audio stream attribute VTS_AST_ATR of the table (VTS_DAPT) 99 for each video title set 72 (step S356).

The system CPU 50 acquires the language on a sub-picture stream by sub-picture stream basis for each title by the sub-picture language code on a sub-picture by sub-picture basis described in sub-picture stream attribute VTS_SPST_ATR of the table (VTS_DAPT) 99 for each video title set 72 ((step S357).

The system CPU 50 makes a search for the video manager menu PGCI unit table VMGM_PGCI_UT 81 which is a fourth table contained in the video manager information VMGM 75 on the video manager VMG 74 (step S358). This CPU makes a search for the video manager menu PGCI unit search pointer VMGM_LU_SRP 81B in which there is described the language code identical to the language set in the playback apparatus by this search (step S359).

When a search is made for the video manager menu PGCI unit search pointer VMGM_LU_SRP 81B in which the same language code is described, the system CPU 50 makes a search for menu ID described for each category VMGM_PGC_CAT of the program chain of each video manager menu of the video manager menu PGCI information search pointer VMGM_PGCI_SRP 81E contained in the video manager menu language unit VMGM_LU 81C which corresponds to the pointer VMGM_LU_SRP 81B (step S360). Then, this CPU determines whether or not a main menu being a root menu exists by this search, and determines whether or not a title menu (video title set menu) exists (step S361).

When the main menu exists, the system CPU 50 reads out the contents of the corresponding VMGM program chain information VMGM_PGCI 81F by the parameter VMGM_PGCI_SA based on the start address of the VMGM program chain information VMGM_PGCI 81F described in one of the video manager menu PGCI information search pointers VMGM_PGCI_SRP 81E in which menu ID of that root menu is described. As the start address of a main menu, this CPU stores the start address C_FVOBU_SA of the start video object unit VOBU 85 described in the VMGM program chain information VMGM_PGCI 81F in a memory table 56A (step S362).

When the title menu exists, the system CPU 50 reads out the contents of the corresponding VMGM program chain information VMGM_PGCI 81F by the parameter VMGM_PGCI_SA based on the start address of the VMGM program chain information VMGM_PGCI 81F described in one of the video manager menu PGC information search pointers VMGM_PGCI_SRP 81E in which menu ID of that title menu is described. As the start address of the title menu, this CPU stores the start address C_FVOBU_SA of the start video object unit VOBU 85 described in the VMGM program chain information VMGM_PGCI 81F (step S363) in the memory table 56A.

The system CPU 50 makes a search for the video title set menu PGCI unit table VTSM_PGCI_UT 111 contained in the video title set information VTSI 94 which is a first table for each video title set 72 (step S364). This CPU 50 makes a search for the video title set menu PGCI unit search pointer VTSM_LU_SRP 111B in which there is described the language code identical to the language set to the playback apparatus by this search (step S365).

When a search is made for the video title set menu PGCI unit search pointer VTSM_LU_SRP 111B in which the same language code is described, the system CPU 50 makes a search for menu ID described for the category of the program chain in each video title set menu on the video title set menu PGC information search pointer VTSM_PGCI_SRP 111E contained in the video title set menu language unit VTSM_LU 111C which corresponds to that pointer VTSM_LU_SRP 111B (step S366). This CPU 50 determines whether or not the sub-picture menu, audio menu, angle menu, or chapter (program) menu exists by this search, and determines whether or not a title menu exists (step S367).

When any of these menus exists, the system CPU 50 reads out the contents of the corresponding VTSM program chain information VTSM_PGCI 111F by the parameter VTSM_PGCI_SA based on the start address of the VTSM program chain information VTSM_PGCI 111F described one of the video title set menu PGCI information search pointers VTSM_PGCI_SRP 111E in which that menu ID is described. As the start address of the corresponding menu, the CPU 50 stores in the memory table 56A the start address C_FVOBU_SA of the start video object unit VOBU 85 described in the VTSM program chain information VTSM_PGCI 111F (step S368).

In this manner, the memory table 56A stores the start address of the sub-picture menu, audio menu, angle menu, or chapter (program) menu for each video title set 72.

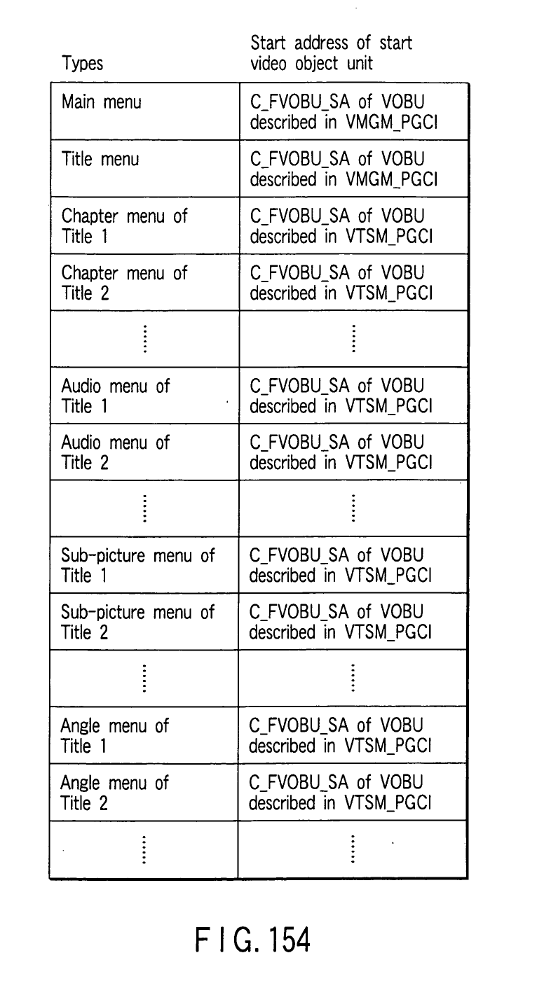

As a result, the memory table 56A, as shown in FIG. 154, stores the start address corresponding to each menu which corresponds to the language set in the playback apparatus.

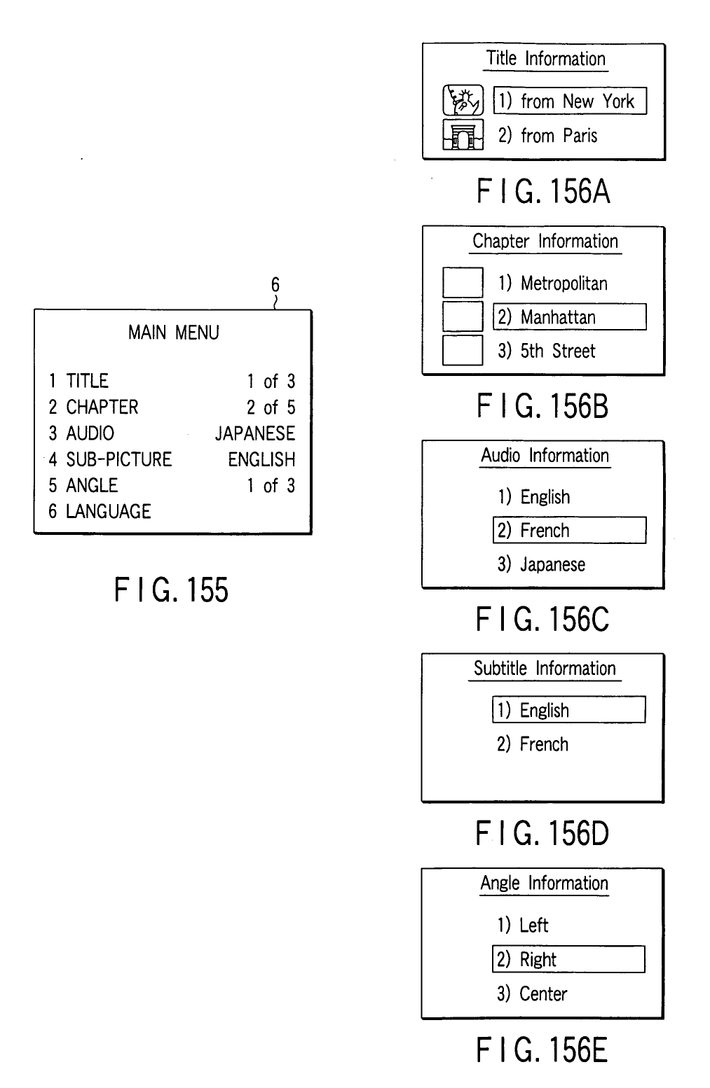

Therefore, when the menu key 5k of the remote controller 5 is input, the system CPU 50 determines playback of a main menu, and determines whether or not the main menu exists. As a result of this determination, when it is determined that the main menu exists, the system CPU 50 reads out the start address C_FVOBU_SA of the start video object unit VOBU 85 stored in correspondence with the main menu of the memory table 56A. Then, this CPU 50 reads out and plays back the main menu data corresponding to this address from a region corresponding to the video object set VMGM_VOBS 76 for the video manager menu VMGM 75 of the optical disk 10. This played-back data is input to the data RAM 56 via the system processor 54. The data cell 84 is supplied to the video decoder 58, audio decoder 60, and sub-picture decoder 62 based on playback time information, and the supplied data cell is decoded therein. Then, the decoded cell is converted into the corresponding signal by the D/A and playback processor 64, the main menu image, as shown in FIG. 155 is reproduced at the monitor 6, and a voice is reproduced from the speaker 8.

When the title key 51 of the remote controller 5 has been input, or in a state in which the above main menu is reproduced, when the key “1” corresponding to a title is input, or when normal playback starts, the system CPU 50 determines playback of a title menu, and determines whether or not the title menu exists. As a result of this determination, when it is determined that the title menu exists, this CPU 50 reads out the start address C_FVOBU_SA of the start video object unit VOBU 85 stored in correspondence with the title menu of the memory table 56A. Then, the system CPU 50 reads out and plays back the data on the title menu corresponding to this address from the region corresponding to the video object set VMGM_VOBS 76 for the video manager menu VMGM 75 of the optical disk 10. This played-back data is input to the data RAM 56 via the system processor 54. The data cell 84 is supplied to the video decoder 58, audio decoder 60, and sub-picture decoder 62 based on playback time information, and the supplied data cell is decoded. Then, the decoded data cell is converted into the corresponding signal by the D/A and playback processor 64. The title menu image as shown in FIG. 156A is reproduced on the monitor 6, and a voice is reproduced from the speaker 8.

In a state in which the main menu is reproduced, when the key “2” corresponding to a chapter is input, or after a title has been selected by normal playback, the system CPU 50 determines playback of a chapter menu corresponding to the currently selected title, and determines whether or not the chapter menu exists. As a result of this determination, when it is determined that the chapter menu exists, this CPU 50 reads out the start address C_VOBU_SA of the start video object unit VOBU 85 stored in correspondence with the chapter menu of the memory table 56A. The system CPU 50 reads out and plays back the data on the chapter menu corresponding to this address from the region corresponding to the video object set VTSM_VOBS 95 for the video title set menu VTSM of the optical disk 10. This played-back data is input to the data RAM 56 via the system processor 54. The data cell 84 is supplied to the video decoder 58, audio decoder 60, and sub-picture decoder 62 based on playback time information, and the supplied data cell is decoded. Then, the decoded data is converted into the corresponding signal by the D/A and playback processor 64. The chapter menu image as shown in FIG. 156B is reproduced, and a voice is reproduced from the speaker 8.

In a state in which the main menu is reproduced, when the key “3” corresponding to audio has been input, or after a title has been selected by normal playback, the system CPU 50 determines playback of an audio menu which corresponds to the currently selected title, and determines whether or not the audio menu exists. As a result of this determination, when it is determined that the audio menu exists, this CPU 50 reads out the start address C_FVOBU_SA of the start video object unit VOBU 85 stored in correspondence with the audio menu of the memory table 56A. The CPU 50 reads out and plays back the data on the audio menu which corresponds to this address from the region corresponding to the video object set VTSM_VOBS 95 for the video title set menu VTSM of the optical disk 10. This played-back data is input to the data RAM 56 via the system processor 54. The data cell 84 is supplied to the video decoder 58, audio decoder 60, and sub-picture decoder 62 based on playback time information, and the supplied data cell is decoded. The decoded data cell is converted into the corresponding signal by the D/A and playback processor 64. The audio menu image as shown in FIG. 156C is reproduced, and a voice is reproduced from the speaker 8.

In a state in which the main menu is reproduced, when the key “4” corresponding to the sub-picture has been input, or after a title has been selected by normal playback, the system CPU 50 determines playback of the sub-picture menu corresponding to the currently selected title, and determines whether or not the sub-picture menu exists. As a result of this determination, when it is determined that the sub-picture menu exists, this CPU reads out the start address C_FVOBU_SA of the start video object unit VOBU 85 stored in correspondence with the sub-picture menu of the memory table 56A. The system CPU 50 reads out and plays back the data on the sub-picture which corresponds to this address from the region corresponding to the video object set VTSM_VOBS 95 for the video title set menu VTSM of the optical disk 10. This played-back data is input to the data RAM 56 via the system processor 54. The data cell 84 is supplied to the video decoder 58, audio decoder 60, and sub-picture decoder 62 based on playback time information, and the supplied data cell is decoded. The decoded data cell is converted into the corresponding signal by the D/A and playback processor 64. The sub-picture menu image as shown in FIG. 156D is reproduced at the monitor section 6, and a voice is reproduced from the speaker 8.

In a state in which the main menu is reproduced, when the key “5” corresponding to an angle has been input, or after a title has been selected by normal playback, the system CPU 50 determines playback of the angle menu which corresponds to the currently selected title, and determines whether or not the angle menu exists. As a result of this determination, when it is determined that the angle menu exists, this CPU 50 reads out the start address C_FVOBU_SA of the start video object unit VOBU 85 stored in correspondence with the angle menu of the memory table 56A. The CPU 50 reads out and plays back the data on the angle menu corresponding to this address from the region corresponding to the video object set VTSM_VOBS 95 for the video title set menu VTSM of the optical disk 10. This played-back data is input to the data RAM 56 via the system processor 54. The data cell 84 is supplied to the video decoder 58, audio decoder 60, and sub-picture decoder 62 based on playback time information and the supplied data cell is decoded. The decoded data cell is converted into the corresponding signal by the D/A and playback processor 64. The angle menu image as shown in FIG. 156E is reproduced at the monitor 6, and a voice is reproduced from the speaker 8.

Therefore, the system CPU 50 is provided so as to store the above acquired position data on each menu in the menu table 56A contained in the data RAM 56. Thus, by using this table, required menu playback can be easily carried out.

The system CPU 50 acquires the number of video, audio, or sub-picture streams and the respective attribute information for the video manager menu described in the information management table VMGI_MAT 78 of the video manager VMGI 75. This CPU 50 sets parameters for video manager menu playback to the video decoder 58, audio decoder 60, and sub-picture decoder 62 each, based on the attribute information.

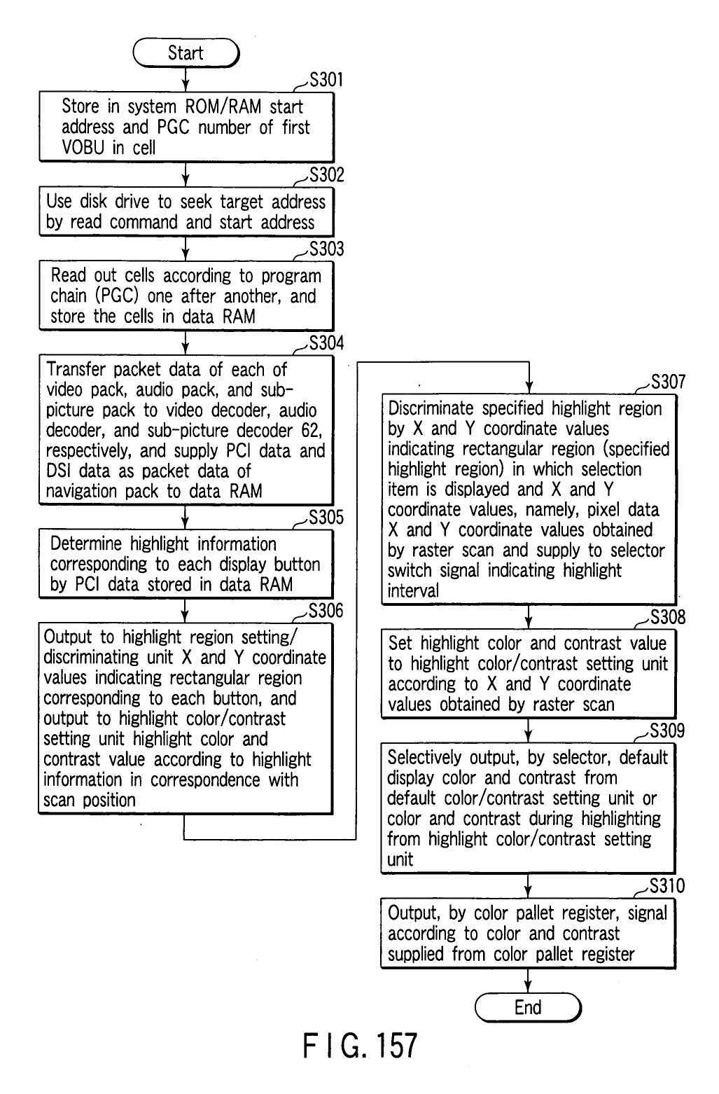

Now, processing when the above menu is reproduced will be described in more detail with reference to a flow chart shown in FIG. 157.

That is, the system ROM/RAM 52 stores the start address and PGC number, i.e., the cell number of the first VOBU in cells which is a start address for a menu to be reproduced (step S301).

A read command is provided from the system CPU 50 to the disk drive 30 at a time point when a video title set is ready to be read, and the disk drive 30 seeks the optical disk 10 based on the above-described start address (step S302). By the read command, cells according to the specified program chain PGC are read out from the optical disk 10 one after another, and the read-out cells are fed to the data RAM 56 via the system CPU 50 and system processor 54 (step S303). With respect to the fed cell data, as shown in FIG. 8, a pack from the navigation pack 86, which is the start pack of the video object unit VOBU 85, is stored in the data RAM 56. Then, the items of packet data of the video pack 88 of the video object unit VOBU, audio pack 91, and sub-picture pack 90 are transferred to the video decoder 58, audio decoder 60, and sub-picture decoder 62, respectively, by the above packet transfer processor 200. The PCI data and DSI data which are packet data of the navigation pack 86 are fed to the data RAM 56 (step S304).

At this time, the system CPU 50 determines highlight information (the above-described contents of FIGS. 71 to 84) corresponding to each button for display based on the PCI data stored in the data RAM 56 (step S305).

That is, on a button by button basis, a rectangular region of that button; the display color and contrast value of each pixel data before selected when that button is a selection button; the display color and contrast value of each pixel data after selected; the display color and contrast value of each pixel data before determined when that button is a determination button; and the display color and contrast value of each data after determined are determined, and are stored in the data RAM 56. As the pixel data, pixels 1 to 16 are prepared, and the display color and contrast value for each pixel are prepared.

In this manner, the system CPU 50 outputs the X and Y coordinate values indicating a rectangular region which corresponding to each button stored in the data RAM 56 to the highlight region setting/discriminating unit 180 of the highlight processor 62C. In addition, according to a scan position, the system CPU 50 outputs the highlight color and contrast value according to highlight information to the highlight color/contrast setting unit 182 of the highlight processor 62C (step S306).

In this manner, the highlight region setting/discriminating unit 180 discriminates a specified highlight region based on the X and Y coordinate values indicating a rectangular region (specified highlight region) in which a selection items is displayed by the system CPU 50 and the X and Y coordinate values obtained by a raster scan, namely, pixel data X and Y coordinate values, and supplies a switch signal indicating a highlight interval to the selector 183 (step S307).

To the highlight color/contrast setting unit 182, the highlight color and contrast value are set by the system CPU 50 according to the X and Y coordinate values obtained by a raster scan (step S308).

In this manner, the selector 183 selectively outputs to the color palette register 184 the default display color and contrast from the default color/contrast setting unit 181 according to the switch signal from the highlight region setting/discriminating unit 180, or outputs to the color palette register 184 the color and contrast during highlighting from the highlight color/contrast setting unit 182 (step S309).

The color palette register 184 outputs a signal according to the color and contrast supplied from the selector 183 (step S310).

As a result, when the highlight region setting/discriminating unit 180 discriminates that a highlight region is out of the range, the selector 183 accepts the default display color and contrast on a pixel data by pixel data basis from the default color/contrast setting unit 181. The accepted display color and contrast are output to the color palette register 184, and a color signal from the color palette register 184 is output to the D/A and playback processor 64.

When the highlight region setting/discriminating unit 180 discriminates that the highlight region is within the range, the selector 183 accepts the display color and contrast during highlighting on a pixel data by pixel data basis from the highlight color/contrast setting unit 182. The accepted display color and contrast are output to the color palette register 184, and a color signal from the color palette register 184 is output to the D/A and playback processor 64.

As a result, the sub-picture data on a pixel by pixel basis after decoding is supplied to an image combining unit 64A (refer to FIG. 1) in the D/A and playback processor 64 shown in FIG. 1 after the color and contrast have been changed according to highlight information.

Therefore, the main picture data decoded by the video decoding portion 58 is supplied to the image combining unit 64A in the D/A and playback processor 64. The supplied main picture data is decoded by the decoder 62B in the sub-picture decoding portion 62, and the decoded main picture data is supplied to the image combining unit 64A in the D/A and playback processor 64 via the highlight processor 62C. In this manner, the main picture data and the sub-picture data are combined by the image combining unit 64A, and the combined image is displayed at the monitor 6.

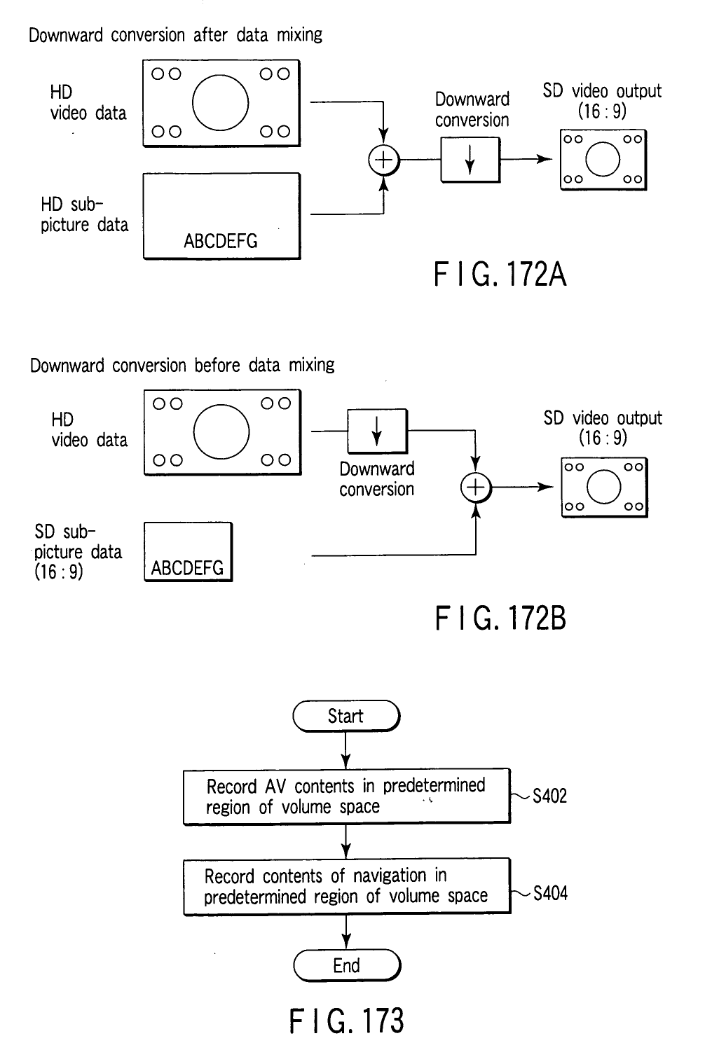

FIGS. 172A and 172B show two models when HD scheme picture data is converted (down-converted) into SD scheme picture data. The playback apparatus has a function for converting a display mode from an HDTV scheme to an SDTV scheme. When the main picture and the sub-picture are superimposed on each other, there are a model for superimposing the main picture on the sub-picture before down-converted (shown in FIG. 172A); and a model for superimposing the main picture on the sub-picture after down-conversion (shown in FIG. 172B). That is, the model shown in FIG. 172A down-converts mixed data after the HD scheme sub-picture data has been superimposed on the SD scheme main picture data. The model shown in FIG. 172B down-converts the HD scheme main picture data on the SD scheme main picture data, and the SD scheme main picture data and sub-picture data are superimposed on each other. It is possible to discriminate whether the sub-picture data is SD scheme or HD scheme by a flag “Raw” indicating run length compression/non-compression in the sub-picture stream attribute table VTS_SPST_ATRT of the video title set VTS contained in the table VTSI_MAT shown in FIG. 39.

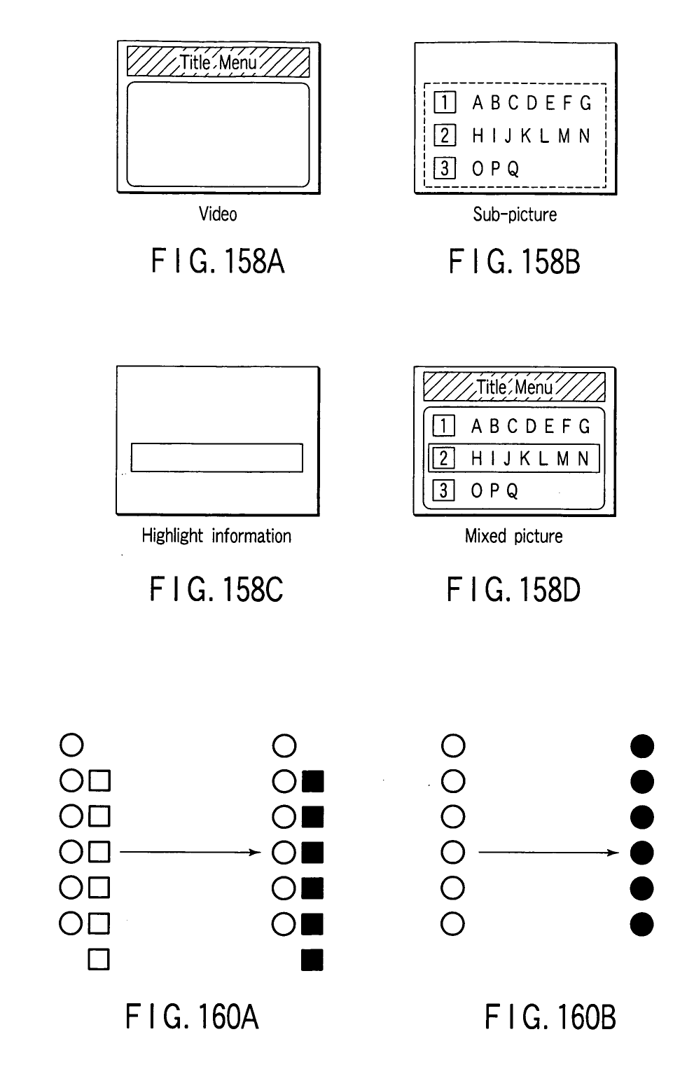

For example, on the main picture which is a background image shown in FIG. 158A, there is obtained a mixed picture shown in FIG. 158D combining a sub-picture comprising a button which is a selection item shown in FIG. 158B, and an image processed to be highlighted based on the highlight information shown in FIG. 158C with each other. At this time, the background of a selection item is displayed by a blue color, and characters of the selection item is displayed by a black color.

The audio data decoded by the audio decoding portion 60 is supplied to the D/A and playback processor 64, whereby the voice corresponding to the menu or main picture is reproduced from the speaker 8.

In the display state of this menu, when the user has selected a selection item displayed to be highlighted by the key operating/display device 4 or remote controller 5, the system CPU 50 outputs the corresponding highlight color and contrast value after selection to the highlight color/contrast setting unit 182 of the highlight processor 62C. As a result, the highlight color and contrast of the selection item are changed. At this time, the background of the selection item is displayed by a red color, and the characters of the selection item are displayed by a white color.

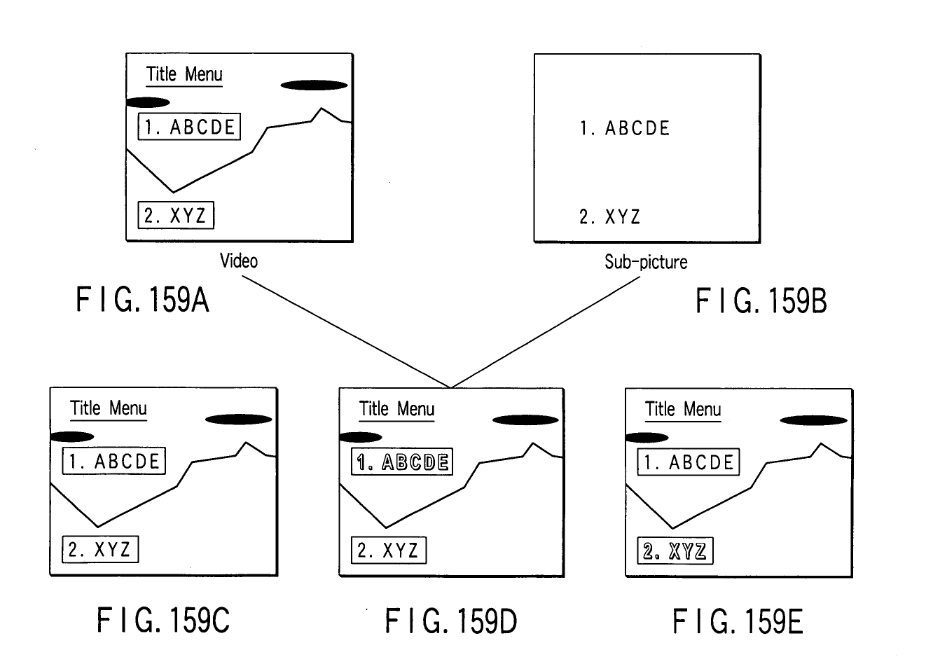

Another example of the menu image will be described with reference to FIGS. 159A to 159E.

That is, when the main picture data as shown in FIG. 159A and the sub-picture as shown in FIG. 159B are supplied, with respect to the menu image before selection, the characters of the selection item for each of “1” and “2” is displayed by a black color, and the background of the selection item is displayed by a gray color as shown in FIG. 159C.

Then, when selection item “1” has been selected by the key operating/display device 4 or remote controller 5, the system CPU 50 sets at the highlight processor 62C the X and Y coordinates indicating a rectangular region for selection item “1” read from the PCI data and the change contents (highlight information) of the color or contrast of each pixel.

In this manner, with respect to the sub-picture data decoded by the decoder 62B of the sub-picture decoding portion 62, the highlight color and contrast value corresponding to selection item “1” are changed by the highlight processor 62C, and the changed color and contrast value are supplied to the image combining unit 64A in the D/A and playback processor 64. As a result, the main picture data and the sub-picture data are combined by the image combining unit 64A, and the combined image, namely, a menu image with the changed display contents of selection item “1” is displayed at the monitor 6, as shown in FIG. 159D. For example, a character portion of selection item “1” is displayed by a white color, and the background of the selection item is displayed by a red color.

When the key operating/display device 4 or remote controller 5 selects selection item “2,” the system CPU 50 reads from the PCI data. The CPU 50 sets to the highlight processor 62C the X and Y coordinates indicating a rectangular region for the selection item “1” read from the PCI data and the change contents (highlight information) of the color or contrast of each pixel.

In this manner, with respect to the sub-picture data decoded by the decoder 62B of the sub-picture decoding portion 62, the highlight processor 62C changes the corresponding highlight color and contrast value to the selection item “1,” and supplies them to the image combining unit 62A in the D/A and playback processor 64. As a result, the image combining unit 64A combines the main picture data and sub-picture data with each other. Then, the combined image, namely, the menu image obtained when the display contents of the selection item “2” is displayed at the monitor 6, as shown in FIG. 159C. For example, a character portion of the selection item “2” is displayed by a white color, and the background of the selection item is displayed by a red color.

Accordingly, a change of a variety of menu screens can be easily achieved without reading out new picture data.

Selection item position information is specified by being associated with a main picture display coordinate system, whereby there is provided a configuration in which a positional relationship between the main picture and the sub-picture is easily determined.

In FIGS. 160A and 160B, there is shown an example of relationship between the sub-picture data on selection item and highlight information which is control data.

In these figures, the pixels represented by ∘ are produced by pixel 1, for example, and the pixels represented by □ are produced by using pixel 16 or the like.

In FIG. 160A, there is a case in which the pixels comprises pixel 1 of sub-picture data, pixel 16 which is a shade of pixel 1, and the like. In this case, after control data has been selected, with respect to display color information, the color of pixel 16 or the like is set to a new color, and the other pixel color and contrast are set to the current color intact, thereby making it possible to change the selected selection item to the shape of a different color from that of the other selection item in real time.

In FIG. 160B, there is a case in which sub-picture data comprises only pixel 1. After highlight information has been selected, with respect to display color information, the color of pixel 1 is set to a new color, and the other pixel and contrast are set to the current color intact, thereby making it possible to change the selected selection item itself to a different color from that of the other selection item in real time.

In addition, settings are provided such that the contrast of pixel 8 in the selection item region or the like is set to 100% with respect to sub-picture data during selection or is set to 0% during non-selection, and the configuration of sub-picture data and the contents of highlight information such as control such that the color of the whole selection region changes are used during selection, whereby a variety of formats can be used in real time.

For example, when the above identified cell type is a menu, processing does not automatically go to next cell playback, and enters a standby state in the last frame display state at a time when cell playback has been ended.

Therefore, when a menu cell has been reproduced, a still picture state is established in the last display state of the cell. The NV pack 88 is always inserted into a cell in a predetermined unit of video data, and thus, highlight information for the menu described previously is stored in the data RAM 56.

The system CPU 50 enters a standby state of a user event (such as key input) at a time when cell playback has ended. Then, processing of a selection item is executed for the user menu selection, referring to information (highlight information) associated with a menu from the PCI data stored in the data RAM 56.

Now, in a state in which a title or the like has been selected by a menu as described above, a playback operation of movie data from the optical disk 10 having the logical format shown in FIGS. 6 to 149 will be described with reference to FIG. 1.

In a state in which a desired title has been selected, when the playback key 4c of the key operating/display device 4 or the playback key 5d of the remote controller 5 is input, the system CPU 50 acquires the last address of the title search pointer table TT_SRPT 79 from the title search pointer table information TT_SRPTI 92. In addition, the above CPU 50 acquires a video title set number VTSN corresponding to an input number from the title search pointer TT_SRP 93 according to selection of an input number from the key operating/display device 4 or a title number using the remote controller 5; the program chain number PGCN, and the start address VTS_SA of video title set. When only one title set exists, a search is made for one title search pointer TT_SRP 93 irrespective of the presence or absence of the input number from the key operating/display device 4 and selection of the title number using the remote controller 5, and the start address VTS_SA of that title set is acquired. The system CPU 50 acquires a target title set from the start address VTS_SA of this title set.

Next, from the start address VTS_SA of the video title set 72 shown in FIG. 19, the video title set information VTSI 94 of that title set is acquired as shown in FIG. 30. The end address VTI_MAT_EA of the video title set information management table VTSI_MAT 98 shown in FIG. 31 is acquired from the video title set information management table VTSI_MAT 98 of the video title set information VTSI 94. In addition, based on the number of audio and sub-picture data streams VTS_AST_Ns, VTS_SPST_Ns, and video, audio sub-picture data attribute information VTS_V_ATR, VTS_A_ATR, VTS_SPST_ATR each portion of the playback apparatus shown in FIG. 1 is set in accordance with that attribute.

When the menu VTSM for the video title set VTS is simply configured, the start address VTSM_VOBS_SA of the video object set VTSM_VOBS 95 for video title set menu is acquired from the video title set information management table VTSI_MAT shown in FIG. 31, and the video title set menu is displayed by the video object set VTSM_VOBS 95. Referring to this menu, when the video object set VTT_VOBS 96 for the title VTST in the title set VTS is simply reproduced without selecting the program chain PGC in particular, the video object set 96 is reproduced from the start address VTSTT_VOBS_SA shown in FIG. 31.

When a program chain PGC is specified by the key operating/display device 4 or the remote controller 5, a search is made for the target program chain in accordance with the following procedures. In searching this program chain, without being limited to a program chain for a title in a video title set, the similar procedures are used with respect to a program chain search for a menu even in a comparatively complicated menu on which the menu comprises a program chain. The start address of the program chain information table VTS_PGCIT 100 in the video title set VTS shown in FIG. 31 described in the management table VTSI_MAT 98 of the video title set information VTSI 94 is acquired, and information VTS_PGCIT_{—}1102 contained in that VTS program chain information table shown in FIG. 49 is read. From this information VTS_PGCIT_{—}1102, the number of program chains VTS_PGC_Ns and the end address VTS_PGCIT_EA of the table 100 shown in FIG. 41 are acquired.

If a program chain number is specified by the key operating/display device 4 or the remote controller 5, the program chain category and the start address of VTS_PGC information 104 corresponding to a search pointer VTS_PGCIT_SRP 103 are acquired from the VTS_PGCIT search pointer VTS_PGCIT_SRP 103 shown in FIG. 40 corresponding to that number. The program chain general information PC_GI shown in FIG. 43 is read out by the start address VTS_PGCI_SA. The category of the program chain PGC, the playback time PGC_CAT, PGC_PB_TIME and the like are acquired by general information PGC_GI, and the start addresses C_PBIT_SA and C_POSIT_SA, of the cell playback information table C_PBIT and cell position information table C_POSIT 108 described in the general information PGC_GI are acquired. From the start address C_PBIT_SA, the video object identifier C_VOB_IDN and cell identification number C_IDN as shown in FIG. 56 are acquired as cell position information C_POSI shown in FIG. 55.

The cell playback information C_PBI shown in FIG. 53 is acquired from the start address C_POSIT_SA; the start address C_FVOBU_SA of the first VOBU 85 in the cell shown in FIG. 54 described in the playback information C_PBI and the start address C_LVOBU_SA of the last VOBU are acquired; and a search is made for the target cell. With respect to the cell playback sequence, playback cells 84 are determined one after another, referring to a program map shown in FIG. 51 of the PGC program map PGC_PGMAP 106 shown in FIG. 43. The thus determined program chain data cells 84 are read out from a video object 144 one after another, and the read-out cells are input to the data RAM 56 via the system processor 54. The data cells 84 are supplied to the video decoder 58, audio decoder 60, and sub-picture decoder 62 based on playback time information, and are decoded. The decoded cells are converted into the corresponding signal by the D/A and playback processor 64, an image is reproduced at the monitor 6, and a voice is reproduced from the speakers 8.

Now, normal playback of video data utilizing the navigation pack 86 will be described in more detail with reference to a flow chart.

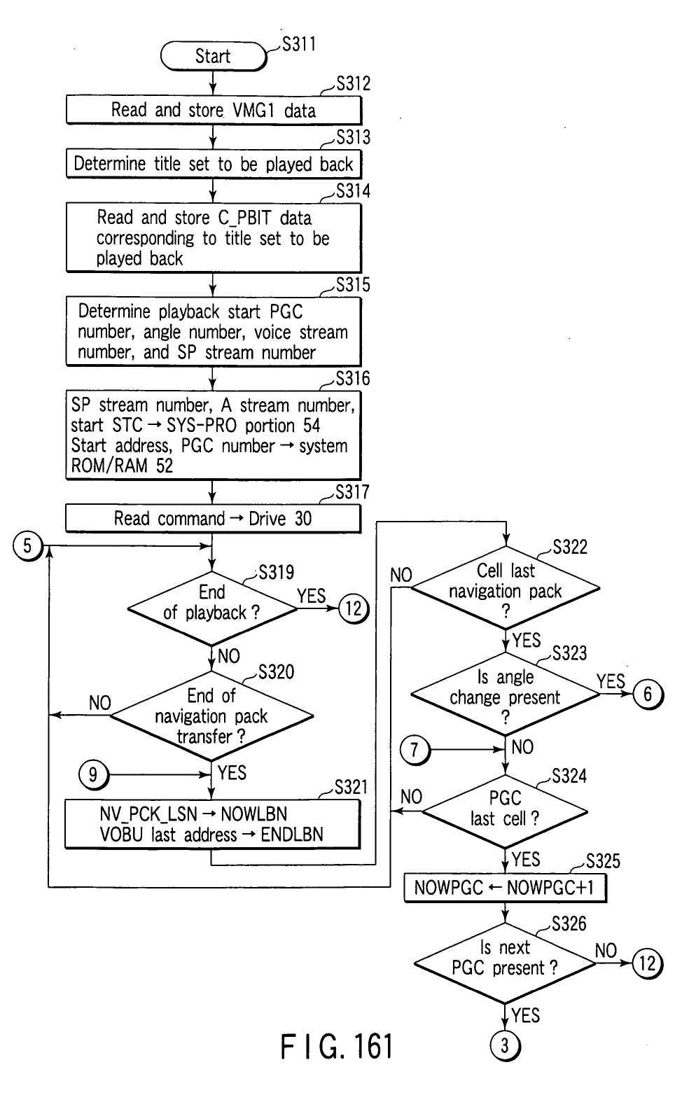

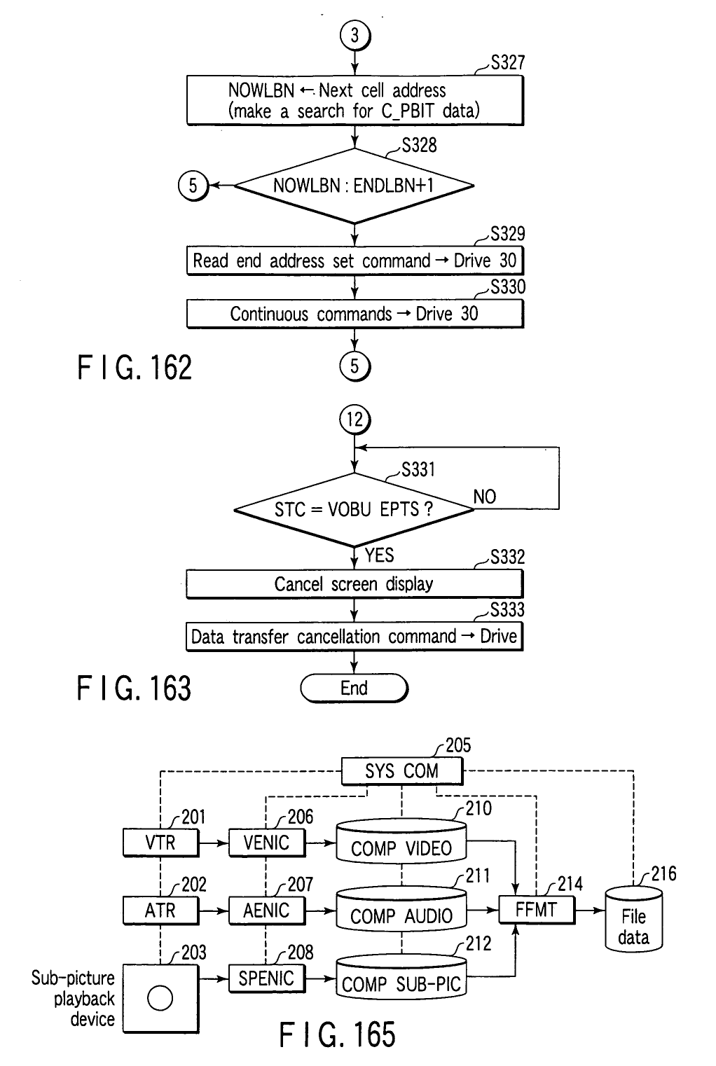

In normal playback of video data, as shown in FIGS. 161 and 162, when normal playback is started, a search is made for video manager information VMGI 75 by the system CPU 50, as has already been described after the start, and the video manager information is stored in the system ROM/RAM 52 (step S312). Similarly, the video title set information VTSI 94 of the video title set VTS 72 is read based on the video manager information VMGI 75, and the video title set menu is displayed at the monitor 6, as described above, by utilizing the video object set VTSM_VOBS 95. Based on this display, as shown in step S313, the title set 72, playback conditions and the like to be reproduced are determined by the user. When the thus determined title set 72 is selected by using the key operating/display device 4, the data contained in the cell playback information table C_PBIT 107 shown in FIGS. 43, 53, and 54 are read by the system CPU 50 from the program chain information table VTS_PCIT 100 shown in FIG. 30 in the title set 72 selected as shown in step S314, and this data is stored in the system ROM/RAM 52.

At the system CPU 50, as shown in step S315, the program chain number VTS_PGC_Ns, angle number ANGNs, audio stream number, and sub-picture stream number in which playback is started is determined by using each menu, according to the playback condition input from the key operating/display device 4 or the remote controller 5. For example, as a program chain, a title of 11th match of the boxing world championship is selected, and it is determined that the Japanese superimposition is displayed as a sub-picture with the English narration. As an angle, the user executes selection for determining a picture on which the user can enjoy a fight between the two boxers. The thus determined sub-picture number and audio stream number are set in the register 54B of the system processor 54, as shown in step S316. Similarly, a playback start time is set in the system time clocks STC 54A, 58A, 60A, and 62A of the system processor 54, video decoder 58, audio decoder 60, and sub-picture decoder 62. The start address and PGC number of the first VOBU in the cell which is the start address, i.e., the cell number is stored in the system ROM/RAM 52.

As shown in step S317, a read command is supplied from the system CPU 50 to the disk drive 30 at a time when a video title set is ready to be read, and the disk drive 30 seeks the optical disk 10 based on the above-described start address. By means of this read command, cells according to the specified program chains PGC are read out one after another from the optical disk 10, and the read-out cells are fed to the data RAM 56 via the system CPU 50 and the system processor 54. With respect to this fed cell data, as shown in FIG. 8, a pack from the navigation pack 86 which is a start pack of the video object unit VOBU 85 is stored in the data RAM 56. Then, the video pack 88 of the video object unit VOBU, audio pack 91, and sub-picture pack 90 are distributed to the video decoder 58, audio decoder 60, and sub-picture decoder 62, respectively; the distributed packs are decoded by the respective decoders; and the decoded packs are fed to the D/A and data playback processor 64. As a result, a picture signal is fed to the monitor 6; a voice signal is fed to the speaker 8; the display of picture together with a sub-picture is started; and voice playback is started.

In reproducing such a picture and voice, when interrupt processing is carried out from the key operating/display device 4 or the remote controller 5, the acquired key data is stored in the system RAM/ROM 52. When key data exists, it is determined whether or not the end of playback from the drive has been interrupted as shown in step S319. When the end of playback is not interrupted, transfer of the navigation pack 86 is waited as shown in step S320. When transfer of the navigation pack 86 is ended, the logical sector number NV_PCK_LSN in the navigation pack 86 is stored as the current logical block number NOWLBN in the system RAM/ROM 52, as shown in step S321.

When transfer of the NV pack 86 ends, it is determined whether or not the last NV pack 86 in that cell exists. That is, as shown in step S322, it is determined whether or not the last navigation pack 86 in the cell 84 exists as shown in step S322. This check is made by comparing the start address of C_LVOBU of the cell playback information table C_PBI 107 shown in FIG. 54 with the address V_PVK_LBN of the navigation pack 86. When the NV pack 86 is not the last pack in the cell, processing is returned to step 19. When the NV pack 86 is the last pack in cell 84, it is determined whether or not an angle is changed as shown in step S323. The angle change is determined based on whether or not an angle change is input from the key operating/display device 4 or the remote controller 5 to the system CPU 50. When no angle is changed, it is determined whether or not there exists the last cell of the program chain PGC to which that cell 84 belongs, as shown in step S324. This check is determined according to whether or not that cell 84 is the last cell of the cell playback information table C_PBIT 107 shown in FIGS. 43 and 53. That is, this check is made according to the number of cells forming a program chain and the identification number of the played-back cell. When a cell does not correspond to the last cell of the program chain PGC, processing is returned to step S319.

When cell 84 is the last cell of the program chain PGC, it is assumed that that program chain has ended, and the next program chain PGC is specified. Except in a special case, program chains are reproduced in order of numbers, the program chain number to be reproduced next is set by adding 1 to the number of program chain for which playback has ended, as shown in step S325. It is determined whether or not there exists a program chain of the set program chain number in step S326. When a program chain to be produced next exists, processing is moved to the flow of procedures for ending playback shown in FIG. 163 described later. When a set program chain exists, as shown in step S327, the address of the program chain cell set again and the start address C_FVOBU_SA of C_FVOBU 85 in the cell playback information C_PBI 107 shown in FIG. 54 are acquired as the current logical block number. As shown in step S328, it is determined whether or not the start address C_FVOBU_SA is equal to the address obtained by adding 1 to the last address ENDLBN of the previously played-back program chain cell 84. If the check result is affirmative, playback of cells for which addresses are-continuous are carried out, and thus, processing is returned to step S318. When the check result is negative, as shown in step S329, cell addresses are not continuous. Thus, the system CPU 50 issues a read end address command for indicating the end address of the current video object unit, and causes the disk drive 30 to cancel a readout operation at the disk drive 30 by using the specified address. Then, as shown in step S330, a read command is supplied from the system CPU 50 to the disk drive 30, and the start address is supplied to the disk drive 30. Then, processing is returned to step S319, and seeking of the navigation pack 86 is started.

When playback ends in step S319, or when a program chain to be reproduced next does not exist in step S326, reference is made to the end time PTMVOBU_EPTM described in general information PCI_GI of PPCI 113 as shown in step S331 of FIG. 163. If the end time PTMVOBU_EPTM matches the system time clock STC, the screen display of the monitor 6 is cancelled as shown in step S332. As shown in step S332, a data transfer cancellation command is supplied from the system CPU 50 to the disk drive 30, data transfer is cancelled, and a playback operation is ended.

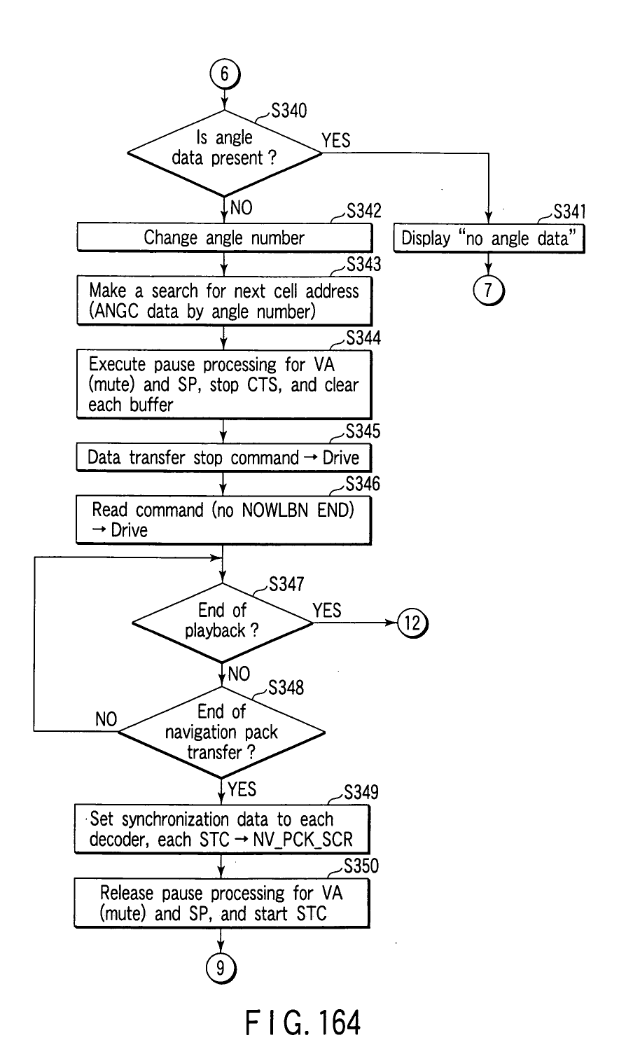

In step S323, if an angle change is input from the key operating/display device 4 or the remote controller 5, it is determined whether or angle data exists as shown in step S340 of FIG. 164. The presence or absence of this angle is described as angle information NSML_AGLI, SML_AGLI in both of PCI data 113 and DSI data 115 of the navigation pack 86. The system CPU 50 checks whether or not any information exists according to input from the key operating/display device 4 or the remote controller 5. In step 340, when no angle is targeted for change, the absence of angle data is displayed at the key operating/display device 4 or the monitor 6, as shown in step S341. After the absence of angle data has been displayed, processing is moved to step S324. When angle data exists, an angle number to be changed from the key operating/display device 4 or the remote controller 5 is specified as shown in step S342. As has already been described, it is specified whether or not an angle is changed utilizing any of angle information NSML_AGLI and SML_AGLI on PCI data and DSI data. However, when only one item of angle information exists, that selection is limited to one side. If an angle number is specified, the target address NSML_AGL_C_DSTA, SML_ANL_C_DSTA of the angle cell corresponding to the angle number specified as shown in FIGS. 69 and 70 is acquired in step S343. A search is made for a cell by using this address, and that address is set as the logical block number NOWLBN to be sought. In particular, during an angle change utilizing PCI, together with an angle change operation, the system CPU 50 applies mute processing to video and audio data playback and applies pause processing to sub-picture playback. Together with this processing, the system time clock STC of each portion of the playback apparatus is stopped, the buffers in the video, audio, and sub-picture encoders 58, 60, and 62 are cleared, enabling acceptance of changed angle data (step S344). At the same time, as shown in step S345, the system CPU 50 issues a read end address command, and causes the disk drive 30 to temporarily cancel a read operation. Then, as shown in step S346, a read command is supplied from the system CPU 50 to the disk drive 30, a search is made for a cell using the set logical block number to be sought, i.e., the start address of the selected angle cell, and transfer of the selected angle cell data is started.

Together with start of transfer, transfer of a navigation pack of a first cell which is a change angle destination is waited. As shown in step S348, it is determined whether or not the end of transfer of the navigation pack occurs together with data transfer. When no transfer of the navigation pack 86 occurs, processing returns to step S347. If transfer of the navigation pack 86 occurs, each system time clock STC is set, referring to SCR_NV_PCK_SCR of the NV pack 86 described in DSI general information DSIG of the navigation pack 86. Then, the video and audio mute states and the sub-picture pause state set in step S344 are released, and an operation of the system time clock STC is started. Then, the step S321 shown in FIG. 161 is executed in the same way as in normal playback.

Now, referring to FIGS. 165 to 170, a description will be given with respect to picture data in accordance with the logical format shown in FIGS. 6 to 74; a method of recording in the optical disk 10 in order to playback the picture data; and a recording system to which the recording method is applied.

FIG. 165 shows an encoder system for generating a picture file 88 of a title set 84 in which picture data has been encoded. In the system shown in FIG. 165, for example, a video tape recorder (VTR) 201, an audio tape recorder (ATR) 203, and a sub-picture playback device (Subpicture source) 203 are employed as sources of main picture data, audio data, and sub-picture data. These elements generate main picture data, audio data, and sub-picture data under the control of a system controller (Sys con) 205. These items of data are supplied to a video encoder (VENC) 206, an audio encoder (AENC) 207, and a sub-picture encoder (SPENC) 208, respectively. Similarly, the supplied data are A/D converted by these encoders 206, 207, and 208 under the control of the system controller (Sys con) 205, and the encoded main-picture data, audio data, and sub-picture data (Comp Video, Comp Audio, and Comp Subpict) are stored in memories 210, 211, and 212.

The main picture data, audio data, and sub-picture data (Comp Video, Comp Audio, and Comp Sub-pict) are output to a file formatter (FFMT) 214 by the system controller (Sys con) 205, and the output data are converted into a file structure of picture data in this file as has already been described. In addition, management information such as data setting conditions, attributes, and highlight information is stored as a file in the memory 216 by the system controller (Sys con) 205.

Hereinafter, a description will be given with respect to a specifications flow of encoding processing in the system controller (Sys con) 205 for producing a file from picture data.

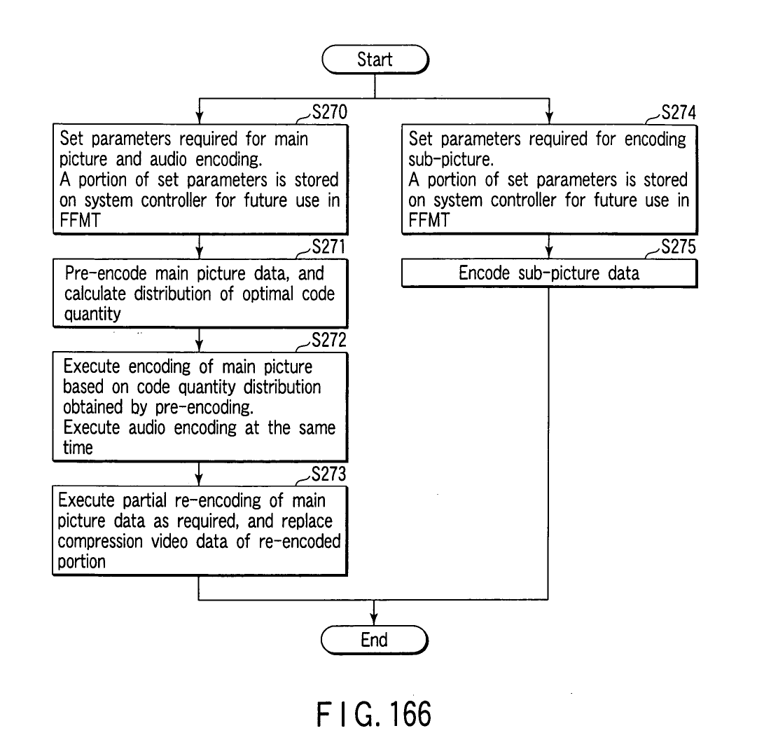

In accordance with the flow shown in FIG. 166, main picture data and audio data are encoded, and the encoded picture data and audio data (Comp Video, Comp Audio) are produced. That is, when encoding processing is started, parameters required for encoding main picture data and audio data are set as shown in step S270 of FIG. 166. A portion of these set parameters is stored in the system controller (Sys con) 205 and the stored portion is utilized by the file formatter (FFMT) 214. As shown in step S271, main picture data is preencoded by utilizing the parameters, and an optimal distribution of code quantity is calculated. As shown in step S272, based on the code quantity distribution obtained by pre-encoding, encoding of the main picture is executed. At this time, encoding of the audio data is executed at the same time. As shown in step S273, partial re-encoding of the main picture data is executed as required, and the main picture data of the re-encoded portion is replaced. In accordance of this series of steps, the main picture data and audio data are encoded. As shown in steps S274 and S275, the sub-picture data is encoded, and the encoded sub-picture data (Comp Sub-pict) is produced. That is, parameters required for encoding the sub-picture data are set similarly. As shown in step S274, a portion of the set parameters is stored in the system controller (Sys con) 205, and the stored portion is utilized by the file formatter (FFMT) 214. Base on these parameters, the sub-picture data is encoded. By this processing, the sub-picture data is encoded.

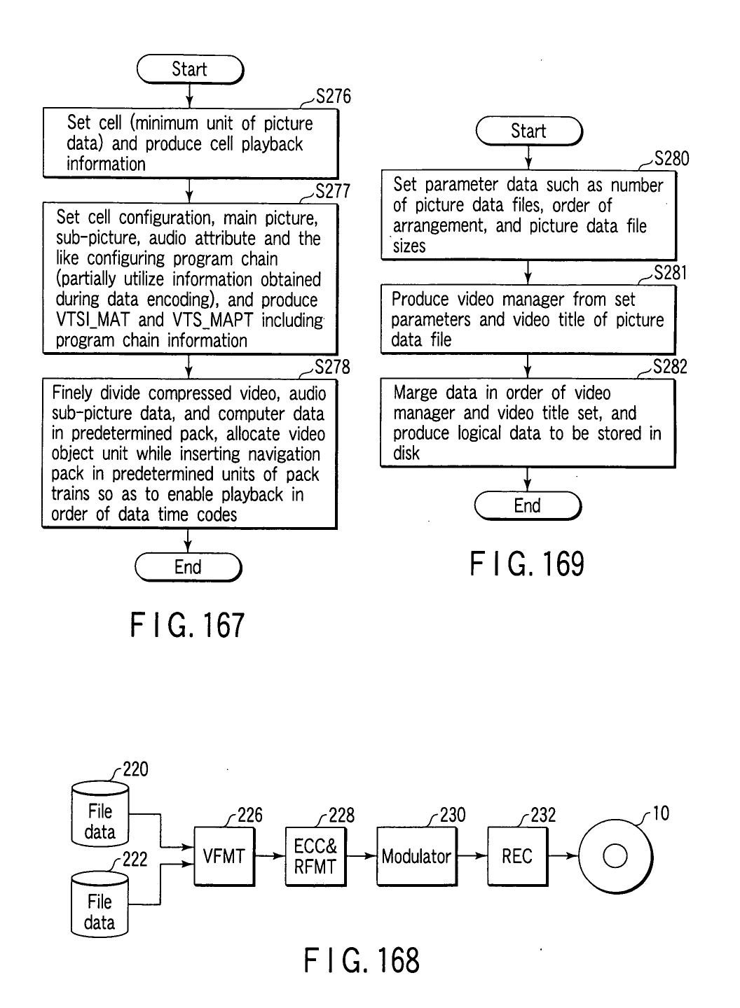

In accordance with the flow shown in FIG. 167, the encoded main picture data, audio data, and sub-picture data (Comp Video, Comp Audio, and Comp Sub-pict) are combined with each other, and combined data is converted into a picture data title set structure as described with reference to FIG. 6. That is, as shown in step S276, a cell is set as a minimum unit of picture data, and cell playback information C_PBI concerning cells is produced. Next, as shown in step S277, the configuration of cells configuring a program chain, sub-picture, audio attributes and the like are set (information obtained during data encoding is utilized as a portion of these items of attribute information). As shown in FIG. 12, there are produced video title set information management table information VTSI_MAT 98 including information concerning a program chain, and a video title set time search map table (VTS_TMAPT) 101. At this time, a video title set part-of-title search pointer table VTS_PTT_SRPT is also produced as required. The encoded main picture data, audio data, and sub-picture data (Comp Video, Comp Audio, and Comp Sub-pict) are finely divided into predetermined packs. Then, data cells are allocated while an NV pack is allocated at the beginning on a VOBU by VOBU basis so that these items of data can be reproduced in order of data time codes. Then, a video object VOB comprising a plurality of cells as shown in FIG. 6 is configured, and the configured video object is formatted in a structure of title set in these video object sets.

In the flow shown in FIG. 167, as program chain information, a database of the system controller (Sys con) 205 is utilized in the course of step S277, or operation for re-inputting data or the like is executed as required, and program chain information PGI is described.

FIG. 168 shows a disk formatter system for recording a formatted title set in an optical disk, as described above. As shown in FIG. 168, in the disk formatter system, these items of file data are supplied to a volume formatter (VFMT) 226 from the memories 220 and 222 in which the produced title sets are stored. In the volume formatter (VFMT) 226, management information is lead out from title sets 84 and 86, and the video manager VMG 74 is produced. Then, the logic data in a state to be recorded in the optical disk 10 in the arrangement order shown in FIG. 6. In a disk formatter (DVMT) 228, error correction data is added to logical data produced by the volume formatter (VFMT) 226, and is re-converted into physical data to be recorded in the disk. In a modulator 230, the physical data produced by the disk formatter (DFMT) 228 is actually converted into recording data to be recorded in the disk, and this recorded data processed to be modulated is recorded in the disk 10 by a recorder 232.

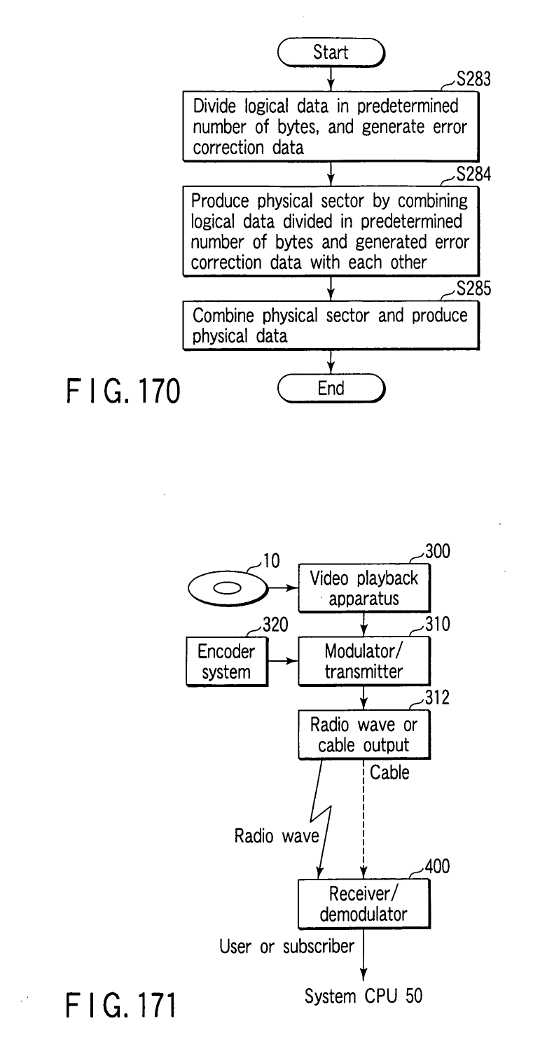

A standard flow for producing the above-described disk will be described with reference to FIGS. 169 and 170. FIG. 169 shows a flow in which logical data to be recorded in the disk 10 is produced. That is, as shown in step S280, parameter data such as the number of picture data files, arrangement order, and picture data file sizes are first set. The video manager VMG 74 is produced from the parameters set as shown in step S281 and the video title set information 281 of each video title set 72. Then, as shown in step S282, data are allocated along the corresponding logical block numbers in order of the video manager VMG 74 and video title set 72, and logical data to be recorded in the disk 10 is produced.

Then, the flow of producing physical data to be recorded in the disk as shown in FIG. 170 is executed. That is, as shown in step S283, logical data is divided into a predetermined number of bytes, and error correction data is produced. Next, as shown in step S284, the logical data divided into a predetermined number of bytes and the generated error correction data are combined with each other, and a physical sector is produced. Then, as shown in step S285, physical data is produced together with the physical sector. In this way, modulation processing based on a predetermined rule is executed for the physical data produced in the flow shown in FIG. 170, and recording data is produced. Then, this recording data is recorded in the disk 10.

The above-described data structure can be applied to a communication system as shown in FIG. 171 without being limited to a case of recorded data in a recording medium such as an optical disk, distributing the data to a user, and reproducing the distributed data there.

That is, in accordance with the procedures shown in FIGS. 165 to 168, the optical disk 10 storing the video manager VMG 74, video title set VTS 72 and the like as shown in FIG. 6 is loaded on a playback apparatus 300, and the data encoded from the system CPU 50 of that playback apparatus is taken out in a digital form so that the digital data may be fed to the user or cable subscriber side via a radio wave or cable by a modulator/transmitter 310. By means of the encoding system 320 shown in FIGS. 165 and 168, the data encoded on the provider side such as a broadcast service company is produced so that the encoded data may be fed to the user or cable subscriber side via a radio wave or cable by the modulator/transmitter 310 similarly. In such a communication system, information contained in the video manager VMG 74 is first modulated by the modulator/transmitter 310, or is directly distributed to the user side with free. When the user has an interest with that title, that title set 72 is fed to the user side via a radio wave or cable by the modulator/transmitter 310 upon the user or subscriber's request. In transfer of title, the video title set information 94 is first fed under the control of the video manager VMG 74, and then, the title video object 95 in a video title set reproduced based on this title set information 94 is transferred. At this time, the video object 95 for video title set menu is also fed as required. The fed data is received by a receiver/demodulator 400 on the user side. Then, the encode data is processed in the same manner as in the above-described playback processing by the system CPU 50 of the playback apparatus on the user or subscriber side shown in FIG. 1, and a video is reproduced.

In transfer of the video title set 72, the video object sets 95 and 96 are transferred on the basis of video object unit 85 shown in FIG. 6. The NV pack 86 in which video playback and search information are stored is allocated at the beginning of the video object unit 85. Moreover, in the NV pack 86, with the video object unit 85 to which that NV pack 86 belongs being a reference, the addresses of the video object units to be reproduced beforehand or afterward are described. Thus, even if the video object unit 85 has faulted for any reason during transfer of the video object unit 85, a request is made for retransfer of that faulty video object unit 85, whereby video data can be reliably reproduced on the user side. Even if transfer is not carried out in playback order of video object units, the user's system ROM/RAM 52 holds precise playback information on a program chain, whereby the system CPU 50 can indicate the playback order, referring to address data contained in that NV pack 86.

FIG. 173 is a flow chart showing an example of processing for recording information in an information recording medium such as a DVD video disk, a DVD audio disk, or a hard disk. The DVD video AV contents (for example, video contents) are recorded in a predetermined place (DVD area) of a volume space (step S402). Navigation contents are recorded in another predetermined place of the volume space (S404). The step of recording the AD contents and the step of recording the navigation contents may be reversed in order.

Finally, a description will be given with respect to a specific transition of a player model which is compatible with HD scheme picture data.

<Setting and Changing Title Playback Audio and Sub-Picture Streams: Relationship between Audio Stream Number and Decoding Audio Stream Number and Relationship between Sub-Picture Stream Number and Decoding Sub-Picture Stream Number>

Audio and sub-picture have two types of stream numbers, respectively. One of these two types includes an “audio stream number” and a “sub-picture stream number.” These numbers are used in argument for user operation and system parameter. The other type include a “decoding audio stream number” and a “decoding sub-picture number.” These numbers are identical to the stream numbers used for a stream_ID field in a packet header and a sub-stream_ID in a private packet. The decoding stream numbers are used in a demultiplexer or a decoder.

The player converts the audio stream number and the sub-picture stream number, respectively, by PGC_AST_CTLT and PGC_SPST_CTTL contained in program chain information PGCI.

An allowable number of streams (not decoding streams) and attributes of streams must not be changed in a title. However, PGC_AST_CLTL and PGC_SPST_CTLT are defined on a program chain information PGCI by program chain information PGCI basis so that the number of decoding streams may be changed on a program chain PGC by program chain PGC basis.

When a video aspect ratio is 16:9, a maximum of 4 decoding sub-picture streams can be allocated for one picture stream. These streams are used for HD, wide, pan/scan, and letterbox playback. When the aspect ratio is 4:3, one decoding sub-picture number is allocated to one sub-picture stream number.

<Information Contained in Video Manager Information VMGI Concerning Audio and Sub-Picture, V Video Title Set Information TSI, and Data Search Information DSI>

Among items of attribute information, VMGM_AST_ATR contained in video manager information VMGI, and VTSM_AST_ATR and VTS_AST_ATR in video title set information VTSI are described for audio streams.

Among items of attribute information, VMGM_SPST_ATR contained in video manager information VMGI, and VTSM_SPST_ATR and VTS_SPST_ATR in video title set information VTSI are described for sub-picture streams.

Audio stop PTM and audio gap length contained in seamless playback information of data search information DSI are described for decoding audio streams.

All the fields in synchronous information of data search information DSI are described for decoding audio streams and decoding sub-picture streams.

<Player's Selection of Decoding Audio Stream Number>

The player must decode a stream specified by a “decoding audio stream number” in PGC_AST_CTL.

<Player's Selection of Decoding Sub-Picture Stream Number>

When the aspect ratio of the current domain video attribute VMGM_V_ATR, VTSM_V_ATR or VTS_V ATR is “00b” (4:3), the player must decode a stream specified by the 4:3 decoding sub-picture stream number in PGC_SPST_CTL. When the aspect ratio of the current domain video attribute is “11b” (16:9), there must be decoded a stream which is one of the HD decoding sub-picture stream number in PGC_SPST_CTL, wide aspect ratio decoding sub-picture stream number, letterbox decoding sub-picture stream number, and pan/scan decoding sub-picture stream number, coinciding with the current video display (HD, wide, pan/scan, or letterbox).

In the foregoing description, although a video object unit has been described as a data train including video, audio, and sub-picture, this unit may include any of video, audio, and sub-picture, and may comprise only an audio pack or only a sub-picture pack.

As has been described above, according to the embodiments of the present invention, by utilizing picture data comprising main picture data and sub-picture data, reaction can be made in real time according to the user's selection result with a little burden on playback equipment.

Further, a menu is produced by using main picture data which is a background image of a menu and sub-picture data comprising a selection item or a determination item of a menu; and highlight information is changed for the selection item or determination item of sub-picture data, namely, a character color or contrast is changed, whereby a variety of menus can be easily produced.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

What is claimed is:

1. An information recording medium recording a video manager and a plurality of video title sets, wherein each of the video title sets describes video title set information; the video title set information describes a video title set information management table; the video title set information management table describes an attribute of a sub-picture stream about a video title set menu; and the attribute of the sub-picture stream describes a flag indicating a method for storing pixel data and a flag indicating a run length compression/non-compression of the pixel data.

2. An information recording medium according to claim 1, wherein the flag indicating the method for storing pixel data indicates one of a storage method according to an interlace display and a storage method according to a non-interlace display.

3. An information recording medium recording a video object set comprising a plurality of video objects, each of the video objects comprising a plurality of cells, each of the cells comprising a plurality of video object units including a video pack and a sub-picture pack, wherein a sub-picture unit formed of a plurality of sub-picture data included in the sub-picture pack comprises a sub-picture unit header, pixel data, and a display control sequence table; the sub-picture unit header describes a sub-picture category; and the sub-picture category describes a flag indicating a method for storing the pixel data and a flag indicating a run length compression/non-compression of the pixel data.

4. An information recording medium according to claim 3, wherein the flag indicating the method for storing pixel data indicates one of a storage method according to an interlace display and a storage method according to a non-interlace display.

5. An information playback apparatus used for an information recording medium recording a video manager and a plurality of video title sets, wherein each of the video title sets describes video title set information; the video title set information describes a video title set information management table; the video title set information management table describes an attribute of a sub-picture stream about a video title set menu; and the attribute of the sub-picture stream describes a flag indicating a method for storing pixel data and a flag indicating a run length compression/non-compression of the pixel data, the information playback apparatus comprising:
means for reading the flag indicating the method for storing pixel data and the flag indicating the run length compression/non-compression from the information recording medium;
means for discriminating whether or not the pixel data is in a high definition scheme or in a standard definition scheme based on the flags read by the reading means; and
means for making a decoder required for playback standby, according to a data scheme discriminated by the discriminating means.

6. An information playback apparatus according to claim 5, wherein the flag indicating the method for storing pixel data indicates one of a storage method according to an interlace display and a storage method according to a non-interlace display.

7. An information playback apparatus used for an information recording medium recording a video object set comprising a plurality of video objects, each of the video objects comprising a plurality of cells, each of the cells comprising a plurality of video object units including a video pack and a sub-picture pack, wherein a sub-picture unit formed of a plurality of sub-picture data included in the sub-picture pack comprises a sub-picture unit header, pixel data, and a display control sequence table; the sub-picture unit header describes a sub-picture category; and the sub-picture category describes a flag indicating a method for storing the pixel data and a flag indicating a run length compression/non-compression of the pixel data, the information playback apparatus comprising:
means for reading the flag indicating the method for storing the pixel data and the flag indicating the run length compression/non-compression from the information recording medium;
means for discriminating whether or not the pixel data is in a high definition scheme or in a standard definition scheme based on the flags read by the reading means; and
making a decoder required for playback standby, according to a data scheme discriminated by the discriminating means.

8. An information playback apparatus according to claim 7, wherein the flag indicating the method for storing pixel data indicates one of a storage method according to an interlace display and a storage method according to a non-interlace display.

9. An information playback method for an information recording medium recording a video manager and a plurality of video title sets, wherein each of the video title sets describes video title set information; the video title set information describes a video title set information management table; the video title set information management table describes an attribute of a sub-picture stream about a video title set menu; and the attribute of the sub-picture stream describes a flag indicating a method for storing pixel data and a flag indicating a run length compression/non-compression of the pixel data, the information playback method comprising:
reading the flag indicating the method for storing the pixel data and the flag indicating the run length compression/non-compression from the information recording medium;
discriminating whether or not the pixel data is in a high definition scheme or in a standard definition scheme based on the read flags; and
making a decoder required for playback standby, according to the discriminated data scheme.

10. An information playback method according to claim 9, wherein the flag indicating the method for storing pixel data indicates one of a storage method according to an interlace display and a storage method according to a non-interlace display.

11. An information playback method for an information recording medium recording a video object set comprising a plurality of video objects, each of the video objects comprising a plurality of cells, each of the cells comprising a plurality of video object units including a video pack and a sub-picture pack, wherein a sub-picture unit formed of a plurality of sub-picture data included in the sub-picture pack comprises a sub-picture unit header, pixel data, and a display control sequence table; the sub-picture unit header describes a sub-picture category; and the sub-picture category describes a flag indicating a method for storing the pixel data and a flag indicating a run length compression/non-compression of the pixel data, the information playback method comprising:
reading the flag indicating the method for storing the pixel data and the flag indicating the run length compression/non-compression from the information recording medium;
discriminating whether or not the pixel data is in a high definition scheme or in a standard definition scheme based on the read flags; and
making a decoder required for playback standby, according to the discriminated data scheme.

12. An information playback method according to claim 11, wherein the flag indicating the method for storing pixel data indicates one of a storage method according to an interlace display and a storage method according to a non-interlace display.
